(19) United States
(12) Patent Application Publication
(10) Pub. No.: US 2008/0275820 A1
(43) Pub. Date: Nov. 6, 2008

(54) Apparatus and method for providing account security

(76) Inventors: Raymond Anthony Joao, Yonkers, NY (US); Robert Richard Bock, Yonkers, NY (US)

Correspondence Address: RAYMOND A. JOAO, ESQ., 122 BELLEVUE PLACE, YONKERS, NY, 10703, US

(21) Appl. No.: 12/217,566

(22) Filed: Jul. 7, 2008

Related U.S. Application Data
(63) Continuation-in-part of application No. 10/769,678, filed on Jan. 31, 2004.
Application No. 10/769,678 is a continuation-in-part of application No. 09/489,657, filed on Jan. 21, 2000, now abandoned.

(51) Int. Cl. G06Q 40/00

(52) U.S. Cl. 705/44

(57) ABSTRACT

An account security apparatus, including a memory device for storing a limitation or restriction on a use of at least one of a cable television account, an electrical utility account, a gas utility account, a fuel oil utility account, an insurance account, a subscription accounts for a good, product, or service, a health care insurance account, a pharmacy account, a social security account, and a credit report account, transmitted to a receiver from a communication device associated with an individual account holder, and a processing device for processing an authorization request for a transaction or a use of the account. The processing device utilizes the limitation or restriction automatically stored in the memory device in processing the authorization request and generates a signal containing information for authorizing or disallowing the transaction or the use of the account.

### RELATED APPLICATIONS

This application is a continuation-in-part application of U.S. patent application Ser. No. 10/769,678, filed Jan. 31, 2004, which application is a continuation-in-part application of U.S. patent application Ser. No. 09/489,657, filed Jan. 21, 2000, now abandoned, the subject matter and teachings of which applications is hereby incorporated by reference herein in their entirety.

### FIELD OF THE INVENTION

The present invention pertains to an apparatus and a method for providing account security and, in particular, to an apparatus and a method for providing account security, monitoring, notification, and/or authorization, for any one or more of credit card accounts, charge card accounts, debit card accounts, smart card accounts, currency card accounts, telephone calling card accounts, cable television accounts, digital television accounts, satellite television accounts, utility accounts, electrical utility accounts, gas utility accounts, fuel oil utility accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, facility access accounts, facility security accounts, bank accounts, savings accounts, checking accounts, financial accounts, brokerage accounts, electronic money accounts, electronic cash accounts, communication accounts, telephone accounts, wireless communication device accounts, non-wireless communication device accounts, cellular communication device accounts, Internet accounts, Internet service provider accounts, credit report accounts, insurance accounts, and/or any other accounts, as well as any cards, devices, and/or other entities which can be associated with any of the above accounts, which can be associated with an individual and/or an entity.

### BACKGROUND OF THE PRESENT INVENTION

Millions of individuals enjoy the convenience of utilizing credit cards, charge cards, debit cards, currency or “smart” cards, telephone calling cards, and/or other cards or devices for use in conjunction with various types of accounts. These cards or accounts can provide for a convenient manner in which to conduct commerce, purchase goods and/or services, conduct financial transactions, conduct non-financial transactions, conduct communications transactions, provide security services, and/or perform a vast array of activities or services.

By utilizing credit cards, charge cards, debit cards, currency or “smart” cards, telephone calling cards, and other cards or devices, an individual can enter into a transaction or communication without having to have cash or currency in hand or otherwise. In the case of credit cards, charge cards and debit cards, the individual, in effect, can obtain an instant loan of the funds needed to make a purchase and/or enter into a transaction.

In the case of currency or “smart” cards, the individual can “store” an amount of money on the card(s) and, thereafter, utilize the card(s), instead of cash or currency, in order to make purchases and/or enter into transactions. In the case of telephone calling cards, subscription cards and/or other account cards, the individual can utilize the respective cards in order to make a communication (i.e. a telephone call) or enter into a transaction (i.e. obtain a good or service from the issuer or other entity) without having cash in hand.

Millions of individuals also enjoy the benefits of having financial accounts, brokerage accounts, savings accounts, checking accounts, and/or automated teller machine accounts. It is also envisioned that electronic money, electronic cash and/or digital cash accounts may also become a viable vehicle by which to conduct commerce.

In the communications field, many individuals enjoy use of wireless telephones, pagers, two-way pagers, personal digital assistants which offer or provide communications capabilities. Many individuals also enjoy the convenience of telephones, telephone accounts, etc. of the non-wireless variety. Lastly, with the ever growing popularity of the Internet and/or the World Wide Web, more and more individuals and businesses are establishing Internet accounts and are conducting commerce, transactions, and/or communications on the Internet.

There is no doubt that the above-described accounts and/or corresponding cards and/or devices, provide many advantages and/or conveniences for their respective account holders. For example, credit cards, charge cards, debit cards, currency or “smart” cards, and/or telephone calling cards, allow account holders or cardholders to be parties to transactions, such as by allowing the account holder or cardholder to buy goods and/or services, and/or to make telephone calls, without having to have cash on hand, and/or without being at the merchant's physical location.

Banking accounts, savings accounts, checking accounts, financial accounts, ATM accounts, brokerage accounts, and/or electronic money accounts, allow individuals to save their money in a secure manner, and/or allows them to invest their money, and/or perform transactions from locations remote from the respective bank, brokerage, and/or electronic money or electronic cash depository or administration facility. Internet accounts provide account holders with access to the Internet and/or the World Wide Web while also allowing them to conduct transactions, financial, commercial, communication, and/or otherwise.

However, along with all of the advantages and conveniences which the above-described accounts and/or corresponding cards and/or devices provide, these accounts can present many problems and/or disadvantages for their respective account holders. For example, credit cards and charge cards, and their respective accounts, have for a long time been plagued by fraud, fraudulent transaction and/or unauthorized account usage.

Credit card fraud and/or charge card fraud can result in millions and millions of dollars in fraud and theft losses each year. This fraudulent activity typically results when credit cards or charge cards are lost, stolen, ands/or when their respective account numbers are stolen or misappropriated. Credit card or charge card fraud can be even more prevalent involving transactions over the telephone and/or the Internet and in other instances when all that is needed to enter into a transaction is the account number and card expiration date.

Debit cards, currency cards, “smart” cards, and/or telephone calling cards, and/or their respective accounts, can also be the subject of theft, fraudulent activity, and/or unauthorized use activity, when they can be lost, stolen, and/or have their respective account numbers and/or expiration dates stolen and/or misappropriated.

Banking accounts, savings accounts, checking accounts, financial accounts, and/or Automated Teller Machine (ATM) accounts, brokerage accounts, and/or electronic money accounts, can also be the subject of theft, fraudulent activity, and/or unauthorized use activity, such as when the respective account numbers are misappropriated, accounts are accessed by unauthorized activity, checks are lost, stolen, obtained by fraudulent activity, and/or cloned, copied and/or “washed”, and/or when ATM cards or other cards associated with an account can be lost, stolen, and/or when a corresponding account is accessed in an unauthorized manner.

As banking accounts, savings accounts, checking accounts, financial accounts, and/or Automated Teller Machine (ATM) accounts, brokerage accounts, and/or electronic money accounts, become more and more accessible on-line and/or over the Internet and/or the World Wide Web, there is no doubt that the threat of the above-described fraudulent activity and/or unauthorized use activity can become even more of threat and/or a problem for these respective account holders.

Wireless communication devices, wireless telephones, cellular telephones, non-wireless communication devices, conventional telephones, line-connected telephones, and/or their corresponding accounts, etc., can also be the subject of fraudulent activity and/or unauthorized use activity. Such fraudulent activity and/or unauthorized use activity can result from a wireless communication device, a wireless telephone, and/or a cellular telephone, being lost, stolen, and/or when the respective electronic transmission information and/or signatures of these devices are stolen or misappropriated, via electronic interception activity, and/or when the respective wireless devices are “cloned”.

Non-wireless communication devices, conventional telephones, line-connected telephones, and/or their corresponding accounts, can also be the subject of fraudulent activity and/or unauthorized use activity, such as when the account is used to make unauthorized communications and/or telephone calls, when a telephone calling card associated with the account is lost, stolen, and/or when the corresponding telephone account calling card number, pin number, and/or call access number, is stolen and/or misappropriated.

Internet accounts can also be the subject of problems and disadvantages. As is well known, the Internet is a medium which can allow or provide access to a great number of different web sites and/or host computers. Many of these web sites contain adult subject matter, pornographic materials, provide access to electronic meeting places or “chat” rooms, and/or in other ways provides access to objectionable subject matter. This presents a problem for parents who want to prohibit their children and other minors from accessing these web sites, host computers and/or materials provided by same.

Another problem which plagues some Internet accounts is that some individuals carry on-line purchasing activities, on-line auctioning and bidding activities, and even on-line gambling activities, to the extremes, thereby resulting in financial and/or other obligations which they may be in no position to address and/or to meet. For example, an individual who, all of a sudden, becomes fixated on buying goods and/or services on-line, and/or who carries on-line auctioning and/or bidding activities too far, thereby incurring debts which they may be unable to satisfy. On-line gamblers can also carry on-line gaming activities too far, thereby resulting gambling debts which they may not be able to satisfy.

The above-described problems and/or disadvantages which are associated with and/or which correspond to the above-described accounts, and/or cards and/or devices corresponding thereto, can present problems, difficulties, and/or inconveniences for the respective account holders.

Current account security and/or usage monitoring practices do not appear to be sufficient in preventing and/or in thwarting the above-described theft activities, fraudulent activities, unauthorized use activities, and/or in preventing the described problems associated with these accounts. As a result, there is a need for an apparatus and a method which can provide account security and/or account usage monitoring for the above-described accounts and/or which can service the needs of the respective account holders.

### SUMMARY OF THE INVENTION

The present invention provides an apparatus and a method for providing account security. The present invention can provide account security for financial accounts, communications accounts, Internet accounts, and/or any other of the herein-described accounts and/or for the various cards, devices, computers, and/or account identifiers, which correspond to the respective accounts.

The present invention can be utilized to provide transaction authorization, notification and/or security, and, in particular, can provide an apparatus and a method which can provide financial transaction authorization, notification, and/or security, in conjunction with use of credit cards, charge cards, debit cards, and/or currency or “smart” cards, credit card accounts, charge card accounts, debit card accounts, smart card accounts, currency card accounts, telephone calling cards, Automated Teller Machine (ATM) cards, as well as any other accounts which utilize cards or other devices, financial accounts, banking accounts, bank accounts, checking accounts, savings accounts, access security accounts, brokerage accounts, electronic money accounts, electronic cash accounts, and/or digital cash accounts, wireless communication accounts, non-wireless communication accounts, Internet accounts, cable television accounts, digital television accounts, satellite television accounts, utility accounts, electrical utility accounts, gas utility accounts, fuel oil utility accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, facility access accounts, facility security accounts, communication accounts, telephone accounts, wireless communication device accounts, non-wireless communication device accounts, cellular communication device accounts, Internet accounts, Internet service provider accounts, credit report accounts, insurance accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, health club membership accounts, merchant credit accounts for customers, merchant accounts, association membership accounts, professional association membership accounts, trade association membership accounts, and/or any accounts, cards, devices, communication devices, and/or computers which can be utilized in conjunction with any of the herein-described accounts.

The present invention overcomes the shortcomings of the prior art and provides an apparatus and method which provides account monitoring, notification or account transactions and/or account communications, account usage, account authorization, and account security.

The apparatus of the present invention, which is utilized in conjunction with credit cards, charge cards, debit cards, currency and/or “smart” cards, and/or respective accounts, and/or other account cards and/or their respective accounts described herein, can include a point-of-sale device or point-of-transaction device, such as those found at retail establishments and/or at other locations where account transactions can take place. The point-of-sale device processes the transactions which occur on the respective account. The apparatus can also include a central processing computer for processing transactions and/or authorization requests for the respective account cards and/or accounts. The apparatus can also include an account holder communication device and/or multiple communication devices for receiving signals, data, and/or information, for providing notification to the account holder of transactions and/or authorization requests which are made on the respective account.

The communication device and/or communication devices can receive signals, data, and/or information directly from the point-of-sale device, via a communication network, and independently of any transaction processing by any central processing computer or service. The communication device and/or communication devices can also receive signals, data, and/or information, directly from the central processing computer via a communication network. The communication device and/or communication devices can also transmit signals, data, and/or information, directly to the point-of-sale device via a communication network. The communication device and/or communication devices can also transmit signals, data, and/or information, directly to the central processing computer, via a communication network.

The apparatus can provide transaction notification to an account holder regarding account transactions, authorization requests, and/or other activity, directly via a communication network. The apparatus can also provide transaction notification to an account holder regarding account transactions, authorization requests, and/or other activity, indirectly via the central processing computer and a communication network.

The account holder, upon receiving notification of the transaction, request for authorization, and/or other activity, can then transmit a response to either the point-of-sale device and/or to the central processing computer for either allowing or authorizing the transaction, request for authorization, and/or the activity.

The account holder can, at any time and from any location, program restrictions and/or limitations regarding account usage and/or account activity into the respective central processing computer servicing the account. Thereafter, transactions, the requests for authorizations, and/or the account activity, can be processed by the central processing computer in conjunction with the restrictions and/or limitations which are provided by the account holder. Similarly, the account holder can program restrictions and/or limitations regarding account activity into a respective point-of-sale device and/or into a respective communication device.

Any and/or all of the communications which occur between any of the point-of-sale devices, the central processing computers, the account holder communication devices, and/or between the account holder and any of the apparatus devices and/or computers, can take place in real-time, and/or otherwise.

The apparatus and method of the present invention can be utilized to provide an account holder with transaction notification in real-time and/or otherwise. The apparatus can provide an account holder with transaction notification from the point-of-sale device, and/or from the central processing computer. The account holder can then transmit a signal, data, and/or information, to the respective point-of-sale device and/or to the central processing computer, to approve, authorize, disallow, or cancel, the transaction.

The apparatus of the present invention, which is utilized in conjunction with banking accounts, savings account, checking accounts, financial accounts, brokerage accounts, and/or electronic money accounts, electronic cash accounts, digital money accounts and/or digital cash accounts, includes a transaction device for servicing the transactions which occur on the respective account. For example, a banking device can be utilized in conjunction with banking accounts, savings accounts, checking accounts, and/or financial accounts, a brokerage device can be utilized in conjunction with brokerage accounts, and an electronic cash device can be utilized in conjunction with electronic money, electronic cash, digital money and/or digital cash accounts.

The apparatus can also include a central processing computer for processing transactions and/or authorization requests for the respective account. The apparatus can also include an account holder communication device and/or multiple communication devices for receiving signals, data, and/or information, for providing notification to the account holder of transactions and/or authorization requests which are made on the respective account.

The communication device and/or communication devices can receive signals, data, and/or information directly from the respective banking device, brokerage device, or electronic cash device, via a communication network, and independently of any transaction processing by any central processing computer or service. The communication device and/or communication devices can also receive signals, data, and/or information, directly from the central processing computer, via a communication network. The communication device and/or communication devices can also transmit signals, data, and/or information directly to the respective banking device, brokerage device, or electronic cash device, via a communication network. The communication device and/or communication devices can also transmit signals, data, and/or information, directly to the central processing computer, via a communication network.

The apparatus can provide transaction notification to an account holder regarding account transactions, authorization requests, and/or other activity, directly via a communication network. The apparatus can also provide transaction notification to an account holder regarding account transactions, authorization requests, and/or other activity, indirectly via the central processing computer and a communication network.

The account holder, upon receiving notification of the transaction, request for authorization, and/or other activity, can then transmit a response to either the respective banking device, brokerage device, or electronic cash device and/or to the central processing computer for either allowing or authorizing the transaction, the request for authorization, and/or the activity.

The account holder can, at any time and from any location, program restrictions and/or limitations regarding account usage and/or account activity into the respective central processing computer servicing the account. Thereafter, transactions, requests for authorizations, and/or account activity, can be processed by the central processing computer in conjunction with the restrictions and/or limitations which are provided by the account holder. Similarly, the account holder can program restrictions and/or limitations regarding account activity into a respective banking device, brokerage device, or electronic cash device and/or into a respective communication device.

Any and/or all of the communications which occur between any of the respective banking devices, brokerage devices, or electronic cash devices, the central processing computers, the account holder communication devices, and/or between the account holder and any of the apparatus devices and/or computers, can take place in real-time, and/or otherwise.

The apparatus and method of the present invention can be utilized to provide an account holder with transaction notification in real-time and/or otherwise. The apparatus can provide an account holder with transaction notification from the respective banking device, brokerage device, or electronic cash device, and/or from the central processing computer. The account holder can then transmit a signal, data, and/or information, to the respective banking device, brokerage device, or electronic cash device, and/or to the central processing computer, to approve, authorize, disallow, or cancel, the transaction.

The apparatus of the present invention, which is utilized in conjunction with wireless communication accounts and/or wireless communication devices, non-wireless communication accounts and/or non-wireless communication devices, and/or Internet accounts and/or Internet communication devices, includes a transaction device for servicing the communications and/or transactions which occur on the respective account. For example, a wireless communication device can be utilized in conjunction with wireless communication accounts, a transaction (non-wireless) communication device can be utilized in conjunction with non-wireless communication accounts, and Internet communication devices can be utilized in conjunction with Internet accounts.

The apparatus can also include a central processing computer for processing communications and/or transactions and/or authorization requests for the respective account. The apparatus can also include an account holder communication device and/or multiple communication devices for receiving signals, data, and/or information, for providing notification to the account holder of communications, transactions, and/or authorization requests, which are made on the respective account.

The account holder communication device and/or communication devices can receive signals, data, and/or information directly from the respective wireless communication device, transaction (non-wireless communication) device, or Internet communication device, via a communication network, and independently of any communication and/or transaction processing by any central processing computer or service.

The account holder communication device and/or communication devices can also receive signals, data, and/or information, directly from the central processing computer, via a communication network. The account holder communication device and/or communication devices can also transmit signals, data, and/or information, directly to the respective wireless communication device, transaction (non-wireless communication) device, or Internet communication device, via a communication network. The account holder communication device and/or communication devices can also transmit signals, data, and/or information, directly to the central processing computer, via a communication network.

The apparatus can provide transaction notification to an account holder regarding account communications, transactions, authorization requests, and/or other activity, directly and via a communication network. The apparatus can also provide communication and/or transaction notification to an account holder regarding account communications, transactions, authorization requests, and/or other activity, indirectly and via the central processing computer and a communication network.

The account holder, upon receiving notification of the communication and/or transaction, request for authorization, and/or other activity, can then transmit a response to either the respective wireless communication device. Transaction (non-wireless) communication device, or Internet communication device, and/or to the central processing computer, for either allowing or authorizing the communication, the transaction, the request for authorization, and/or the activity.

The account holder can, at any time and from any location, program restrictions and/or limitations regarding account usage and/or account activity into the respective central processing computer servicing the account. Thereafter, transactions, requests for authorizations, and/or account activity, can be processed by the central processing computer in conjunction with the restrictions and/or limitations which are provided by the account holder. Similarly, the account holder can program restrictions and/or limitations regarding account activity into a respective wireless communication device, transaction (non-wireless) communication device, or Internet communication device, and into a respective account holder communication device.

Any and/or all of the communications which occur between any of the respective wireless communication devices, transaction (non-wireless) communication devices, Internet communication devices, the central processing computers, the account holder communication devices, and/or between the account holder and any of the apparatus devices and/or computers, can take place in real-time, and/or otherwise.

The apparatus and method of the present invention can be utilized to provide an account holder with communication and/or transaction notification in real-time and/or otherwise. The apparatus can provide an account holder with transaction notification from the respective wireless communication device, transaction (non-wireless) communication device, or Internet communication device, and/or from the central processing computer. The account holder can then transmit a signal, data, and/or information, to the respective wireless communication device, transaction (non-wireless) communication device, or Internet communication device, and/or to the central processing computer, to approve, authorize, disallow, or cancel, the transaction.

The present invention can be utilized in conjunction with any appropriate or suitable communication network or system, including, but not limited to, telephone communication networks or systems, telecommunication networks or systems, satellite communication network or systems, wireless communication networks or systems, radio communication networks or systems, digital satellite communication networks or systems, personal communication services communication networks or systems, global standard for mobile communication network or systems, cable television networks or systems, digital television networks or systems, satellite television networks or systems, broadband communication networks or systems, the Internet, the World Wide Web, as well as any other appropriate communication network or system.

The account holder communication devices can also include a facsimile (fax) machine, a personal computer, a personal digital assistant, a telephone, a telephone answering machine, an alternate telephone, an alternate telephone answering machine, a network computer and/or an alternate beeper or pager.

The apparatus and method of the present invention can be utilized in order to provide account holders with transaction and/or communication authorization services, notification services, account monitoring services, and/or security services, for any of the accounts described herein.

The apparatus and method of the present invention can also be utilized in connection with an on-line service and/or on, or over, the Internet and/or the World Wide Web, so as to provide for a means by which the authorized user or operator can utilize the apparatus in conjunction with a home and/or a personal computer and/or a commercial or industrial computer system (i.e., an internet server computer) and/or any other appropriate device, including a personal communication and/or computing device, in a network environment, and which can be utilized over any suitable and/or appropriate communications network or medium.

The communications system utilized in conjunction with the present invention can operate anywhere in the electromagnetic and/or the radio spectrum. Personal communication service (PCS) systems and devices, including stationary, portable and/or hand-held devices, and digital signal communications devices and systems, can also be utilized. The communication system or medium should provide for the transmission and for the reception of a multitude of remote electrical, electronic, electromagnetic, and/or other suitable signals, over long distances and/or in a mobile and/or a wireless communications environment.

The apparatus and method of the present invention can be utilized in conjunction any appropriate communications device which can be utilized with any appropriate communications system and/or medium.

The present invention can also be equipped with, and be utilized with, hardware and software necessary for providing self-monitoring functions, automatic control and/or responses to occurrences, automatic notice of an occurrence and/or a situation, to an account holder, cardholder, account owner, and/or other authorized individual. In this regard, any and all of the embodiments described herein can include a monitoring device, a triggering device and/or any other suitable device for detecting an occurrence and/or for identifying a situation which can warrant providing notice to an account holder, a cardholder, an account owner, and/or any other authorized individual.

In this regard, the apparatus and method can provide a transmission of any appropriate signal from a transmitter and, if desired, from a voice synthesizer to the respective account holder, cardholder, account owner, and/or any other authorized individual. The signal utilized could be in the form of a communication transmission, depending upon the communication medium utilized, a telephone call, a voice message, a beeper and/or a pager message, an electronic mail message, a fax transmission, and/or any other mode of communication which can be utilized with any of the apparatuses, devices and/or components described herein.

The apparatus can be designed or programmed to telephone and/or communicate with the respective account holder, cardholder, account owner, and/or any other authorized individual, at a primary phone number, at an alternate or forwarding phone number, and/or at a business phone number, send a beeper or pager message to the individual, and/or send a fax message, an electronic mail (e-mail) message, a voice mail message and/or an answering service message to, or for, the respective account holder, cardholder, account owner, and/or any other authorized individual. In this manner, the apparatus can communicate with the respective individual by utilizing multiple notification and/or reporting avenues and/or devices so as to provide and to ensure that best efforts are to be made to communicate with the desired individual as soon as possible.

The apparatus and method of the present invention can also be programmable for programmed and/or automatic activation, self-activation, programmed and/or automatic operation and/or self-operation. The apparatus and method of the present invention can provide for an immediate, as well as for a deferred, authorization, monitoring, notification, and/or security, in any of the herein-described transactions and/or communications.

The present invention can also be utilized in such a manner that a communication device can receive and/or transmit signals, data, and/or information, which pertains to multiple accounts and/or multiple types of accounts in order to provide authorization, monitoring, notification, and/or security, for a plurality of any of the accounts described herein.

The present invention, in any of the embodiments described herein, can also be designed to be user-friendly. In this regard, the present invention can be menu-driven, and/or its operation can be menu-selected, from audio menus, video or visual menus, or both audio and video menus.

The present invention can also be utilized in conjunction with intelligent agents, software agents, and/or mobile agents, which can be programmed and/or which can be utilized to act for, and/or on behalf of, any of the respective parties described herein.

Accordingly, it is an object of the present invention to provide an apparatus and a method for account security.

It is another object of the present invention to provide and apparatus and a method for providing account security, monitoring, notification, or authorization for any one of more of credit card accounts, charge card accounts, debit card accounts, smart card accounts, currency card accounts, telephone calling card accounts, cable television accounts, digital television accounts, satellite television accounts, utility accounts, electrical utility accounts, gas utility accounts, fuel oil utility accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, facility access accounts, facility security accounts, bank accounts, savings accounts, checking accounts, financial accounts, brokerage accounts, electronic money accounts, electronic cash accounts, communication accounts, telephone accounts, wireless communication device accounts, non-wireless communication device accounts, cellular communication device accounts, Internet accounts, Internet service provider accounts, credit report accounts, insurance accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, health club membership accounts, merchant credit accounts for customers, merchant accounts, association membership accounts, professional association membership accounts, trade association membership accounts, and/or any other accounts, as well as any cards, devices, and/or other entities which can be associated with any of the above accounts, which can be associated with an individual and/or an entity.

It is still another object of the present invention to provide an apparatus and a method for providing account security which provides notification of the occurrence of a transaction on any one or more of credit card accounts, charge card accounts, debit card accounts, smart card accounts, currency card accounts, telephone calling card accounts, cable television accounts, digital television accounts, satellite television accounts, utility accounts, electrical utility accounts, gas utility accounts, fuel oil utility accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, facility access accounts, facility security accounts, bank accounts, savings accounts, checking accounts, financial accounts, brokerage accounts, electronic money accounts, electronic cash accounts, communication accounts, telephone accounts, wireless communication device accounts, non-wireless communication device accounts, cellular communication device accounts, Internet accounts, Internet service provider accounts, credit report accounts, insurance accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, health club membership accounts, merchant credit accounts for customers, merchant accounts, association membership accounts, professional association membership accounts, trade association membership accounts, and/or any other accounts, as well as any cards, devices, and/or other entities which can be associated with any of the above accounts, which can be associated with an individual and/or an entity.

It is yet another object of the present invention to provide an apparatus and a method for providing account security which provides notification of the occurrence of a communication on any one or more of credit card accounts, charge card accounts, debit card accounts, smart card accounts, currency card accounts, telephone calling card accounts, cable television accounts, digital television accounts, satellite television accounts, utility accounts, electrical utility accounts, gas utility accounts, fuel oil utility accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, facility access accounts, facility security accounts, bank accounts, savings accounts, checking accounts, financial accounts, brokerage accounts, electronic money accounts, electronic cash accounts, communication accounts, telephone accounts, wireless communication device accounts, non-wireless communication device accounts, cellular communication device accounts, Internet accounts, Internet service provider accounts, credit report accounts, insurance accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, health club membership accounts, merchant credit accounts for customers, merchant accounts, association membership accounts, professional association membership accounts, trade association membership accounts, and/or any other accounts, as well as any cards, devices, and/or other entities which can be associated with any of the above accounts, which can be associated with an individual and/or an entity.

It is another object of the present invention to provide an apparatus and a method for providing account security which provides notification to an account holder, cardholder, account owner, and/or any other authorized individual, of a transaction, a communication, or account activity, which occurs on any of the herein-described accounts.

It is still another object of the present invention to provide an apparatus and a method for providing account security which provides notification to an account holder, cardholder, account owner, and/or any other authorized individual, of a transaction, a communication, or account activity, which occurs on any of the herein-described accounts, in real-time.

It is yet another object of the present invention to provide an apparatus and a method for providing account security which allows an account holder, cardholder, account owner, and/or any other authorized individual, to authorize, allow, disallow, or cancel, a transaction, a communication, or account activity, which occurs on any of the herein-described accounts.

It is another object of the present invention to provide an apparatus and a method for providing account security which allows an account holder, cardholder, account owner, and/or any other authorized individual, to authorize, allow, disallow, or cancel, a transaction, a communication, or account activity, which occurs on any of the herein-described accounts, in real-time.

It is still another object of the present invention to provide an apparatus and a method for providing account security which allows an account holder, cardholder, account owner, and/or any other authorized individual, to monitor transactions, communications, or account activity, which occurs on, and/or which involves, any of the herein-described accounts.

It is yet another object of the present invention to provide an apparatus and a method for providing account security which allows an account holder, cardholder, account owner, and/or any other authorized individual, to monitor transactions, communications, or account activity, which occurs on, and/or which involves, any of the herein-described accounts, in real-time.

It is another object of the present invention to provide an apparatus and a method for providing account security which allows an account holder, cardholder, account owner, or any other authorized individual, to program or provide a restriction(s) and/or a limitation(s) for, or regarding, transactions, communications, or account activity, for any of the herein-described accounts.

It is still another object of the present invention to provide an apparatus and a method for providing account security which allows an account holder, a cardholder, an account owner, or any other authorized individual, to program or provide a restriction(s) and/or a limitation(s) for, or regarding, transactions, communications, or account activity, for any of the herein-described accounts, in real-time.

It is yet another object of the present invention to provide an apparatus and a method for providing account security which allows an account holder, a cardholder, an account owner, or any other authorized individual, to program the apparatus or an apparatus component in order to restrict and/or to limit transactions, communications, or account activity, for any of the herein-described accounts.

It is another object of the present invention to provide an apparatus and a method for providing account security which allows an account holder, a cardholder, an account owner, or any other authorized individual, to program the apparatus or an apparatus component in order to restrict and/or to limit transactions, communications, or account activity, for any of the herein-described accounts, in real-time.

It is still another object of the present invention to provide an apparatus and a method for providing account security which allows an account holder, a cardholder, an account owner, and/or any other authorized individual, to respond to an occurrence of a transaction, a communication, or account activity, for any of the herein-described accounts.

It is yet another object of the present invention to provide an apparatus and a method for providing account security which allows an account holder, a cardholder, an account owner, and/or any other authorized individual, to respond to an occurrence of a transaction, a communication, or account activity, for any of the herein-described accounts, in real time.

It is still another object of the present invention to provide an apparatus and a method for providing account security which allows an account holder, a cardholder, an account owner, and/or any other authorized individual, to authorize, allow, disallow, cancel, or terminate, a transaction, a communication, or account activity, which occurs on any of the herein-described accounts.

It is yet another object of the present invention to provide an apparatus and a method for providing account security which allows an account holder, a cardholder, an account owner, and/or any other authorized individual, to authorize, allow, disallow, cancel, or terminate, a transaction, a communication, or account activity, which occurs on any of the herein-described accounts, in real-time.

It is another object of the present invention to provide an apparatus and a method for providing account security in transactions involving credit cards, charge cards, debit cards, ATM cards, telephone calling cards, electronic currency cards and/or “smart” cards, wherein the account holder, cardholder, account owner, or any other authorized individual, can allow, authorize, disapprove, cancel, or terminate, a transaction or account activity.

It is still another object of the present invention to provide an apparatus and a method for providing account security in transactions involving credit cards, charge cards, debit cards, ATM cards, telephone calling cards, electronic currency cards and/or “smart” cards, wherein the account holder, cardholder, account owner, or any other authorized individual, can allow, authorize, disapprove, cancel, or terminate, a transaction or account activity, in real-time.

It is yet another object of the present invention to provide an apparatus and a method for providing account security in transactions involving banking accounts, savings accounts, checking accounts, brokerage accounts, electronic cash accounts, or electronic money accounts, wherein the account holder, cardholder, account owner, or any other authorized individual, can allow, authorize, disapprove, cancel, or terminate, a transaction or account activity.

It is yet another object of the present invention to provide an apparatus and a method for providing account security in transactions involving banking accounts, savings accounts, checking accounts, brokerage accounts, electronic cash accounts, or electronic money accounts, wherein the account holder, cardholder, account owner, or any other authorized individual, can allow, authorize, disapprove, cancel, or terminate, a transaction or account activity, in real-time.

It is yet another object of the present invention to provide an apparatus and a method for providing account security in communications or transactions involving wireless communication accounts or non-wireless communication accounts, wherein the account holder, cardholder, account owner, or any other authorized individual, can allow, authorize, disapprove, cancel, or terminate, a communication, a transaction, or account activity.

It is another object of the present invention to provide an apparatus and a method for providing account security in communications or transactions involving wireless communication accounts or non-wireless communication accounts, wherein the account holder, cardholder, account owner, or any other authorized individual, can allow, authorize, disapprove, cancel, or terminate, a communication, a transaction, or account activity, in real-time.

It is still another object of the present invention to provide an apparatus and a method for providing account security in communications or transactions involving Internet accounts, wherein the account holder, account owner, or any other authorized individual, can allow, authorize, disapprove, cancel, or terminate, a communication, a transaction, or account activity.

It is yet another object of the present invention to provide an apparatus and a method for providing account security in communications or transactions involving Internet accounts, wherein the account holder, account owner, or any other authorized individual, can allow, authorize, disapprove, cancel, or terminate, a communication, a transaction, or account activity, in real-time.

It is another object of the present invention to provide an apparatus and a method for providing account security which can be utilized on, over, or in conjunction with, an on-line service, the Internet, the World Wide Web, or any other communication network, system, or medium.

It is still another object of the present invention to provide an apparatus and a method for providing account security which is programmable and/or which can provide for pre-programmed and/or pre-specified transaction, communication, or account activity, authorization and/or disapproval.

It is yet another object of the present invention to provide an apparatus and a method for providing account security which is programmable, in real-time, and/or which can provide for pre-programmed and/or pre-specified transaction, communication, or account activity, authorization and/or disapproval.

It is another object of the present invention to provide an apparatus and a method for providing account security which allows an account holder, a cardholder, an account owner, or any other authorized individual, to program, change, or modify account usage parameters, account restrictions, account limitations, or account activity, for any of the herein-described accounts.

It is still another object of the present invention to provide an apparatus and a method for providing account security which allows an account holder, a cardholder, an account owner, or any other authorized individual, to program, change, or modify account usage parameters, account restrictions, account limitations, or account activity, for any of the herein-described accounts, in real-time.

It is yet another object of the present invention to provide an apparatus and a method for providing account security which allows an account holder, a cardholder, an account owner, or any other authorized individual, to program, change, or modify account usage parameters, account restrictions, account limitations, or account activity, for any of the herein-described accounts at any time and/or from any location.

It is another object of the present invention to provide an apparatus and a method for providing account security which allows an account holder, a cardholder, an account owner, or any other authorized individual, to program, change, or modify account usage parameters, account restrictions, account limitations, or account activity, for any of the herein-described accounts at any time and/or from any location, in real-time.

It is still another object of the present invention to provide an apparatus and a method for providing account security for a plurality of accounts and/or for different types of accounts.

It is yet another object of the present invention to provide an apparatus and a method for providing account security which utilized intelligent agents, software agents, or mobile accounts, in order to act for, and/or on behalf of, any of the account holders, cardholders, account owners, any other authorized individuals, or any user or operator of the apparatus or any apparatus components described herein.

It is another object of the present invention to provide an apparatus and a method for providing account security which can provide an advertisement or advertisements in, in conjunction with, or along with, any signal(s), data, information, message(s), and/or transmission(s), which is, or which can be, transmitted to an account holder, a cardholder, an account owner, or any other authorized individual.

Other objects and advantages of the present invention will be apparent to those skilled in the art upon a review of the Description of the Preferred Embodiment taken in conjunction with the Drawings which follow.

### BRIEF DESCRIPTION OF THE DRAWINGS

In the Drawings:

FIG. 1 illustrates a block diagram of the apparatus of the present invention which is utilized in conjunction with a credit card, a charge card, a debit card, and/or on electronic currency and/or “smart” card account authorization process;

FIG. 2 illustrates the various components of the apparatus of FIG. 1;

FIGS. 3A and 3B illustrate a preferred embodiment operation of the apparatus of FIG. 1, in flow diagram form;

FIGS. 4A, 4B and 4C illustrate another preferred embodiment operation of the apparatus of FIG. 1, in flow diagram form;

FIG. 5 illustrates a block diagram of another preferred embodiment of the apparatus of the present invention which is utilized in conjunction with a banking account, a checking account, a savings account, and/or an automated teller machine transaction;

FIG. 6 illustrates the various components of the apparatus of FIG. 5;

FIGS. 7A and 7B illustrate a preferred embodiment operation of the apparatus of FIG. 5, in flow diagram form;

FIGS. 8A, 8B and 8C illustrate another preferred embodiment operation of the apparatus of FIG. 5, in flow diagram form;

FIG. 9 illustrates a block diagram of another preferred embodiment of the apparatus of the present invention which is utilized in conjunction with a brokerage account;

FIG. 10 illustrates the various components of the apparatus of FIG. 9;

FIGS. 11A and 11B illustrate a preferred embodiment operation of the apparatus of FIG. 9, in flow diagram form;

FIGS. 12A, 12B and 12C illustrate another preferred embodiment operation of the apparatus of FIG. 9, in flow diagram form;

FIG. 13 illustrates a block diagram of another preferred embodiment of the apparatus of the present invention which is utilized in conjunction with an electronic cash account, an electronic money, a digital cash account, and/or a digital money account;

FIG. 14 illustrates the various components of the apparatus of FIG. 13;

FIGS. 15A and 15B illustrate a preferred embodiment operation of the apparatus of FIG. 13, in flow diagram form;

FIGS. 16A, 16B and 16C illustrate another preferred embodiment operation of the apparatus of FIG. 13, in flow diagram form;

FIG. 17 illustrates a block diagram of another preferred embodiment of the apparatus of the present invention which is utilized in conjunction with a wireless communication account and/or a wireless communication device;

FIG. 18 illustrates the various components of the apparatus of FIG. 17;

FIGS. 19A and 19B illustrate a preferred embodiment operation of the apparatus of FIG. 17, in flow diagram form;

FIGS. 20A, 20B and 20C illustrate another preferred embodiment operation of the apparatus of FIG. 17, in flow diagram form;

FIG. 21 illustrates a block diagram of another preferred embodiment of the apparatus of the present invention which is utilized in conjunction with a non-wireless communication account and/or a non-wireless communication device;

FIG. 22 illustrates the various components of the apparatus of FIG. 21;

FIGS. 23A and 23B illustrate a preferred embodiment operation of the apparatus of FIG. 21, in flow diagram form;

FIGS. 24A, 24B and 24C illustrate another preferred embodiment operation of the apparatus of FIG. 21, in flow diagram form;

FIG. 25 illustrates a block diagram of another preferred embodiment of the apparatus of the present invention which is utilized in conjunction with an Internet account and/or an Internet communication device;

FIG. 26 illustrates the various components of the apparatus of FIG. 25;

FIGS. 27A and 27B illustrate a preferred embodiment operation of the apparatus of FIG. 25, in flow diagram form;

FIGS. 28A, 28B and 28C illustrate another preferred embodiment operation of the apparatus of FIG. 25, in flow diagram form;

FIG. 29 illustrates yet another alternate embodiment of the present invention wherein the apparatus of the present invention is utilized on, or over, an on-line service, the INTERNET and/or the World Wide Web or other suitable communication network or medium; and

FIG. 30 illustrates yet another alternate embodiment of the present invention which is also utilized in conjunction with an on-line service and/or on, or over, the INTERNET and/or the World Wide Web or the suitable communication network or medium.

### DESCRIPTION OF THE PREFERRED EMBODIMENTS

The present invention pertains to an apparatus and method for providing account security and, in particular, to an apparatus and a method for providing account security, monitoring, notification, and/or authorization, for any one or more of credit card accounts, charge card accounts, debit card accounts, smart card accounts, currency card accounts, telephone calling card accounts, cable television accounts, digital television accounts, satellite television accounts, utility accounts, electrical utility accounts, gas utility accounts, fuel oil utility accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, facility access accounts, facility security accounts, bank accounts, savings accounts, checking accounts, financial accounts, brokerage accounts, electronic money accounts, electronic cash accounts, communication accounts, telephone accounts, wireless communication device accounts, non-wireless communication device accounts, cellular communication device accounts, Internet accounts, Internet service provider accounts, credit report accounts, insurance accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, health club membership accounts, merchant credit accounts for customers, merchant accounts, association membership accounts, professional association membership accounts, trade association membership accounts, and/or any other accounts, as well as any cards, devices, and/or other entities which can be associated with any of the above accounts, which can be associated with an individual and/or an entity.

The terms “cardholder”, “account owner” and “account holder”, or the plural of same, can be used interchangeably herein and refer to any individuals and/or entities which hold, own, subscribe to, and/or utilize, any of the various cards, devices, and/or accounts described herein.

The apparatus and method of the present invention can process transactions, communications, requests for authorization for an account, requests for authorization for account usage, requests for authorization for account transactions, requests for authorization for account communications, and/or any other transactions and/or communications (hereinafter, for simplicity, referred to as “transaction”, “communication”, “transmission”, “transfer”, or any other suitable or appropriate term or terms) which can occur and/or be which can be incidental to usage of any of the accounts described herein.

Applicant hereby incorporates by reference herein the subject matter of U.S. patent application Ser. No. 08/918,284, filed Aug. 25, 1997; U.S. patent application Ser. No. 09/169,053, filed Oct. 9, 1998; U.S. patent application Ser. No. 08/873,945, filed Jun. 12, 1997, now U.S. Pat. No. 5,878,337; U.S. patent application Ser. No. 08/874,051, now U.S. Pat. No. 5,903,830; and U.S. patent application Ser. No. 08/694,199, filed Aug. 8, 1996.

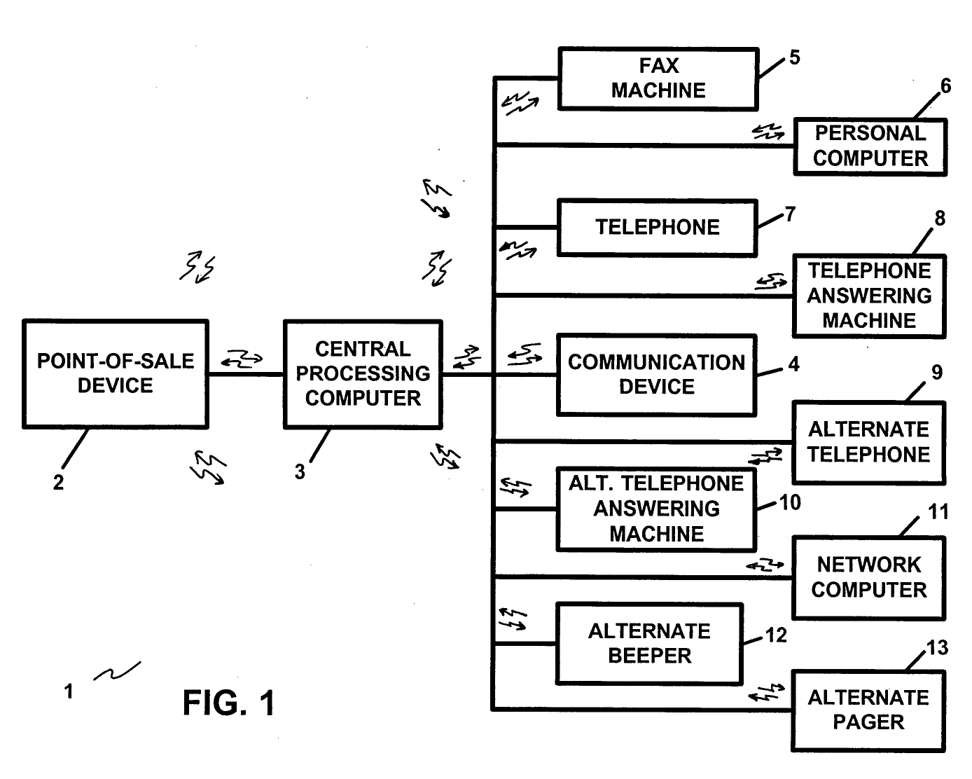

FIG. 1 illustrates a block diagram of a preferred embodiment of the apparatus of the present invention, which is utilized in conjunction with a credit card, a charge card a debit card, an electronic currency card, a “smart” card, a telephone calling card, and/or subscription card, a credit card account, a charge card account, a debit card account, a smart card account, a currency card account, a telephone calling card account, a cable television account, a digital television account, a satellite television account, a utility account, an electrical utility account, a gas utility account, a fuel oil utility account, an insurance account, a subscription account for any goods, products, and/or services, a health care insurance account, a pharmacy account, a social security account, accounts monitoring use of official seals, accounts monitoring use of private, individual, and/or organizational seals or access codes, a security access account, a computer access code account, computer access account, computer security account, and/or with any authorization processes regarding any of the above.

The apparatus 1 of FIG. 1 can also be utilized in conjunction with any one or more of credit card accounts, charge card accounts, debit card accounts, smart card accounts, currency card accounts, telephone calling card accounts, cable television accounts, digital television accounts, satellite television accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, and/or facility access accounts.

The apparatus of FIG. 1 is denoted generally by the reference numeral 1. With reference to FIG. 1, the apparatus includes of a point-of-sale or point-of-transaction device 2 (hereinafter “point-of-sale device 2”), depending on the respective account, which device(s) are found in various establishments and utilized in conjunction with the sale of goods and/or services and in other financial transactions and/or communication transactions.

The point-of-sale authorization device 2 (hereinafter referred to as “point-of-sale device”) can be any of the widely used and well known devices, terminals, computers, or communication devices for providing point-of-sale authorization for transactions involving credit cards, charge cards, debit cards and/or other currency cards, electronic currency cards, “smart” cards, telephone calling cards, and/or subscription cards. The point-of-sale device 2 can be utilized at the location of the goods and/or service provider, such as the retail store or office, and/or the point-of-sale device 2 can be located at the site of the goods or service provider or vendor, such as in cases when the sale is a telephone order, mail order and/or other type of transaction, including transactions made over the INTERNET and/or other on-line mediums.

Typically, the devices and terminals for providing point-of-sale authorization includes and utilizes a magnetic card reader and/or magnetic strip card reader, for reading data from the magnetic strip located on credit cards, charge cards, debit cards and/or currency cards, electronic currency cards and/or “smart” cards. The present invention can also be utilized in conjunction with telephone calling cards, prepaid or otherwise, and/or communication accounts.

The point-of-sale device 2 transmits an authorization request and/or a transaction notification signal, which can include the data pertaining to the particular card utilized in the transaction and the amount of the transaction, as well as any other information pertaining to the transaction, over a communications medium, to an individual account holder, an individual authorized to receive information for, and/or other wise act for and/or on behalf of an individual account holder, and/or to a central processing computer for processing the credit, charge, debit, and/or any other account described herein, and/or any other transaction card and/or communication card transaction request and/or authorization request pertaining thereto.

The point-of-sale device 2 also receives the authorization and/or authorization data and/or information from the respective communication device associated with the individual account holder, the individual authorized to receive information for and/or on behalf of the account holder, and/or the central processing computer. A printed transaction receipt can also be provided at and/or obtained via the point-of-sale device 2, or peripheral device associated therewith, for printing a transaction receipt which is usually or typically signed by the card holder in completing the transaction. The point-of-sale device 2 can be designed to read other data besides and/or in addition to magnetic card data. The point-of-sale device 2 can also include, or have associated therewith, a keypad for the manual entry of transaction information and/or data, such as the amount of the transaction. The point-of-sale device 2 can also be an integral component of a cash register or other transaction device which can provide for the automatic entry of transaction information and/or data.

The point-of-sale device 2 can be equipped to read multiple contact information from magnetic strip cards so as to provide for the transmission of data and/or information to multiple individuals, entities and/or to multiple communication devices associated with the individual(s), entity, or entities. For example, the magnetic strip on the back of a credit card, charge card, debit card, smart card, telephone calling card, and/or subscription card, can contain the phone number and/or contact information for a central transaction authorization computer associated with the card as well as a the identity, address, phone number, pager number, e-mail address, fax number, and/or any other contact information for the individual account holder.

In cases involving “smart” cards, or cards having processors, memory chips, computer chips and/or other processors and/or processing devices, the point-of-sale device 2 can be equipped with an appropriate card reading device for reading and/or obtaining information from the respective processor, memory chip, computer chip and/or other processor and/or processing device.

The respective account cards, in addition to containing cardholder contact information, can also contain information regarding restrictions and/or limitations on account usage. In this manner, the respective card can contain information regarding restrictions and/or limitations as to the type of authorized transactions, the goods and/or services authorized to be purchased with the card, identification required, required personal identification information, authorized times of usage, authorized geographic location of usage, as well as any other restriction and/or limitation on card or account usage.

The apparatus 1 also includes a central processing computer 3 which services any predefined group of cardholders or account holders. For example, the central processing computer 3 can handle all MASTERCARD® transactions for a given financial and/or credit institution. The central processing computer 3, for example, can process credit cards, charge cards, debit cards, currency cards, electronic currency cards and/or “smart” cards and/or combinations of same, such as, for example, VISA®, MASTERCARD®, and/or AMERICAN EXPRESS® cards and process and/or mange account information pertaining thereto. The central processing computer 3 can also process accounts for any of the various banks and/or financial institutions, which issue and/or manage credit cards, charge cards, debit cards and/or currency or “smart” cards, and/or other transaction cards (hereinafter referred to as “card” or “cards”) and/or process or manage these accounts. The central processing computer 3 can also process accounts for any respective communication service providers or utilities.

The central processing computer 3 can be a mainframe computer, a mini-computer, a micro-computer, a server computer, such as those utilized in conjunction with on-line services and/or in a network environment, and/or any other suitable computer or computer system.

In the preferred embodiment, the point-of-sale device 2 is linked and/or connected to the central processing computer 3 via a telecommunications system, link and/or medium (hereinafter referred to as “communications system”) such as, for example, a telephone network or line. The communications system which is utilized can be any communications system and can include telecommunication systems, satellite communications systems, radio communication systems, digital communications systems, digital satellite communications systems, personal communications services communication systems, cable television systems, digital television systems, satellite television systems, broadband communications systems, as well as any other appropriate communications system. The point-of-sale device 2 transmits signals and/or data to the central processing computer 3 as well as receives signals and/or data from the central processing computer 3.

The apparatus 1 also includes a cardholder communication device 4 which can receive signals and/or data from either or both of the point-of-sale device 2 and/or the central processing computer 3. In a preferred embodiment of FIG. 1, the communication device 4 receives signals and data from the point-of-sale device 2, directly and/or indirectly, with said signals being transmitted via a suitable communication system. In this preferred embodiment, the communication device 4 can also transmit signals and data to the point-of-sale device 2, directly and/or indirectly, with said signals being transmitted via a suitable communication system. In another preferred embodiment of FIG. 1, the communication device 4 receives signals and data, directly and/or indirectly, from the central processing computer 3 with said signals being transmitted via a suitable communication system. In this preferred embodiment, the communication device 4 can also transmit signals and data to the central processing computer 3, directly and/or indirectly, with said signals being transmitted via a suitable communication system.

In the preferred embodiment, the communications system utilized for transmitting signals and/or data to the communication device 4 is a wireless telephone line and the communication device 4 is a telephone signal receiving device such as a telephone beeper or pager. The communication device 4 or pager receives the wireless telephone signals and/or data from the central processing computer 3 during the authorization procedure as will be described in more detail below.

In the preferred embodiment, the communication device 4 is also equipped with a transmitter for transmitting signals and/or data to the central processing computer 3. In this regard, the central processing computer 3 transmits signals and/or data to the communication device 4 as well as receives signals and/or data from the communication device 4. The communication device 4 can also transmit signals and/or data directly to the point-of-sale device 2 and receive signals and/or data directly from the point-of-sale device 2. In the preferred embodiment, the point-of-sale device 2 can transmit signals and/or data to the central processing computer 3 and/or to the communication device 4 and can receive signals and/or data from the central processing computer 3 and/or from the communication device 4. Further, in the preferred embodiment, the communication device 4 can receive signals and/or data from the central processing computer 3 and/or from the point-of-sale device and can transmit signals and/or data to the central processing computer 3 and/or to the point-of-sale device 2.

The communication device 4 can be either a wireless communication device and/or can be a wired or line wired communication device such as a conventional telephone, fax machine, or computer. The communication device 4 can be carried by the cardholder and/or be kept on and/or close to the cardholder's person so that the point-of-sale device 2 and/or the central processing computer 3 can transmit signals and/or data to the communication device 4 so as to communicate with the cardholder at any time. The communication device 4 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch. The point-of-sale device 2 and/or the central processing computer 3 can be linked with each of the above devices via any suitable communication system.

In the preferred embodiment, the apparatus 1 also includes a facsimile (fax) machine 5, a personal computer or personal digital assistant 6, a telephone 7, a telephone answering machine 8, an alternate telephone 9, an alternate telephone answering machine 10, a network computer 11, an alternate beeper 12 and an alternate pager 13. The central processing computer 3 can be linked with the above fax machine 5, personal computer or personal digital assistant 6, telephone 7, associated answering machine 8, alternate telephone 9, alternate telephone answering machine 10, network computer 11, and/or alternate beeper 12 or pager 13, via any suitable communication system. In the preferred embodiment, a telecommunications link or telephone network, line or link, which may or may not be a wireless link depending on the device and/or the circumstances, is utilized in order to link the central processing computer 3 with each of the fax machine 5, the personal computer or personal digital assistant 6, the telephone 7, the associated answering machine 8, the alternate telephone 9, alternate telephone answering machine 10, the network computer 11, and/or the alternate beeper 12 and the alternate pager 13.

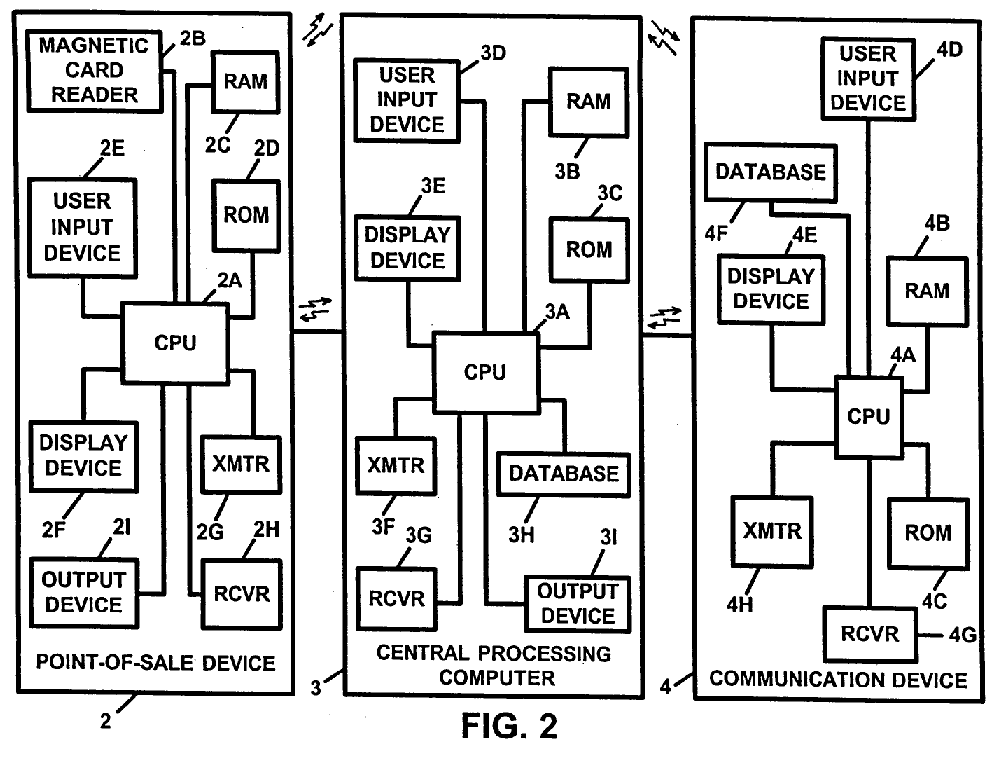

FIG. 2 illustrates the various components of the apparatus 1 of FIG. 1. In FIG. 2, the point-of-sale device 2, in the preferred embodiment, includes a central processing unit or CPU 2A, a magnetic card reader 2B, which is connected to the CPU 2A, associated random access memory 2C (RAM) and read only memory 2D (ROM) devices, which are also connected to the CPU 2A, a user input device 2E, which is typically a keypad or other suitable input device for inputting data into the device 2 and which is also connected to the CPU 2A, and a display device 2F for displaying information and/or data to a user.

The point-of-sale device magnetic card reader or card reader 2B can, in the preferred embodiment, be capable of reading and processing data and/or information, which is stored on the magnetic strips and/or on the processors or chips which are located on the respective account card, and for providing one or multiple communications for one or multiple parties as well as reading and processing any restriction and/or limitation information regarding and/or related to account usage.

For example, the magnetic card reader or card reader 2B can read and/or process data and/or information for identifying and communicating with a central transaction processing computer as well as can read and/or process data and/or information for communicating with the individual account holder and/or an individual or agent authorized to act for and/or on behalf of the individual account holder, at any one or more of the communication devices associated with the individual account holder or the individual or agent associated with the individual account holder.

Data and/or information for providing any other the communications described herein can be obtained from the data and/or information contained in the magnetic strip on the card, the respective processor or chip located on the card, and/or can be obtained form an external database (not shown) which can be linked to the point-of-sale device 2 and/or which can be accessed thereby for obtaining any additional data and/or information.

The user input device 2E can include any data input device including, but not limited to, a keyboard, a mouse, a scanner, a reader or card reader, an audio input device, a voice recognition device, a fingerprint reading device, a retinal scanning device, a fingerprint reading device, a retinal scanning device, and/or any other device for inputting data and/or information into the point-of-sale device 2.

The point-of-sale device 2 also includes a transmitter 2G for transmitting signals and/or data to the central processing computer 3, and/or to the communication device 4, and/or to any other device associated with the cardholder and/or account holder and/or the apparatus, if desired. The transmitter 2G is also connected to the CPU 2A. The point-of-sale device 2 also includes a receiver 2H for receiving signals and/or data from the central processing computer 3, and/or from the communication device 4, and/or any other associated device which can be utilized, if desired. The receiver 2H is also connected to the CPU 2A.

The point-of-sale device 2 also includes a printer 2I or other appropriate output device for outputting data to the user. The printer 2I is also connected to the CPU 2A. In the preferred embodiment, the printer 2I prints receipts corresponding to the transaction.

In FIG. 2, the central processing computer 3, in the preferred embodiment, includes a central processing unit or CPU 3A, associated random access memory 3B (RAM) and read only memory 3C (ROM) devices, which are connected to the CPU 3A, a user input device 3D, which is a keypad and/or any other suitable input device for inputting data into the central processing computer 3 and which is also connected to the CPU 3A and a display device 3E for displaying information and/or data to a user or operator.

The user input device 3D can include any data input device including, but not limited to, a keyboard, a mouse, a scanner, a reader or card reader, an audio input device, a voice recognition device, a fingerprint reading device, a retinal scanning device, and/or any other device for inputting data and/or information into the central processing computer 3.

The central processing computer 3 also includes a transmitter(s) 3F for transmitting signals and/or data to the point-of-sale device 2 and to the communication device 4 and/or to any one or more of the fax machine 5, personal computer or personal digital assistant 6, telephone 7, telephone answering machine 8, alternate telephone 9, alternate telephone answering machine 10, network computer 11 and/or alternate beeper 12 or alternate pager 13. The transmitter(s) 3F is also connected to the CPU 3A.

The central processing computer 3 also includes a receiver(s) 3G for receiving signals and/or data from the point-of-sale device 2 and from the communication device 4 and/or from any other suitable device which can be utilized in conjunction with the apparatus 1. The receiver(s) 3G is also connected to the CPU 3A. The central processing computer 3, in any and/or all of the embodiments described herein, can utilize a fax/modem and/or any other suitable computer communication device.

The central processing computer also includes a database(s) 3H which contains account information and data pertaining to the cardholders and/or to the cardholder accounts.

The database 3H contains information about the cardholder, the cardholders account number, credit and/or account limits, previous purchases, number of unauthorized purchases made to the account and other information and/or data necessary to manage and/or process an account transaction as described herein.

The database 3H can include any number of databases which can or can not be linked to one another. The database 3H can also be linked to a database or databases which are located external from the central processing computer 3.

The database 3H can also include data and/or information regarding specific limitations and/or restrictions which can be placed on a particular card or account, which can be pre-selected and/or programmed by the cardholder and which can include limitations and/or restrictions on the usage of the card or account. The limitations and/or restrictions can include the types of transactions which are allowed and/or authorized, the goods and/or services which can be purchased with the card or account, the vendors, stores and/or service provider which can be authorized to accept the card or account, limits on the dollar amounts of transactions pertaining to each authorized vendor, seller and/or service provider, daily spending limits, and/or the geographical area or location wherein authorized card or account use can be limited, and/or authorized times for card or account usage (i.e. specific days, dates, time of day, time of month, year, etc.), and/or any other limitation and/or restriction regarding amount of transaction, parties involved, geographical area, and/or times of allowed card or account usage. The database 3H is also connected to the CPU 3A.

The central processing computer 3 also includes a printer 3I or other appropriate output device for outputting information and/or data to a user or operator.

In FIG. 2, the communication device 4, in the preferred embodiment, includes a central processing unit or CPU 4A, associated random access memory 4B (RAM) and read only memory 4C (ROM) devices, which are connected to the CPU 4A, a user input device 4D, which is a keypad or a plurality of keys and/or switches for inputting data into the communication device 4 and which is also connected to the CPU 4A, and a display device 4E, for displaying information and/or data to the cardholder, and a database 4F, which are also connected to the CPU 4A. The communication device 4 also includes a receiver 4G for receiving signals and/or data from the central processing computer 3 and which is also connected to the CPU 4A, a transmitter 4H for transmitting signals and/or data to the central processing computer 3 and which is also connected to the CPU 4A.

The user input device 4D can include any data input device including, but not limited to, a keyboard, a mouse, a scanner, a reader or card reader, an audio input device, a voice recognition device, a fingerprint reading device, a retinal scanning device, and/or any other device for inputting data and/or information into the central processing computer 3.

In the preferred embodiment, the communication device 4 which can be utilized can be a computer communication device such as a personal computer, a hand-held computer, a personal digital assistant, a pager, a two-way pager, an interactive television, a telephone, a wireless telephone, and/or any other communication device. In the preferred embodiment, the communication device 4 can have a reply feature and/or device for facilitating two-way communication between the communication device 4 and any of the point-of-sale devices and central processing computers described herein. A two-way pager and/or pager systems can also be utilized for implementing the respective component system(s) in the apparatus 1 and/or the component combinations and/or communication systems.

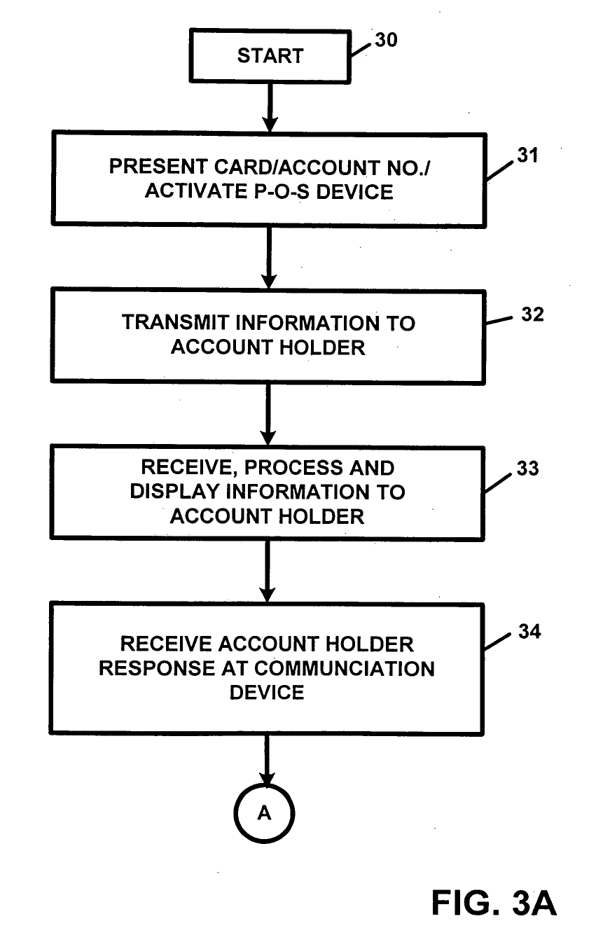

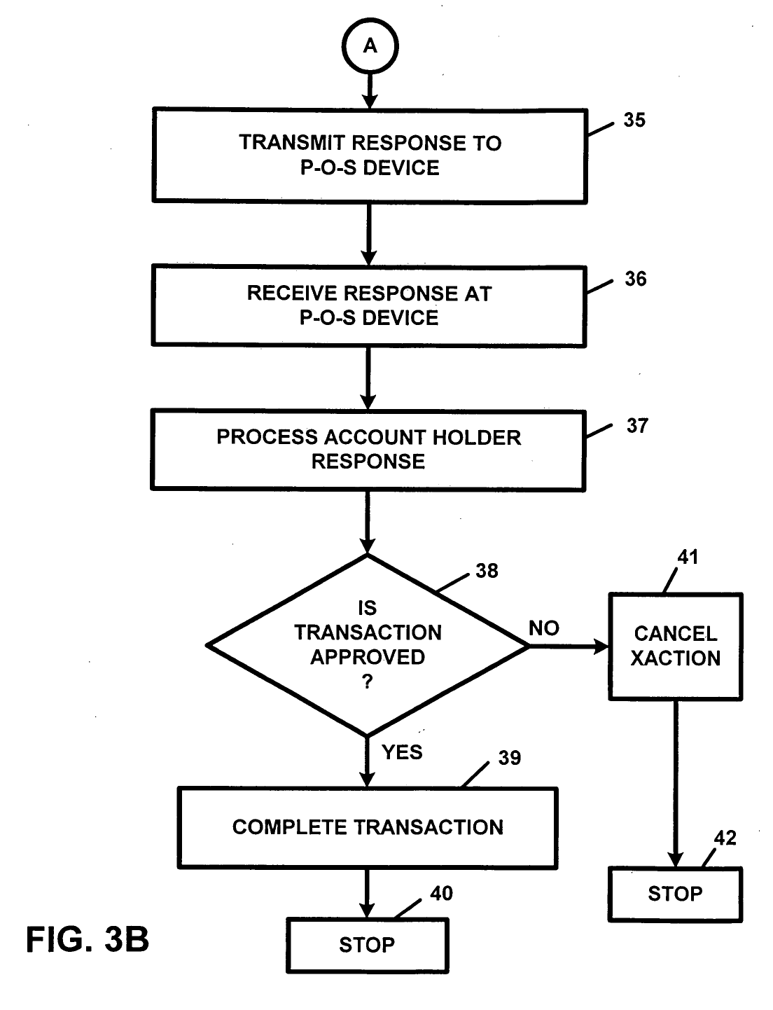

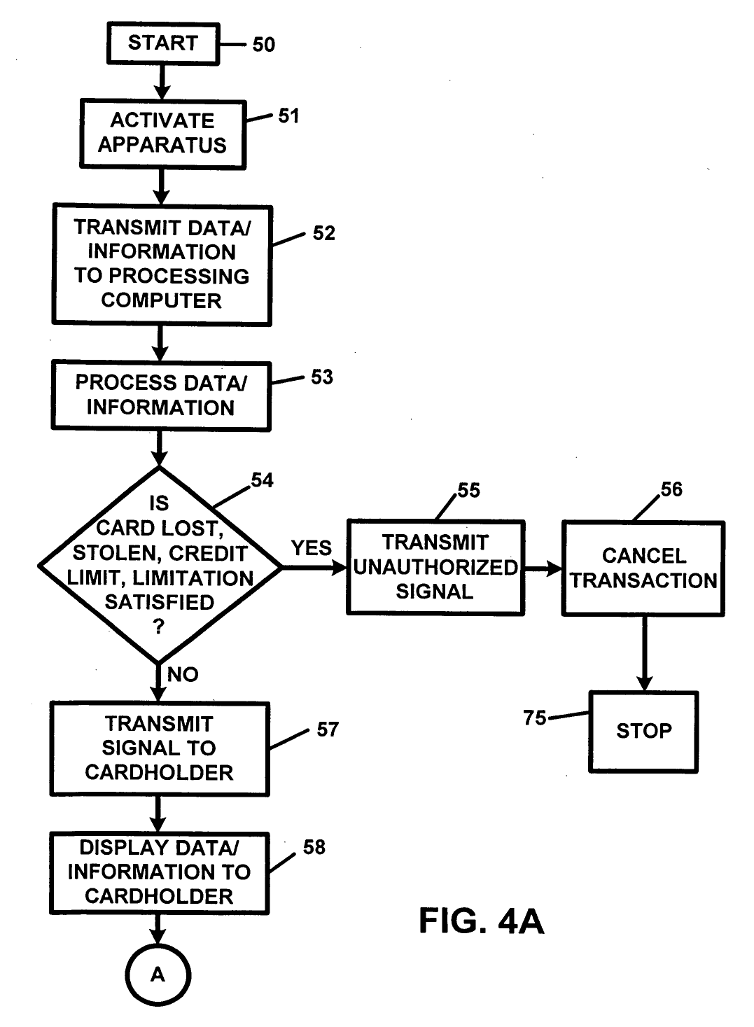

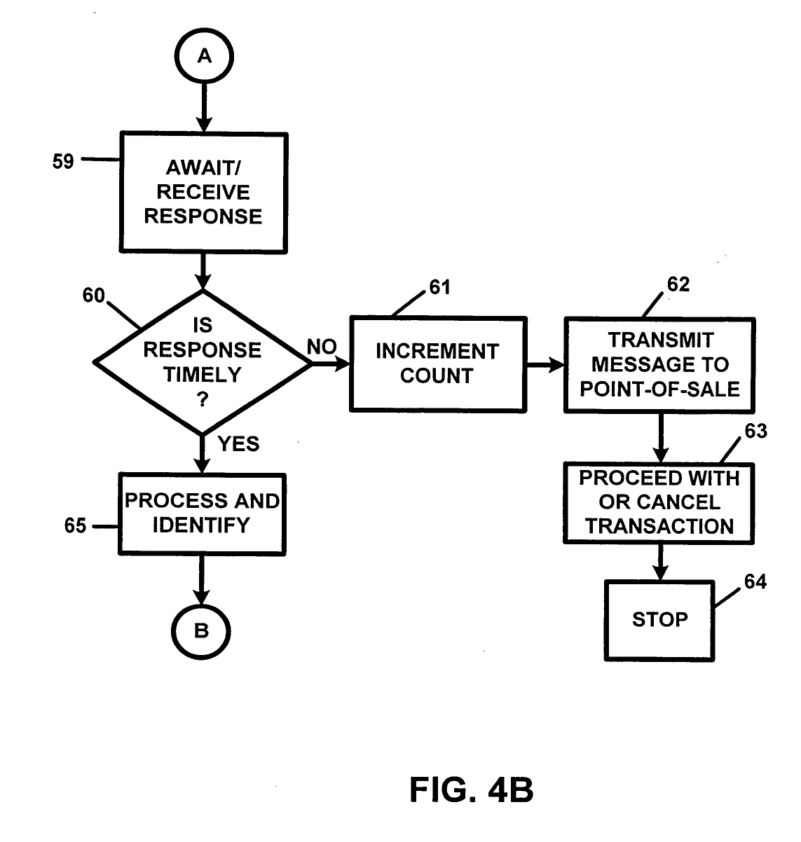

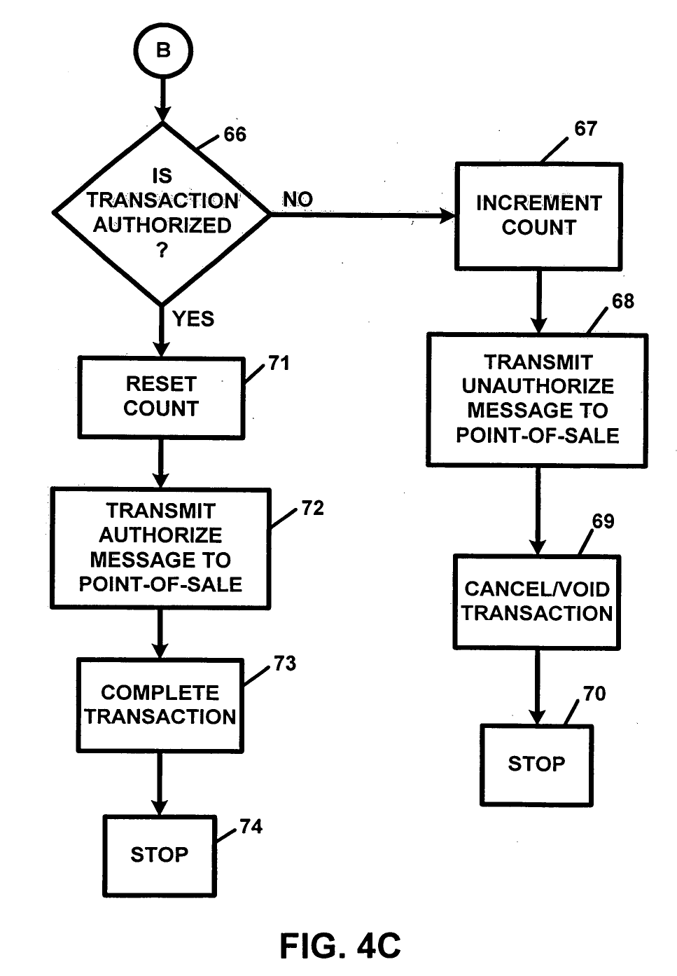

The apparatus 1 of the present invention, in the preferred embodiment, can be utilized in order to facilitate cardholder authorization, notification and/or security measures in financial transactions involving credit cards, charge cards, debit cards, currency cards, electronic currency cards, telephone account cards and/or “smart” cards, in the manner described below and with reference to FIGS. 3 and 4A, 4B, and 4C. In this manner, the apparatus 1 of the present invention can be utilized to obtain cardholder authorization in a card-related transaction.

FIGS. 3A and 3B illustrate a preferred embodiment operation of the apparatus 1 in flow diagram form. With reference to FIGS. 3A and 3B, the operation of the apparatus 1 commences at step 30. At step 31, the card, which is to be utilized in a credit card, charge card, debit card, and/or currency card, electronic currency card, “smart” card, telephone calling card, and/or subscription card, transaction is presented in the transaction. The sales or service attendant or point-of-sale device operator can activate the point-of-sale device 2 in any typical manner, such as by obtaining a phone line and entering card information into the point-of-sale device 2. This data entry is typically performed by swiping the magnetic strip of the card through the card reader 2B or by reading information stored on the respective processor or chip located on the respective card.

The data obtained from magnetic strip and/or from any associated database can be utilized to contact the cardholder communication device and/or the cardholder directly and/or to process the transaction.

In another preferred embodiment, the point-of-sale device, can process the transaction in conjunction with any restrictions and/or limitations on account usage, information of which is obtained from the respective card. If the point-of-sale device 2 determines that the transaction violates and/or otherwise dose not conform to a restriction and/or limitation on account usage, the point-of sale device 2 can cancel and/or reject the transaction without proceeding further. For example, the point-of-sale device 2, upon reading a restriction involving a time of use (i.e. no account usage allowed between 12:00 A.M. and 6:00 A.M.), a location of usage (i.e. no usage outside a particular city, state, or country), or a transaction amount limitation (i.e. no account usage for transactions exceeding $100), can process the transaction and determine if the transaction would violate a particular restriction or limitation.

If the transaction would violate a restriction or limitation, the point-of-sale device 2 can cancel the transaction and no further processing would be required. If the transaction would not violate a restriction and/or limitation, the transaction processing could continue in any appropriate manner described herein and/or otherwise.

The information and/or data pertinent to the transaction, and/or the card account, is then transmitted, at step 32, to the communication device 4 via the communication network. The transmission of the information and/or pertinent data, which takes place at step 32, is a transmission from the point-of-sale device 2 to the communication device 4 via the communication network.

In any of the embodiments described herein, any information and/or data which is transmitted from the point-of-sale device 2 to the communication device 4 can be transmitted directly to the communication device 4 via the communication network. The information and/or data which is transmitted from the point-of-sale device 2 to the communication device 4 can also be transmitted indirectly to the communication device 4, via the communication network, and independently of any transaction processing by a central transaction processing computer and/or central transaction processing system.

The transmission of the information and/or pertinent data, which takes place at step 32, is a transmission from the point-of-sale device 2 to the communication device 4 via the communication network and takes place independently of any processing of the transaction by a central processing computer or central processing service, such as by the central processing computer 3 and/or otherwise.

In this manner, the present invention provides notification to the cardholder of the transaction independently of any transaction processing by a central processing computer and/or a central processing service and can take place independently of any processing of the transaction by a central processing computer or central processing service, such as by the central processing computer 3 and/or otherwise. In this manner, the present invention provides notification to the cardholder of the transaction independently of any transaction processing by a central processing computer and/or a central processing service.

At step 32, the point-of-sale device 2, by utilizing cardholder contact information obtained form the card and/or otherwise, can also transmit respective signals and/or data to any one or more of the cardholder's designated fax machine 5, personal computer or personal digital assistant 6, telephone 7, telephone answering machine 8, alternate telephone 9, alternate telephone answering machine 10, network computer 11, and/or alternate beeper 12 or alternate pager 13.

The information and/or data which is transmitted to the communication device 4 can include information and/or data identifying the transaction and can include the name of the store or the service provider and the amount of the transaction. The information and/or data can also provide the time of the transaction, the location (i.e. city, town, village, state, country etc.) of the transaction. The information and/or data can also include the phone number of the central processing office and/or computer servicing the account so that the cardholder can telephone same in order to authorize or cancel the transaction. The information and/or data can also be supplemented to include the type of goods and/or services involved in the transaction, if such information can be entered at the point-of-sale device 2.

The communication device 4 will, at step 33, receive and process the information and/or data pertinent to the transaction and provide the information to the cardholder. At step 33, the information and/or data which is transmitted from the point-of-sale device 2 and received at the communication device 4 can is displayed to the cardholder on the display device 4E of the communication device 4. The information displayed on the display device 4E can include the name of the store or the service provider, the amount of the transaction, the time of the transaction and the location of the transaction. The information and/or data can also be supplemented to include the type of goods and/or services involved in the transaction, if such information can be entered at the point-of-sale device 2.

The communication device 4 can utilize any of the widely known data processing and/or software routines, which are known to those skilled in that art, in order to process transaction requests and/or authorizations involving the use of the respective card(s).

Thereafter, the cardholder can, at step 34, enter a response either approving or disapproving the transaction. At step 35, the cardholder's response is then transmitted, via the transmitter 4H of the communication device 4 to the point-of-sale device 2. In any of the embodiments described herein, any information and/or data which is transmitted from the communication device to the point-of-sale device 2 can be transmitted directly to the point-of-sale device 2 and/or indirectly to the point-of-sale device 2 via the communication network.

The information and/or data which is transmitted from the communication device 4 to the point-of-sale device 2 can also be transmitted indirectly to the communication device 4, via the communication network, and independently of any transaction processing by a central transaction processing computer and/or central transaction processing system. In another embodiment, the information and/or data which is transmitted from the communication device 4 to the point-of-sale device 2 can also be transmitted indirectly to the point-of-sale device 2, via the central processing computer 3 or other processing computer or device.

At step 36, the receiver 2H of the point-of-sale device 2 will receive the cardholder's response. At step 37, the point-of-sale device 2 will process the cardholder's response. At step 38, the point-of-sale device 2 will determine whether the transaction is approved or authorized. If, at step 38, it is determined that the transaction is approved or authorized the point-of-sale device 2 will consummate the transaction at step 39. Thereafter, operation of the apparatus 1 will cease at step 40.

If, however, at step 38, it is determined that the transaction is disapproved or unauthorized, the point-of-sale device 2 will cancel the transaction, at step 41. Thereafter, the operation of the apparatus 1 will cease at step 42.

In the embodiment described above, as well as in any of the embodiments described herein, the point-of-sale device 2 can be programmed to wait a pre-specified amount of time for the cardholder's response. The point-of-sale device 2, can also be programmed to cancel the transaction or consummate the transaction if no response is received. Any of the particular instructions for the particular cardholder account can be included in the data and/or information which is stored on the magnetic strip and/or otherwise stored on the respective card. In this manner, the point-of-sale device 2 can utilize transaction instructions which are stored on, and/or obtained from, the respective account card and utilize this data and/or information in performing processing routines regarding the transaction. In this manner, the present invention can be utilized in order to provide custom tailoring of transaction processing regarding a particular account which information being pre-specified and stored on the respective account card.

In instances when the communication device 4 does not have a reply or two-way pager feature, the cardholder can simply telephone the point-of-sale device 2, or center or office servicing, and/or associated with, same, in order to personally appraise the device 2, or center or office of his or her response to the point-of-sale device 2 transmission regarding the transaction.

In this manner, the point-of-sale device 2 can communicate with the cardholder via the communication device 4 and independently of any transaction processing by a central transaction processing computer or central transaction processing service.

FIGS. 4A, 4B and 4C illustrate another preferred embodiment operation of the apparatus 1, in flow diagram form. In the preferred embodiment of FIGS. 4A, 4B and 4C, the apparatus 1 is utilized in conjunction with a central transaction processing computer or service. With reference to FIGS. 4A, 4B and 4C, the operation of the apparatus 1 commences at step 50 when the card, which is to be utilized in a credit card, charge card, debit card, and/or currency card, electronic currency card, “smart” card transaction, telephone calling card, and/or subscription card, is presented in the transaction. At step 51, the sales or service attendant or point-of-sale device operator will activate the apparatus 1 in any typical manner, such as by obtaining a phone line and entering card information into the point-of-sale device 2. This data entry is typically performed by swiping the magnetic strip of the card through the card reader 2B. The information and/or data pertinent to the transaction, and/or the card, is then transmitted, at step 52, to the central processing computer 3.

The central processing computer 3 will, at step 53, process the information and/or data pertinent to the transaction and/or to the particular card account and can request, if needed, that the point-of-sale operator enter the transaction amount. The central processing computer 3 will then process the information and/or data pertinent to the transaction in conjunction with the card account information in order to determine if the card has been lost, stolen and/or cancelled and/or de-activated. Further, the central processing computer 3 will perform a test to determine if the card has reached and/or exceeded the maximum credit, charge or debit limit and/or if the card has been depleted of its currency value.

The central processing computer 3 can utilize any of the widely known data processing and/or software routines, which are known to those skilled in that art, in order to process transaction requests and/or authorizations involving the use of the respective card(s). Once the information and/or data processing has been completed at step 53, the central processing computer 3, at step 54, will determine if the card has been lost, stolen, and/or cancelled and/or de-activated, or if the credit, charge or debit limit of the card has been reached and/or exceeded, or if the currency value of the card has been depleted.

The central processing computer 3 will, at step 54, also perform a test in order to determine if the predetermined maximum number of unauthorized transactions have occurred on the account. The unauthorized transactions count refers to transactions which are not authorized by the cardholder as will be described herein. The authorized transaction count (UNAUTHCT) is a variable which is pre-set to zero (0) at the time the card account is issued. Each time an unauthorized transaction occurs, the unauthorized transaction count is incremented by one (1).

Once the unauthorized transaction count reaches a pre-defined limit of, for example, three (3), the central processing computer 3 will cancel the transaction and de-activate the card. The central processing computer 3 will then notify the cardholder. In this manner, the apparatus 1 will enable the central processing computer 3 of an issuing and/or card servicing institution to cancel and/or de-activate the card, either permanently and/or temporarily, in cases when the cardholder may have failed to respond or to reply to transaction notices, which may be the case when the cardholder is not aware that the card has been lost or stolen, or when the card or account number has been duplicated, “cloned”, or in other ways utilized without the cardholder's authorization, and/or when the cardholder is unable to respond or reply to the transaction notices for some other reason(s). This feature of the present invention serves to put a usage limit on the use of the card(s). The central processing computer 3, at step 54, will also perform a test(s) to determine if any additional limitations and/or restrictions have been met and/or satisfied.

If any of the above listed conditions exist (i.e. card is lost, stolen, cancelled and/or de-activated, or credit, charge or debit limit is reached and/or exceeded, currency value depleted, unauthorized transaction limit reached or exceeded limitations and/or restrictions violated, etc.), the central processing computer 3 will, at step 55, transmit a signal to the point-of-sale device 2 indicating that the transaction is not approved and/or is not authorized. The point-of-sale device operator can then cancel the transaction, at step 56. The point-of-sale device operator can then confiscate the card and/or alert the authorities. Upon the completion of step 56, the apparatus will cease operation at step 75.

If, at step 54, the central processing computer 3 determines that the card is not lost, stolen, cancelled or de-activated, or that the credit, charge or debit limit of the card has not been reached or exceeded, or that the of unauthorized transactions count (UNAUTHCT) has not reached a pre-defined limit, or whether any other pre-defined, pre-selected and/or programmed limitation(s) and/or restriction(s) have been met, have been satisfied and/or have been reconciled, the central processing computer 3 will, at step 57, transmit a signal and/or data to the communication device 4 which is located at the cardholder.

At step 57, the central processing computer 3 will then also transmit respective signals and/or data to any one or more of the cardholder's designated fax machine 5, personal computer or personal digital assistant 6, telephone 7, telephone answering machine 8, alternate telephone 9, alternate telephone answering machine 10, network computer 11, and/or alternate beeper 12 or alternate pager 13.

The information and/or data which is transmitted to the communication device 4 includes information and/or data identifying the transaction and can include the name of the store or the service provider and the amount of the transaction. The information and/or data can also provide the time of the transaction, the location (i.e. city, town, village, state, country etc.) of the transaction. The information and/or data can also include the phone number of the central processing office and/or computer servicing the account so that the cardholder can telephone same in order to authorize or cancel the transaction. The information and/or data can also be supplemented to include the type of goods and/or services involved in the transaction, if such information can be entered at the point-of-sale device 2.

At step 58, the information and/or data which is transmitted from the central processing computer 3 and received at the communication device 4 is displayed to the cardholder on the display device 4E of the communication device 5. The information displayed on the display device 4E includes the name of the store or the service provider, the amount of the transaction, the time of the transaction and the location of the transaction. The information and/or data can also be supplemented to include the type of goods and/or services involved in the transaction, if such information can be entered at the point-of-sale device 2.

The apparatus 1 will then, at step 59, wait for the cardholder to respond to the transmission. During this time, the cardholder may either utilize the reply or two-way pager feature on the communication device 4 in order to either approve or authorize the transaction or disapprove of or void the transaction. At step 59, the central processing computer 3 will also receive the response if one is sent.

At step 60, the apparatus 1 will determine if the cardholder has made a reply or response within the pre-defined time limit which is chosen, in the preferred embodiment, to be one (1) minute. The cardholder can also transmit a signal via an appropriate key or button suspending use of the card such as when he or she can first be apprised of the fact that the card has been lost or stolen. In instances when the communication device 4 does not have a reply or two-way pager feature, the cardholder can simply telephone the central processing office or a processing center for the card in order to personally appraise the center or office of his or her response to the central processing computer transmission regarding the transaction.

If the cardholder does not respond or reply to the central processing office within the pre-specified time, chosen, in the preferred embodiment, to be one (1) minute, the central office computer will, at step 61, increment the unauthorized transaction count (UNAUTHCT) by one (1) and will, at step 62, transmit a signal and/or data to the point-of-sale device 2 indicating that, with the exception of receiving the authorization of the cardholder, the transaction is otherwise approved. The point-of-sale device operator can then, at step 63, either proceed to consummate the transaction, try to obtain additional information from the purchaser, or cancel the transaction.

The action taken by the point-of-sale device operator can be dictated by the specific agreement in effect between the sales and/or service provider establishment and the bank or financial institution administering the card account. Upon the completion of step 63, the operation of the apparatus 1 will cease at step 64. If the cardholder should reply or respond to the transaction notice at a later period, the response or reply information can then be utilized in order to approve of, or to disapprove and/or to dispute, the transaction.

If, at step 60, the response or reply is determined to be timely, the central processing computer 3 will, at step 65, process and identify the cardholder response. At step 66, the central processing computer 3 will determine if the cardholder has replied or responded so as to authorize the transaction. If the cardholder's response is to cancel, disapprove or, or not to authorize, the transaction, the central processing computer 3 will, at step 67, increment an unauthorized transaction count by 1. At this juncture, the unauthorized count (UNAUTHCT) is set to zero at the time of the issuance of the card.

After the unauthorized transaction count has been incremented, the central processing computer 3 will, at step 68, transmit a signal and/or data to the point-of-sale device 2 which will notify and/or instruct the point-of-sale device operator that the transaction is not authorized and should, therefore, be cancelled or voided. The point-of-sale device operator can then cancel the transaction at step 69. The point-of-sale device operator can then confiscate the card and/or alert the authorities. Upon the completion of step 69, the apparatus will cease operation at step 70.

If, at step 66, the central processing computer 3 identifies the cardholder reply or response as being one to authorize the transaction, the central processing computer 3, at step 71, will reset the unauthorized transaction count (UNAUTHCT) to 0. An unauthorized transaction count (UNAUTHCT) of 0 will signify that any string of unauthorized transactions has now been broken by the cardholder, and further, that the present transaction is approved by the cardholder. The central processing computer 3 will then, at step 72, transmit a signal and/or data to the point-of-sale device 2 which will notify and/or instruct the point-of-sale device operator that the transaction is authorized and/or approved.

The point-of-sale device operator can then complete the transaction, at step 73. After the transaction has been completed at step 73, the operation of the apparatus 1 will cease at step 74.

In another preferred embodiment, the central processing computer 3 can perform any and/or all of the functionality described as being performed by the point-of-sale device 2 as described herein in conjunction with FIGS. 3A and 3B. In this manner, in another preferred embodiment of FIG. 1, the central processing computer 3 can transmit a notification signal, data, and/or information, to the communication device 4, to notify the cardholder or account holder of a transaction on the respective credit card account, charge card account, debit card account, currency card account, “smart” card account, telephone calling card account, and/or any other herein-described account. Thereafter, the cardholder or account holder can transmit a response, to the notification signal, to the central processing computer 3. The central processing computer 3 can thereafter process the cardholder's or account holder's response. If the central processing computer 3 determines that the transaction is authorized or approved, the central processing computer 3 can consummate or complete the transaction. If the transaction is not authorized or not approved, the central processing computer 3 can cancel or terminate the transaction.

In any of the embodiments described herein, any of the communications which are transmitted, received, and/or which take place during apparatus operation, by and between any of the point-of-sale devices 2, the central processing computers 3, and the communication devices 4, can take place in real-time and/or otherwise.

In instances when the cardholder is a party to the transaction, he or she, having the communication device 4 on his or her person, can authorize the transaction at the point-of-sale location. If the transaction is a telephone and/or other remotely made transaction, the cardholder can authorize the transaction from his or her remote location. The cardholder can also program and/or set the communication device 4 to automatically authorize or disapprove or disallow transactions. In this regard, the communication device 4 can be programmable so as to receive and analyze the transaction information and/or data and reply and/or respond to same automatically and/or with preset and/or programmed relies and/or responses. The communication device 4 can also be programmable so as to limit the amounts of transactions. In this regard, the cardholder can provide for temporary transaction and/or purchasing amounts.

The communication device 4, in the preferred embodiment, is provided with a memory device for storing any number of transactions so that the cardholder can review his or her card and/or account activity and/or transactions which have occurred involving his or her card. In this manner, the cardholder can “scroll” through and/or in other ways review card and/or account activity. The communication device 4 can also be equipped to service more than one card. For example, a cardholder's MASTERCARD®, VISA®, and/or AMERICAN EXPRESS® card or cards and the accounts corresponding thereto can all be serviced with or by a single communication device 4.

In another preferred embodiment of the apparatus 1 of FIG. 1, the apparatus 1 can be programmed and/or can be programmable by the respective cardholder, account holder, account owner, and/or other authorized individual, (hereinafter referred to as “cardholder” or “account holder”). The cardholder or account holder can access the central processing computer 3 via the communication device 4, a telephone, and/or any other communication device. The cardholder or account holder can thereafter program the central processing computer 3 by transmitting a signal, data, and/or information, containing and/or corresponding to instructions for restricting and/or limiting activity and/or transactions which can occur and/or take place on, or in conjunction with, the respective account.

The signal, data and/or information, containing the restriction(s) and/or limitation(s) data and/or information is received by the receiver 3G. Thereafter, the CPU 3A will process the restriction(s) and/or limitation(s) data and/or information and store any appropriate data and/or information in the database 3H.

The above-described programming of restrictions and/or limitations into the central processing computer 3 can take place in real-time and/or otherwise.

The restrictions and/or limitations which can be programmed into the central processing computer 3 can include the types of transactions which are allowed and/or authorized, the goods and/or services which can be purchased with the card or account, the vendors, stores and/or service provider which can be authorized to accept the card or account, limits on the dollar amounts of transactions pertaining to each authorized vendor, seller and/or service provider, daily spending limits, and/or the geographical area or location wherein authorized card or account use can be limited, and/or authorized times for card or account usage (i.e. specific days, dates, time of day, time of month, year, etc.), and/or any other limitation and/or restriction regarding amount of transaction, parties involved, geographical area, and/or times of allowed usage.

For example, the cardholder or account holder can program the central processing computer 3, and/or the server computer, if utilized, so as to change the credit limits on his or her account, periodically and/or at any desired time. For example, a cardholder or account holder having a credit card with a $10,000 dollar credit limit, but who very seldom or rarely utilizes his or her card for much more than $500 dollars during a monthly billing period, can program the apparatus and, in particular, the central processing computer 3, or server computer, if utilized, so as to temporarily reduce his or her credit limit.

If the cardholder or account holder should thereafter desire to make a major purchase with his or her credit card of, for example, a purchase in the amount of $8500, the cardholder or account holder can, prior to the transaction, access and re-program the central processing computer 3 and/or server computer, if utilized, so as to temporarily increase his or her temporary credit limit. The apparatus 1 can then be programmed so that, after the major purchase has been made, the apparatus 1 can revert operation back to the reduced credit limit.

The cardholder or account holder can program the central processing computer 3, and/or the server computer, if utilized, via the communication device 4, a telephone, and/or any other suitable communication device. The cardholder can also perform the above-described programming via a touch-tone telephone. In the same manner, the cardholder or account holder can program the apparatus 1 so as to limit the types of transactions involving, and/or the goods and/or services which can be purchased with, his or her card or account, and/or the stores, goods and/or service providers which can be authorized to accept the card or account, limits on the dollar amounts of transactions pertaining to each authorized vendor, seller and/or service provider, daily spending limits, the vendors, sellers, and/or service providers with which the card or account can be utilized, the geographical area or location within which the card or account can be utilized, and/or authorized times for card or account usage (i.e. specific days, dates, times of day, times of month, year, etc.), and/or any other limitations and/or restrictions regarding amount of transaction, parties involved, geographical area, and or times of allowed card or account usage.

Once programmed by the cardholder or account holder, the central processing computer 3, upon receiving a transaction authorization request or a transaction processing request, will process the transaction in conjunction with the restriction(s) and/or limitation(s) provided, programmed, and/or dictated, by the cardholder or account holder.

By utilizing the above-described programming routine(s), a cardholder, account holder, account owner, and/or other authorized individual, can program and/or update any data and/or information which can or may be stored in the database 3H. The above programming routine(s) can be performed in real-time and/or otherwise.

In another preferred embodiment, the cardholder, account holder, account owner, and/or other authorized individual, can program the respective point-of-sale sale device 2 and/or communication device 4, in real-time and/or otherwise, in the same manner in which the central processing computer 3 can be programmed, so as to program restrictions and/or limitations into the respective devices. The point-of-sale device 2 can, in this manner, be directly programmable, by the cardholder, account holder, account owner, and/or other authorized individual, in real-time and/or otherwise, in the same manner described above regarding the central processing computer 3, so as to automatically process a transaction in accordance with the restrictions or limitations provided by cardholder or account holder.

The communication device 4 can also be directly programmable by the cardholder, account holder, account owner, and/or other authorized individual, in real-time and/or otherwise, in the same manner described above regarding the central processing computer 3, so as to automatically process a transaction authorization request and/or a transaction.

In a similar manner, the cardholder, account holder, account owner, and/or other authorized individual, can program the apparatus 1 as described above in conjunction with the use of any of the herein-described cards and/or accounts, such as, for example, credit card, a charge card a debit card, an electronic currency card, a “smart” card, a telephone calling card, and/or subscription card, a credit card account, a charge card account, a debit card account, a smart card account, a currency card account, a telephone calling card account, a cable television account, a digital television account, a satellite television account, a utility account, an electrical utility account, a gas utility account, a fuel oil utility account, an insurance account, a subscription account for any goods, products, and/or services, a health care insurance account, a pharmacy account, a social security account, accounts monitoring use of official seals, accounts monitoring use of private, individual, and/or organizational seals or access codes, a security access account, a computer access code account, computer access account, computer security account, e-mail account, membership account, club membership account, entertainment membership account, entertainment tickets account, sports tickets account, theatre ticket account, concert or opera ticket account, consumer or purchaser memberships account, sports club membership account, health club membership account, merchant credit account for customers, merchant account, association membership account, professional association membership account, and/or trade association membership account.

The central processing computer 3 can also be programmed to provide notification to the cardholder upon the occurrence of any number of events and/or occurrences which take place regarding and/or relating to the respective account. The central computer 3 can provide notification to the cardholder upon the receipt of a cardholder's payment on a respective account, the crediting of the payment to the respective account, the reaching of a pre-specified credit, charge, debit, and/or other respective limit on the respective account, a change in interest rate on the account, a change in a credit limit, and/or any other change and/or occurrence regarding and/or relating to the account which may be of interest to the respective cardholder. The central processing computer 3 can also notify the cardholder regarding a payment due date, an overdue status of a payment, an interest rate change, a credit limit change, an account restriction and/or limitation on usage, etc.

In this manner, the cardholder can be notified of any of the above-described and/or any other event or occurrences. For example, the cardholder can be notified when a payment, sent in and/or made by the cardholder for and/or on his or her respective account, is received and/or applied and/or credited to his or her account. Similarly, the cardholder can be notified when he or she has reached and/or is close to reaching a pre-specified credit limit and/or upon the occurrence of administrative events or occurrences, i.e. payment due date, payment overdue, interest rate change, credit limit change, account restrictions, etc.

In another preferred embodiment, the point-of-sale device 2 can be programmed to provide any of the functions described herein as being performed by the central processing computer 3, including, but not limited to, providing any of the notification functions for providing notification to the cardholder of any of the above-described events and/or occurrences.

The various processing routines described herein as being performed by the apparatus 1 of the present invention in FIGS. 3A and 3B and FIGS. 4A, 4B and 4C can also be performed in conjunction with each other and/or can be combined so that the apparatus 1 can perform multiple routines in conjunction with each other. In this regard, the point-of-sale device 2 can, in another preferred embodiment, transmit the information and/or data pertinent to a transaction to the communication device 4 associated with a cardholder, and process the transaction in the manner described herein with the cardholder, while also transmitting the information and/or data pertinent to the transaction to the central processing computer 3 and processing the transaction with the central processing computer 3.

The point-of-sale device 2 can transmit the respective transmissions to the respective devices 4 and 3 in a sequential fashion and/or in any desired and/or specified order and/or the point-of-sale device can transmit the respective transmissions to the respective devices 4 and 3 simultaneously. In any event, the point-of-sale device(s) 2, the central processing computer(s) 3, and the communication device(s) 4, in the preferred embodiments described herein, can be suitably equipped with any necessary, additional, and/or desired, hardware and/or software for facilitation their respective operations and/or functionality as described herein.

In a similar manner, the cardholder may program the apparatus 1 as described above in conjunction with the use of any of the herein-described cards and/or accounts.

In a similar manner, a cardholder, account holder and/or account owner, and/or any other authorized individual, of and/or for any of the herein-described cards and/or accounts (i.e. credit card, a charge card a debit card, an electronic currency card, a “smart” card, a telephone calling card, and/or subscription card, a credit card account, a charge card account, a debit card account, a smart card account, a currency card account, a telephone calling card account, a cable television account, a digital television account, a satellite television account, a utility account, an electrical utility account, a gas utility account, a fuel oil utility account, an insurance account, a subscription account for any goods, products, and/or services, a health care insurance account, a pharmacy account, a social security account, accounts monitoring use of official seals, accounts monitoring use of private, individual, and/or organizational seals or access codes, a security access account, a computer access code account, a computer security account, a computer access account) can program the apparatus 1 so as to limit the types of transactions involving, and/or the goods and/or services which can be purchased with, his or her card or account, and/or the stores or service providers which can be authorized to accept the card or account, limits on the dollar amounts of transactions pertaining to each authorized vendor, seller and/or service provider, daily spending limits, the vendors, sellers, and/or service providers with which the card can be utilized, the geographical area or location within which the card or account can be utilized, and/or authorized times for card or account usage (i.e. specific days, dates, times of day, times of month, year, etc.), and/or any other limitations and/or restrictions regarding amount of transactions, parties involved, geographical area, and or times of allowed card or account usage.

The apparatus and method of the present invention provides for the real-time notification of financial transactions involving credit cards, charge cards, debit cards, and/or currency cards, electronic currency cards, “smart” cards, and/or telephone account cards, and/or any other accounts, described herein and/or otherwise, which may be the subject of a financial interest, a safety interest, and/or a security interest, and which enables a cardholder, account holder, account owner, and/or other authorized individual, to monitor, in real-time and/or otherwise, activity involving his or her card(s), corresponding accounts, and/or accounts.

The apparatus and method of the present invention also provides a means and a mechanism by which to inform a cardholder that his or her card(s) are lost or stolen, and/or that his or her card(s), and/or the account numbers corresponding thereto, are utilized without his or her authorization and also provides an indication to the cardholder of where his or her card(s) or corresponding account number(s) is being utilized in transactions. The cardholder can then report the card lost or stolen and/or cancel and/or de-activate the card and/or the account.

The present invention also provides a means and a mechanism by which to monitor the number of transactions which are unauthorized by the cardholder and to determine whether or not to authorize transactions and/or cancel or de-activate the card(s) and/or the account.

The central processing computer 3 and/or the point-of-sale device 2 can also generate and transmit notification signals, e-mails, and/or other electronic and/or conventional message and/or transmission to notify the cardholder when he or she is about to reach a pre-determined credit limit, has reached a pre-determined credit limit, has a balance due on the account, and/or to provide notification regarding a payment due date, a past due payment, and/or to provide notification regarding any other event, occurrence, and/or account activity which can be related to the account and/or which may be of interest to a cardholder and/or an individual or entity authorized to receive notification for, and/or on behalf of, the cardholder.

In the above manner, the apparatus and method of the present invention provides an apparatus and a method for preventing and/or for drastically limiting fraudulent and/or unauthorized use of credit cards, charge cards, debit cards, and/or currency or “smart” cards, telephone calling cards, and/or subscription cards, and/or any account numbers corresponding thereto.

With regards to security type accounts, computer security accounts, computer access accounts, computer access code accounts, facility access accounts, facility security accounts, and other like accounts, the apparatus 1 can be utilized to monitor use of and/or access to the respective computer or facility. For example, the apparatus 1 can be utilized to provide a notification signal to an authorized individual upon the accessing of a secured computer system and/or a secured facility.

Any and/or all of the embodiments described herein can be modified so as to provide the described security, notification, and/or authorization, functions and/or services described herein for any of the security type accounts, computer security accounts, computer access accounts, computer access code accounts, facility security accounts, described herein.

The present invention, in another preferred embodiment, can be utilized so as to provide authorization, notification and/or security in banking and related financial transactions involving checking accounts, savings accounts, and/or automated teller machine (ATM) accounts and transactions, and/or other transactions, financial and/or otherwise, wherein an account owner can be notified of a transaction and/or an attempted transaction.

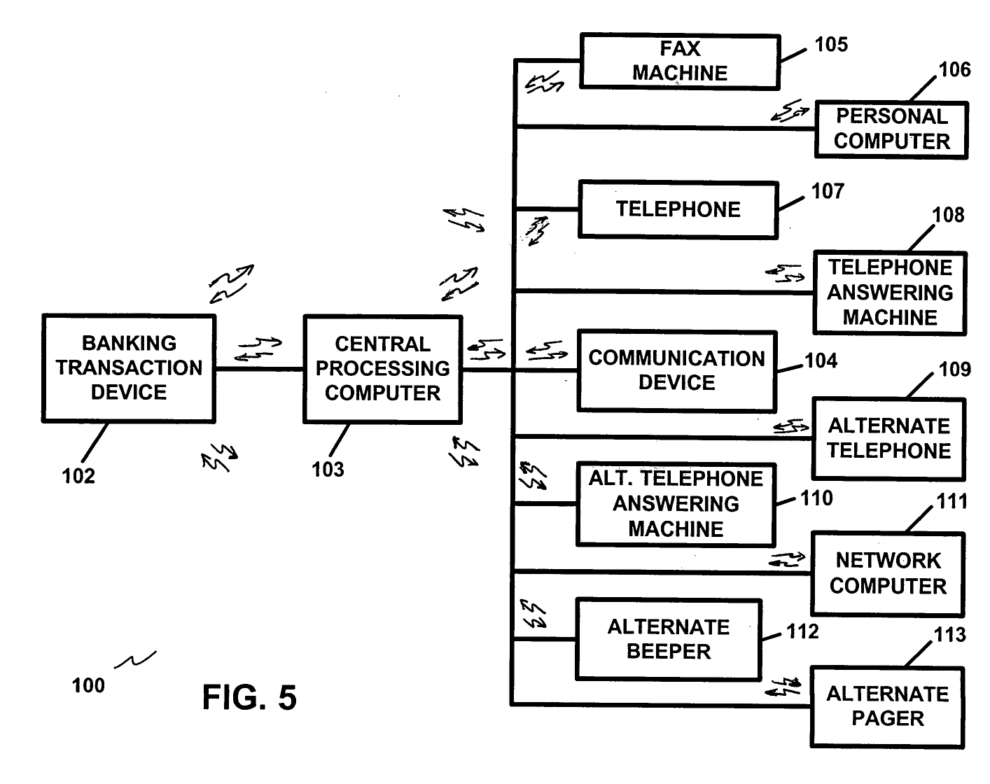

FIG. 5 illustrates a block diagram of another preferred embodiment of the apparatus of the present invention which is utilized in conjunction with a checking account, savings account and/or ATM account and/or transaction (hereinafter referred to as a “banking transaction”) and/or the authorization process involved therewith. The apparatus of FIG. 5 is denoted generally by the reference numeral 100.

In FIG. 5, the apparatus 100 includes of a banking transaction device 102 which devices or terminals are found in banks and financial establishments. In the preferred embodiment, the banking transaction device 102 is a teller device, a processing computer device or terminal and/or an ATM terminal. Any other device or similar device can also be utilized as the banking transaction device 102 depending upon the application and/or the transaction.

The banking transaction device 102 (hereinafter referred to as “banking device”) can be any of the widely used and well known devices, terminals or computers for providing banking transactions, over-the-counter transactions, ATM transactions, and/or which can be utilized in any other type of financial transactions, including clearing transactions, deposit transactions, withdrawal transactions, check clearing transactions, and/or account charging and/or charge-back transactions, which transactions banks and financial institutions perform and/or engage in.

Typically, the banking devices and/or terminals include a computer terminal having an input device such as a keyboard, mouse, scanner, reader, card reader, and/or card reading and/or scanning device, for reading and/or scanning, respectively, information and/or data necessary in order to perform the transaction. The banking device 102 transmits an authorization request and/or a transaction notification signal, which can include the data pertaining to the particular account which is accessed and/or involved in the transaction and the type and the amount of the transaction, as well as any other information pertaining to the transaction, over a communications medium, to an individual account holder, an individual authorized to receive information for, and/or otherwise act for and/or on behalf of the individual account holder, and/or to a central processing computer for processing the transaction, the transaction request and/or the authorization request pertaining thereto.

The banking device 102 can transmit the transaction authorization request and/or notice to a central processing computer via a central bank computer (not shown) which can be a central computer at the particular bank or financial institution. The central processing computer can also be a central computer system which is not located at the bank or financial institution, but rather, services the particular bank or financial institution or a group of banks or financial institutions.

The banking device 102 also receives the transaction and/or authorization data and/or information from the respective communication device associated with the individual account holder, the individual authorized to receive information for and/or on behalf of the account holder, and/or the central processing computer. If a central bank computer is utilized, the data transmitted from the central processing computer would be transmitted to the banking device 102 via the central bank computer. A printed transaction receipt can also be provided at and/or obtained via the banking device 102, or peripheral device associated therewith, for printing a transaction receipt which is usually provided to the account holder at the time and/or location of the transaction.

The banking device 102 can also include, and/or have associated therewith, a keypad for the manual entry of transaction information and/or data, such as the amount of the transaction, account number, etc. The banking device 102 can also be an integral component of a teller and/or cashier work station and/or other transaction terminals and/or devices, including those which can provide for the automatic entry of transaction information and/or data.

The banking device 102 can be equipped to read multiple contact information from magnetic strip cards so as to provide for the transmission of data and/or information to multiple individuals, entities and/or to multiple communication devices associated with the individual(s), entity, or entities. For example, the magnetic strip on the back of a bank card, banking card, debit card, smart card, and/or automated teller machine (ATM) card, associated with the bank account and/or financial account, can contain the phone number and/or contact information for a central transaction authorization computer associated with the card as well as a the identity, address, phone number, pager number, e-mail address, fax number, and/or any other contact information for the individual account holder.

In cases involving banking “smart” cards, or cards having processors, memory chips, computer chips and/or other processors and/or processing devices, the banking device 102 can be equipped with an appropriate card reading device for reading and/or obtaining information from the respective processor, memory chip, computer chip and/or other processor and/or processing device.

The respective account cards, in addition to containing account holder contact information, can also contain information regarding restrictions and/or limitations on account usage. In this manner, the respective card can contain information regarding restrictions and/or limitations as to the type of authorized transactions, authorized parties to a transaction, identification required, required personal identification information, authorized times of usage, authorized geographic location of usage, as well as any other restriction and/or limitation on account usage.

The apparatus 100 also includes a central processing computer 103 which services any bank and/or financial institution and/or any pre-defined group of banks and/or financial institutions and/or any number of accounts, and/or account holders, associated therewith. For example, the central processing computer 103 can handle all checking accounts, savings accounts and/or other accounts for a given bank or banks. The central processing computer 103, for example, can process and maintain records of deposits, withdrawals, checks cashed, drafts, ATM deposits, ATM withdrawals, charges made against an account, credits made to an account, etc., and/or any combinations of same. The central processing computer 103 can process accounts for any of the various banks and/or financial institutions.

In the preferred embodiment, the banking device 102 is linked and/or connected to the central processing computer 103 via a telecommunications system, link and/or medium (hereinafter referred to as “communications system”) such as, for example, a telephone network or line. As noted above, the banking device 102 may or may not be linked to the central processing computer 103 via a central bank computer. The communications system which is utilized can be any communications system and can include telecommunication systems, satellite communications systems, radio communication systems, digital communications systems, digital satellite communications systems, personal communications services communication systems, cable television systems, digital television systems, satellite television systems, broadband communication systems, as well as any other appropriate communications system. The banking device 102 transmits signals and/or data to the central processing computer 103 as well as receives signals and/or data from the central processing computer 103.

The central processing computer 103 can be a mainframe computer, a mini-computer, a micro-computer, a server computer, such as those utilized in conjunction with on-line services and/or in a network environment, and/or any other suitable computer or computer system.

The apparatus 100 also includes an account owner communication device 104 which can receive signals and/or data from either or both of the banking transaction device 102 and/or the central processing computer 103. The communication device 104 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch.

In another preferred embodiment of FIG. 5, the communication device 104 receives signals and data directly from the banking device 102 with said signals being transmitted via a suitable communication system. In this preferred embodiment, the communication device 104 can also transmit signals and data to the banking device 102, directly and/or indirectly, with said signals being transmitted via a suitable communication system. In another preferred embodiment of FIG. 5, the communication device 104 can receive signals and data from the central processing computer 103, directly and/or indirectly, with said signals being transmitted via a suitable communication system. In this preferred embodiment, the communication device 104 can also transmit signals and data to the central processing computer 103, directly and/or indirectly, with said signals being transmitted via a suitable communication system.

In the preferred embodiment, the communications system utilized for transmitting signals and/or data to the communication device 104 is a wireless telephone line and the communication device 104 is a wireless telephone signal receiving device such as a telephone beeper or pager. The communication device 104, which can be a pager, receives the wireless telephone signals and/or data from the central processing computer 103 during the authorization procedure as will be described in more detail below.

In the preferred embodiment, the communication device 104 is also equipped with a transmitter for transmitting signals and/or data to the central processing computer 103. In this regard, the central processing computer 103 transmits signals and/or data to the communication device 104 as well as receives signals and/or data from the communication device 104. The communication device 104 can also transmit signals and/or data directly to the banking device 102 and receive signals and/or data directly from the banking device 102. In the preferred embodiment, the banking device 102 transmits signals and/or data to the central processing computer 103 and receives signals and/or data from the central processing computer 103. Further, in the preferred embodiment, the communication device 104 receives signals and/or data from the central processing computer 103 and transmits signals and/or data to the central processing computer 103.

As noted above, the communication device 104 is a wireless device. In this regard, the communication device 104 or pager can be carried by the account owner and/or be kept on and/or close to the account owner's person so that the central processing computer 103 can transmit signals and/or data to the communication device 104 so as to communication with the account owner at any time.

In the preferred embodiment, the apparatus 100 also includes a facsimile (fax) machine 105, a personal computer or personal digital assistant 106, a telephone 107, a telephone answering machine 108, an alternate telephone 109, an alternate telephone answering machine 110, a network computer 111, and/or an alternate beeper 112 or alternate pager 113. The central processing computer 103 can be linked with the above fax machine 105, personal computer or personal digital assistant 106, telephone 107, associated answering machine 108, alternate telephone 109, alternate telephone answering machine 110, network computer 111 alternate beeper 112 and alternate pager 113, via any suitable communication system.

In the preferred embodiment, a telecommunications link or telephone line or link, which may or may not be a wireless link, depending on the device and/or the circumstances, is utilized in order to link the central processing computer 103 with each of the fax machine 105, the personal computer or personal digital assistant 106, the telephone 107, the associated answering machine 108, the alternate telephone 109, the alternate telephone answering machine 110, the network computer 111, the alternate beeper 112 and the alternate pager 113.

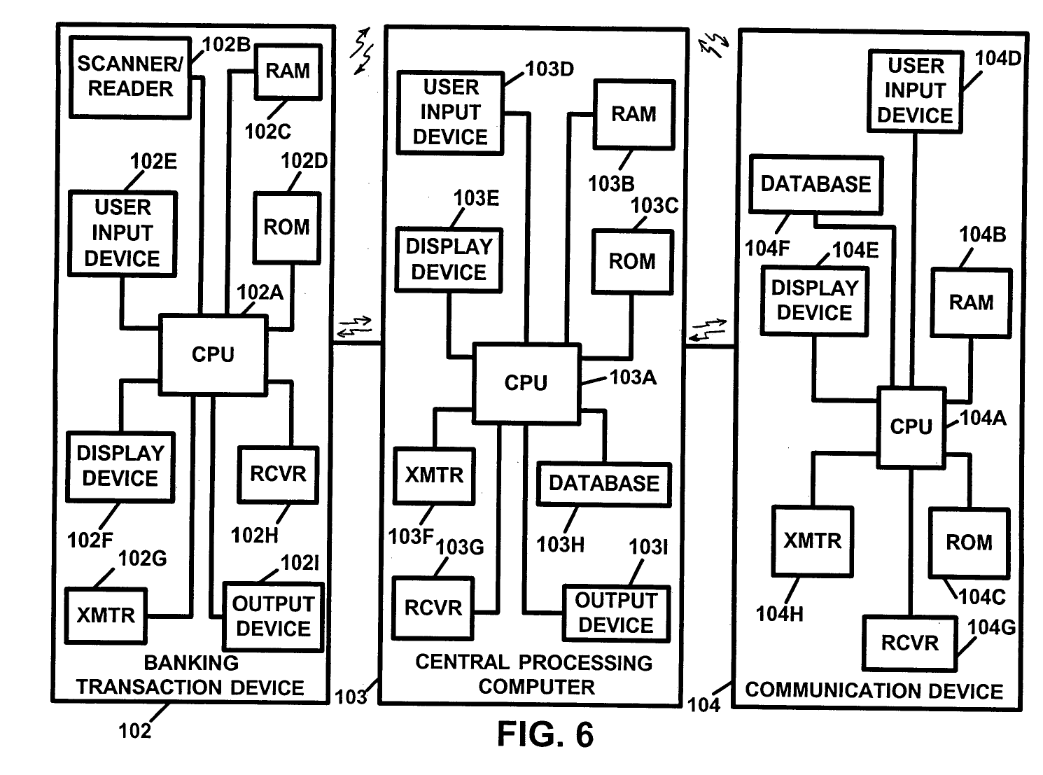

FIG. 6 illustrates the various components of the apparatus 100 of FIG. 5. In FIG. 6, the banking device 102, in the preferred embodiment, includes a central processing unit or CPU 102A, a scanner or reader 102B, which is connected to the CPU 102A, associated random access memory 102C (RAM) and read only memory 102D (ROM) devices, which are also connected to the CPU 102A, a user input device 102E, which is typically a keypad or other suitable input device for inputting data into the banking device 102 and which is also connected to the CPU 102A, and a display device 102F for displaying information and/or data to a user or operator, which display device 102F is also connected to the CPU 102A.

The banking device magnetic card reader or card reader 102B can, in the preferred embodiment, be capable of reading and processing data and/or information, which is stored on the magnetic strips and/or on the processors or chips which are located on the respective account card, and for providing one or multiple communications for one or multiple parties as well as reading and processing any restriction and/or limitation information regarding and/or related to account usage. For example, the magnetic card reader or card reader 102B can read and/or process data and/or information for identifying and communicating with a central transaction processing computer 103 as well as can read and/or process data and/or information for communicating with the individual account holder and/or an individual or agent authorized to act for and/or on behalf of the individual account holder, at any one or more of the communication devices associated with the individual account holder or the individual or agent associated with the individual account holder.

Data and/or information for providing any other the communications described herein can be obtained from the data and/or information contained in the magnetic strip on the card, the respective processor or chip located on the card, and/or can be obtained form an external database (not shown) which can be linked to the banking device 102 and/or which can be accessed thereby for obtaining any additional data and/or information.

The user input device 102E can include any data input device including, but not limited to, a keyboard, a mouse, a scanner, a reader or card reader, an audio input device, a voice recognition device, a fingerprint reading device, a retinal scanning device, and/or any other device for inputting data and/or information into the banking device 102.

The banking device 102 also includes a transmitter 102G for transmitting signals and/or data to the central processing computer 103, and/or to the communication device 104 and/or to any other device associated with the account owner, the account holder, and/or the apparatus, if desired. The transmitter 102G is also connected to the CPU 102A.

The banking device 102 also includes a receiver 102H for receiving signals and/or data from the central processing computer 103, and from the communication device 104 and/or from any other associated device which can be utilized, if desired. The receiver 102H is also connected to the CPU 102A. The banking device 102 also includes a printer 102I or other appropriate output device for outputting data to the operator. The printer 102I is also connected to the CPU 102A. In the preferred embodiment, the printer 102I prints receipts corresponding to the transaction.

In FIG. 6, the central processing computer 103, in the preferred embodiment, includes a central processing unit or CPU 103A, associated random access memory 103B (RAM) and read only memory 103C (ROM) devices, which are connected to the CPU 103A, a user input device 103D, which is a keypad or any other suitable input device, for inputting data into the central processing computer 103 and which is also connected to the CPU 103A, and a display device 103E for displaying information and/or data to a user or operator.

The user input device 103D can include any data input device including, but not limited to, a keyboard, a mouse, a scanner, a reader or card reader, an audio input device, a voice recognition device, a fingerprint reading device, a retinal scanning device, and/or any other device for inputting data and/or information into the central processing computer 103.

The central processing computer 103 also includes a transmitter(s) 103F for transmitting signals and/or data to the banking device 102 and to the communication device 104 and/or to any one or more of the fax machine 105, the personal computer or personal digital assistant 106, the telephone 107, the telephone answering machine 108, the alternate telephone 109, the alternate telephone answering machine 110, the network computer 111, the alternate beeper 112, and/or the alternate pager 113. The transmitter(s) 103F is also connected to the CPU 103A.

The central processing computer 103 also includes a receiver(s) 103G for receiving signals and/or data from the banking transaction device 102 and from the communication device 104 and/or from any other suitable device which can be utilized in conjunction with the apparatus 100. The receiver(s) 103G is also connected to the CPU 103A.

The central processing computer 103 also includes a database(s) 103H which contains account information and data pertaining to the account owner's account(s). The database 103H contains information about the account owner, the account number, etc., and any other information and/or data necessary to the manage and/or process an account and/or account transaction as described herein.

The database 103H can include any number of databases which may or may not be linked to one another. The database 103H can also be linked to a database or databases which are located external from the central processing computer 103.

The database 103H can also include data and/or information regarding specific limitations and/or restrictions which can be placed on a particular account, which can be pre-selected and/or programmed by the account holder and which can include limitations and/or restrictions on the usage of the account.

The limitations and/or restrictions can include the types of transactions which are allowed and/or authorized, limits on the amounts of transactions which can occur on an account, number of transactions which can occur on an account, authorized parties to use the account, authorized geographical area or location of usage, wherein authorized card use can be limited, and/or authorized times for account access and/or account usage (i.e. specific days, dates, time of day, time of month, year, etc.), and/or any other limitation and/or restriction regarding amount of transaction, parties involved, geographical area, and/or times of allowed usage. The database 3H is also connected to the CPU 103A.

The central processing computer 103 also includes a printer 103I or other appropriate output device for outputting information and/or data to a user or operator, which printer 103I or other output device is also connected to the CPU 103A.

In FIG. 6, the communication device 104, in the preferred embodiment, includes a central processing unit or CPU 104A, associated random access memory 104B (RAM) and read only memory 104C (ROM) devices, which are also connected to the CPU 104A, a user input device 104D, which is a keypad or a plurality of keys and/or switches for inputting data into the communication device 104 and which is also connected to the CPU 104A, and a display device 104E, for displaying information and/or data to the account owner, and a database 104F. This display device 104E and the database 104F are also connected to the CPU 104A.

The communication device 104 also includes a receiver 104G for receiving signals and/or data from the central processing computer 103 and which is also connected to the CPU 104A, and a transmitter 104H for transmitting signals and/or data to the central processing computer 103 and which is also connected to the CPU 104A.

The user input device 104D can include any data input device including, but not limited to, a keyboard, a mouse, a scanner, a reader or card reader, an audio input device, a voice recognition device, a fingerprint reading device, a retinal scanning device, and/or any other device for inputting data and/or information into the communication device 104.

In the preferred embodiment, the communication device 104 which can be utilized can be a computer communication device such as a personal computer, a hand-held computer, a personal digital assistant, a pager, a two-way pager, an interactive television, a telephone, a wireless telephone, and/or any other communication device. In the preferred embodiment, the communication device 104 can have a reply feature and/or device for facilitating two-way communication between the communication device 104 and any of the banking devices and central processing computers described herein. A two-way pager and/or pager systems can also be utilized for implementing the respective component system(s) in the apparatus 100 and/or the component combinations and/or communication systems and/or communication links.

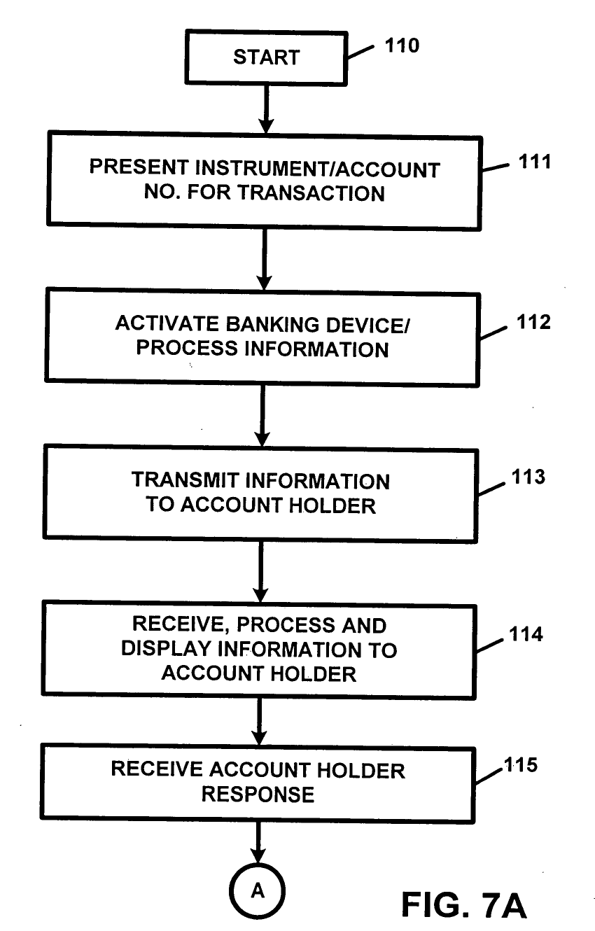

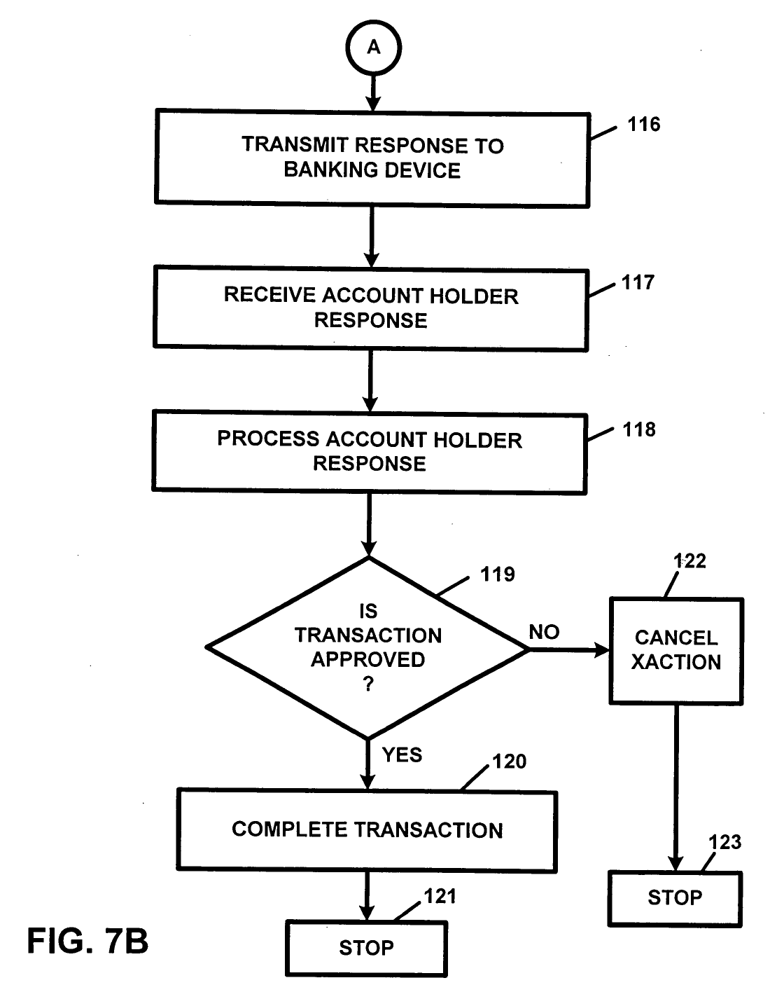

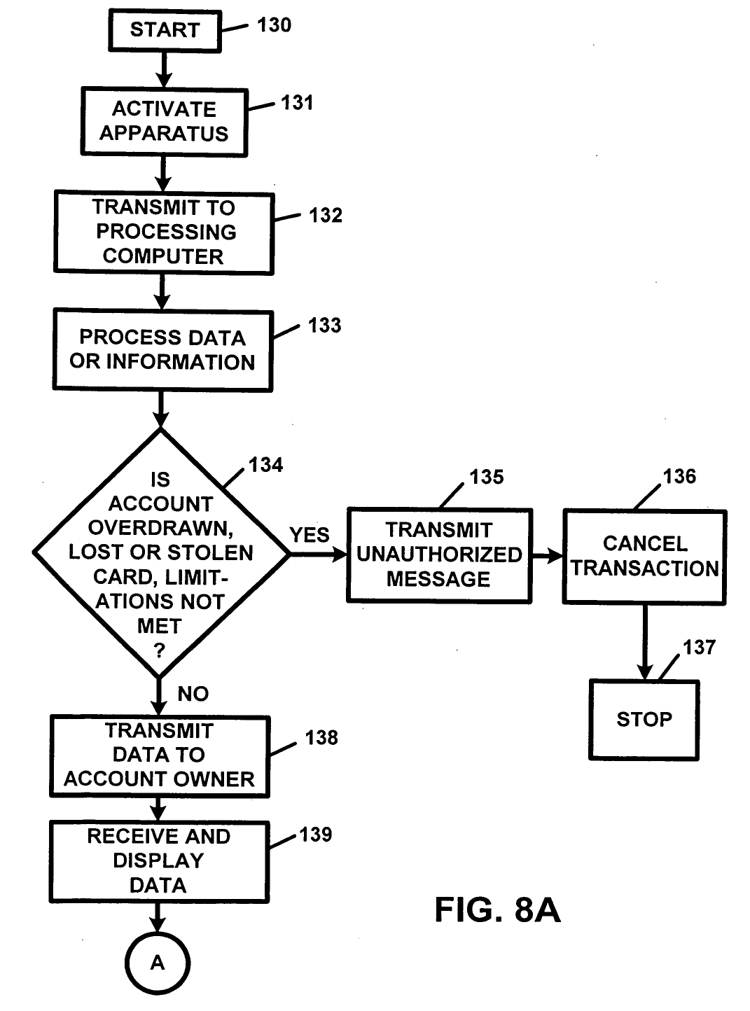

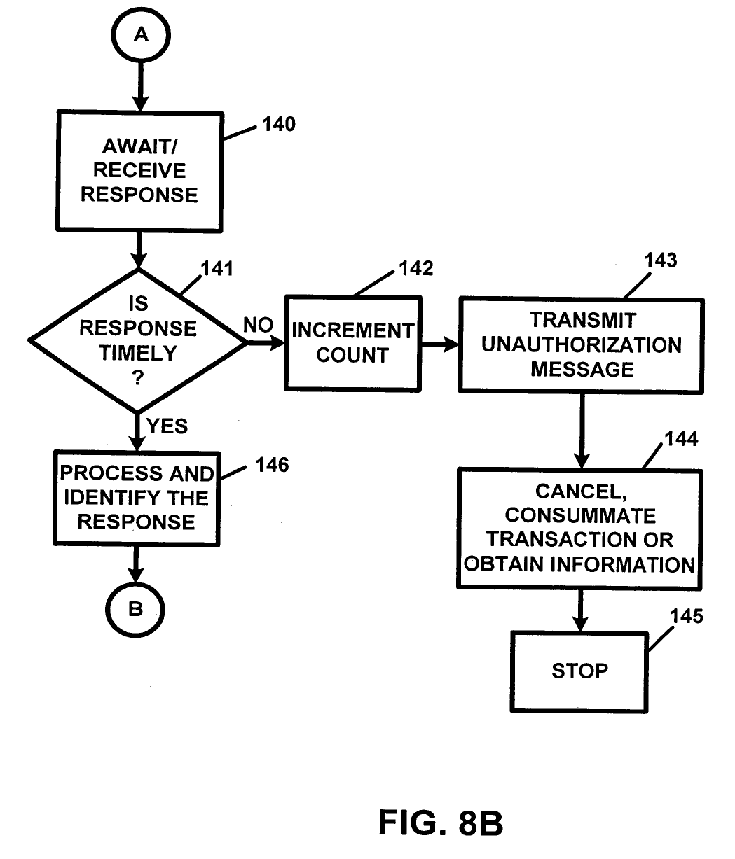

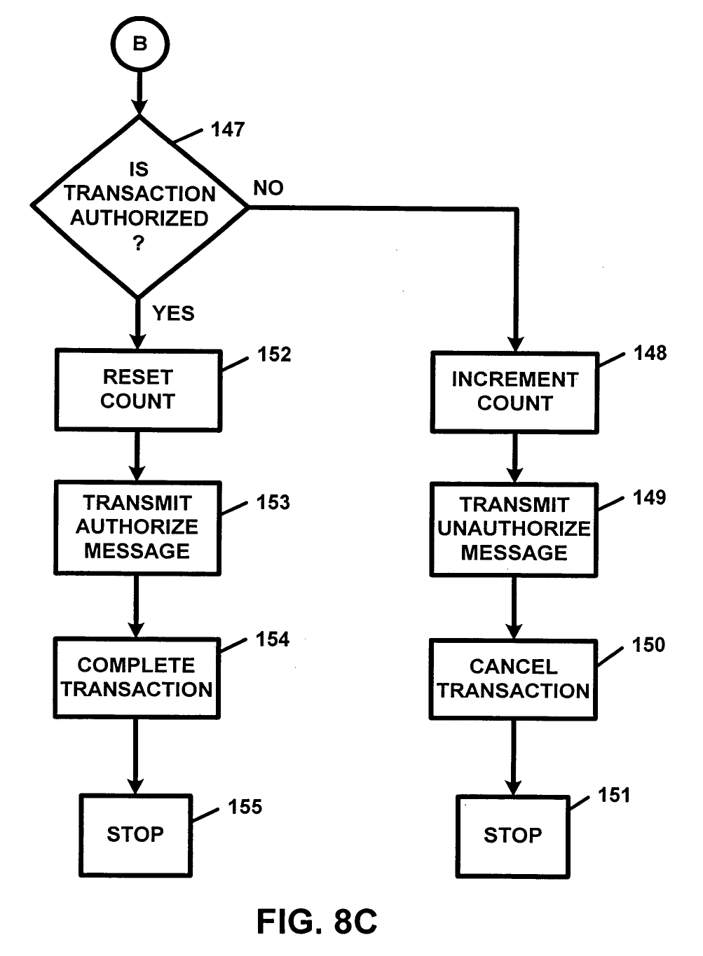

The apparatus 100 of the present invention, in other preferred embodiments, can be utilized in order to facilitate account owner authorization, notification and/or security, in financial transactions involving bank account, financial accounts, checking accounts, savings accounts, electronic money accounts, electronic cash accounts, ATM accounts, and/or any transactions involving same in the manner described below and/or with reference to FIGS. 7A and 7B and FIGS. 8A, 8B and 8C. In this manner, the apparatus and method of the present invention can be utilized to obtain account owner authorization in a banking and/or financial transaction.

The apparatus 100 can also be utilized in conjunction with an account card or cards which correspond to, or which are associated with, banking and/or financial accounts.

FIGS. 7A and 7B illustrate a preferred embodiment operation of the apparatus 100 in flow diagram form. With reference to FIGS. 7A and 7B, the operation of the apparatus 100 commences at step 110. At step 111, the financial transaction, financial instrument, account card, and/or ATM card, is presented to a bank or financial institution employee, and/or computer system, such as for example, the banking device 102, and/or otherwise presented for a transaction on the respective account. In any of the embodiments described herein, the transaction can involve and/or represent a withdrawal, a check cashing, an ATM withdrawal, a deposit, a deposit of any kind, an ATM deposit, a credit to the account, a charge to the account, a chargeback to the account, and/or any other event which may deposit and/or withdrawal funds from the respective account.

At step 112, the service attendant or banking device operator will activate the banking device 102 in any typical manner, such as by entering information regarding the account involved and the transaction into the banking device 102 via the user input device 102E, the scanner/reader 102B, and/or via receiving same via the receiver 102H. This data entry can typically be performed by entering information via a keyboard or mouse, or by swiping the magnetic strip of the account card through the scanner/reader 102B or by reading information from the processor or chip on the account card via the scanner/reader. The data obtained from the magnetic strip and/or the card processor or chip, and/or from any associated database, can be utilized to contact the account holder communication device 104 and/or the account holder directly and/or to process the transaction.

In another preferred embodiment, the banking device 102 can process the transaction in conjunction with any restrictions and/or limitations on account usage, information of which is obtained from the respective card. If the banking device 102 determines that the transaction violates and/or otherwise does not conform to a restriction and/or limitation on account usage, the banking device 102 can cancel and/or reject the transaction without proceeding further. For example, the banking device 102, upon reading a restriction involving a time of use (i.e. no account usage allowed between 12:00 A.M. and 6:00 A.M.), a location of usage (i.e. no usage outside a particular city, state, or country), or a transaction amount limitation (i.e. no account usage for transactions exceeding $100), can process the transaction and determine if the transaction would violate a particular restriction or limitation.

If the transaction would violate a restriction or limitation, the banking device 102 can cancel the transaction and no further processing would be required. If the transaction would not violate a restriction and/or limitation, the transaction processing could continue in any appropriate manner described herein and/or otherwise. The transaction is also processed at step 112.

The information and/or data pertinent to the transaction, and/or the account, is then transmitted, at step 113, to the communication device 104 via the communication network. In any of the embodiments described herein, any information and/or data which is transmitted from the banking device 102 to the communication device 104 can be transmitted directly to the communication device 104 via the communication network. The information and/or data which is transmitted from the banking device 102 to the communication device 104 can also be transmitted indirectly to the communication device 104, via the communication network, and independently of any transaction processing by a central transaction processing computer and/or central transaction processing system.

The transmission of the information and/or pertinent data, which takes place at step 113, is a transmission from the banking device 102 to the communication device 104 via the communication network and takes place independently of any processing of the transaction by a central processing computer or central processing service, such as by the central processing computer 103 and/or otherwise. In this manner, the present invention provides notification to the account holder of the transaction independently of any transaction processing by a central processing computer and/or a central processing service.

At step 113, the banking device 102, by utilizing account holder contact information obtained from the card and/or otherwise, can also transmit respective signals and/or data to any one or more of the account holder's designated fax machine 105, personal computer or personal digital assistant 106, telephone 107, telephone answering machine 108, alternate telephone 109, alternate telephone answering machine 110, network computer 111, and/or alternate beeper 112 or alternate pager 113.

The information and/or data which is transmitted to the communication device 104 can include information and/or data identifying the transaction and can include the name of the bank or financial institution and the amount of the transaction. The information and/or data can also provide the time of the transaction, the location (i.e. city, town, village, state, country etc.) of the transaction. The information and/or data can also include the phone number of the bank or financial institution and/or a central processing office and/or computer servicing the account so that the account holder can telephone same in order to authorize or cancel the transaction. The information and/or data can also be supplemented to include the type of instrument or sums involved in the transaction.

The communication device 104 will, at step 114, receive and process the information and/or data pertinent to the transaction and provide the information to the account holder. At step 114, the information and/or data which is transmitted from the banking device 102 and received at the communication device 104 can is displayed to the account holder on the display device 104E of the communication device 104. The information displayed on the display device 104E can include the name of the bank or financial institution, the amount of the transaction, the time of the transaction and the location of the transaction. The information and/or data can also be supplemented to include the type of instruments, instrument identification (i.e. check or wire transfer number) involved in the transaction.

The communication device 104 can utilize any of the widely known data processing and/or software routines, which are known to those skilled in that art, in order to process transaction requests and/or authorizations involving the use of the respective account(s).

Thereafter, the account holder can, at step 115, enter a response either approving or disapproving the transaction. At step 116, the account holder's response is then transmitted, via the transmitter 104H of the communication device 104 to the banking device 102. In any of the embodiments described herein, any information and/or data which is transmitted from the communication device to the banking device 102 can be transmitted directly to the banking device 102 and/or indirectly to the banking device 102 via the communication network. The information and/or data which is transmitted from the communication device 104 to the banking device 102 can also be transmitted indirectly to the communication device 104, via the communication network, and independently of any transaction processing by a central transaction processing computer and/or central transaction processing system.

In another embodiment, the information and/or data which is transmitted from the communication device 104 to the banking device 102 can also be transmitted indirectly to the banking device 104, via the central processing computer 103 or other processing computer or device.

At step 117, the receiver 102H of the banking device 102 will receive the account holder's response. At step 118, the banking device 102 will process the account holder's response. At step 119, the banking device 102 will determine whether the transaction is approved or authorized. If, at step 119, it is determined that the transaction is approved or authorized the banking device 2 will consummate the transaction at step 120. Thereafter, operation of the apparatus 100 will cease at step 121. If, however, at step 119, it is determined that the transaction is disapproved or unauthorized, the banking device 102 will cancel the transaction, at step 122. Thereafter, the operation of the apparatus 100 will cease at step 123.

In the embodiment described above, as well as in any of the embodiments described herein, the banking device 102 can be programmed to wait a pre-specified amount of time for the account holder's response. The banking device 102, can also be programmed to cancel the transaction or consummate the transaction if no response is received.

Any of the particular instructions for the particular account can be included in the data and/or information which is stored on the magnetic strip and/or otherwise stored on the respective account card. In this manner, the banking device 102 can utilize transaction instructions which are stored on, and/or obtained from, the respective account card and utilize this data and/or information in performing processing routines regarding the transaction. In this manner, the present invention can be utilized in order to provide custom tailoring of transaction processing regarding a particular account which information can be pre-specified and stored on the respective account card.

In instances when the communication device 104 does not have a reply or two-way pager feature, the account holder can simply telephone the banking device 102, or center or office servicing, and/or associated with, same, in order to personally appraise the device 102, or center or office, of his or her response to the banking device 102 transmission regarding the transaction.

In this manner, the banking device 102 can communicate with the account holder via the communication device 104 and independently of any transaction processing by a central transaction processing computer or central transaction processing service.

FIGS. 8A, 8B and 8C, illustrate another preferred embodiment operation of the apparatus 100, in flow diagram form. In the preferred embodiment of FIGS. 8A, 8B and 8C, the apparatus 100 can be utilized in conjunction with a central transaction processing computer or service. With reference to FIGS. 8A, 8B and 8C, the operation of the apparatus 100 commences at step 130 when the financial transaction and/or instrument or ATM card is presented to the bank or financial institution employee, representative and/or placed in a card reader, respectively.

At step 131, the employee or representative of the bank or financial institution will activate the apparatus, via the banking transaction device 102, in any typical manner, such as by entering account and/or card information, into the banking transaction device 102. This data entry is typically performed by manual data entry and/or via a card reader, depending upon the transaction. For example, if a person offers a check for cashing and provides a savings account or a checking account number, as the means by which to endorse the check, the employee or representative will enter the savings account or checking account number into the banking device 102 for processing. Similarly, if one desires to withdraw money from an ATM account, the card reader will read and enter the account number and/or information for processing. The information and/or data pertinent to the transaction and the card is then transmitted, at step 132, to the central processing computer 103.

The central processing computer 103 will then, at step 133, process the information and/or data pertinent to the transaction and to the particular account. The central processing computer 103 can utilize any of the widely known data processing and/or software routines, which are known to those skilled in that art, in order to process transaction requests and/or authorizations involving the use of the respective account(s) and/or related card(s).

The central processing computer 103 will process the information and/or data pertinent to the transaction in conjunction with the account information in order to determine the status of the account (i.e. whether any holds have been placed on the account, such as those prohibiting withdrawals). Further, the central processing computer 103 will then perform a test, at step 134, in order to determine if the transaction amount has reached and/or exceeded the amount available in the account and/or if the ATM card has been reported lost, stolen, cancelled and/or de-activated, and/or determine whether any other pre-defined, pre-selected and/or programmed limitation(s) and/or restriction(s) have been met, satisfied and/or reconciled. The central processing computer 103 will also perform a test in order to determine if the predetermined maximum number count of unauthorized transactions, pre-defined in the preferred embodiment to be one (1), has occurred on the account.

The unauthorized transaction count refers to a count of the transactions which are not authorized by the account owner as will be described herein. The authorized transaction count (UNAUTHCT) is a variable which is pre-set to zero (0) at the time the account is opened. Each time an unauthorized transaction occurs, the unauthorized transaction count is incremented by one. Once the unauthorized transaction count reaches a pre-defined limit of, for example, one (1), although it can be pre-defined to be zero (0), the central processing computer 103 will cancel the transaction and de-activate the account and/or the ATM card. The central processing computer 103 will then notify the account owner. In this manner, the apparatus 100 will enable the central processing computer 103 of a banking and/or financial institution to cancel and/or de-activate the account and/or the ATM card, either permanently or temporarily, in cases when the account owner may have failed to respond or to reply to transaction notices, which can be the case when the account owner is not aware that the account has been charged, overdrawn, and/or that the ATM card has been lost or stolen, cancelled or de-activated, duplicated, “cloned”, or in other ways utilized without the account owner's knowledge or authorization, or when the account owner is unable to respond or reply to the transaction notices for some other reason(s). This feature of the present invention serves to place a transaction stop limit on the account and/or on the use of the ATM card.

If any of the above listed conditions exist (i.e. account overdrawn and/or ATM card is lost, stolen, cancelled and/or de-activated), the central processing computer 103 will, at step 135, transmit a signal to the banking transaction device 102 indicating that the transaction is not approved and/or is not authorized. The banking device operator, or employee, or representative, can then cancel the transaction at step 136. The employee or representative can then alert the authorities and/or confiscate the ATM card. In the case when an ATM machine is utilized as the banking device 102, the ATM machine can confiscate the ATM card automatically. Upon the completion of step 136, the apparatus will cease operation at step 137.

If, at step 134, the central processing computer 103 determines that the account is not overdrawn or that the ATM card is not lost, stolen, cancelled or de-activated, or that the of unauthorized transactions count (UNAUTHCT) has not reached a predefined limit, and/or that pre-defined or pre-specified limitations and/or restrictions have been met, the central processing computer 103 will, at step 138, transmit a signal and/or data to the communication device 104 which is located at the account owner.

At step 138, the central processing computer 103 will then also transmit respective signals and/or data to any one or more of the cardholder's designated fax machine 105, personal computer or personal digital assistant 106, telephone 107, telephone answering machine 108, alternate telephone 109, alternate telephone answering machine 110, network computer 111, and/or alternate beeper 112 or alternate pager 113.

The information and/or data transmitted to the communication device 104 includes information and data identifying the transaction and can include the name of the bank or financial institution where the transaction is taking place, the account number and/or description, the amount of the transaction, the time of the transaction and the location (i.e. city, town, village, state, country etc.) of the transaction.

The information and/or data can also include the phone number of the central processing office and/or computer servicing, and/or the banking and/or financial institution handling, the account so that the account owner can telephone same in order to authorize or cancel the transaction. The information and/or data can also be supplemented to include a description of the person seeking to make the transaction and the type of transaction sought (i.e. cash withdrawal, cashing of check, etc.).

At step 139, the information and/or data which is transmitted from the central processing computer 103, and received at the communication device 104, is displayed to the account owner on the display device 104E of the communication device 104. The information displayed on the display device 104 includes the name of the banking and/or financial institution, the amount of the transaction, the time of the transaction and the location of the transaction. The information and/or data can also include the type of transaction and a description of the person seeking to make the transaction, etc.

The apparatus 100, at step 140, will then wait for the account owner to respond to the transmission. During this time, the account owner can either utilize the reply or two-way pager feature on the communication device 104 in order to either approve or authorize the transaction or disapprove of, or void, the transaction. At step 140, the apparatus 100 will receive the reply or response from the account owner. At step 141, the central processing computer 103 will determine if the account owner has made a reply or response within the pre-defined time limit which is chosen, in the preferred embodiment, to be one (1) minute.

The account owner can also transmit a signal via an appropriate key or button suspending use of the account or ATM card, such as when he or she may first be apprised of the fact that the account is being unlawfully accessed, or the use thereof is unauthorized, or that the ATM card has been lost or stolen.

In instances when the communication device 104 does not have a reply or two-way pager feature, the account owner can simply telephone the central processing office or processing center and/or the banking or financial institution so as to personally reply or respond to the authorization request.

If, at step 141, it is determined that the account owner's reply or response was not made within the pre-specified time, chosen in the preferred embodiment to be one (1) minute, the central processing computer 103 will, at step 142, increment the unauthorized transaction count (UNAUTHCT) by one (1) and will, at step 143, transmit a signal and/or data to the banking transaction device 102 indicating that the transaction is not authorized by the account owner. The banking device operator can then, at step 144, either cancel the transaction, proceed to consummate the transaction, and/or attempt to obtain additional information or identification from the customer and/or obtain an alternate account number from which to draw against.

The action taken by the banking transaction device operator can be dictated by the specific agreement in effect between the account owner and the bank or financial institution administering the accounts. Upon the completion of step 144, the operation of the apparatus will cease at step 145. If the account owner should reply or respond to the transaction notice at a later period, this information can then be utilized to approve of or to disapprove and/or to dispute the transaction.

If, at step 141, it is determined that the reply or response was timely, the central processing computer 103 will, at step 146, process and identify the account owner response. At step 147, the central processing computer 103 will determine if the account owner has authorized the transaction. If the account owner's response is to cancel, to disapprove, or to not authorize, the transaction, the central processing computer 103 will, at step 148, increment the unauthorized transaction count (UNAUTHCT) by 1. At this juncture, the unauthorized count (UNAUTHCT) is set to zero at the time of the opening of the account.

After the unauthorized transaction count has been incremented, the central processing computer 103 will, at step 149, transmit a signal and/or data to the banking device 102 which will notify and/or instruct the banking device operator that the transaction is not authorized and should, therefore, be cancelled or voided. The banking device operator can then cancel the transaction at step 150. The banking transaction device operator or the ATM machine can then confiscate the ATM card and/or alert the authorities. Upon the completion of step 150, the apparatus will cease operation at step 151.

If, at step 147, the central processing computer 103 identifies the account owner's reply or response as being one to authorize the transaction, the central processing computer 103 will, at step 151, reset the unauthorized transaction count (UNAUTHCT) to zero (0). The central processing computer 103 will then, at step 153, transmit a signal and/or data to the banking device 102 which will notify and/or instruct the banking device operator, and/or the ATM machine, that the transaction is authorized and/or approved. The banking device operator, and/or the ATM machine, can then complete the transaction, at step 154. After the transaction has been completed at step 154, the operation of the apparatus 100 will cease at step 155.

In another preferred embodiment, the central processing computer 103 can perform any and/or all of the functionality described as being performed by the banking device 102 as described herein in conjunction with FIGS. 7A and 7B. In this manner, in another preferred embodiment of FIG. 5, the central processing computer 103 can transmit a notification signal, data, and/or information, to the communication device 104, to notify the account holder of a transaction on the banking account. Thereafter, the account holder can transmit a response, to the notification signal, to the central processing computer 103. The central processing computer 103 can thereafter process the account holder's response.

If the central processing computer 103 determines that the transaction is authorized or approved, the central processing computer 103 can consummate or complete the transaction. If the transaction is not authorized or not approved, the central processing computer 103 can cancel or terminate the transaction.

In any of the embodiments described herein, any of the communications which are transmitted, received, and/or which take place during apparatus operation, by and between any of the banking devices 102, the central processing computers 103, and the communication devices 104, can take place in real-time and/or otherwise.

In instances when the account owner is a party to the transaction, which should typically be the case in banking and/or financial transactions, the account owner, having the communication device 104 on his or her person, can authorize the transaction at the point of the transaction. If the transaction is an overnight or other remotely made transaction, such as in clearing and/or account settling transactions, the account owner can authorize the transaction from his or her remote location.

In another preferred embodiment of the apparatus of FIG. 5, the apparatus 100 can be programmed and/or can be programmable by the respective account holder, account owner, cardholder, and/or other authorized individual, (hereinafter referred to as “account holder” or “account owner”). The account holder or account owner can access the central processing computer 103 via the communication device 104, a telephone, and/or any other communication device. The account holder or account owner can thereafter program the central processing computer 103 by transmitting a signal, data, and/or information, containing and/or corresponding to instructions for restricting and/or limiting activity and/or transactions which can occur and/or take place on, or in conjunction with, the respective account.

The signal, data and/or information, containing the restriction(s) and/or limitation(s) data and/or information is received by the receiver 103G. Thereafter, the CPU 103A will process the restriction(s) and/or limitation(s) data and/or information and store any appropriate data and/or information in the database 103H.

The above-described programming of restrictions and/or limitations into the central processing computer 103 can take place in real-time and/or otherwise.

The restrictions and/or limitations which can be programmed into the central processing computer 103 can include the types of transactions which are allowed and/or authorized, limitations on the amounts of transactions which can occur on an account, number of transactions which can occur on an account, authorized parties to use the account, authorized geographical area or location of usage, wherein authorized card use can be limited, and/or authorized times for account access and/or account usage (i.e. specific days, dates, time of day, time of month, year, etc.), and/or any other limitation and/or restriction regarding amount of transaction, parties involved, geographical area, and/or times of allowed usage.

The limitation or restriction can also include stopping payment on checks or drafts, stop payment orders, and/or any other limitation and/or restriction regarding any type of bank account, savings account, checking account, Automated Teller machine (ATM) account, and/or other financial account and/or account usage. The limitations and/or restrictions can also include any other limitation(s) and/or restriction(s) on account activity, amount of transactions, parties involved, geographical area, and/or times of allowed usage.

The limitations and/or restrictions can also include limitations on and/or regarding amounts of any one transaction or more transactions, individuals who may make the transactions, proof of identity of which the types of proof may be specified, specific banks, financial and/or brokerage institutions authorized to accept and/or perform transactions for the account, the nature of the transactions, geographical areas and/or location within which banks, financial and brokerage institutions which can be authorized to accept and/or perform transactions with the account, specific purchases and/or trades which can be made in conjunction with the account, specific securities which can be purchased and/or traded in conjunction with the account, specific times of day, specific days, dates and/or time of the month in, or on, which transactions can be authorized, limits of charge-backs, returned item amount withdrawals, maintenance and/or other fee charge withdrawals, etc. and/or authorized times for account usage (i.e. specific days, dates, times of day, times of month, year, etc.), and/or any other limitations and/or restrictions regarding amount of transaction, parties involved, securities involved, geographical area, and or times of allowed usage. Limitations and/or restrictions can also include limitations on deposits, types of deposits, wire transfers, etc.

With regards to any of the cards and/or accounts described herein, such as, for example, automated teller machine accounts and/or Internet accounts, the account holder or account holder can also change, specify, or programmably change, passwords, personal identification numbers and/or any other access code(s) and provide for various personal identification numbers and/or access codes for different locations, different automated teller machines, different days, different times and/or different transaction amounts.

For example, the account holder, account owner, and/or cardholder, can program the central processing computer 103, and/or the server computer, if utilized, so as to limit account transactions by amounts (i.e. no withdrawals over $500.00, no aggregate daily withdrawals exceeding $1000.00, etc.), to limit transactions by times of usage (i.e. no ATM usage between 10:00 P.M. and 8:00 A.M.), to stop payment on a check or draft, to increase or decrease credit or overdraft limits, to limit a number of checks which can be cashed on an account, to establish and/or change credit limits on an account, periodically and/or at any desired time.

The account holder of account owner can program the central processing computer 103, and/or the server computer, if utilized, via the communication device 104, a telephone, and/or any other suitable communication device. The account holder or account owner can also perform the above-described programming via a touch-tone telephone. In the same manner, the account holder or account owner, can also program the apparatus 100 so as to limit the types of transactions involving his or her account.

Once programmed by the account holder or account owner, the central processing computer 103, upon receiving a transaction authorization request or a transaction processing request, will process the transaction in conjunction with the restriction(s) and/or limitation(s) provided, programmed, and/or dictated, by the account holder or account owner.

By utilizing the above-described programming routine(s), an account holder, account owner, cardholder, and/or other authorized individual, can program and/or update any data and/or information which can or may be stored in the database 103H. The above-described programming routine(s) can be performed in real-time and/or otherwise.

In another preferred embodiment, the account holder or account owner can program the respective banking device 102 and/or communication device 104, in the same manner in which the central processing computer 103 can be programmed, so as to program restrictions and/or limitations into the respective devices. The banking device 102 can, in this manner, be directly programmable, by the account holder, or account owner, cardholder, and/or other authorized individual, in real-time and/or otherwise, in the same manner described above regarding the central processing computer 103, so as to automatically process a transaction in accordance with the restrictions or limitations provided by account holder, account owner, and/or cardholder.

The communication device 104 can also be directly programmable by the account holder or account owner, in real-time and/or otherwise, in the same manner described above regarding the central processing computer 103, so as to automatically process a transaction authorization request and/or a transaction.

In a similar manner, the account holder, account owner, and/or cardholder, can program the apparatus 100 as described above in conjunction with the use of any of the herein-described banking account, savings accounts, checking accounts, ATM account, and/or other financial accounts.

The account owner can also program and/or set the communication device 104 so as to automatically authorize or disapprove or disallow transactions. In this regard, the communication device 104 can be programmable so as to receive and analyze the transaction information and/or data and reply or respond to same automatically and/or with preset or programmed replies and/or responses. The communication device 104 can also be programmable so as to limit the amounts of transactions. In this regard, the account owner can provide for temporary transaction types and/or amounts.

The communication device 104, in the preferred embodiment, is provided with a memory device for storing any number of transactions so that the account owner can review his or her account activity and/or transactions which have occurred involving his or her accounts and/or ATM card. In this manner, the account owner may “scroll” through and/or in other ways review account activity. The communication device 104 can also be equipped to service more than one bank and/or financial account and/or ATM card. For example, any number and/or types of accounts can be serviced with or by a single communication device 104.

The central processing computer 103 can also be programmed to provide notification to the account owner upon the occurrence of any number of events and/or occurrences which take place regarding and/or relating to the respective account. The central computer 103 can provide notification to the account owner upon the receipt of an account owner's deposit, receipt of a stop payment order, a stop payment order being effected, wire transfer deposit, electronic transfer, withdrawal, wire transfer withdrawal, credit, debit, check presentment, check clearing, check cashing, account charge, account chargeback, the crediting of the payment to the respective account, the reaching of a pre-specified credit, charge, debit, and/or other respective limit on the respective account, a direct payment withdrawal, a direct deposit, a change in interest rate on the account, a change in a credit limit, and/or any other change and/or occurrence regarding and/or relating to the account which may be of interest to the respective account owner and/or any other transaction related to and/or involving the respective account.

The central processing computer 103 can also notify the account owner regarding a payment due date, an overdue status of a payment, an interest rate change, a credit limit change, an account restriction and/or limitation on usage, etc.

In this manner, the account owner can be notified of any of the above-described and/or any other event or occurrences. For example, the account owner can be notified when a deposit is received, when a check has cleared, when a stop payment order has been effected, when a withdrawal is made, and/or when any other event or transaction of interest to the account owner occurs on and/or regarding the account.

Similarly, the account owner can be notified when he or she has reached and/or is close to reaching a pre-specified credit limit and/or upon the occurrence of administrative events or occurrences, i.e. payment due date, payment overdue, interest rate change, credit limit change, account restrictions, maintenance or service fee charges, returned checks occurrences and/or charges, etc.

In another preferred embodiment, the banking device 102 can be programmed to provide any of the functions described herein as being performed by the central processing computer 103, including, but not limited to, providing any of the notification functions for providing notification to the account owner of any of the above-described events and/or occurrences.

The various processing routines described herein as being performed by the apparatus 100 of the present invention in FIGS. 7A and 7B and FIGS. 8A, 8B and 8C can also be performed in conjunction with each other and/or can be combined so that the apparatus 100 can perform multiple routines in conjunction with each other. In this regard, the banking device 102 can, in another preferred embodiment, transmit the information and/or data pertinent to a transaction to the communication device 104 associated with an account owner, and process the transaction in the manner described herein with the account owner, while also transmitting the information and/or data pertinent to the transaction to the central processing computer 103 and processing the transaction with the central processing computer 103.

The banking device 102 can transmit the respective transmissions to the respective devices 104 and 103 in a sequential fashion and/or in any desired and/or specified order and/or the banking device can transmit the respective transmissions to the respective devices 104 and 103 simultaneously. In any event, the banking device(s) 102, the central processing computer(s) 103, and the communication device(s) 104, in the preferred embodiments described herein, can be suitably equipped with any necessary, additional, and/or desired, hardware and/or software for facilitation their respective operations and/or functionality as described herein.

The apparatus and method of the present invention provides for the real-time notification of banking and/or financial transactions involving various bank and/or financial accounts and enables an account owner to monitor, in real-time, activity involving his or her bank and/or financial accounts and/or ATM card(s).

The apparatus and method of the present invention also provides a means and a mechanism by which to inform an account owner that his or her account is overdrawn, has been charged against and/or that his or her ATM card(s) are lost, stolen, cancelled or de-activated and/or provides an indication to the account owner of when and/or where his or her accounts are being accessed in transactions.

The central processing computer 103 and/or the banking device 102 can also generate and transmit notification signals, e-mails, and/or other electronic and/or conventional message and/or transmission to notify the cardholder when he or she is about to reach a pre-determined account balance, when he or she has reached a pre-determined account balance, has reached a pre-determined credit limit, has a check returned for insufficient funds, has deposited a check which has subsequently returned for insufficient funds, and/or to provide notification regarding a service charge, a payment due, a payment due date, a past due payment, and/or to provide notification regarding any other event, occurrence, and/or account activity which can be related to the account and/or which may be of interest to a bank and/or financial account holder and/or an individual or entity authorized to receive notification for, and/or on behalf of, the account holder. The account owner can then report the unauthorized activity, and/or the discovery of a lost or stolen ATM card, and/or cancel and/or de-activate the respective account(s) and/or ATM card(s).

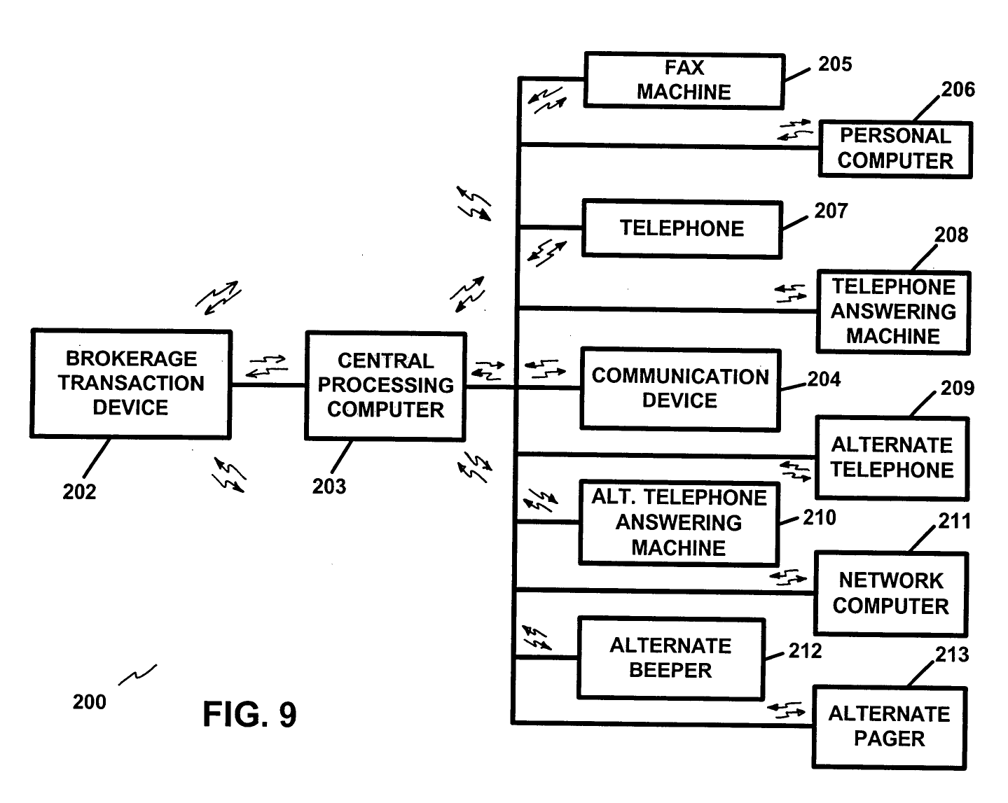

FIG. 9 illustrates a block diagram of another preferred embodiment of the apparatus of the present invention which is utilized in conjunction with a brokerage account and/or a financial services account and/or transaction (hereinafter referred to as a “brokerage account”) and/or the authorization process involved therewith. The brokerage account can be any brokerage account, including conventional brokerage accounts, on-line brokerage accounts, investment accounts, investment portfolio accounts, retirement accounts, 401K, Keogh, Self-employed Pension, and/or any other brokerage and/or investment account. The apparatus of FIG. 9 is denoted generally by the reference numeral 200.

In FIG. 9, the apparatus 200 includes of a brokerage and/or financial services transaction device (hereafter “brokerage transaction device”) which devices are found in brokerage and/or financial services establishments. In the preferred embodiment, the brokerage transaction device 202 is a device and/or a processing computer terminal which is utilized by a broker, a trader, an account manager and/or assistant and/or any other individual authorized to execute the transaction. Any other terminal or similar device can also be utilized as the brokerage transaction device 202 depending upon the application and/or the transaction.

The brokerage transaction device 202 (hereinafter referred to as “brokerage device”) can be any of the widely used and well known devices, computers, or terminals for providing brokerage transactions, including transactions in cash, cash instruments, cash derivative instruments, securities, stocks, bonds, stock derivative instruments, bond derivative instruments, commodities, commodity derivatives, mutual fund shares and instruments, currencies, currency derivatives, interest rate instruments, interest rate derivatives, futures, options, index funds, index derivatives, derivative instruments and derivative securities, as well as securities and instruments of any kind, and further including financial transactions related to an account, including clearing transactions, check clearing and/or account charging and/or charge-back transactions, which transactions brokerage and financial institutions perform and/or engage in for their account owner and/or clients.

The brokerage device 202 can be utilized in any type of brokerage, financial and/or other transactions, including performing trades of financial securities, stocks, bonds, mutual funds, investment trusts, derivatives, deposits into brokerage accounts, withdrawals from brokerage accounts, account check clearing, account charging, account chargebacks, and/or any other transaction which can occur in and/or in conjunction with brokerage accounts and/or which are provided by banks, financial institutions, brokerages, etc.

Typically, the brokerage transaction device 202 and/or device can include a computer terminal having an input device such as a keyboard and/or various reader(s) and/or scanning device(s) for reading and/or scanning, respectively, information and/or data necessary in order to perform the transaction. The brokerage transaction device 202 transmits an authorization request and/or a transaction notification signal, which can include the data pertaining to the particular account which is accessed and/or involved in the transaction and the type and the amount of the transaction, as well as any other information pertaining to the transaction, over a communications medium, to an individual account holder, an individual authorized to receive information for, and/or otherwise act for and/or on behalf of the individual account holder, a central processing computer 203 for processing the transaction, the transaction request and/or the authorization request pertaining thereto.

The brokerage device 202 can transmit the transaction authorization request and/or notice to a central processing computer via a central computer which can be a central computer at the particular brokerage or financial institution. The central processing computer can also be a central computer system which is not located at the brokerage or financial institution, but rather, services the particular brokerage or financial institution or a group of brokerage or financial institutions.

The brokerage device 202 also receives the transaction and/or authorization data and/or information from the respective communication device associated with the individual account holder, the individual authorized to receive information for and/or on behalf of the account holder, and/or the central processing computer. If a central brokerage computer is utilized, the data transmitted from the central processing computer would be transmitted to the brokerage device 202 via the central bank computer. A printed transaction receipt can also be provided at and/or obtained via the brokerage device 202, or peripheral device associated therewith, for printing a transaction receipt which is usually provided to the account holder.

The brokerage device 202 can also include, and/or have associated therewith, a keypad for the manual entry of transaction information and/or data, such as the amount of the transaction, account number, etc. The brokerage device 202 can also be an integral component of a broker, trader, teller and/or cashier work station and/or other transaction devices and/or terminals, including those which can provide for the automatic entry of transaction information and/or data.

The brokerage device 202 can be equipped to read multiple contact information from magnetic strip cards so as to provide for the transmission of data and/or information to multiple individuals, entities and/or to multiple communication devices associated with the individual(s), entity, or entities. For example, the magnetic strip on the back of a brokerage card, banking card, debit card, smart card, and/or automated teller machine (ATM) card, associated with the brokerage account, can contain the phone number and/or contact information for a central transaction authorization computer associated with the card as well as a the identity, address, phone number, pager number, e-mail address, fax number, and/or any other contact information for the individual account holder.

In cases involving brokerage “smart” cards, or cards having processors, memory chips, computer chips and/or other processors and/or processing devices, the brokerage device 102 can be equipped with an appropriate card reading device for reading and/or obtaining information from the respective processor, memory chip, computer chip and/or other processor and/or processing device.

The respective account cards, in addition to containing account holder contact information, can also contain information regarding restrictions and/or limitations on account usage. In this manner, the respective card can contain information regarding restrictions and/or limitations as to the type of authorized transactions, authorized parties to a transaction, identification required, required personal identification information, authorized times of usage, authorized geographic location of usage, as well as any other restriction and/or limitation on account usage, including restrictions and/or limitations on the types of securities, stocks, bonds, stock derivatives, bond derivatives, mutual funds, investment trusts, and/or other financial and/or security instrument and/or derivatives of same, which can be purchased, sold, and/or traded, as well as any restrictions and/or limitations of any activity which can occur in the respective brokerage account.

The apparatus 200 also includes a central processing computer 203 which services any brokerage and/or financial institution and/or any pre-defined group of brokerages and/or financial institutions and/or any number of accounts, and/or account holders, associated therewith. For example, the central processing computer 203 can handle all brokerage and/or financial accounts for a given brokerage or brokerages. The central processing computer 203, for example, can process and maintain records of transactions, trades, deposits, withdrawals, checks cashed, drafts, ATM deposits, ATM withdrawals, charges made against an account, credits made to an account, etc., and/or any combinations of same. The central processing computer 203 can process accounts for any of the various brokerages and/or financial institutions.

In the preferred embodiment, the brokerage device 202 is linked and/or connected to the central processing computer 203 via a telecommunications system, link and/or medium (hereinafter referred to as “communications system”) such as, for example, a telephone network or line. As noted above, the brokerage device 202 may or may not be linked to the central processing computer 203 via a central brokerage computer. The communications system which is utilized can be any communications system and can include telecommunication systems, satellite communications systems, radio communication systems, digital communications systems, digital satellite communications systems, personal communications services communication systems, cable television communications systems, digital television communication systems, satellite television communication systems, broadband communication systems, as well as any other appropriate communications system.

The brokerage device 202 transmits signals and/or data to the central processing computer 203 as well as receives signals and/or data from the central processing computer 203.

The central processing computer 203 can be a mainframe computer, a mini-computer, a micro-computer, a server computer, and/or a personal computer, such as those utilized in conjunction with on-line services and/or in a network environment, and/or any other suitable computer or computer system.

The apparatus 200 also includes an account owner communication device 204 which can receive signals and/or data from either or both of the brokerage transaction device 202 and/or the central processing computer 203. The communication device 204 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch.

In another preferred embodiment of FIG. 9, the communication device 204 receives signals and data from the brokerage device 202 with said signals being transmitted via a suitable communication system. In this preferred embodiment, the communication device 204 can also transmit signals and data to the brokerage device 202, directly and/or indirectly, with said signals being transmitted via a suitable communication system. In another preferred embodiment of FIG. 9, the communication device 204 can receive signals and data from the central processing computer 203, directly and/or indirectly, with said signals being transmitted via a suitable communication system. In this preferred embodiment, the communication device 204 can also transmit signals and data to the central processing computer 203, directly and/or indirectly, with said signals being transmitted via a suitable communication system.

In the preferred embodiment, the communications system utilized for transmitting signals and/or data to the communication device 204 is a wireless telephone line and the communication device 204 is a wireless telephone signal receiving device such as a telephone beeper or pager. The communication device 204, which can be a pager, receives the wireless telephone signals and/or data from the central processing computer 203 during the authorization procedure as will be described in more detail below.

In the preferred embodiment, the communication device 204 is also equipped with a transmitter for transmitting signals and/or data to the central processing computer 203. In this regard, the central processing computer 203 transmits signals and/or data to the communication device 204 as well as receives signals and/or data from the communication device 204. The communication device 204 can also transmit signals and/or data directly to the brokerage device 202 and receive signals and/or data directly from the brokerage device 202. In the preferred embodiment, the brokerage device 202 transmits signals and/or data to the central processing computer 203 and receives signals and/or data from the central processing computer 203. Further, in the preferred embodiment, the communication device 204 receives signals and/or data from the central processing computer 203 and transmits signals and/or data to the central processing computer 203.

As noted above, the communication device 204 is a wireless device. In this regard, the communication device 204 or pager can be carried by the account owner and/or be kept on and/or close to the account owner's person so that the central processing computer 203 can transmit signals and/or data to the communication device 204 so as to facilitate communication with the account owner at any time.

In the preferred embodiment, the apparatus 200 also includes a facsimile (fax) machine 205, a personal computer or personal digital assistant 206, a telephone 207, a telephone answering machine 208, an alternate telephone 209, an alternate telephone answering machine 210, a network computer 211, and/or an alternate beeper 212 or alternate pager 213. The central processing computer 203 can be linked with the above fax machine 205, personal computer or personal digital assistant 206, telephone 207, associated answering machine 208, alternate telephone 209, alternate telephone answering machine 210, network computer 211 alternate beeper 212 and alternate pager 213, via any suitable communication system.

In the preferred embodiment, a telecommunications link or telephone line or link, which may or may not be a wireless link, depending on the device and/or the circumstances, is utilized in order to link the central processing computer 203 with each of the fax machine 205, the personal computer or personal digital assistant 206, the telephone 207, the associated answering machine 210, the alternate telephone 209, the alternate telephone answering machine 210, the network computer 211, the alternate beeper 212 and the alternate pager 213.

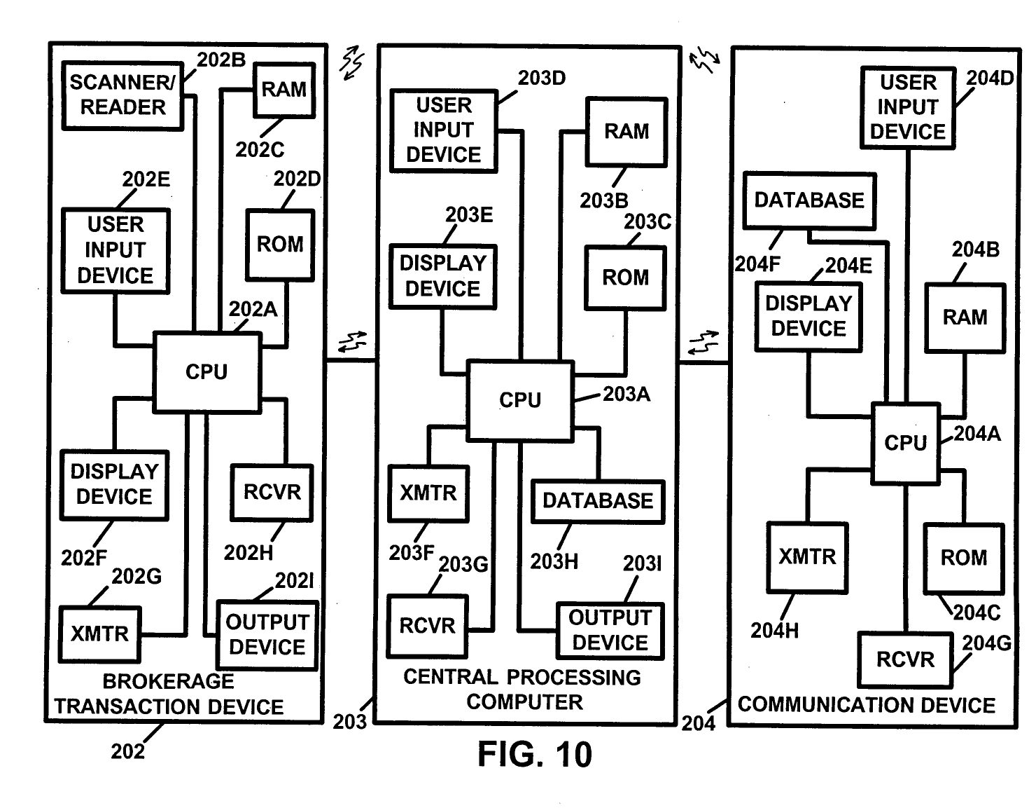

FIG. 10 illustrates the various components of the apparatus 200 of FIG. 9. In FIG. 10, the brokerage device 202, in the preferred embodiment, includes a central processing unit or CPU 202A, a scanner or reader 202B, which is connected to the CPU 202A, associated random access memory 202C (RAM) and read only memory 202D (ROM) devices, which are also connected to the CPU 202A, a user input device 202E, which is typically a keypad or other suitable input device for inputting data into the brokerage device 202 and which is also connected to the CPU 202A, and a display device 202F for displaying information and/or data to a user or operator, which display device 202F is also connected to the CPU 202A.

The brokerage device magnetic card reader or card reader 202B can, in the preferred embodiment, be capable of reading and processing data and/or information, which is stored on the magnetic strips and/or on the processors or chips which are located on the respective account card, and for providing one or multiple communications for one or multiple parties as well as reading and processing any restriction and/or limitation information regarding and/or related to account usage. For example, the magnetic card reader or card reader 202B can read and/or process data and/or information for identifying and communicating with a central transaction processing computer 203 as well as can read and/or process data and/or information for communicating with the individual account holder and/or an individual or agent authorized to act for and/or on behalf of the individual account holder, at any one or more of the communication devices associated with the individual account holder or the individual or agent associated with the individual account holder.

Data and/or information for providing any other the communications described herein can be obtained from the data and/or information contained in the magnetic strip on the card, the respective processor or chip located on the card, and/or can be obtained form an external database (not shown) which can be linked to the brokerage device 202 and/or which can be accessed thereby for obtaining any additional data and/or information.

The user input device 202E can include any data input device including, but not limited to, a keyboard, a mouse, a scanner, a reader or card reader, an audio input device, a voice recognition device, a fingerprint reading device, a retinal scanning device, and/or any other device for inputting data and/or information into the brokerage device 202.

The brokerage device 202 also includes a transmitter 202G for transmitting signals and/or data to the central processing computer 203, and/or to the communication device 204 and/or to any other device associated with the account owner, the account holder, and/or the apparatus, if desired. The transmitter 202G is also connected to the CPU 202A.

The brokerage device 202 also includes a receiver 202H for receiving signals and/or data from the central processing computer 203, and from the communication device 204 and/or from any other associated device which can be utilized, if desired. The receiver 202H is also connected to the CPU 202A. The brokerage device 202 also includes a printer 202I or other appropriate output device for outputting data to the operator. The printer 202I is also connected to the CPU 202A. In the preferred embodiment, the printer 202I prints receipts corresponding to the transaction.

In FIG. 10, the central processing computer 203, in the preferred embodiment, includes a central processing unit or CPU 203A, associated random access memory 203B (RAM) and read only memory 203C (ROM) devices, which are connected to the CPU 203A, a user input device 203D, which is a keypad or any other suitable input device, for inputting data into the central processing computer 203 and which is also connected to the CPU 203A, and a display device 203E for displaying information and/or data to a user or operator.

The user input device 203D can include any data input device including, but not limited to, a keyboard, a mouse, a scanner, a reader or card reader, an audio input device, a voice recognition device, a fingerprint reading device, a retinal scanning device, and/or any other device for inputting data and/or information into the central processing computer 203.

The central processing computer 203 also includes a transmitter(s) 203F for transmitting signals and/or data to the brokerage device 202 and to the communication device 204 and/or to any one or more of the fax machine 205, the personal computer or personal digital assistant 206, the telephone 207, the telephone answering machine 208, the alternate telephone 209, the alternate telephone answering machine 210, the network computer 211, the alternate beeper 212, and/or the alternate pager 213. The transmitter(s) 203F is also connected to the CPU 203A. The central processing computer 203 also includes a receiver(s) 203G for receiving signals and/or data from the brokerage transaction device 202 and from the communication device 204 and/or from any other suitable device which can be utilized in conjunction with the apparatus 200. The receiver(s) 203G is also connected to the CPU 203A.

The central processing computer 203 also includes a database(s) 203H which contains account information and data pertaining to the account owner's account(s). The database 203H is also connected to the CPU 203A. The database 203H contains information about the account owner, the account number, etc., and any other information and/or data necessary to manage and/or process an account and/or account transaction as described herein.

The database 203H can include any number of databases which may or may not be linked to one another. The database 203H can also be linked to a database or databases which are located external from the central processing computer 203.

The database 203H can also include data and/or information regarding specific limitations and/or restrictions which can be placed on a particular account, which can be pre-selected and/or programmed by the account holder and which can include limitations and/or restrictions on the usage of the account. The limitations and/or restrictions can include the types of transactions which are allowed and/or authorized, limits on the amounts of transactions which can occur on an account, number of transactions which can occur on an account, authorized parties to use the account, authorized geographical area or location of usage, wherein authorized card use can be limited, and/or authorized times for account access and/or account usage (i.e. specific days, dates, time of day, time of month, year, etc.), and/or any other limitation and/or restriction regarding amount of transaction, parties involved, geographical area, and/or times of allowed usage.

The limitations and/or restrictions can also include the types of securities, stocks, bonds, financial instruments, financial securities, derivatives, securities derivatives, stock derivative instruments, bond derivative instruments, cash instruments, cash derivative instruments, commodities, commodity derivatives, mutual fund shares and instruments, currencies, currency derivatives, interest rate instruments, interest rate derivatives, mutual fund shares and instruments, mutual funds, investment trusts, including restrictions and/or limitations by industry and/or market sector, market capitalization, price/earnings ratios, and/or other financial ratios, etc., which can be authorized to be transacted in a particular account and/or accounts, as well as the types of securities, stocks, bonds, financial instruments, financial securities, derivatives, mutual funds, investment trusts, etc., which are not authorized to be transacted in a particular account and/or accounts.

In the preferred embodiment, the account holder can limit and/or restrict the type of securities, stocks, bonds, financial instruments, financial securities, derivatives, mutual funds, investment trusts, etc., by types, market sectors, industry sectors, investment grades and/or investment ratings.

Restrictions and limitations can also include price limits, prices, and/or prices ranges, for buying and/or for selling any of the herein-described stocks, securities, bonds, and/or any derivatives, and/or any other financial instruments described herein.

Stock transactions can be restricted and/or limited by industry or market sector (i.e., technical stocks, utility stocks, agricultural stocks, Internet stocks, transportation stocks, automobile stocks, energy stocks, as well as any other industry), stock prices (i.e., penny stocks, low priced stocks, medium priced stocks, high priced stocks), specific companies, market capitalization, price to earnings ratio, and/or any other categories and/or classifications known and/or utilized in the stock investment field.

Bond transactions can be restricted and/or limited by bond type (i.e., treasury securities, bonds, bills, notes, municipal bonds, tax-free bonds, corporate bonds, convertible bonds, and/or any other type of bonds), bond rating (i.e. high investment grade, “junk” bonds, and/or any other bonds ratings, including all ratings provided and/or used by Standard & Poors and Moody's); discount bonds, premium bonds, and/or any other categories and/or classifications known and/or utilized in the bond investment field.

The central processing computer 203 also includes a printer 203I or other appropriate output device for outputting information and/or data to a user or operator, which printer 203I or other output device is also connected to the CPU 203A.

In FIG. 10, the communication device 204, in the preferred embodiment, includes a central processing unit or CPU 204A, associated random access memory 204B (RAM) and read only memory 204C (ROM) devices, which are also connected to the CPU 204A, a user input device 204D, which is a keypad or a plurality of keys and/or switches for inputting data into the communication device 204 and which is also connected to the CPU 204A, and a display device 204E, for displaying information and/or data to the account owner, and a database 204F. This display device 204E and the database 204F are also connected to the CPU 204A.

The communication device 204 also includes a receiver 204G for receiving signals and/or data from the central processing computer 203 and which is also connected to the CPU 204A, and a transmitter 204H for transmitting signals and/or data to the central processing computer 203 and which is also connected to the CPU 204A.

The user input device 204D can include any data input device including, but not limited to, a keyboard, a mouse, a scanner, a reader or card reader, an audio input device, a voice recognition device, a fingerprint reading device, a retinal scanning device, and/or any other device for inputting data and/or information into the communication device 204.

In the preferred embodiment, the communication device 204 which can be utilized can be a computer communication device such as a personal computer, a hand-held computer, a personal digital assistant, a pager, a two-way pager, an interactive television, a telephone, a wireless telephone, and/or any other communication device. In the preferred embodiment, the communication device 204 can have a reply feature and/or device for facilitating two-way communication between the communication device 204 and any of the brokerage devices and central processing computers described herein. A two-way pager and/or pager systems can also be utilized for implementing the respective component system(s) in the apparatus 200 and/or the component combinations and/or communication systems and/or communication links.

In the preferred embodiment, the communication device 204, which is utilized, can also be a pager with a reply feature and/or device. A two-way pager and/or pager system(s) can also be utilized for implementing the respective component systems in the communication device 204/central processing computer 203 combination and/or link.

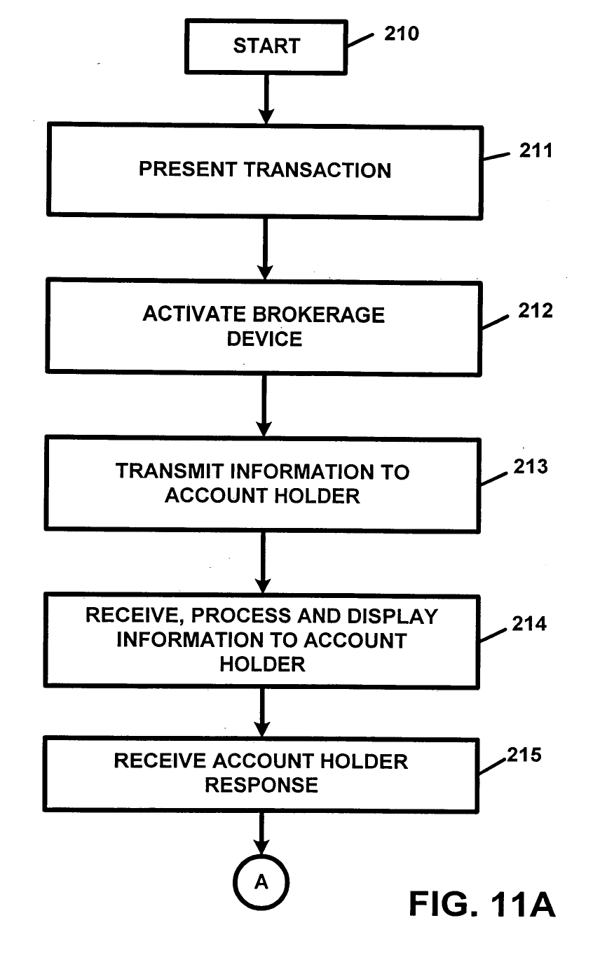

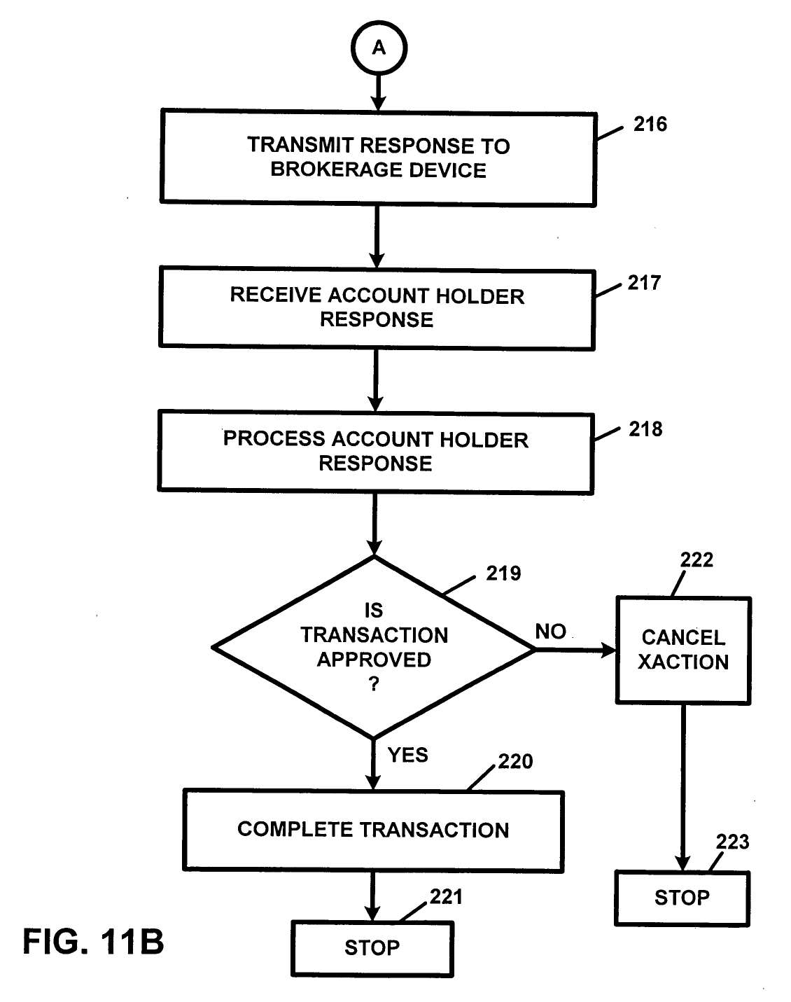

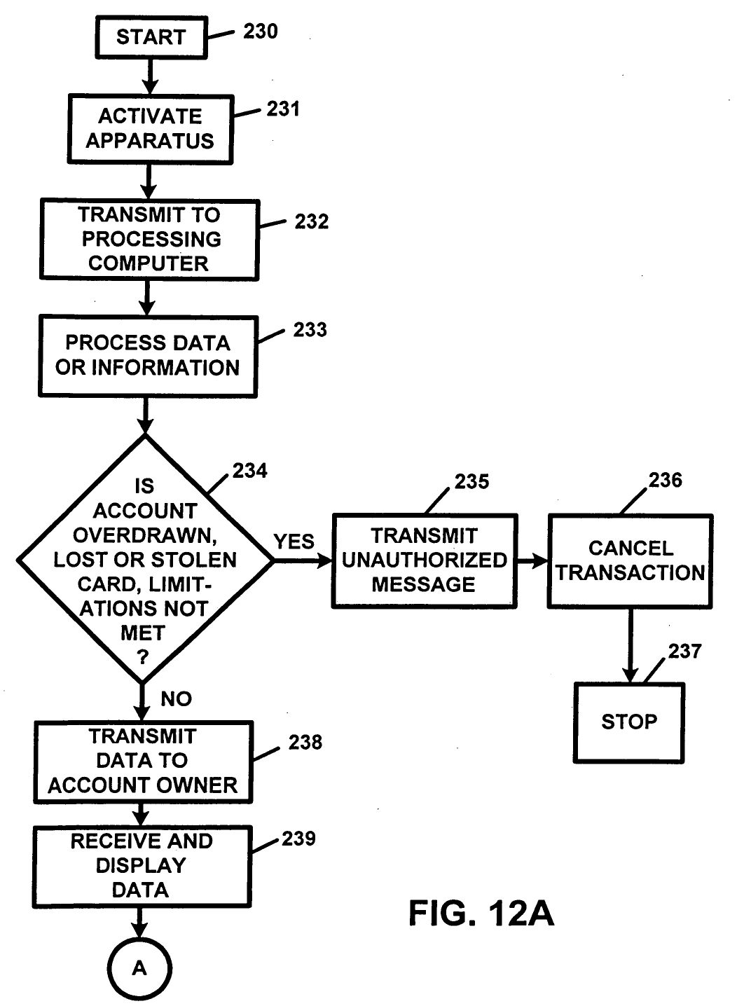

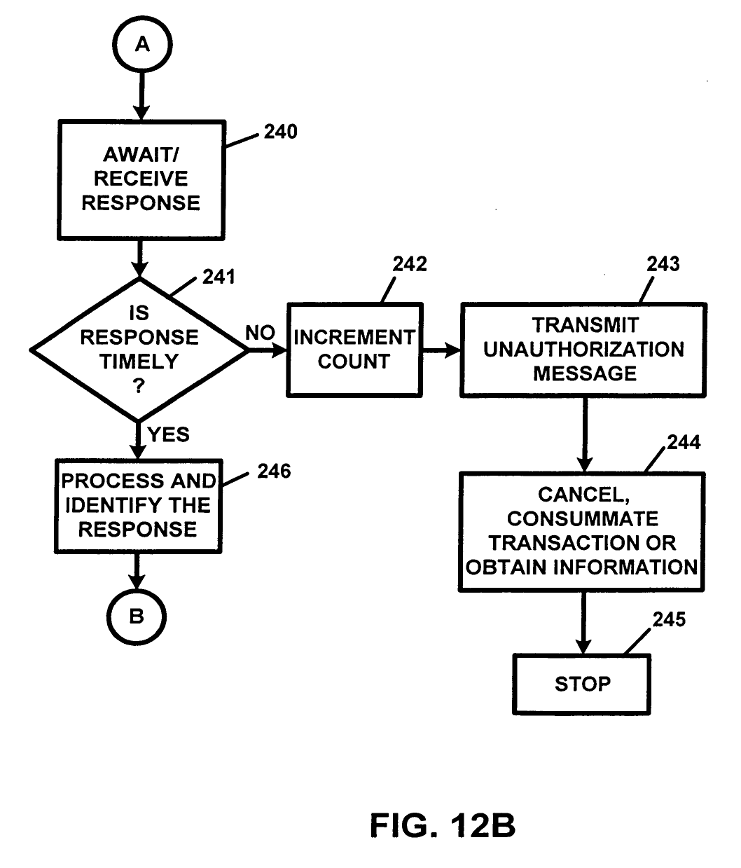

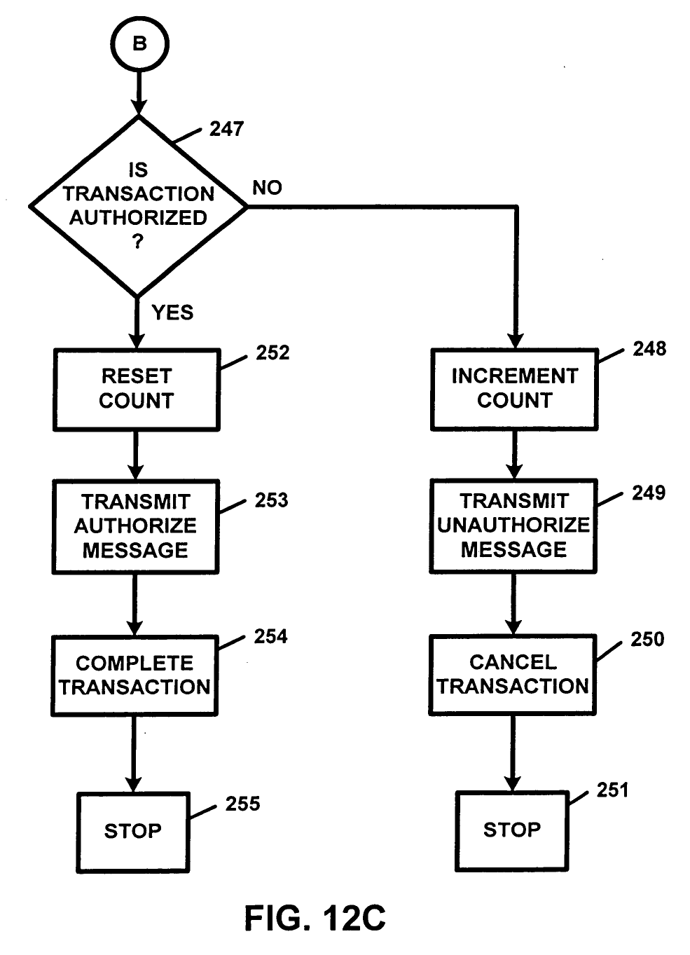

The apparatus 200 of the present invention, in the preferred embodiment, can be utilized in order to facilitate account owner authorization, notification and/or security, in brokerage and/or financial transactions involving cash, cash instruments, cash derivative instruments, securities, stocks, bonds, securities derivatives, stock derivative instruments, bond derivative instruments, cash instruments, cash derivative instruments, commodities, commodity derivatives, mutual fund shares and instruments, currencies, currency derivatives, interest rate instruments, interest rate derivatives, mutual fund shares and instruments, futures, options, index funds and their related and/or derivative instruments and derivative securities as well as securities and instruments of any kind, and further including financial transactions related to an account, including trading transactions, selling transactions, purchasing transactions, clearing transactions, check clearing and/or account charging and/or charge-back transactions, and in transactions involving checking accounts, savings accounts and electronic money accounts, electronic cash accounts, ATM accounts, and/or any transactions involving same in the manner described below and with reference to FIGS. 11A, 11B and FIGS. 12A, 12B and 12C. In this manner, the apparatus and method of the present invention can be utilized to obtain account owner authorization in a brokerage and/or financial account transaction.

The apparatus 200 can also be utilized in conjunction with an account card or cards which correspond to, or which are associated with, brokerage and/or financial accounts.

FIGS. 11A and 11B illustrate a preferred embodiment operation of the apparatus 200 in flow diagram form. With reference to FIGS. 11A and 11B, the operation of the apparatus 200 commences at step 210. At step 211, the brokerage transaction, financial instrument, account card, and/or brokerage account card, is presented to a brokerage institution employee, trader, broker, and/or computer system, such as for example, the brokerage device 202, and/or otherwise presented for a transaction on the respective account.

In any of the embodiments described herein, the transaction can involve and/or represent a purchase, sale, and/or trade, securities, stocks, bonds, mutual funds, investment trusts, derivatives, financial instruments and/or securities, deposits into brokerage accounts, withdrawals from brokerage accounts, account check cashing and/or clearing, account charging, account chargebacks, and/or any other transaction which can occur in and/or in conjunction with brokerage accounts and/or which are provided by banks, financial institutions, brokerages, etc.

At step 212, the service attendant or brokerage device operator will activate the brokerage device 202 in any typical manner, such as by entering information regarding the account involved and the transaction into the brokerage device 202 via the user input device 202E, the scanner/reader 202B, and/or via receiving same via the receiver 202H. This data entry can typically be performed by entering information via a keyboard or mouse, or by swiping the magnetic strip of the account card through the scanner/reader 202B or by reading information from the processor or chip on the account card via the scanner/reader. The data obtained from the magnetic strip and/or the card processor or chip, and/or from any associated database, can be utilized to contact the account holder communication device 204 and/or the account holder directly and/or to process the transaction.

In another preferred embodiment, the brokerage device 202 can process the transaction in conjunction with any restrictions and/or limitations on account usage, information of which is obtained from the respective card. If the brokerage device 202 determines that the transaction violates and/or otherwise does not conform to a restriction and/or limitation on account usage, the brokerage device 202 can cancel and/or reject the transaction without proceeding further. For example, the brokerage device 202, upon reading a restriction involving a time of use (i.e. no account usage allowed between 12:00 A.M. and 6:00 A.M.), a location of usage (i.e. no usage outside a particular city, state, or country), or a transaction amount limitation (i.e. no account usage for transactions exceeding $100), type of securities, stocks, bonds, mutual funds, investment trusts, financial instruments and/or financial securities, and/or derivatives, can process the transaction and determine if the transaction would violate a particular restriction or limitation.

If the transaction would violate a restriction or limitation, the brokerage device 202 can cancel the transaction and no further processing would be required. If the transaction would not violate a restriction and/or limitation, the transaction processing could continue in any appropriate manner described herein and/or otherwise.

The information and/or data pertinent to the transaction, and/or the account, is then transmitted, at step 213, to the communication device 204 via the communication network. In any of the embodiments described herein, any information and/or data which is transmitted from the brokerage device 202 to the communication device 204 can be transmitted directly to the communication device 204 via the communication network. The information and/or data which is transmitted from the brokerage device 202 to the communication device 204 can also be transmitted indirectly to the communication device 204, via the communication network, and independently of any transaction processing by a central transaction processing computer and/or central transaction processing system.

The transmission of the information and/or pertinent data, which takes place at step 213, is a transmission from the brokerage device 202 to the communication device 204 via the communication network and takes place independently of any processing of the transaction by a central processing computer or central processing service, such as by the central processing computer 203 and/or otherwise. In this manner, the present invention provides notification to the account holder of the transaction independently of any transaction processing by a central processing computer and/or a central processing service.

At step 213, the brokerage device 202, by utilizing account holder contact information obtained from the card and/or otherwise, can also transmit respective signals and/or data to any one or more of the account holder's designated fax machine 205, personal computer or personal digital assistant 206, telephone 207, telephone answering machine 208, alternate telephone 209, alternate telephone answering machine 210, network computer 211, and/or alternate beeper 212 or alternate pager 213.

The information and/or data which is transmitted to the communication device 204 can include information and/or data identifying the transaction and can include the name of the brokerage, bank or financial institution, involved in the account transaction, and the amount of the transaction. The information and/or data can also provide the time of the transaction, the location (i.e. city, town, village, state, country etc.) of the transaction. The information and/or data can also include the phone number of the brokerage, bank, or financial institution, and/or a central processing office and/or computer servicing the account so that the account holder can telephone same in order to authorize or cancel the transaction. The information and/or data can also be supplemented to include the type of instrument or sums involved in the transaction

The communication device 204 will, at step 214, receive and process the information and/or data pertinent to the transaction and provide the information to the account holder. At step 214, the information and/or data which is transmitted from the brokerage device 202 and received at the communication device 204 can is displayed to the account holder on the display device 204E of the communication device 204.

The information displayed on the display device 204E can include the name of the brokerage, bank, or financial institution, the amount of the transaction, the time of the transaction and the location of the transaction, and/or the securities, stocks, bonds, mutual funds, investment trusts, financial instruments and/or financial securities, and/or derivatives, involved in the transaction. The information and/or data can also be supplemented to include the type of instruments, instrument identification (i.e. check or wire transfer number) involved in the transaction.

The communication device 204 can utilize any of the widely known data processing and/or software routines, which are known to those skilled in that art, in order to process transaction requests and/or authorizations involving the use of the respective account(s).

Thereafter, the account holder can, at step 215, enter a response either approving or disapproving the transaction. At step 216, the account holder's response is then transmitted, via the transmitter 204H of the communication device 204 to the brokerage device 202. In any of the embodiments described herein, any information and/or data which is transmitted from the communication device to the brokerage device 202 can be transmitted directly to the brokerage device 202 and/or indirectly to the brokerage device 202 via the communication network.

The information and/or data which is transmitted from the communication device 204 to the brokerage device 202 can also be transmitted indirectly to the communication device 204, via the communication network, and independently of any transaction processing by a central transaction processing computer and/or central transaction processing system. In another embodiment, the information and/or data which is transmitted from the communication device 204 to the brokerage device 202 can also be transmitted indirectly to the brokerage device 204, via the central processing computer 203 or other processing computer or device.

At step 217, the receiver 202H of the brokerage device 202 will receive the account holder's response. At step 218, the brokerage device 202 will process the account holder's response. At step 219, the brokerage device 202 will determine whether the transaction is approved or authorized. If, at step 219, it is determined that the transaction is approved or authorized the brokerage device 202 will consummate the transaction at step 220. Thereafter, operation of the apparatus 200 will cease at step 221. If, however, at step 219, it is determined that the transaction is disapproved or unauthorized, the brokerage device 202 will cancel the transaction, at step 222. Thereafter, the operation of the apparatus 200 will cease at step 223.

In the embodiment described above, as well as in any of the embodiments described herein, the brokerage device 202 can be programmed to wait a pre-specified amount of time for the account holder's response. The brokerage device 202, can also be programmed to cancel the transaction or consummate the transaction if no response is received. Any of the particular instructions for the particular account can be included in the data and/or information which is stored on the magnetic strip and/or otherwise stored on the respective account card. In this manner, the brokerage device 202 can utilize transaction instructions which are stored on, and/or obtained from, the respective account card and utilize this data and/or information in performing processing routines regarding the transaction. In this manner, the present invention can be utilized in order to provide custom tailoring of transaction processing regarding a particular account which information can be pre-specified and stored on the respective account card.

In instances when the communication device 204 does not have a reply or two-way pager feature, the account holder can simply telephone the brokerage device 202, or center or office servicing, and/or associated with, same, in order to personally appraise the device 202, or center or office, of his or her response to the brokerage device 202 transmission regarding the transaction.

In this manner, the brokerage device 202 can communicate with the account holder via the communication device 204 and independently of any transaction processing by a central transaction processing computer or central transaction processing service.

FIGS. 12A, 12B and 12C illustrate the operation of the apparatus 200, in flow diagram form. In the embodiment of FIGS. 12A, 12B and 12C, the apparatus 200 can be utilized in conjunction with a central transaction processing computer or service. With reference to FIGS. 12A, 12B, and 12C, the operation of the apparatus 200 commences at step 230 when the brokerage transaction is presented to and/or handled by the brokerage institution broker, trader, account executive, and/or teller, etc. (hereinafter brokerage representative) employee. At step 231, the brokerage representative will activate the apparatus, via the brokerage transaction device 202, in any typical manner, such as by entering account information, into the brokerage transaction device 202. This data entry is typically performed by manual data entry and/or via a card reader, depending upon the transaction. For example, if a person offers a check for purchasing securities or a charge is made to the account, the brokerage representative will enter the brokerage account number and the associated transaction information into the brokerage device 202 for processing. Similarly, if one desires to sell securities, information corresponding thereto will be entered into the brokerage device 202. The information and/or data pertinent to the transaction is then transmitted, at step 232, to the central processing computer 203.

The central processing computer 203 will then, at step 233, process the information and/or data pertinent to the transaction and to the particular account. The central processing computer 203 can utilize any of the widely known data processing and/or software routines, which are known to those skilled in that art, in order to process brokerage transaction requests and/or authorizations involving the use of the respective account(s).

The central processing computer 203 will process the information and/or data pertinent to the brokerage transaction in conjunction with the account information in order to determine the status of the account (i.e. whether any blocks or holds have been placed on the account, such as those prohibiting transactions, trades, withdrawals, etc.). Further, the central processing computer 203 will then perform a test, at step 234, in order to determine if the transaction amount has reached and/or exceeded the amount which is available in the account and/or which has been presented with the brokerage institution and/or if the account has been cancelled and/or de-activated, and/or determine whether any other pre-defined, pre-selected and/or programmed limitation(s) and/or restriction(s) have been met, satisfied and/or reconciled. The central processing computer 203 will also perform a test in order to determine if the predetermined maximum number count of unauthorized transactions, pre-defined in the preferred embodiment to be one (1), has occurred on the account.

The unauthorized transaction count refers to a count of the transactions which are not authorized by the account owner as will be described herein. The unauthorized transaction count (UNAUTHCT) is a variable which is pre-set to zero (0) at the time the account is opened. Each time an unauthorized transaction occurs, the unauthorized transaction count is incremented by one. Once the unauthorized transaction count reaches a pre-defined limit of, for example, one (1), although it can be pre-defined to be zero (0), the central processing computer 203 will cancel the transaction and de-activate the account. The central processing computer 203 will then notify the account owner. In this manner, the apparatus 200 will enable the central processing computer 203 of a brokerage and/or financial institution to cancel and/or de-activate the account either permanently or temporarily, in cases when the account owner may have failed to respond or to reply to transaction notices, which may be the case when the account owner is not aware that the account has been accessed, charged, overdrawn, and/or cancelled or de-activated, or in other way utilized without the account owner's knowledge or authorization, or when the account owner is unable to respond or reply to the transaction notices for some other reason(s). This feature of the present invention serves to place a transaction stop limit on transactions involving the account.

If any of the above listed conditions exist (i.e. account blocked, hold placed thereon, overdrawn, cancelled and/or de-activated), the central processing computer 203 will, at step 235, transmit a signal to the brokerage transaction device 202 indicating that the transaction is not approved and/or is not authorized. The brokerage device operator, or employee, or representative, can then cancel the transaction at step 236. The employee or representative can then alert the authorities. In the case when an account card is utilized in a publicly accessible brokerage device 202, the machine can confiscate the account card automatically. Upon the completion of step 236, the apparatus will cease operation at step 237.

If, at step 234, the central processing computer 203 determines that the account is not blocked, subject to a hold, cancelled and/or re-activated or that the account is not overdrawn or that the account card is not lost, stolen, cancelled or de-activated, or that the of unauthorized transactions count (UNAUTHCT) has not reached a predefined limit, and/or that pre-defined or pre-specified limitations and/or restrictions have been met, the central processing computer 203 will, at step 238, transmit a signal and/or data to the communication device 204 which is located at the account owner.

At step 238, the central processing computer 203 will then also transmit respective signals and/or data to any one or more of the cardholder's designated fax machine 205, personal computer or personal digital assistant 206, telephone 207, telephone answering machine 208, alternate telephone 209, alternate telephone answering machine 210, network computer 211, and/or alternate beeper 212 or alternate pager 213.

The information and/or data transmitted to the communication device 204 includes information and data identifying the transaction and can include the name of the brokerage or financial institution where the transaction is taking place, the account number and/or description, the amount of the transaction, the nature of the transaction, the time of the transaction and the location (i.e. city, town, village, state, country etc.) of the transaction.

The information and/or data can also include the phone number of the central processing office and/or computer servicing, and/or the brokerage and/or financial institution handling the account so that the account owner can telephone same in order to authorize or cancel the transaction. The information and/or data can also be supplemented to include a description of the person seeking to make the transaction and the type of transaction sought (i.e. securities trade, cash withdrawal, cashing of check, etc.).

At step 239, the information and/or data which is transmitted from the central processing computer 203, and received at the communication device 204, is displayed to the account owner on the display device 204E of the communication device 204. The information displayed on the display device 204 includes the name of the brokerage and/or financial institution, the amount of the transaction, the nature of the transaction, the time of the transaction and the location of the transaction. The information and/or data can also include the type of transaction and a description of the person seeking to make the transaction, etc.

The apparatus 200, at step 240, will then wait for the account owner to respond to the transmission. During this time, the account owner can either utilize the reply or two-way pager feature on the communication device 204 in order to either approve, or authorize, the transaction or disapprove of, or void, the transaction. At step 240, the apparatus 200 will receive the reply or response from the account owner. At step 241, the central processing computer 203 will determine if the account owner has made a reply or response within the pre-defined time limit which is chosen, in the preferred embodiment, to be one (1) minute. The account owner can also transmit a signal via an appropriate key or button suspending use of the account or account card, such as when he or she may first be apprised of the fact that the account is being unlawfully accessed, or the use thereof is unauthorized, or that the account card has been lost or stolen.

In instances when the communication device 204 does not have a reply or two-way pager feature, the account owner can simply telephone the central processing office or processing center and/or the brokerage or financial institution so as to personally reply or respond to the authorization request.

If, at step 241, it is determined that the account owner's reply or response was not made within the pre-specified time, chosen in the preferred embodiment to be one (1) minute, the central processing computer 203 will, at step 242, increment the unauthorized transaction count (UNAUTHCT) by one (1) and will, at step 243, transmit a signal and/or data to the brokerage transaction device 202 indicating that the transaction is not authorized by the account owner. The brokerage device operator can then, at step 244, either cancel the transaction, proceed to consummate the transaction, and/or attempt to obtain additional information or identification from the client or customer and/or obtain an alternate account number from which to draw against.

The action taken by the brokerage transaction device operator can be dictated by the specific agreement in effect between the account owner and the brokerage or financial institution administering the accounts. Upon the completion of step 244, the operation of the apparatus will cease at step 245. If the account owner should reply or respond to the transaction notice at a later period, this information can then be utilized to approve of or to disapprove and/or to dispute the transaction.

If, at step 241, it is determined that the reply or response was timely, the central processing computer 203 will, at step 246, process and identify the account owner response. At step 247, the central processing computer 203 will determine if the account owner has authorized the transaction. If the account owner's response is to cancel, to disapprove, or to not authorize, the transaction, the central processing computer 203 will, at step 248, increment the unauthorized transaction count (UNAUTHCT) by 1. At this juncture, the unauthorized count (UNAUTHCT) is set to zero at the time of the opening of the account.

After the unauthorized transaction count has been incremented, the central processing computer 203 will, at step 249, transmit a signal and/or data to the brokerage device 202 which will notify and/or instruct the brokerage device operator that the transaction is not authorized and should, therefore, be cancelled or voided. The brokerage device operator can then cancel the transaction at step 250. The brokerage transaction device operator or the account machine can then confiscate the account card, if pertinent, and/or alert the authorities. Upon the completion of step 250, the apparatus will cease operation at step 257.

If, at step 247, the central processing computer 203 identifies the account owner's reply or response as being one to authorize the transaction, the central processing computer 203 will, at step 257, reset the unauthorized transaction count (UNAUTHCT) to zero (0). The central processing computer 203 will then, at step 253, transmit a signal and/or data to the brokerage device 202 which will notify and/or instruct the brokerage device operator that the transaction is authorized and/or approved. The brokerage device operator can then complete the transaction, at step 254. After the transaction has been completed at step 254, the operation of the apparatus 200 will cease at step 255.

In any of the herein-described embodiments the data and/or information provided to the account holder can include the security, securities, stock, stocks, bond, bonds, and/or any derivative or derivatives described herein and/or any other financial instrument along with transaction prices, trade quantity, and/or any other transaction-related information and/or any other information customarily provided in conjunction with reporting a financial and/or brokerage transaction to a brokerage account holder.

In another preferred embodiment, the central processing computer 203 can perform any and/or all of the functionality described as being performed by the brokerage device 202 as described herein in conjunction with FIGS. 11A and 11B. In this manner, in another preferred embodiment of FIG. 9, the central processing computer 203 can transmit a notification signal, data, and/or information, to the communication device 204, to notify the account holder of a transaction on the brokerage account. Thereafter, the account holder can transmit a response, to the notification signal, to the central processing computer 203. The central processing computer 203 can thereafter process the account holder's response. If the central processing computer 203 determines that the transaction is authorized or approved, the central processing computer 203 can consummate or complete the transaction. If the transaction is not authorized or not approved, the central processing computer 203 can cancel or terminate the transaction.

In any of the embodiments described herein, any of the communications which are transmitted, received, and/or which take place during apparatus operation, by and between any of the brokerage devices 202, the central processing computers 203, and the communication devices 204, can take place in real-time and/or otherwise.

In instances when the account owner is a party to the transaction, which may be the case in brokerage and/or financial transactions, the account owner, having the communication device 204 on his or her person, may authorize the transaction. If the transaction is an overnight or other remotely made transaction, such as in clearing and/or account settling transactions, the account owner can authorize the transaction from his or her remote location.

In another preferred embodiment of the apparatus of FIG. 9, the apparatus 200 can be programmed and/or can be programmable by the respective account holder, account owner, cardholder, and/or other authorized individual, (hereinafter referred to as “account holder” or “account owner”). The account holder or account owner can access the central processing computer 203 via the communication device 204, a telephone, and/or any other communication device. The account holder or account owner can thereafter program the central processing computer 203 by transmitting a signal, data, and/or information, containing and/or corresponding to instructions for restricting and/or limiting activity and/or transactions which can occur and/or take place on, or in conjunction with, the respective account.

The signal, data and/or information, containing the restriction(s) and/or limitation(s) data and/or information is received by the receiver 203G. Thereafter, the CPU 203A will process the restriction(s) and/or limitation(s) data and/or information and store any appropriate data and/or information in the database 203H.

The above-described programming of restrictions and/or limitations into the central processing computer 203 can take place in real-time and/or otherwise.

The restrictions and/or limitations which can be programmed into the central processing computer 203 can include the types of transactions which are allowed and/or authorized, limitations on the amounts of transactions which can occur on an account, number of transactions which can occur on an account, authorized parties to use the account, authorized geographical area or location of usage, wherein authorized card use can be limited, and/or authorized times for account access and/or account usage (i.e. specific days, dates, time of day, time of month, year, etc.), and/or any other limitation and/or restriction regarding amount of transaction, parties involved, geographical area, and/or times of allowed usage.

The limitation or restriction can also include stopping payment on checks or drafts, stop payment orders, and/or any other limitation and/or restriction regarding any type of bank account, savings account, checking account, Automated Teller machine (ATM) account, and/or other financial account and/or account usage. The limitations and/or restrictions can also include any other limitation(s) and/or restriction(s) on account activity, amount of transactions, parties involved, geographical area, and/or times of allowed usage.

The limitations and/or restrictions can also include limitations and/or restrictions on the usage of the account, types of transactions which are allowed and/or authorized, limits on the amounts of transactions which can occur on an account, number of transactions which can occur on an account, authorized parties to use the account, authorized geographical area or location of usage, wherein authorized card use can be limited, and/or authorized times for account access and/or account usage (i.e. specific days, dates, time of day, time of month, year, etc.), and/or any other limitation and/or restriction regarding amount of transaction, parties involved, geographical area, and/or times of allowed usage.

The limitations and/or restrictions can also include the types of securities, stocks, bonds, financial instruments, financial securities, derivatives, securities derivatives, stock derivative instruments, bond derivative instruments, cash instruments, cash derivative instruments, commodities, commodity derivatives, mutual fund shares and instruments, currencies, currency derivatives, interest rate instruments, interest rate derivatives, mutual fund shares and instruments, mutual funds, investment trusts, including restrictions and/or limitations by industry and/or market sector, market capitalization, price/earnings ratios, and/or other financial ratios, etc., which can be authorized to be transacted in a particular account and/or accounts, as well as the types of securities, stocks, bonds, financial instruments, financial securities, derivatives, mutual funds, investment trusts, etc., which are not authorized to be transacted in a particular account and/or accounts. In the preferred embodiment, the account holder can limit and/or restrict the type of securities, stocks, bonds, financial instruments, financial securities, derivatives, mutual funds, investment trusts, etc., by types, market sectors, industry sectors, investment grades and/or investment ratings.

The limitations and/or restrictions can also include price limitations and/or restrictions, price limitations and/or restrictions, and/or price range limitations and/or restrictions, for buying and/or for selling any of the herein-described stocks, securities, bonds, and/or any derivatives, and/or any other financial instruments described herein.

Stock transactions can be restricted and/or limited by industry or market sector (i.e., technical stocks, utility stocks, agricultural stocks, Internet stocks, transportation stocks, automobile stocks, energy stocks, as well as any other industry), stock prices (i.e., penny stocks, low priced stocks, medium priced stocks, high priced stocks), specific companies, market capitalization, price to earnings ratio, and/or any other categories and/or classifications known and/or utilized in the stock investment field.

Bond transactions can be restricted and/or limited by bond type (i.e., treasury securities, bonds, bills, notes, municipal bonds, tax-free bonds, corporate bonds, convertible bonds, and/or any other type of bonds), bond rating (i.e. high investment grade, “junk” bonds, and/or any other bonds ratings, including all ratings provided and/or used by Standard & Poors and Moody's); discount bonds, premium bonds, and/or any other categories and/or classifications known and/or utilized in the bond investment field.

The limitations and/or restrictions can also include limitations on and/or regarding amounts of any one transaction or more transactions, individuals who may make the transactions, proof of identity of which the types of proof may be specified, specific banks, financial and/or brokerage institutions authorized to accept and/or perform transactions for the account, the nature of the transactions, geographical areas and/or location within which banks, financial and brokerage institutions which can be authorized to accept and/or perform transactions with the account, specific purchases and/or trades which can be made in conjunction with the account, specific securities which can be purchased and/or traded in conjunction with the account, specific times of day, specific days, dates and/or time of the month in, or on, which transactions can be authorized, limits of charge-backs, returned item amount withdrawals, maintenance and/or other fee charge withdrawals, etc. and/or authorized times for account usage (i.e. specific days, dates, times of day, times of month, year, etc.), and/or any other limitations and/or restrictions regarding amount of transaction, parties involved, securities involved, geographical area, and or times of allowed usage. Limitations and/or restrictions can also include limitations on deposits, types of deposits, wire transfers, etc.

With regards to any of the cards and/or accounts described herein, such as, for example, automated teller machine accounts and/or Internet accounts, the account holder or account holder can also change, specify, or programmably change, passwords, personal identification numbers and/or any other access code(s) and provide for various personal identification numbers and/or access codes for different locations, different automated teller machines, different days, different times and/or different transaction amounts.

For example, the account holder, account owner, and/or cardholder, can program the central processing computer 203, and/or the server computer, if utilized, so as to limit brokerage account by type of transaction (i.e. no derivative purchases, no tax-free bond purchases, nor stock purchases in excess of $50,000.00, etc) to limit transactions by times of usage (i.e. no trading activity between 10:00 P.M. and 8:00 A.M.), to stop payment on a check or draft, to increase or decrease credit or overdraft limits, to increase a margin limit, etc.

The account holder of account owner can program the central processing computer 203, and/or the server computer, if utilized, via the communication device 204, a telephone, and/or any other suitable communication device. The account holder or account owner can also perform the above-described programming via a touch-tone telephone. In the same manner, the account holder or account owner, can also program the apparatus 200 so as to limit the types of transactions involving his or her account.

Once programmed by the account holder or account owner, the central processing computer 203, upon receiving a transaction authorization request or a transaction processing request, will process the transaction in conjunction with the restriction(s) and/or limitation(s) provided, programmed, and/or dictated, by the account holder or account owner.

By utilizing the above-described programming routine(s), an account holder, account owner, cardholder, and/or other authorized individual, can program and/or update any data and/or information which can or may be stored in the database 203H. The above-described programming routine(s) can be performed in real-time and/or otherwise.

In another preferred embodiment, the account holder or account owner can program the respective brokerage device 202 and/or communication device 204, in the same manner in which the central processing computer 203 can be programmed, so as to program restrictions and/or limitations into the respective devices. The brokerage device 202 can, in this manner, be directly programmable, by the account holder, or account owner, cardholder, and/or other authorized individual, in real-time and/or otherwise, in the same manner described above regarding the central processing computer 203, so as to automatically process a transaction in accordance with the restrictions or limitations provided by account holder, account owner, and/or cardholder.

The communication device 204 can also be directly programmable by the account holder or account owner, in real-time and/or otherwise, in the same manner described above regarding the central processing computer 203, so as to automatically process a transaction authorization request and/or a transaction.

In a similar manner, the account holder, account owner, and/or cardholder, can program the apparatus 200 as described above in conjunction with the use of any of the herein-described brokerage accounts, conventional brokerage accounts, and/or on-line brokerage accounts.

The account owner can also program and/or set the communication device 204 so as to automatically authorize or disapprove or disallow transactions. In this regard, the communication device 204 can be programmable so as to receive and analyze the transaction information and/or data and reply or respond to same automatically and/or with preset or programmed replies and/or responses. The communication device 204 can also be programmable so as to limit the amounts of transactions. In this regard, the account owner can provide for temporary transaction types and/or amounts.

The communication device 204, in the preferred embodiment, is provided with a memory device for storing any number of transactions so that the account owner can review his or her account activity and/or transactions which have occurred involving his or her account(s) and/or account card(s). In this manner, the account owner can “scroll” through and/or in other ways review account activity. The communication device 204 can also be equipped to service more than one brokerage and/or financial services account and/or account card. For example, any number and/or types of accounts can be serviced with or by a single communication device 204.

The central processing computer 203 can also be programmed to provide notification to the account owner upon the occurrence of any number of events and/or occurrences which take place regarding and/or relating to the respective brokerage account. The central computer 203 can provide notification to the account owner upon the occurrence of a trade of a security, a stock, a bond, a mutual fund, an investment fund, and/or financial instrument and/or financial security, and/or derivative, involved in the transaction, the receipt of an account owner's deposit, a withdrawal from the account, the receipt of a stop payment order, a stop payment order being effected, wire transfer deposit, electronic transfer, withdrawal, wire transfer withdrawal, credit, debit, check presentment, check clearing, check cashing, account charge, account chargeback, the crediting of the payment to the respective account, the reaching of a pre-specified credit, charge, debit, and/or other respective limit on the respective account, a direct payment withdrawal, a direct deposit, a change in interest rate on the account, a change in a credit limit, and/or any other change and/or occurrence regarding and/or relating to the account which may be of interest to the respective account owner and/or any other transaction related to and/or involving the respective brokerage account.

The central processing computer 203 can also notify the account owner regarding a settlement data, a margin call, a margin call date, a short position cover notification, a payment due date, an overdue status of a payment, an interest rate change, a credit limit change, an account restriction and/or limitation on usage, etc.

In this manner, the account owner can be notified of any of the above-described and/or any other event or occurrences. For example, the account owner can be notified when a trade is being made along with information regarding the security, stock, bond, mutual fund, investment trust, derivative, and/or other financial instrument and/or financial security, a deposit is received, when a check has cleared, when a stop payment order has been effected, when a withdrawal is made, and/or when any other event or transaction of interest to the account owner occurs on and/or regarding the account.

Similarly, the account owner can be notified when he or she has reached and/or is close to reaching a pre-specified settlement date, credit limit and/or upon the occurrence of administrative events or occurrences, i.e. settlement date, payment due date, payment overdue, interest rate change, credit limit change, account restrictions, maintenance or service fee charges, returned checks occurrences and/or charges, etc.

In another preferred embodiment, the brokerage device 202 can be programmed to provide any of the functions described herein as being performed by the central processing computer 203, including, but not limited to, providing any of the notification functions for providing notification to the account owner of any of the above-described events and/or occurrences.

The various processing routines described herein as being performed by the apparatus 200 of the present invention in FIGS. 11A and 11B and FIGS. 12A, 12B and 12C can also be performed in conjunction with each other and/or can be combined so that the apparatus 200 can perform multiple routines in conjunction with each other. In this regard, the brokerage device 202 can, in another preferred embodiment, transmit the information and/or data pertinent to a transaction to the communication device 204 associated with an account owner, and process the transaction in the manner described herein with the account owner, while also transmitting the information and/or data pertinent to the transaction to the central processing computer 203 and processing the transaction with the central processing computer 203.

The brokerage device 202 can transmit the respective transmissions to the respective devices 204 and 203 in a sequential fashion and/or in any desired and/or specified order and/or the brokerage device can transmit the respective transmissions to the respective devices 204 and 203 simultaneously. In any event, the brokerage device(s) 202, the central processing computer(s) 203, and the communication device(s) 204, in the preferred embodiments described herein, can be suitably equipped with any necessary, additional, and/or desired, hardware and/or software for facilitation their respective operations and/or functionality as described herein.

The apparatus and method of the present invention provides for the real-time notification of brokerage and/or financial transactions involving various brokerage and/or financial accounts and enables an account owner to monitor, in real-time, activity involving his or her brokerage and/or financial account(s) and/or account card(s).

The apparatus and method of the present invention also provides a means and a mechanism by which to inform an account owner that his or her account is being accessed and/or is overdrawn, has been charged against and/or that his or her account card(s) are lost, stolen, cancelled or de-activated and/or provides an indication to the account owner of when and/or where his or her accounts are being accessed in transactions. The account owner can then report the unauthorized activity, and/or the discovery of a lost or stolen account card, and/or cancel and/or de-activate the respective account(s) and/or account card(s).

The central processing computer 203 and/or the brokerage device 202 can also generate and transmit notification signals, e-mails, and/or other electronic and/or conventional message and/or transmission to notify the account holder when he or she is about to reach a pre-determined account balance, when he or she has reached a pre-determined account balance, has reached a pre-determined credit limit, has a check returned for insufficient funds, has deposited a check which has subsequently returned for insufficient funds, and/or to provide notification regarding a service charge, a payment due, a payment due date, a past due payment, and/or to provide notification regarding any other event, occurrence, and/or account activity which can be related to the account and/or which may be of interest to a brokerage account holder and/or an individual or entity authorized to receive notification for, and/or on behalf of, the account holder.

The present invention, in another preferred embodiment, can also be utilized so as to provide authorization, notification and/or security for, and in conjunction with electronic money, electronic cash and/or digital cash transactions and/or accounts.

FIG. 10 illustrates a block diagram of another preferred embodiment of the apparatus of the present invention which is utilized in conjunction with an electronic cash and/or a digital cash account (hereinafter “electronic cash account”). As defined herein the terms “electronic cash” and “digital cash”, or their plural forms, refer to, and include, electronic cash, digital cash, electronic money, digital money, electronic and/or digital cash, electronic and/or digital currency, electronic and/or digital coins, electronic and/or digital tokens and/or currency accounts, electronic and/or digital cash accounts, savings accounts, checking accounts, and/or any other type of electronic media financial accounts, alternate value media accounts and accounts and systems for the storing, maintenance and the record keeping of same involving cash or money in an electronic or digital form.

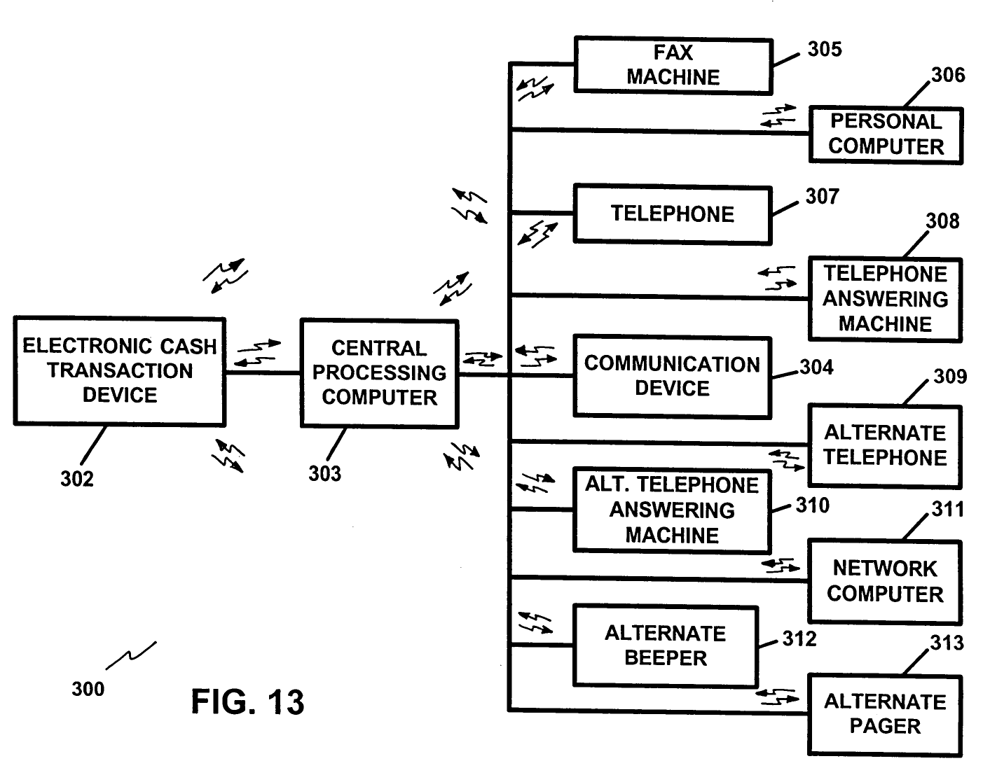

The apparatus of FIG. 13 is denoted generally by the reference numeral 300. In FIG. 13, the apparatus 300 includes of an electronic cash or electronic transaction device (hereafter “electronic cash device”) which devices can be found at establishments and/or entities, and/or financial institutions and/or administrators of the respective accounts, which perform commercial and/or other transactions with electronic cash. In the preferred embodiment, the electronic transaction device 302 is a terminal computer or other device which is utilized by an operator in performing transactions involving electronic cash.

The electronic cash device 302 can also be utilized in performing account deposit transactions, account withdrawal transactions, electronic bill payment transactions, electronic check cashing transactions, electronic clearing transactions, and/or any other financial and/or related transaction which can be performed and/or contemplated involving electronic cash accounts and/or digital cash accounts. Any other terminal or similar device can also be utilized as the electronic cash device 302 depending upon the application and/or the transaction.

The electronic cash transaction device 302 can be any of the widely used and well known devices, computers or terminals for providing electronic cash transactions, of any kind, and further including financial transactions related to a savings account and/or checking account for electronic cash, including electronic clearing transactions, electronic check clearing and/or account charging and/or charge-back transactions and/or on-line commerce transactions, which transactions institutions and/or establishments can perform and/or engage in the utilization of electronic cash transactions and commerce.

Typically, the electronic cash device and/or devices include a computer terminal having an input device such as a keyboard and/or various reader and/or scanning device for reading and/or scanning, respectively, information and/or data necessary in order to perform the transaction. The electronic cash device 302 transmits an authorization request and/or a transaction notification signal, which can include the data pertaining to the particular electronic cash account which is accessed and/or involved in the transaction and the type and the amount of the transaction, as well as any other information pertaining to the transaction, over a communications medium, to an individual account holder, an individual authorized to receive information for, and/or otherwise act for and/or on behalf of the individual account holder, to a central processing computer for processing the electronic cash transaction, the transaction request and/or the authorization request pertaining thereto.

The electronic cash device 302 can transmit the transaction authorization request and/or notice to a central processing computer via a central computer which can be a central computer at the particular institution which services the electronic cash accounts. The central processing computer can also be a central computer system which is not located at the institution, but rather, which services the particular electronic cash institution and/or account and/or group institutions and/or accounts.

The electronic cash device 302 also receives the transaction and/or authorization data and/or information from the respective communication device associated with the individual account holder, the individual authorized to receive information for and/or on behalf of the account holder, and/or the central processing computer. If a central electronic cash computer is utilized, the data transmitted from the central processing computer would be transmitted to the electronic cash device 302 via the central computer. A printed transaction receipt can also be provided at and/or obtained via the electronic cash device 302, or peripheral device associated therewith, for printing a transaction receipt.

The electronic cash device 302 can also include, and/or have associated therewith, a keypad for the manual entry of electronic cash transaction information and/or data, such as the amount of the electronic cash transaction, account number, etc. The electronic cash device 302 can also be an integral component of a cashier or operator work station and/or other transaction terminals and/or devices, including those which can provide for the automatic entry of electronic cash transaction information and/or data.

The electronic cash device 302 can be equipped to read multiple contact information from magnetic strip cards so as to provide for the transmission of data and/or information to multiple individuals, entities and/or to multiple communication devices associated with the individual(s), entity, or entities. For example, the magnetic strip on the back of an account card, banking card, debit card, smart card, and/or automated teller machine (ATM) card, associated with the electronic cash account, can contain the phone number and/or contact information for a central transaction authorization computer associated with the account card as well as a the identity, address, phone number, pager number, e-mail address, fax number, and/or any other contact information for the individual account holder.

In cases involving electronic cash “smart” cards, or cards having processors, memory chips, computer chips and/or other processors and/or processing devices, the electronic cash device 302 can be equipped with an appropriate card reading device for reading and/or obtaining information from the respective processor, memory chip, computer chip and/or other processor and/or processing device.

The respective account cards, in addition to containing account owner contact information, can also contain information regarding restrictions and/or limitations on account usage. In this manner, the respective card can contain information regarding restrictions and/or limitations as to the type of authorized transactions, authorized parties to a transaction, identification required, required personal identification information, authorized times of usage, authorized geographic location of usage, as well as any other restriction and/or limitation on account usage.

The apparatus 300 also includes a central processing computer 303 which services any institution, account, and/or any pre-defined group of institutions which services electronic cash accounts and/or any number of accounts, and/or account holders, associated therewith. For example, the central processing computer 303 can handle all electronic cash accounts and savings accounts, checking accounts and/or related thereto for a given institution or institutions. The central processing computer 303, for example, can process and maintain records of deposits, withdrawals, checks cashed, drafts, digital cash deposits, digital cash withdrawals, charges made against an account, credits made to an account, etc., and/or any combinations of same as they relate to electronic cash accounts. The central processing computer 303 can process accounts for any of the various electronic cash accounts and/or institutions.

In the preferred embodiment, the electronic cash device 302 is linked and/or connected to the central processing computer 303 via a telecommunications system, link and/or medium (hereinafter referred to as “communications system”) such as, for example, a telephone network or line. As noted above, the electronic cash device 302 may or may not be linked to the central processing computer 303 via a central computer. The communications system which is utilized can be any communications system and can include telecommunication systems, satellite communications systems, radio communication systems, digital communications systems, digital satellite communications systems, personal communications services communication systems, cable television communications systems, digital television communication systems, satellite television communication systems, broadband communication systems, as well as any other appropriate communications system.

The electronic cash device 302 transmits signals and/or data to the central processing computer 303 as well as receives signals and/or data from the central processing computer 303.

The central processing computer 303 can be a mainframe computer, a mini-computer, a micro-computer, a personal computer and/or a server computer, such as those utilized in conjunction with on-line services and/or in a network environment, and/or any other suitable computer or computer system.

The apparatus 300 also includes an account owner communication device 304 which can receive signals and/or data from either or both of the electronic cash device 302 and/or the central processing computer 303. The communication device 304 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch.

In another preferred embodiment of FIG. 13, the communication device 304 receives signals and data directly from the electronic cash device 302 with said signals being transmitted via a suitable communication system. In this preferred embodiment, the communication device 304 can also transmit signals and data to the electronic cash device 302, directly and/or indirectly, with said signals being transmitted via a suitable communication system. In another preferred embodiment of FIG. 13, the communication device 304 can receive signals and data from the central processing computer 303, directly and/or indirectly, with said signals being transmitted via a suitable communication system. In this preferred embodiment, the communication device 304 can also transmit signals and data to the central processing computer 303, directly and/or indirectly, with said signals being transmitted via a suitable communication system.

In the preferred embodiment, the communications system utilized for transmitting signals and/or data to the communication device 304 can be a wireless telephone line and the communication device 304 is a wireless telephone signal receiving device such as a telephone beeper or pager. The communication device 304, which can also be a pager, receives the wireless telephone signals and/or data from the central processing computer 303 during the authorization procedure as will be described in more detail below.

In the preferred embodiment, the communication device 304 is also equipped with a transmitter for transmitting signals and/or data to the central processing computer 303. In this regard, the central processing computer 303 transmits signals and/or data to the communication device 304 as well as receives signals and/or data from the communication device 304. The communication device 304 can also transmit signals and/or data directly to the electronic cash device 302 and receive signals and/or data directly from the electronic cash device 302.

In the preferred embodiment, the electronic cash device 302 transmits signals and/or data to the central processing computer 303 and receives signals and/or data from the central processing computer 303. Further, in the preferred embodiment, the communication device 304 receives signals and/or data from the central processing computer 303 and transmits signals and/or data to the central processing computer 303.

As noted above, the communication device 304 is a wireless device. In this regard, the communication device 304 or pager can be carried by the account owner and/or be kept on and/or close to the account owner's person so that the central processing computer 303 can transmit signals and/or data to the communication device 304 so as to communication with the account owner at any time.

In the preferred embodiment, the apparatus 300 also includes a facsimile (fax) machine 305, a personal computer or personal digital assistant 306, a telephone 307, a telephone answering machine 308, an alternate telephone 309, an alternate telephone answering machine 310, a network computer 311, and/or an alternate beeper 312 or alternate pager 313. The central processing computer 303 can be linked with the above fax machine 305, personal computer or personal digital assistant 306, telephone 307, associated answering machine 308, alternate telephone 309, alternate telephone answering machine 310, network computer 311, alternate beeper 312 and alternate pager 313, via any suitable communication system.

In the preferred embodiment, a telecommunications link or telephone line or link, which may or may not be a wireless link, depending on the device and/or the circumstances, is utilized in order to link the central processing computer 303 with each of the fax machine 305, the personal computer or personal digital assistant 306, the telephone 307, the associated answering machine 308, the alternate telephone 309, the alternate telephone answering machine 310, the network computer 311, the alternate beeper 312 and the alternate pager 313.

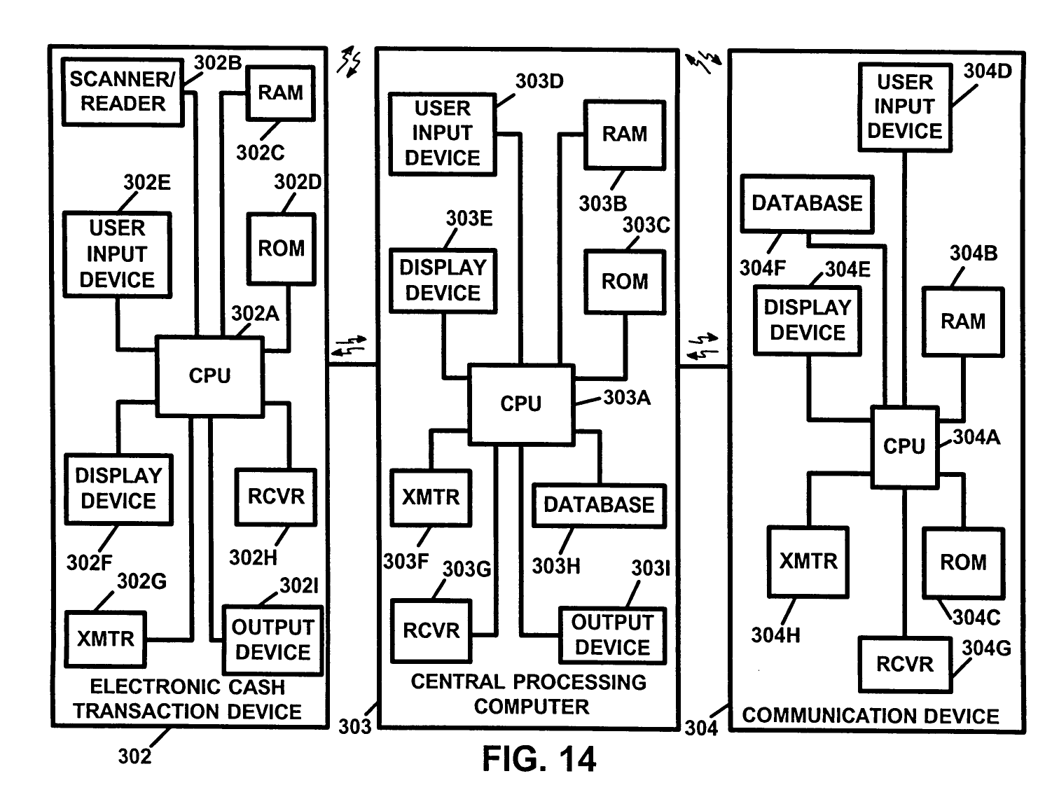

FIG. 14 illustrates the various components of the apparatus 300 of FIG. 13. In FIG. 14, the electronic cash device 302, in the preferred embodiment, includes a central processing unit or CPU 302A, a scanner or reader 302B, which is connected to the CPU 302A, associated random access memory 302C (RAM) and read only memory 302D (ROM) devices, which are also connected to the CPU 302A, a user input device 302E, which is typically a keypad or other suitable input device for inputting data into the electronic cash device 302 and which is also connected to the CPU 302A, and a display device 302F for displaying information and/or data to a user or operator, which display device 302F is also connected to the CPU 302A.

The electronic cash device magnetic card reader or card reader 302B can, in the preferred embodiment, be capable of reading and processing data and/or information, which is stored on the magnetic strips and/or on the processors or chips which are located on the respective account card, and for providing one or multiple communications for one or multiple parties as well as reading and processing any restriction and/or limitation information regarding and/or related to account usage. For example, the magnetic card reader or card reader 302B can read and/or process data and/or information for identifying and communicating with a central transaction processing computer 303 as well as can read and/or process data and/or information for communicating with the individual account holder and/or an individual or agent authorized to act for and/or on behalf of the individual account holder, at any one or more of the communication devices associated with the individual account holder or the individual or agent associated with the individual account holder.

Data and/or information for providing any other the communications described herein can be obtained from the data and/or information contained in the magnetic strip on the account card, the respective processor or chip located on the card, and/or can be obtained form an external database (not shown) which can be linked to the electronic cash device 302 and/or which can be accessed thereby for obtaining any additional data and/or information.

The user input device 302E can include any data input device including, but not limited to, a keyboard, a mouse, a scanner, a reader or card reader, an audio input device, a voice recognition device, a fingerprint reading device, a retinal scanning device, and/or any other device for inputting data and/or information into the banking device 302.

The electronic cash device 302 also includes a transmitter 302G for transmitting signals and/or data to the central processing computer 303, and/or to the communication device 304 and/or to any other device associated with the account owner, and/or the apparatus, if desired. The transmitter 302G is also connected to the CPU 302A. The electronic cash device 302 also includes a receiver 302H for receiving signals and/or data from the central processing computer 303, and from the communication device 304 and/or from any other associated device which can be utilized, if desired. The receiver 302H is also connected to the CPU 302A. The electronic cash device 302 also includes a printer 302I or other appropriate output device for outputting data to the operator. The printer 302I is also connected to the CPU 302A. In the preferred embodiment, the printer 302I prints receipts corresponding to the electronic cash transaction.

In FIG. 14, the central processing computer 303, in the preferred embodiment, includes a central processing unit or CPU 303A, associated random access memory 303B (RAM) and read only memory 303C (ROM) devices, which are connected to the CPU 303A, a user input device 303D, which is a keypad or any other suitable input device, for inputting data into the central processing computer 303 and which is also connected to the CPU 303A, and a display device 303E for displaying information and/or data to a user or operator.

The user input device 303D can include any data input device including, but not limited to, a keyboard, a mouse, a scanner, a reader or card reader, an audio input device, a voice recognition device, a fingerprint reading device, a retinal scanning device, and/or any other device for inputting data and/or information into the central processing computer 303.

The central processing computer 303 also includes a transmitter(s) 303F for transmitting signals and/or data to the electronic cash device 302 and to the communication device 304 and/or to any one or more of the fax machine 305, the personal computer or personal digital assistant 306, the telephone 307, the telephone answering machine 308, the alternate telephone 309, the alternate telephone answering machine 310, the network computer 311, the alternate beeper 312, and/or the alternate pager 313. The transmitter(s) 303F is also connected to the CPU 303A. The central processing computer 303 also includes a receiver(s) 303G for receiving signals and/or data from the electronic cash device 302 and from the communication device 304 and/or from any other suitable device which can be utilized in conjunction with the apparatus 300. The receiver(s) 303G is also connected to the CPU 303A.

The central processing computer 303 also includes a database(s) 303H which contains electronic cash account information and data pertaining to the account owner's account(s). The database 303H contains information about the account owner, the account number, etc., and any other information and/or data necessary to the manage and/or process an account and/or account transaction as described herein. The database 303H is also connected to the CPU 303A.

The database 303H can include any number of databases which may or may not be linked to one another. The database 303H can also be linked to a database or databases which are located external from the central processing computer 303.

The database 303H can also include data and/or information regarding specific limitations and/or restrictions which can be placed on a particular account, which can be pre-selected and/or programmed by the account holder and which can include limitations and/or restrictions on the usage of the account.

The limitations and/or restrictions can include the types of transactions which are allowed and/or authorized, limits on the amounts of transactions which can occur on an account, number of transactions which can occur on an account, authorized parties to use the account, authorized geographical area or location of usage, wherein authorized card use can be limited, and/or authorized times for account access and/or account usage (i.e. specific days, dates, time of day, time of month, year, etc.), and/or any other limitation and/or restriction regarding amount of transaction, parties involved, geographical area, and/or times of allowed usage.

The central processing computer 303 also includes a printer 303I or other appropriate output device for outputting information and/or data to a user or operator, which printer 303I or other output device is also connected to the CPU 303A.

In FIG. 14, the communication device 304, in the preferred embodiment, includes a central processing unit or CPU 304A, associated random access memory 304B (RAM) and read only memory 304C (ROM) devices, which are also connected to the CPU 304A, a user input device 304D, which is a keypad or a plurality of keys and/or switches for inputting data into the communication device 304 and which is also connected to the CPU 304A, and a display device 304E, for displaying information and/or data to the account owner, and a database 304F. This display device 704E and the database 304F are also connected to the CPU 304A.

The communication device 304 also includes a receiver 304G for receiving signals and/or data from the central processing computer 303 and which is also connected to the CPU 304A, and a transmitter 304H for transmitting signals and/or data to the central processing computer 303 and which is also connected to the CPU 304A.

The user input device 304D can include any data input device including, but not limited to, a keyboard, a mouse, a scanner, a reader or card reader, an audio input device, a voice recognition device, a fingerprint reading device, a retinal scanning device, and/or any other device for inputting data and/or information into the communication device 304.

In the preferred embodiment, the communication device 304 which can be utilized can be a computer communication device such as a personal computer, a hand-held computer, a personal digital assistant, a pager, a two-way pager, and/or any other communication device. In the preferred embodiment, the communication device 304 can have a reply feature and/or device for facilitating two-way communication between the communication device 304 and any of the electronic cash devices and central processing computers described herein. A two-way pager and/or pager systems can also be utilized for implementing the respective component system(s) in the apparatus 300 and/or the component combinations and/or communication systems and/or communication links.

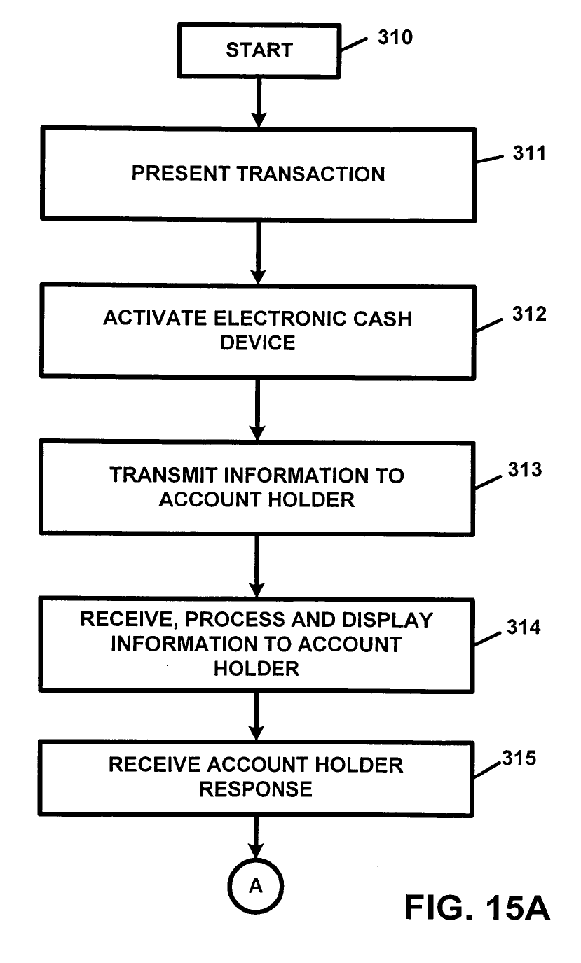

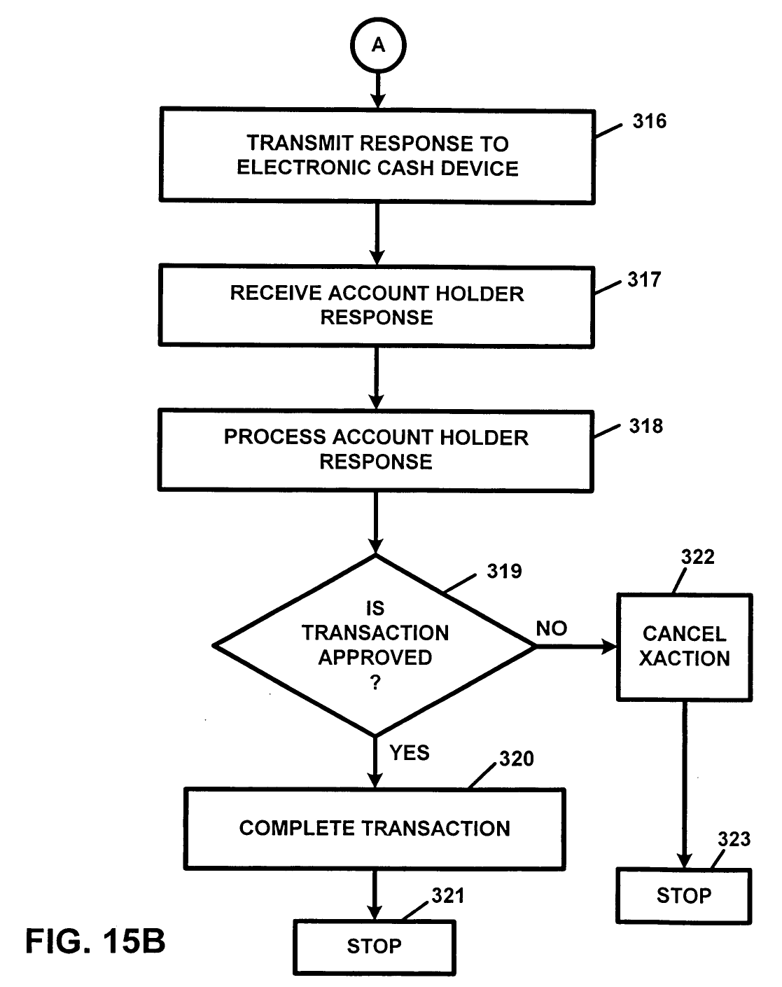

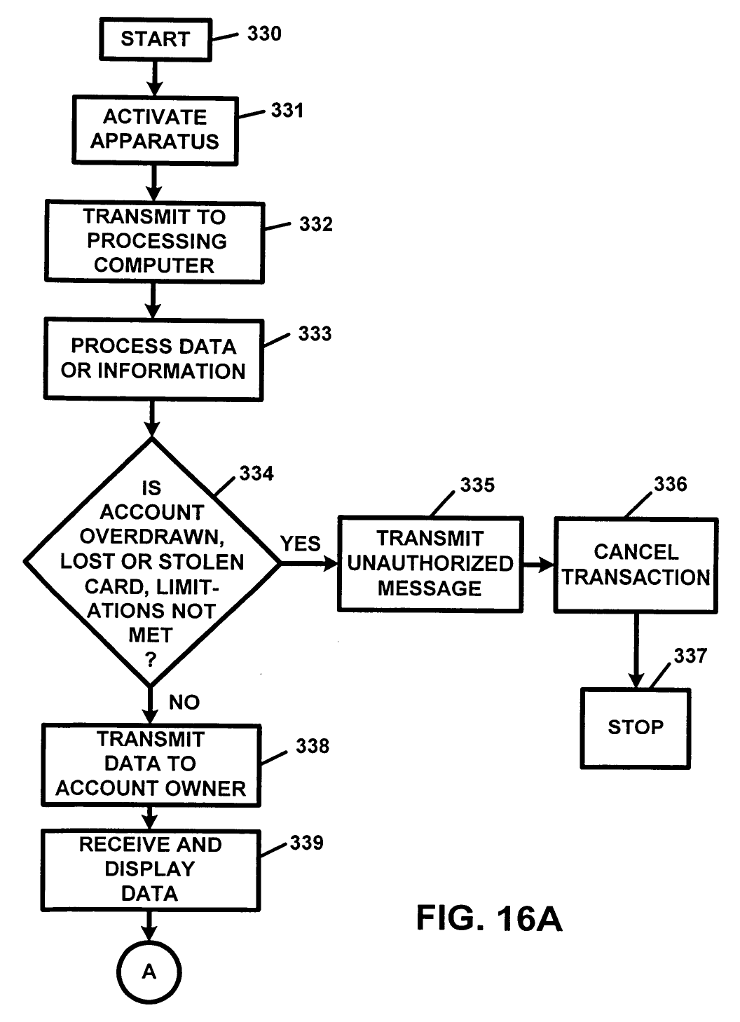

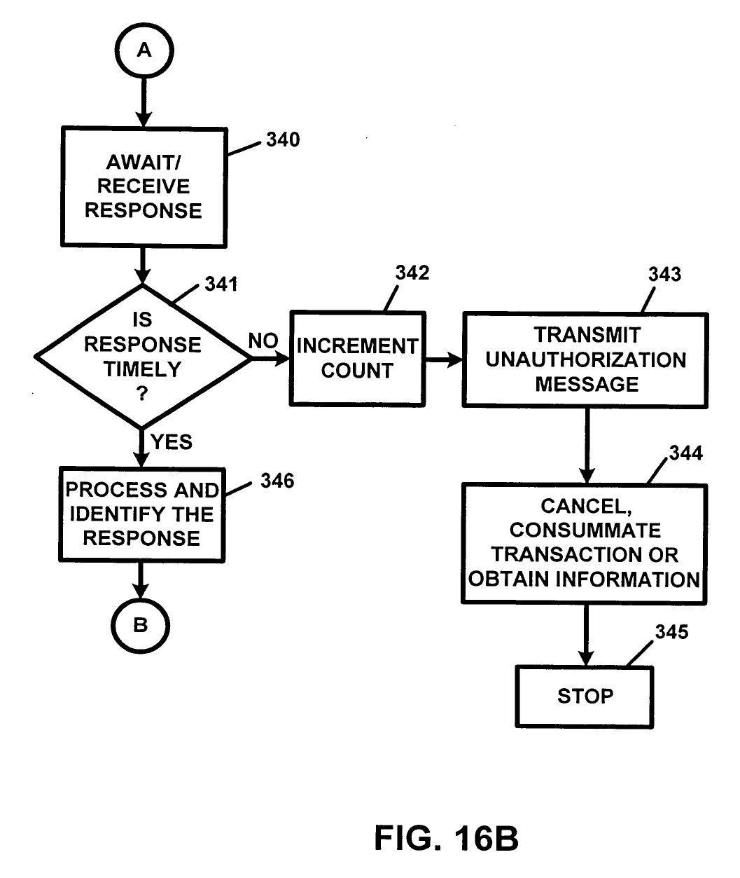

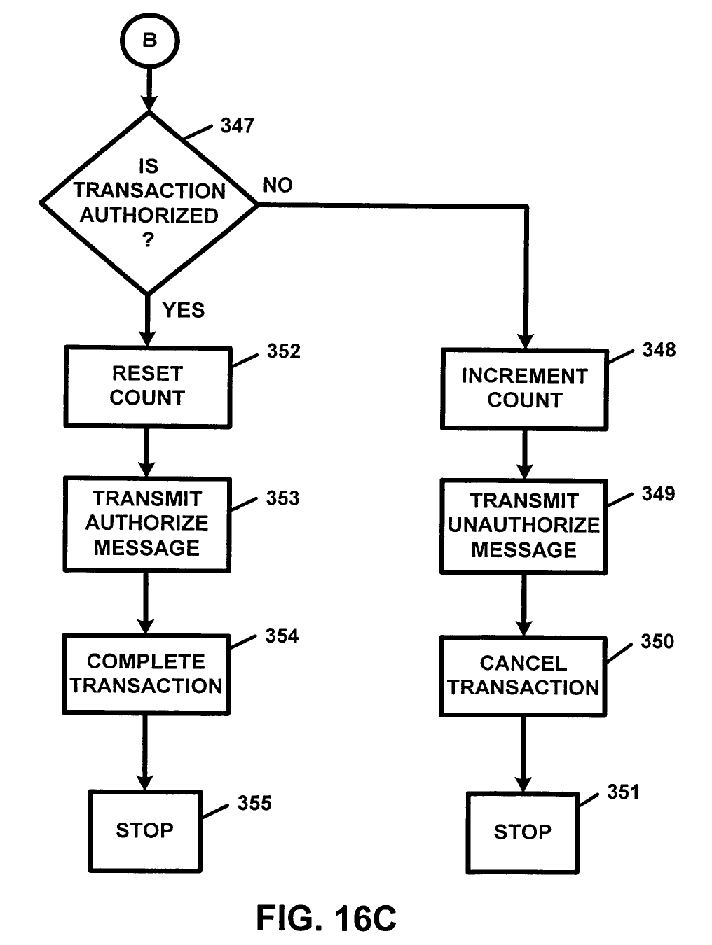

The apparatus 300 of the present invention, in the preferred embodiment, can be utilized in order to facilitate account owner authorization, notification and/or security, in transactions involving electronic cash accounts and checking accounts, savings accounts and electronic currency accounts, ATM accounts and/or any transactions involving and/or related to same in the manner described below and with reference to FIGS. 15A, 15B and FIGS. 16A, 16B and 16C. In this manner, the apparatus and method of the present invention can be utilized to obtain account owner authorization in an electronic cash transaction.

The apparatus 300 can be utilized in conjunction with an account card or cards which correspond to, or which are associated with electronic money, electronic cash and/or digital cash accounts described herein.

FIGS. 15A and 15B illustrate a preferred embodiment operation of the apparatus 300 in flow diagram form. With reference to FIGS. 15A and 15B, the operation of the apparatus 300 commences at step 310. At step 311, the electronic cash transaction, electronic cash instrument, account card, and/or ATM card, is presented to an electronic cash institution employee, and/or computer system, such as for example, the electronic cash device 102, and/or otherwise presented for a transaction on the respective account. In any of the embodiments described herein, the transaction can involve and/or represent a withdrawal, a check cashing, an ATM withdrawal, a deposit, a deposit of any kind, an ATM deposit, a credit to the account, a charge to the account, a chargeback to the account, and/or any other event which can deposit and/or withdrawal of funds from the respective account.

At step 312, the service attendant or electronic cash device operator will activate the electronic cash device 302 in any typical manner, such as by entering information regarding the account involved and the transaction into the electronic cash device 302 via the user input device 302E, the scanner/reader 302B, and/or via receiving same via the receiver 302H. This data entry can typically be performed by entering information via a keyboard or mouse, or by swiping the magnetic strip of the account card through the scanner/reader 302B or by reading information from the processor or chip on the account card via the scanner/reader.

The data obtained from the magnetic strip and/or the card processor or chip, and/or from any associated database, can be utilized to contact the account holder communication device 304 and/or the account holder directly and/or to process the transaction.

In another preferred embodiment, the electronic cash device 302 can process the transaction in conjunction with any restrictions and/or limitations on account usage, information of which can be obtained from a respective account card. If the electronic cash device 302 determines that the transaction violates and/or otherwise does not conform to a restriction and/or limitation on account usage, the electronic cash device 302 can cancel and/or reject the transaction without proceeding further. For example, the electronic cash device 302, upon reading a restriction involving a time of use (i.e. no account usage allowed between 12:00 A.M. and 6:00 A.M.), a location of usage (i.e. no usage outside a particular city, state, or country), or a transaction amount limitation (i.e. no account usage for transactions exceeding $100), can process the transaction and determine if the transaction would violate a particular restriction or limitation.

If the transaction would violate a restriction or limitation, the electronic cash device 302 can cancel the transaction and no further processing would be required. If the transaction would not violate a restriction and/or limitation, the transaction processing could continue in any appropriate manner described herein and/or otherwise.

The information and/or data pertinent to the transaction, and/or the account, is then transmitted, at step 313, to the communication device 304 via the communication network. In any of the embodiments described herein, any information and/or data which is transmitted from the electronic cash device 302 to the communication device 304 can be transmitted directly to the communication device 304 via the communication network.

The information and/or data which is transmitted from the electronic cash device 302 to the communication device 304 can also be transmitted indirectly to the communication device 304, via the communication network, and independently of any transaction processing by a central transaction processing computer and/or central transaction processing system. The transmission of the information and/or pertinent data, which takes place at step 313, is a transmission from the electronic cash device 302 to the communication device 304 via the communication network and takes place independently of any processing of the transaction by a central processing computer or central processing service, such as by the central processing computer 303 and/or otherwise. In this manner, the present invention provides notification to the account holder of the transaction independently of any transaction processing by a central processing computer and/or a central processing service.

At step 313, the electronic cash device 302, by utilizing account holder contact information obtained from an associated card and/or otherwise, can also transmit respective signals and/or data to any one or more of the account holder's designated fax machine 305, personal computer or personal digital assistant 306, telephone 307, telephone answering machine 308, alternate telephone 309, alternate telephone answering machine 310, network computer 311, and/or alternate beeper 312 or alternate pager 313.

The information and/or data which is transmitted to the communication device 304 can include information and/or data identifying the transaction and can include the name of the electronic cash bank or financial institution and the amount of the transaction. The information and/or data can also provide the time of the transaction, the location (i.e. city, town, village, state, country etc.) of the transaction.

The information and/or data can also include the phone number of the electronic cash bank or financial institution and/or a central processing office and/or computer servicing the account so that the account holder can telephone same in order to authorize or cancel the transaction. The information and/or data can also be supplemented to include the type of instrument or sums involved in the transaction.

The communication device 304 will, at step 314, receive and process the information and/or data pertinent to the transaction and provide the information to the account holder. At step 314, the information and/or data which is transmitted from the electronic cash device 302 and received at the communication device 304 can is displayed to the account holder on the display device 304E of the communication device 304. The information displayed on the display device 304E can include the name of the electronic cash bank or financial institution, the amount of the transaction, the time of the transaction and the location of the transaction. The information and/or data can also be supplemented to include the type of instruments, instrument identification (i.e. check or wire transfer number) involved in the transaction.

The communication device 304 can utilize any of the widely known data processing and/or software routines, which are known to those skilled in that art, in order to process transaction requests and/or authorizations involving the use of the respective account(s).

Thereafter, the account holder can, at step 315, enter a response either approving or disapproving the transaction. At step 316, the account holder's response is then transmitted, via the transmitter 304H of the communication device 304 to the electronic cash device 302. In any of the embodiments described herein, any information and/or data which is transmitted from the communication device to the electronic cash device 302 can be transmitted directly to the electronic cash device 302 and/or indirectly to the electronic cash device 302 via the communication network.

The information and/or data which is transmitted from the communication device 304 to the electronic cash device 302 can also be transmitted indirectly to the communication device 304, via the communication network, and independently of any transaction processing by a central transaction processing computer and/or central transaction processing system. In another embodiment, the information and/or data which is transmitted from the communication device 304 to the electronic cash device 302 can also be transmitted indirectly to the electronic cash device 304, via the central processing computer 303 or other processing computer or device.

At step 317, the receiver 302H of the electronic cash device 302 will receive the account holder's response. At step 318, the electronic cash device 302 will process the account holder's response. At step 319, the electronic cash device 302 will determine whether the transaction is approved or authorized. If, at step 319, it is determined that the transaction is approved or authorized the electronic cash device 302 will consummate the transaction at step 320. Thereafter, operation of the apparatus 300 will cease at step 321. If, however, at step 319, it is determined that the transaction is disapproved or unauthorized, the electronic cash device 302 will cancel the transaction, at step 322. Thereafter, the operation of the apparatus 300 will cease at step 323.

In the embodiment described above, as well as in any of the embodiments described herein, the electronic cash device 302 can be programmed to wait a pre-specified amount of time for the account holder's response. The electronic cash device 302, can also be programmed to cancel the transaction or consummate the transaction if no response is received.

Any of the particular instructions for the particular account can be included in the data and/or information which is stored on the magnetic strip and/or otherwise stored on the respective account card. In this manner, the electronic cash device 302 can utilize transaction instructions which are stored on, and/or obtained from, the respective account card and utilize this data and/or information in performing processing routines regarding the transaction. In this manner, the present invention can be utilized in order to provide custom tailoring of transaction processing regarding a particular account which information can be pre-specified and stored on the respective account card.

In instances when the communication device 304 does not have a reply or two-way pager feature, the account holder can simply telephone the electronic cash device 302, or center or office servicing, and/or associated with, same, in order to personally appraise the device 302, or center or office, of his or her response to the electronic cash device 302 transmission regarding the transaction.

In this manner, the electronic cash device 302 can communicate with the account holder via the communication device 304 and independently of any transaction processing by a central transaction processing computer or central transaction processing service.

FIGS. 16A, 16B and 16C illustrate the operation of the apparatus 300, in flow diagram form. In the preferred embodiment of FIGS. 16A, 16B and 16C, the apparatus 300 can be utilized in conjunction with a central transaction processing computer or service. With reference to FIGS. 16A, 16B and 16C, the operation of the apparatus 300 commences at step 330 when the electronic cash transaction and/or instrument is presented to the electronic cash institution employee, representative and/or when an associated card is placed in a card reader, respectively.

At step 331, the employee or representative of the electronic cash account services institution will activate the apparatus, via the electronic cash transaction device 302, in any typical manner, such as by entering account and/or card information, into the electronic cash transaction device 302. This data entry is typically performed by manual data entry and/or via a card reader, depending upon the transaction. For example, if an individual provides an electronic cash account number and amount, the employee or representative will enter the account information and/or transaction information into the electronic cash device 302 for processing. The information and/or data pertinent to the transaction is then transmitted, at step 332, to the central processing computer 303.

The central processing computer 303 will then, at step 333, process the information and/or data pertinent to the transaction and to the particular account. The central processing computer 303 can utilize any of the widely known data processing and/or software routines, which are known to those skilled in that art, in order to process transaction requests and/or authorizations involving the use of the respective account and/or account(s) and/or related account card(s).

The central processing computer 303 will process the information and/or data pertinent to the transaction in conjunction with the account information in order to determine the status of the account (i.e. whether any holds have been placed on the account, such as those prohibiting withdrawals and/or whether the account has been cancelled or de-activated). Further, the central processing computer 303 will then perform a test, at step 334, in order to determine if the transaction amount has reached and/or exceeded the amount available in the account and/or if the account card has been reported lost, stolen, cancelled and/or de-activated, and/or to determine whether any other pre-defined, pre-selected and/or programmed limitation(s) and/or restriction(s) have been met, satisfied and/or reconciled. The central processing computer 303 will also perform a test in order to determine if the predetermined maximum number count of unauthorized transactions, pre-defined in the preferred embodiment to be one (1), has occurred on the account.

The unauthorized transaction count refers to a count of the transactions which are not authorized by the account owner as will be described herein. The authorized transaction count (UNAUTHCT) is a variable which is pre-set to zero (0) at the time the account is opened. Each time an unauthorized transaction occurs, the unauthorized transaction count is incremented by one. Once the unauthorized transaction count reaches a pre-defined limit of, for example, one (1), although it can be pre-defined to be zero (0), the central processing computer 303 will cancel the transaction and de-activate the electronic cash account and/or the electronic cash account card. The central processing computer 303 will then notify the account owner. In this manner, the apparatus 300 will enable the central processing computer 303 of the institution to cancel and/or de-activate the account and/or the account card, either permanently or temporarily, in cases when the account owner can have failed to respond or to reply to transaction notices, which may be the case when the account owner is not aware that the account has been charged, overdrawn, and/or that the account card has been lost or stolen, cancelled or de-activated, duplicated, “cloned”, or in other ways utilized without the account owner's knowledge or authorization, or when the account owner is unable to respond or reply to the transaction notices for some other reason(s). This feature of the present invention serves to place a transaction stop limit on the electronic cash account and/or on the use of an associated account card.

If any of the above listed conditions exist (i.e. account overdrawn and/or account card is lost, stolen, cancelled and/or de-activated), the central processing computer 303 will, at step 335, transmit a signal to the electronic cash transaction device 302 indicating that the transaction is not approved and/or is not authorized. The electronic cash device operator or employee can then cancel the transaction at step 336. The employee or representative can then alert the authorities and/or confiscate the account card. In the case when an automated device is utilized as the electronic cash device 302, the device can confiscate the electronic cash card automatically. Upon the completion of step 336, the apparatus will cease operation at step 337.

If, at step 334, the central processing computer 303 determines that the account is not overdrawn or that the electronic cash card is not lost, stolen, cancelled or de-activated, or that the number of unauthorized transactions count (UNAUTHCT) has not reached a predefined limit, and/or that pre-defined or pre-specified limitations and/or restrictions have been met, the central processing computer 303 will, at step 338, transmit a signal and/or data to the communication device 304 which is located at the account owner.

At step 338, the central processing computer 303 will then also transmit respective signals and/or data to any one or more of the cardholder's designated fax machine 305, personal computer or personal digital assistant 306, telephone 307, telephone answering machine 308, alternate telephone 309, alternate telephone answering machine 310, network computer 311, and/or alternate beeper 312 or alternate pager 313.

The information and/or data transmitted to the communication device 304 includes information and data identifying the transaction and can include the name of the institution where the transaction is taking place, the name of the product or service provider seeking the electronic cash payment or transfer, the account number and/or description, the amount of the transaction, the time of the transaction and the location (i.e. city, town, village, state, country etc.) of the transaction. The information and/or data can also include the phone number of the central processing office and/or computer servicing, and/or the institution handling the account so that the account owner can telephone same in order to authorize or cancel the transaction. The information and/or data can also be supplemented to include a description of the type of transaction.

At step 339, the information and/or data which is transmitted from the central processing computer 303, and received at the communication device 304, is displayed to the account owner on the display device 304E of the communication device 304. The information displayed on the display device 304 can include the name of the institution, the name of the product or service provider seeking the electronic cash payment or transfer the amount of the transaction, the time of the transaction and the location of the transaction. The information and/or data can also include the type of transaction.

The apparatus 300, at step 340, will then wait for the account owner to respond to the transmission. During this time, the account owner can either utilize the reply or two-way pager feature on the communication device 304 in order to either approve, or authorize, the transaction or disapprove of, or void, the transaction. At step 340, the apparatus 300 will receive the reply or response from the account owner. At step 341, the central processing computer 303 will determine if the account owner has made a reply or response within the pre-defined time limit which is chosen, in the preferred embodiment, to be one (1) minute. The account owner can also transmit a signal via an appropriate key or button suspending use of the account or the account card, such as when he or she may first be apprised of the fact that the account is being accessed without authorization, or the use thereof is unauthorized, or that the account card has been lost or stolen.

In instances when the communication device 304 does not have a reply or two-way pager feature, the account owner can simply telephone the central processing office or processing center and/or the institution servicing the electronic cash account so as to personally reply or respond to the authorization request.

If, at step 341, it is determined that the account owner's reply or response was not made within the pre-specified time, chosen in the preferred embodiment to be one (1) minute, the central processing computer 303 will, at step 342, increment the unauthorized transaction count (UNAUTHCT) by one (1) and will, at step 343, transmit a signal and/or data to the electronic cash transaction device 302 indicating that the transaction is not authorized by the account owner. The electronic cash device operator can then, at step 344, either cancel the transaction, proceed to consummate the transaction, and/or attempt to obtain additional information or identification from the customer and/or obtain an alternate account number from which to draw against.

The action taken by the electronic cash transaction device operator can be dictated by the specific agreement in effect between the account owner and the institution which services the electronic cash account(s). Upon the completion of step 344, the operation of the apparatus will cease at step 345. If the account owner should reply or respond to the transaction notice at a later period, this information can then be utilized to approve of or to disapprove and/or to dispute the transaction.

If, at step 341, it is determined that the reply or response was timely, the central processing computer 303 will, at step 346, process and identify the account owner response. At step 347, the central processing computer 303 will determine if the account owner has authorized the transaction. If the account owner's response is to cancel, to disapprove, or to not authorize, the transaction, the central processing computer 303 will, at step 348, increment the unauthorized transaction count (UNAUTHCT) by 1. At this juncture, the unauthorized count (UNAUTHCT) is set to zero at the time of the opening of the account.

After the unauthorized transaction count has been incremented, the central processing computer 303 will, at step 349, transmit a signal and/or data to the electronic cash device 302 which will notify and/or instruct the electronic cash device operator that the transaction is not authorized and should, therefore, be cancelled or voided. The electronic cash device operator can then cancel the transaction at step 350. The electronic cash transaction device operator can then confiscate the account card and/or alert the authorities. In the case of an automated transaction device 302, the device can confiscate the card. Upon the completion of step 350, the apparatus will cease operation at step 357.

If, at step 347, the central processing computer 303 identifies the account owner's reply or response as being one to authorize the transaction, the central processing computer 303 will, at step 357, reset the unauthorized transaction count (UNAUTHCT) to zero (0). The central processing computer 303 will then, at step 353, transmit a signal and/or data to the electronic cash device 302 which will notify and/or instruct the electronic cash device operator, and/or the account card machine, that the transaction is authorized and/or approved. The electronic cash device operator, and/or the account card machine, can then complete the transaction, at step 354. After the transaction has been completed at step 354, the operation of the apparatus 300 will cease at step 355.

In another preferred embodiment, the central processing computer 303 can perform any and/or all of the functionality described as being performed by the electronic cash device 302 as described herein in conjunction with FIGS. 15A and 15B. In this manner, in another preferred embodiment of FIG. 13, the central processing computer 303 can transmit a notification signal, data, and/or information, to the communication device 304, to notify the account holder of a transaction on the electronic cash account. Thereafter, the account holder can transmit a response, to the notification signal, to the central processing computer 303. The central processing computer 303 can thereafter process the account holder's response. If the central processing computer 303 determines that the transaction is authorized or approved, the central processing computer 303 can consummate or complete the transaction. If the transaction is not authorized or not approved, the central processing computer 303 can cancel or terminate the transaction.

In any of the embodiments described herein, any of the communications which are transmitted, received, and/or which take place during apparatus operation, by and between any of the electronic cash devices 302, the central processing computers 303, and the communication devices 304, can take place in real-time and/or otherwise.

In instances when the account owner is a party to the transaction, which can be the case in an electronic cash transaction, the account owner, having the communication device 304 on his or her person, may authorize the transaction at the point or time of the transaction. If the transaction is an overnight or other remotely made transaction, such as in clearing and/or account settling transactions, the account owner can authorize the transaction from his or her remote location.

In another preferred embodiment of the apparatus of FIG. 13, the apparatus 300 can be programmed and/or can be programmable by the respective account holder, account owner, cardholder, and/or other authorized individual, (hereinafter referred to as “account holder” or “account owner”). The account holder or account owner can access the central processing computer 303 via the communication device 304, a telephone, and/or any other communication device.

The account holder or account owner can thereafter program the central processing computer 303 by transmitting a signal, data, and/or information, containing and/or corresponding to instructions for restricting and/or limiting activity and/or transactions which can occur and/or take place on, or in conjunction with, the respective account.

The signal, data and/or information, containing the restriction(s) and/or limitation(s) data and/or information is received by the receiver 303G. Thereafter, the CPU 303A will process the restriction(s) and/or limitation(s) data and/or information and store any appropriate data and/or information in the database 303H.

The above-described programming of restrictions and/or limitations into the central processing computer 303 can take place in real-time and/or otherwise.

The restrictions and/or limitations which can be programmed into the central processing computer 303 can include the types of transactions which are allowed and/or authorized, limitations on the amounts of transactions which can occur on an account, number of transactions which can occur on an account, authorized parties to use the account, authorized geographical area or location of usage, wherein authorized card use can be limited, and/or authorized times for account access and/or account usage (i.e. specific days, dates, time of day, time of month, year, etc.), and/or any other limitation and/or restriction regarding amount of transaction, parties involved, geographical area, and/or times of allowed usage.

The limitation or restriction can also include stopping payment on checks or drafts, stop payment orders, and/or any other limitation and/or restriction regarding any type of bank account, savings account, checking account, Automated Teller machine (ATM) account, and/or other financial account and/or account usage. The limitations and/or restrictions can also include any other limitation(s) and/or restriction(s) on account activity, amount of transactions, parties involved, geographical area, and/or times of allowed usage.

The limitations and/or restrictions can also include limitations on and/or regarding amounts of any one transaction or more transactions, individuals who may make the transactions, proof of identity of which the types of proof may be specified, specific banks, financial and/or brokerage institutions authorized to accept and/or perform transactions for the account, the nature of the transactions, geographical areas and/or location within which banks, financial and brokerage institutions which can be authorized to accept and/or perform transactions with the account, specific purchases and/or trades which can be made in conjunction with the account, specific securities which can be purchased and/or traded in conjunction with the account, specific times of day, specific days, dates and/or time of the month in, or on, which transactions can be authorized, limits of charge-backs, returned item amount withdrawals, maintenance and/or other fee charge withdrawals, etc. and/or authorized times for account usage (i.e. specific days, dates, times of day, times of month, year, etc.), and/or any other limitations and/or restrictions regarding amount of transaction, parties involved, securities involved, geographical area, and or times of allowed usage. Limitations and/or restrictions can also include limitations on deposits, types of deposits, wire transfers, etc.

With regards to any of the cards and/or accounts described herein, such as, for example, automated teller machine accounts and/or Internet accounts for servicing electronic money or digital money accounts, the account holder or account holder can also change, specify, or programmably change, passwords, personal identification numbers and/or any other access code(s) and provide for various personal identification numbers and/or access codes for different locations, different automated teller machines, Interment communication devices, different days, different times and/or different transaction amounts.

For example, the account holder, account owner, and/or cardholder, can program the central processing computer 303, and/or the server computer, if utilized, so as to limit account transactions by amounts (i.e. no withdrawals over $500.00, no aggregate daily withdrawals exceeding $1000.00, etc.), to limit transactions by times of usage (i.e. no account access and/or usage between 10:00 P.M. and 8:00 A.M.), to stop payment on a check or draft, to increase or decrease credit or overdraft limits, to limit a number of checks which can be cashed on an account, to establish and/or change credit limits on an account, periodically and/or at any desired time. Limitations and/or restrictions can also include any source or identification of a transaction requesting party and/or destination or location of a payment receiving party.

The account holder of account owner can program the central processing computer 303, and/or the server computer, if utilized, via the communication device 304, a telephone, and/or any other suitable communication device. The account holder or account owner can also perform the above-described programming via a touch-tone telephone. In the same manner, the account holder or account owner, can also program the apparatus 300 so as to limit the types of transactions involving his or her account.

Once programmed by the account holder or account owner, the central processing computer 303, upon receiving a transaction authorization request or a transaction processing request, will process the transaction in conjunction with the restriction(s) and/or limitation(s) provided, programmed, and/or dictated, by the account holder or account owner.

By utilizing the above-described programming routine(s), an account holder, account owner, cardholder, and/or other authorized individual, can program and/or update any data and/or information which can or may be stored in the database 303H. The above-described programming routine(s) can be performed in real-time and/or otherwise.

In another preferred embodiment, the account holder or account owner can program the respective banking device 302 and/or communication device 304, in the same manner in which the central processing computer 303 can be programmed, so as to program restrictions and/or limitations into the respective devices. The electronic cash device 302 can, in this manner, be directly programmable, by the account holder, or account owner, cardholder, and/or other authorized individual, in real-time and/or otherwise, in the same manner described above regarding the central processing computer 303, so as to automatically process a transaction in accordance with the restrictions or limitations provided by account holder, account owner, and/or cardholder.

The communication device 304 can also be directly programmable by the account holder or account owner, in real-time and/or otherwise, in the same manner described above regarding the central processing computer 303, so as to automatically process a transaction authorization request and/or a transaction.

In a similar manner, the account holder, account owner, cardholder, and/or other authorized individual, can program the apparatus 300 as described above in conjunction with the use of any of the herein-described electronic money accounts, digital money accounts, electronic cash accounts, digital cash accounts, electronic money savings and checking accounts, digital money savings and checking account, and/or any other electronic or digital money, cash, currency, coin or token accounts, described herein and/or otherwise.

The account owner can also program and/or set the communication device 304 so as to automatically authorize or disapprove or disallow transactions. In this regard, the communication device 304 can be programmable so as to receive and analyze the transaction information and/or data and reply or respond to same automatically and/or with preset or programmed replies and/or responses. The communication device 304 can also be programmable so as to limit the amounts of transactions. In this regard, the account owner can provide for temporary transaction types and/or amounts.

The communication device 304, in the preferred embodiment, is provided with a memory device for storing any number of transactions so that the account owner can review his or her account activity and/or transactions which have occurred involving his or her electronic cash accounts and/or corresponding account card. In this manner, the account owner can “scroll” through and/or in other ways review account activity. The communication device 304 can also be equipped to service more than one electronic cash accounts and/or account cards. For example, any number and/or types of electronic cash accounts can be serviced with or by a single communication device 304.

The central processing computer 303 can also be programmed to provide notification to the account owner upon the occurrence of any number of events and/or occurrences which take place regarding and/or relating to the respective account. The central computer 303 can provide notification to the account owner upon the receipt of an account owner's deposit, receipt of a stop payment order, a stop payment order being effected, wire transfer deposit, electronic transfer, withdrawal, wire transfer withdrawal, credit, debit, check presentment, check clearing, check cashing, account charge, account chargeback, the crediting of the payment to the respective account, the reaching of a pre-specified credit, charge, debit, and/or other respective limit on the respective account, a direct payment withdrawal, a direct deposit, a change in interest rate on the account, a change in a credit limit, and/or any other change and/or occurrence regarding and/or relating to the account which may be of interest to the respective account owner and/or any other transaction related to and/or involving the respective account.

The central processing computer 303 can also notify the account owner regarding a payment due date, an overdue status of a payment, an interest rate change, a credit limit change, an account restriction and/or limitation on usage, etc.

In this manner, the account owner can be notified of any of the above-described and/or any other event or occurrences. For example, the account owner can be notified when a deposit is received, when an electronic check has cleared, when a stop payment order has been effected, when a withdrawal is made, and/or when any other event or transaction of interest to the account owner occurs on and/or regarding the account.

Similarly, the account owner can be notified when he or she has reached and/or is close to reaching a pre-specified credit limit and/or upon the occurrence of administrative events or occurrences, i.e. payment due date, payment overdue, interest rate change, credit limit change, account restrictions, maintenance or service fee charges, returned checks occurrences and/or charges, etc.

In another preferred embodiment, the electron cash device 302 can be programmed to provide any of the functions described herein as being performed by the central processing computer 303, including, but not limited to, providing any of the notification functions for providing notification to the account owner of any of the above-described events and/or occurrences.

The apparatus and method of the present invention provides for the real-time notification of electronic cash and/or digital cash transactions involving various electronic cash and/or digital cash accounts and enables an account owner to monitor, in real-time, activity involving his or her accounts and/or account card(s) associated and/or corresponding therewith.

The apparatus and method of the present invention also provides a means and a mechanism by which to inform an account owner that his or her electronic cash electronic cash account is overdrawn, has been accessed and/or charged against and/or that his or her account card(s) are lost, stolen, cancelled or de-activated and/or provides an indication to the account owner of when and/or where his or her accounts are being accessed in transactions. The account owner may then report the unauthorized activity, and/or the discovery of a lost or stolen account card, and/or cancel and/or de-activate the respective account(s) and/or account card(s).

The central processing computer 303 and/or the electronic cash device 302 can also generate and transmit notification signals, e-mails, and/or other electronic and/or conventional message and/or transmission to notify the account holder when he or she is about to reach a pre-determined account balance, when he or she has reached a pre-determined account balance, has reached a pre-determined credit limit, has a check returned for insufficient funds, has deposited a check which has subsequently returned for insufficient funds, and/or to provide notification regarding a service charge, a payment due, a payment due date, a past due payment, and/or to provide notification regarding any other event, occurrence, and/or account activity which can be related to the account and/or which may be of interest to a electronic cash account holder and/or an individual or entity authorized to receive notification for, and/or on behalf of, the account holder.

In another alternate embodiments of the present invention, the apparatus and method of the present invention can be utilized in conjunction with wireless communication devices and/or wireless telephones.

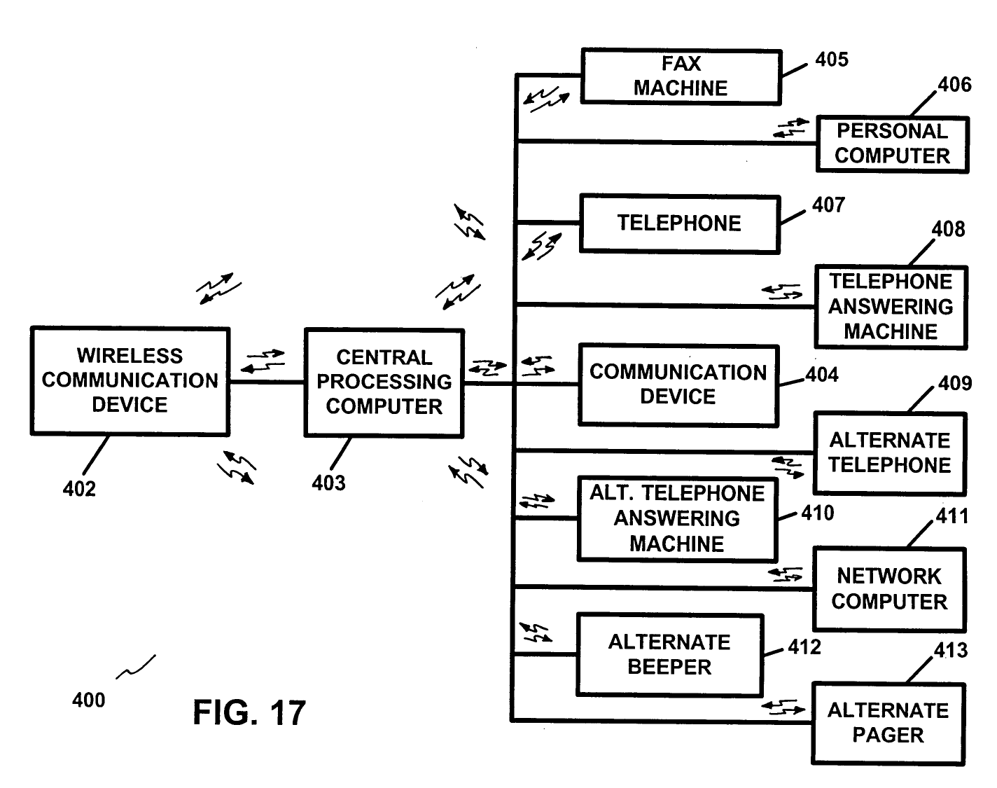

FIG. 17 illustrates a block diagram of another preferred embodiment of the apparatus of the present invention which is utilized in conjunction with wireless telephones, cellular telephones, wireless analog telephones, wireless digital telephones, Personal Communication Services (PCS) telephones, global standard for mobile (GSM) telephones, mobile telephones, wireless access protocol (WAP) telephones, broadband telephones, broadband mobile telephones, broadband wireless telephones, Bluetooth telephones, broadband wireless telephones, wireless internet telephones, wireless communication devices, cellular communication devices, wireless analog communication devices, wireless digital communication devices, Personal Communication Services (PCS) communication devices, global standard for mobile (GSM) communication devices, wireless access protocol (WAP) communication devices, broadband communication devices, broadband mobile communication devices, broadband wireless communication devices, Bluetooth communication devices, broadband wireless communication devices, wireless internet communication devices, mobile communication devices, and/or any other type of wireless telephones and/or communication devices (hereinafter, for simplicity, collectively referred to as “wireless communication device”.

The term “communication device” or the plural of same can include, but are not limited to, telephones, facsimile (fax) machines, personal digital assistants, hand-held devices, Palm top devices such as Palm Pilot® devices, computers, personal computers, laptop computers, mini-computers, mainframe computers, watches, electronic wallets and/or electronic purses, and/or any other device which can be utilized on or over a wireless, cellular, mobile, PCS, GSM, and/or other communication network and/or system. The present invention can be utilized in conjunction with the respective wireless communication device and/or the communication account associated with the wireless communication device.

The apparatus of FIG. 17 is denoted generally by the reference numeral 400. In FIG. 17, the apparatus 400 includes of a wireless communication device 402 which can be any wireless communication device described herein.

In the embodiment of FIG. 17, the wireless communication device 402 serves as the transaction device which is described in the above described embodiments. The wireless communication device 402 can transmit an authorization request and/or a transaction notification signal, which can include data and/or information pertaining to the communication transaction and/or event, to a central processing computer and/or to an account holder communication device and/or another communication device associated with the communication account holder, and/or an individual authorized to act for, and/or on behalf of the account holder. The wireless communication device 402 can also receive authorization data and/or information from the central processing computer and/or from the communication device associated with the communication account holder. The wireless communication device 402 can also include, or have associated therewith, a keypad for the manual entry of transaction information and/or data, such as the telephone number, as well as various command codes utilized in making or placing a communication, transmission, and/or a telephone call.

The apparatus 400 also includes a central processing computer 403 which services any predefined group of wireless communication devices and/or communication accounts. For example, the central processing computer 403 can handle wireless communication and/or wireless telephone accounts and/or devices for a given utility, telecommunications service provider and/or company and/or for any communication network, area and/or region. The central processing computer 403, for example, can process and maintain records of wireless communication device communications, transactions, telephone calls, including billing information, account activity, usage records, times of usage, usage time, total usage time, usage costs, total usage costs, telephone numbers called, incoming calls telephone numbers, etc., for any number of wireless communication devices which are serviced by a particular communications company or central processing office or computer.

The central processing computer 403 can be a mainframe computer, a mini-computer, a micro-computer, a server computer, such as those utilized in conjunction with on-line services and/or in a network environment, and/or any other suitable computer or computer system.

The central processing computer 403 can also process accounts for any of the wireless communication devices and/or wireless communication accounts described herein. In the preferred embodiment, the wireless communication device 402 is linked and/or connected to the central processing computer 403 via a telecommunications network, system, link and/or medium (hereinafter referred to as “communications network” or “communication system”) such as, for example, a telephone network or line, a wireless network or link, the Internet, the World Wide Web, and/or any other suitable network.

The communications network or system which is utilized can be any communications network or system and can include telecommunication systems, satellite communications systems, radio communication systems, digital communications systems, digital satellite communications systems, personal communications services communication systems, cable television systems, digital television systems, satellite television systems, broadband communication systems, as well as any other appropriate communications system. The wireless communication device 402 transmits signals and/or data to the central processing computer 403 as well as receives signals and/or data from the central processing computer 403.

The apparatus 400 also includes a communication account holder communication device 404 which can receive signals and/or data from as well as transmit signals and/or data from, the wireless communication device 402.

In another preferred embodiment of FIG. 17, the communication device 404 receives signals and data directly from the wireless communication device 402 with said signals being transmitted via a suitable communication system. In this preferred embodiment, the communication device 404 can also transmit signals and data to the wireless communication device 402, directly and/or indirectly, with said signals being transmitted via a suitable communication system. In another preferred embodiment of FIG. 17, the communication device 404 can receive signals and data from the central processing computer 403, directly and/or indirectly, with said signals being transmitted via a suitable communication system. In this preferred embodiment, the communication device 404 can also transmit signals and data to the central processing computer 403, directly and/or indirectly, with said signals being transmitted via a suitable communication system.

The communication device 404 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch. The communication account holder communication device 404 can also receive signals and/or data from as well as transmit signals and/or data from the central processing computer 403. In the embodiment of FIG. 17, the communications network or system utilized for transmitting signals and/or data to and/or from any of the communication devices 402 and 404 and the central processing computer(s) 403 is a communication network which can include a wireless network or link.

In the preferred embodiment, the communication device 404 is also equipped with a transmitter for transmitting signals and/or data to the central processing computer 403. In this regard, the central processing computer 403 transmits signals and/or data to the communication device 404 as well as receives signals and/or data from the communication device 404. The communication device 404 can also transmit signals and/or data directly to the wireless communication device 402 and receive signals and/or data directly from the wireless communication device 402.

As noted above, the communication device 404 can be a wireless device. In any of the embodiments described herein, any of the account holder's communication devices can be carried by the account holder and/or the individual authorized to act for and/or on behalf of the account holder.

In the alternate embodiment of FIG. 17, the apparatus 400 also includes a facsimile (fax) machine 405, a personal computer or personal digital assistant 406, a telephone 402, a telephone answering machine 408, an alternate telephone 409, an alternate telephone answering machine 410, a network computer 411, an alternate beeper 412, and an alternate pager 413.

The wireless communication device 402 and the central processing computer 403 can be linked with the above fax machine 405, personal computer or personal digital assistant 406, telephone 407 and associated answering machine 408, alternate telephone 409 and associated answering machine 410, network computer 411, alternate beeper 412 and/or alternate pager 413, via any suitable communication system. In the preferred embodiment, a telecommunications link or telephone line or link, which may or may not be a wireless link depending on the device and/or the circumstances, is utilized in order to link the central processing computer 403 with each of the fax machine 405, the personal computer or personal digital assistant 406, the telephone 407 and associated answering machine 408, the alternate telephone 409 and associated answering machine 410, the network computer 411, the alternate beeper 412, and/or the alternate pager 413.

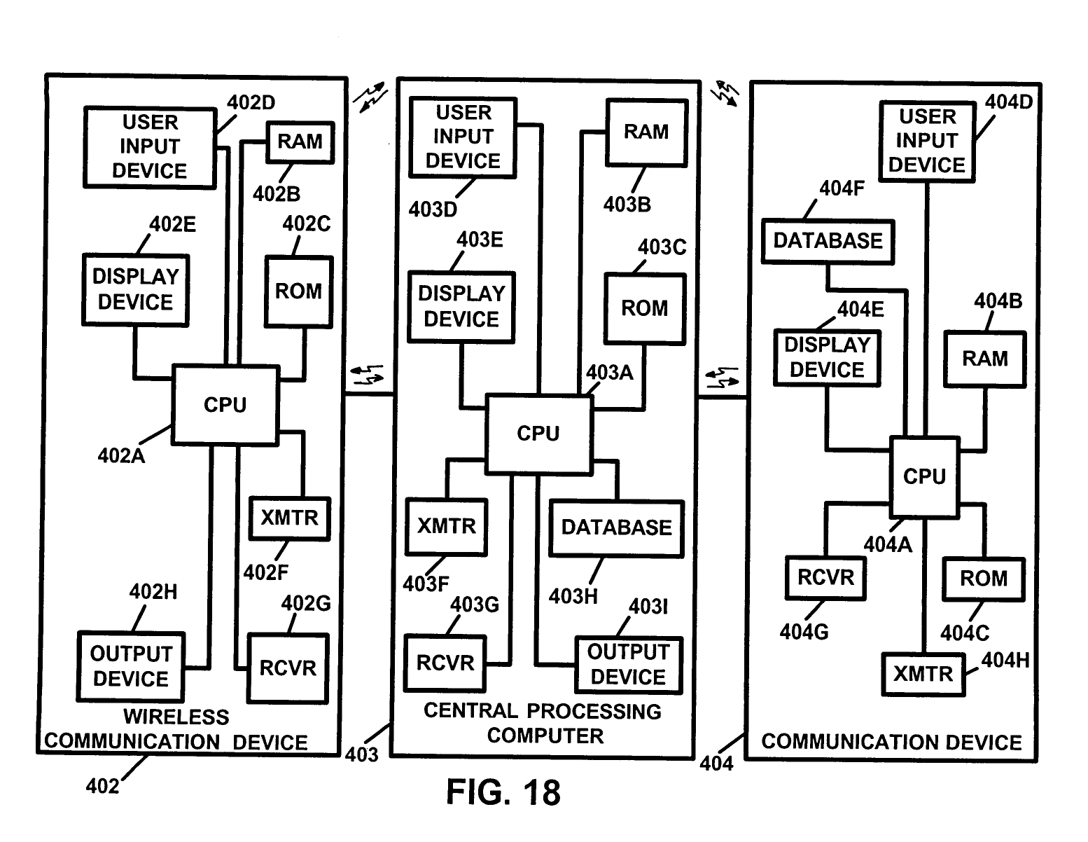

FIG. 18 illustrates the various components of the apparatus 400 of FIG. 17. In FIG. 18, the wireless communication device 402, in the preferred embodiment, includes a central processing unit or CPU 402A, associated random access memory 402B (RAM) and read only memory 402C (ROM) devices, which are also connected to the CPU 402A, a user input device 402D, which is a typically a keypad or other suitable input device for inputting data into the wireless communication device 402 and which is also connected to the CPU 402A, and a display device 402E for displaying information and/or data to a user or operator of the wireless communication device 402.

The wireless communication device 402 also includes a transmitter 402F for transmitting signals during normal communication operation and for transmitting signals and/or data to the central processing computer 403, and/or to the account holder communication device 404 and/or to any other device associated with the account owner or apparatus 400, if desired. The transmitter 402F is also connected to the CPU 402A. The wireless communication device 402 also includes a receiver 402G for receiving signals during normal telephone operation and/or for receiving signals and/or data from the central processing computer 403 and from the communication device 404 and/or from any other associated device which can be utilized, if desired.

The receiver 402G is also connected to the CPU 402A. The wireless communication device 402 can also include a printer 402H or other appropriate output device for outputting data to the user. The printer 402H, if utilized, is also connected to the CPU 402A. In the preferred embodiment, the printer 402H prints receipts corresponding to the transaction and/or information transmitted during the communication or telephone call or transaction.

The wireless communication device also includes a database 402I. The database 402I can include data and/or information regarding the wireless communication device, the account holder, the wireless communication account, restrictions and/or limitations on account usage and/or wireless communication device account usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of wireless communication devices. The wireless communication device 402 can also be programmable so that any of the restrictions and/or limitations described herein can be programmed into the wireless communication device 402.

The wireless communication device 402 can also includes a scanner or reader device 402J which is connected to the CPU 402A and which can be utilized to scan or read data and/or information from a respective account card and/or magnetic strip or “smart” chip located thereon or therein.

In FIG. 18, the central processing computer 403, in the preferred embodiment, includes a central processing unit or CPU 403A, associated random access memory 403B (RAM) and read only memory 403C (ROM) devices, which are connected to the CPU 403A, a user input device 403D, which is a keypad or any other suitable input device for inputting data into the central processing computer 403 and which is also connected to the CPU 403A and a display device 403E for displaying information and/or data to a user or operator.

The user input device 403D can include any data input device including, but not limited to, a keyboard, a mouse, a scanner, a reader or card reader, an audio input device, a voice recognition device, a fingerprint reading device, a retinal scanning device, and/or any other device for inputting data and/or information into the central processing computer 403.

The central processing computer 403 also includes a transmitter(s) 403F for transmitting signals and/or data to the wireless communication device 402 and to the communication device 404, and/or to any other device which can be utilized, and/or to any one or more of the fax machine 405, personal computer or personal computer or personal digital assistant 406, telephone 407 and associated answering machine 408, alternate telephone 409 and associated answering machine 410, network computer 411, alternate beeper 412, and/or alternate pager 413. The transmitter(s) 403F is also connected to the CPU 403A.

The central processing computer 403 also includes a receiver(s) 403G for receiving signals and/or data from the wireless communication device 402 and from the communication device 404, and/or from any other suitable device which can be utilized in conjunction with the apparatus 400. The receiver(s) 403G is also connected to the CPU 403A.

The central processing computer 403 also includes a database(s) 403H which contains account information and data pertaining to the wireless communication account, device, and/or account holder. The database 403H contains information about the wireless communication device, account, and account holder, information and/or data necessary to the manage and/or process an account and/or account transaction as described herein, as well as restrictions and/or limitations on account usage and/or wireless communication device account usage, for any of the accounts processed and/or managed via the central processing computer 403, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of wireless communication devices. The central processing computer 403 can also be programmable so that any of the restrictions and/or limitations described herein can be programmed into the central processing computer 403. The database 403H is also connected to the CPU 403A.

The database 403H can include any number of databases which may or may not be linked to one another. The database 403H can also be linked to a database or databases which are located external from the central processing computer 403.

The database 403H can also include data and/or information regarding specific limitations and/or restrictions which can be placed on a particular account, which can be pre-selected and/or programmed by the account holder and which can include limitations and/or restrictions on the usage of the wireless communication device.

The limitations and/or restrictions can include the types of transactions or communications which are allowed and/or authorized, limits on the amounts of transactions or communications which can occur with the wireless communication devices, number of transactions or communications which can occur with the wireless communication devices, authorized parties to use the wireless communication devices, authorized geographical area or location of usage, wherein authorized communication device use can be limited, and/or authorized times for account access and/or account usage (i.e. specific days, dates, time of day, time of month, year, etc.), and/or any other limitation and/or restriction regarding amount of transaction or communication, parties involved, geographical area, and/or times of allowed usage.

The central processing computer 403 also includes a printer 403I or other appropriate output device for outputting information and/or data to a user or operator.

In FIG. 18, the account holder communication device 404, in the preferred embodiment, includes a central processing unit or CPU 404A, associated random access memory 404B (RAM) and read only memory 404C (ROM) devices, which also connected to the CPU 404A, a user input device 404D, which is a keypad or a plurality of keys and/or switches for inputting data into the communication device 404 and which is also connected to the CPU 404A, and a display device 404E, for displaying information and/or data to the wireless communication device account holder, and a database 404F, which are also connected to the CPU 404A.

The user input device 404D can include any data input device including, but not limited to, a keyboard, a mouse, a scanner, a reader or card reader, an audio input device, a voice recognition device, a fingerprint reading device, a retinal scanning device, and/or any other device for inputting data and/or information into the account holder communication device 404.

The database 404F can include data and/or information regarding the wireless communication device, the account holder, the wireless communication account, restrictions and/or limitations on account usage and/or wireless communication device account usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of wireless communication devices. The communication device 404 can also be programmable so that any of the restrictions and/or limitations described herein can be programmed into the wireless communication device 404. The communication device 404 can be programmed to process any transaction described herein.

The communication device 404 also includes a receiver 404G for receiving signals and/or data from the central processing computer 403 and for receiving signals and/or data from the wireless communication device 402. The receiver 404G is also connected to the CPU 404A. The communication device 404 also includes a transmitter 404H for transmitting signals and/or data to the central processing computer 403 and for transmitting signals and/or data to the wireless communication device 402. The transmitter 404H is also connected to the CPU 404A.

The wireless communication device 402 can also include a scanner and/or reader device 402I, such as a card reader, a magnetic strip card reader, and/or any other reading or scanning device for obtaining information from an account card associated with a wireless communication account. The scanner or reader device 402I can, in the preferred embodiment, be capable of reading and processing data and/or information, which is stored on the magnetic strips and/or on the processors or chips which are located on the respective account card, and for providing one or multiple communications for one or multiple parties as well as reading and processing any restriction and/or limitation information regarding and/or related to account usage. For example, the magnetic card reader or card reader 402I can read and/or process data and/or information for identifying and communicating with a central transaction processing computer 403 as well as can read and/or process data and/or information for communicating with the individual account holder and/or an individual or agent authorized to act for and/or on behalf of the individual account holder, at any one or more of the communication devices 404 associated with the individual account holder or the individual or agent associated with the individual account holder.

Data and/or information for providing any other the communications described herein can be obtained from the data and/or information contained in the magnetic strip on the card, the respective processor or chip located on the card, and/or can be obtained form an external database (not shown) which can be linked to the wireless communication device 402 and/or which can be accessed thereby for obtaining any additional data and/or information.

In the preferred embodiment, the communication device 404 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch. A two-way pager and/or pager systems can also be utilized for implementing the respective components, and/or systems in the communication device 404/central processing computer 403 combination and/or link.

The apparatus 400 of the present invention, in the preferred embodiment, can be utilized in order provide a wireless communication device owner and/or account holder with authorization, notification and/or security measures in transactions involving any of the wireless communication devices described herein, and/or any transaction involving and/or related to same as described herein.

The apparatus and method of the present invention can be utilized to obtain wireless communication device owner and/or account holder authorization in a transaction involving wireless communication devices.

The apparatus 400 can also be utilized in conjunction with an account card or cards which correspond to, and/or which are associated with wireless communication devices and/or the accounts corresponding thereto.

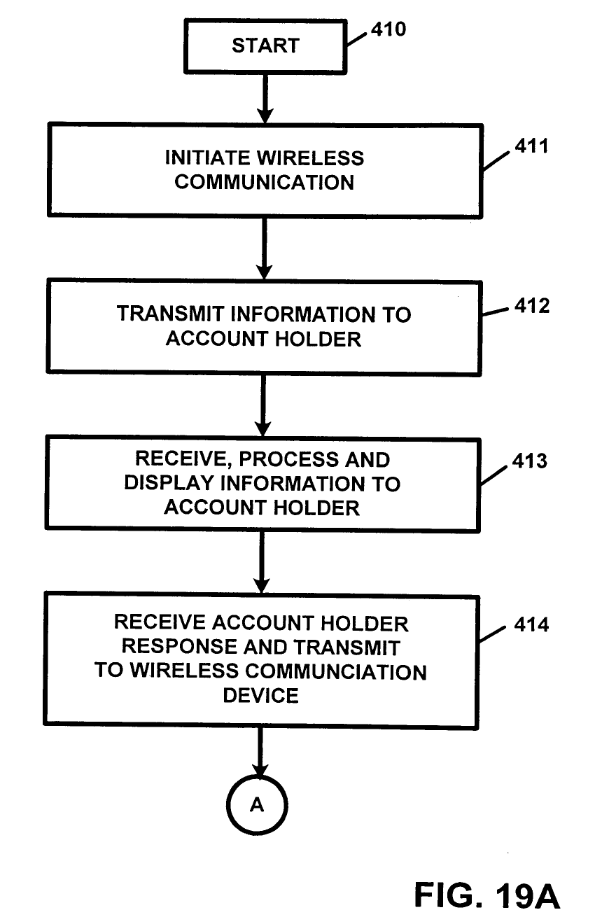

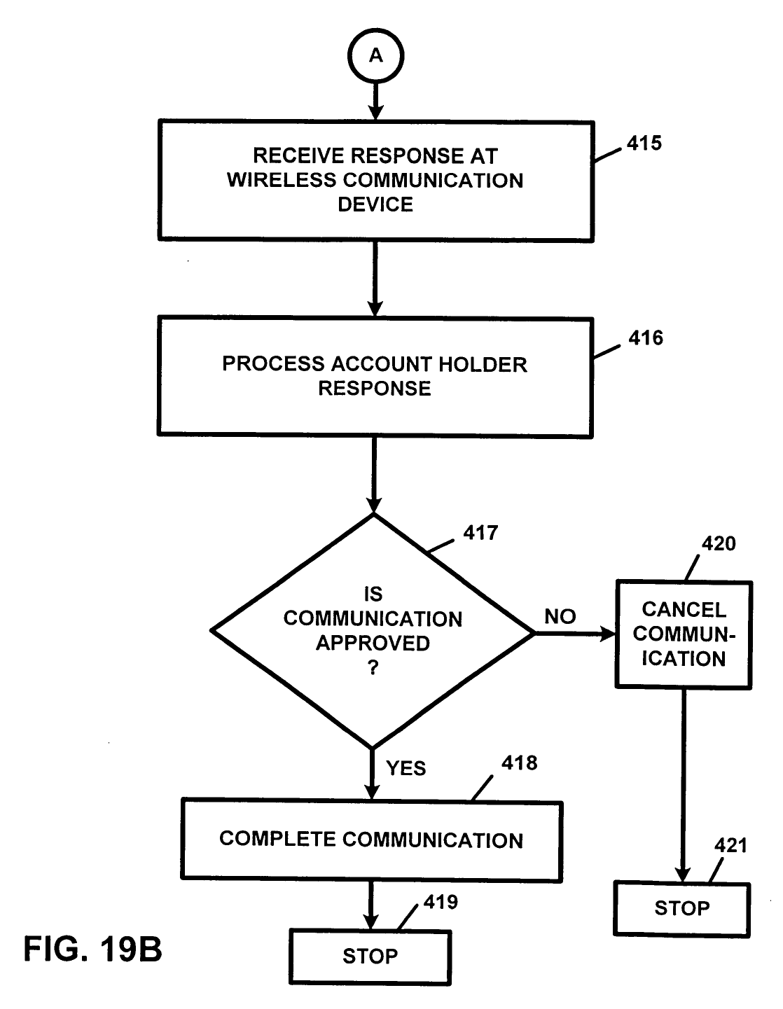

FIGS. 19A and 19B illustrate a preferred embodiment operation of the apparatus 400, in flow diagram form. With reference to FIGS. 19A and 19B, the operation of the apparatus 400 commences at step 410. At step 411, the owner, user, or operator, of the wireless communication device initiates the wireless communication, transmission, telephone call, and/or transaction, via the wireless communication device. The communication or transaction can be initiated by dialing a desired phone number, by swiping an appropriate account card, and/or via any other suitable practice. Thereafter, the wireless communication or transaction can either take place, while the remainder of the routine proceeds as described hereinbelow, or the wireless communication or transaction can be halted until authorized by the account holder as described herein.

In any of the embodiments described herein, the wireless communication or transaction can involve any one or more of a voice transmission, a data transmission, a telephone call, facsimile transmission, Internet or World Wide Web transmission, and/or any other transmission involving communication devices.

Data entry prior to, and/or during communication or transaction initiation can typically be performed by entering information via the data input device 402D, such as keyboard or mouse, or by swiping the magnetic strip of the account card through the scanner/reader 402J or by reading information from the processor or chip on the account card via the scanner/reader 402J. The data obtained from the magnetic strip and/or the card processor or chip, and/or from any associated database, can be utilized to contact the account holder communication device 404 and/or the account holder directly and/or to process the communication or transaction.

In another preferred embodiment, the wireless communication device 402 can process the communication or transaction in conjunction with any restrictions and/or limitations on account usage. The restrictions and/or limitations on account usage can be obtained via the data input device 402D, a respective account card, and/or which can be stored in the database 402J.

If the wireless communication device 402 determines that the communication or transaction violates and/or otherwise does not conform to a restriction and/or limitation on account usage, the wireless communication device 402 can cancel and/or reject the communication or transaction without proceeding further. For example, the wireless communication device 402, upon reading a restriction involving a time of use (i.e. no account usage allowed between 12:00 A.M. and 6:00 A.M.), a location of usage (i.e. no usage outside a particular city, state, or country), or a transaction amount limitation (i.e. no account usage for transactions exceeding $100), can process the communication or transaction and determine if the communication or transaction would violate a particular restriction or limitation.

If the communication or transaction would violate a restriction or limitation, the wireless communication device 402 can cancel the communication or transaction or prevent the communication or transaction, whichever the case may be, and no further processing would be required. If the communication or transaction would not violate a restriction and/or limitation, the communication or transaction processing could continue in any appropriate manner described herein and/or otherwise.

The information and/or data pertinent to the communication or transaction, and/or the account, is then transmitted, at step 412, to the communication device 404 via the communication network. In any of the embodiments described herein, any information and/or data which is transmitted from the wireless communication device 402 to the communication device 404 can be transmitted directly to the communication device 404 via the communication network.

The information and/or data which is transmitted from the wireless communication device 402 to the communication device 404 can also be transmitted indirectly to the communication device 404, via the communication network, and independently of any communication or transaction processing by a central transaction processing computer and/or central transaction processing system. The transmission of the information and/or pertinent data, which takes place at step 412, is a transmission from the wireless communication device 402 to the communication device 404 via the communication network and takes place independently of any processing of the communication or transaction by a central processing computer or central processing service, such as by the central processing computer 403 and/or otherwise. In this manner, the present invention provides notification to the account holder of the communication or transaction independently of any communication or transaction processing by a central processing computer and/or a central processing service. In this manner, the communication or transaction can also take place independently of any processing by the apparatus 400.

At step 412, the wireless communication device 402, by utilizing account holder contact information obtained from the account card, the database 402H, and/or otherwise, can also transmit respective signals and/or data to any one or more of the account holder's designated fax machine 405, personal computer or personal digital assistant 406, telephone 407, telephone answering machine 408, alternate telephone 409, alternate telephone answering machine 410, network computer 411, and/or alternate beeper 412 or alternate pager 413.

The information and/or data which is transmitted to the communication device 404 can include information and/or data identifying the communication or transaction, telephone number, and/or destination identification, time of transmission, location of communication or transaction origination, telephone number called, communication or transaction destination, parties involved, projected cost of communication or transaction, time of communication or transaction, name of the wireless services carrier, etc.

The information and/or data can also include the phone number of the entity and/or a central processing office and/or computer servicing the account so that the account holder can telephone same in order to authorize or cancel the communication or transaction.

The communication device 404 will, at step 413, receive and process the information and/or data pertinent to the communication or transaction and provide the information to the account holder. At step 403, the information and/or data which is transmitted from the wireless communication device 402 and received at the communication device 404 can is displayed to the account holder on the display device 404E of the communication device 404.

The information displayed on the display device 404E can include the data identifying the communication or transaction, telephone number and/or destination identification, time of transmission, location of communication or transaction origination, telephone number called, communication or transaction destination, parties involved, projected cost of communication or transaction, time of communication or transaction, name of the wireless services carrier, and/or any other information described herein as being pertinent to and/or related to the wireless communication device, account, and/or the wireless communication, etc. The information and/or data can also include the phone number of the entity and/or a central processing office and/or computer servicing the account so that the account holder can telephone same in order to authorize or cancel the communication or transaction.

The communication device 404 can utilize any of the widely known data processing and/or software routines, which are known to those skilled in that art, in order to process communication or transaction requests and/or authorizations involving the use of the respective account(s).

Thereafter, the account holder can, at step 414, enter a response either approving or disapproving the communication or transaction. At step 414, the account holder's response is also transmitted, via the transmitter 404H of the communication device 404, to the wireless communication device 402. In any of the embodiments described herein, any information and/or data which is transmitted from the communication device 404 to the wireless communication device 402 can be transmitted directly to the wireless communication device 402 and/or indirectly to the wireless communication device 402 via the communication network.

The information and/or data which is transmitted from the communication device 404 to the wireless communication device 402 can also be transmitted indirectly to the communication device 404, via the communication network, and independently of any communication or transaction processing by a central transaction processing computer and/or central transaction processing system. In another embodiment, the information and/or data which is transmitted from the communication device 404 to the wireless communication device 402 can also be transmitted indirectly to the wireless communication device 404, via the central processing computer 403 or other processing computer or device.

At step 415, the receiver 402H of the wireless communication device 402 will receive the account holder's response. At step 416, the wireless communication device 402 will process the account holder's response. At step 417, the wireless communication device 402 will determine whether the communication or transaction is approved or authorized. If, at step 417, it is determined that the communication or transaction is approved or authorized the wireless communication device 402 will authorize, allow, and/or connect or complete, the respective communication or transaction at step 418. Thereafter, operation of the apparatus 400 will cease at step 419.

If, however, at step 417, it is determined that the communication or transaction is disapproved or unauthorized, the communication device 402 will disconnect or cancel the respective communication or transaction, at step 420. Thereafter, the operation of the apparatus 400 will cease at step 421.

The apparatus 400 can be utilized and/or can be programmed so that the account holder can or must approve the communication or transaction prior to the communication or transaction being made, effected, and/or transacted. The apparatus 400 can also be utilized and/or programmed so that the account holder can or must approve the communication or transaction subsequent to the communication or transaction being made, effected, the communication link established, and/or transacted. In the case when the account holder disapproves of the communication or transaction after the communication or transaction or call has been made, effected, communication or transaction established, and/or transacted, the wireless communication device 402 will terminate and/or cancel the communication or transaction.

In the embodiment described above, as well as in any of the embodiments described herein, the wireless communication device 402 can be programmed to wait a pre-specified amount of time for the account holder's response. The wireless communication device 402, can also be programmed to cancel the communication or transaction or complete the communication or transaction if no response is received.

Any of the particular instructions for the particular account can be included in the data and/or information which is stored in the respective databases of the wireless communication device 402, central processing computer 403, and/or the communication device 404, and/or which can be stored on the magnetic strip and/or otherwise stored on the respective account card. In this manner, the wireless communication device 402 can utilize transaction instructions which are stored in the respective databases and/or on the respective account card and utilize this data and/or information in performing processing routines regarding the communication. In this manner, the present invention can be utilized in order to provide custom tailoring of communication or transaction processing regarding a particular wireless communication device account which information can be pre-specified and stored in the respective databases of the respective wireless communication devices, central processing computer(s) and/or communication devices and/or on the respective account cards.

In instances when the communication device 404 does not have a reply or two-way pager feature, the account holder can simply telephone the wireless communication device 402, or center or office servicing, and/or associated with, same, in order to personally appraise the device 402, or center or office, of his or her response to the communication or transaction.

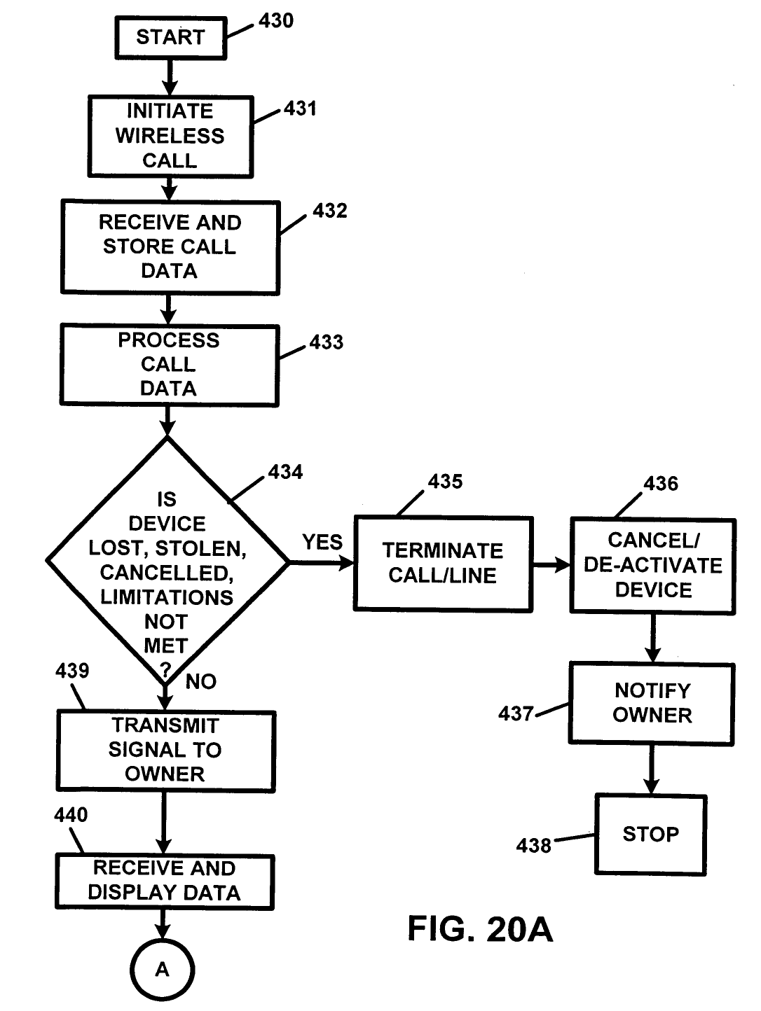

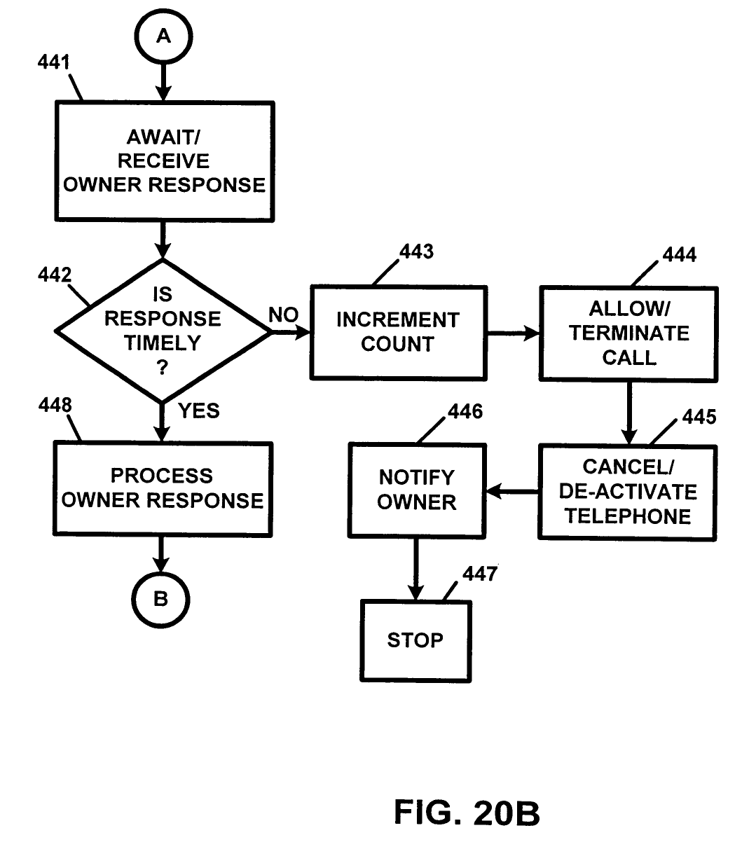

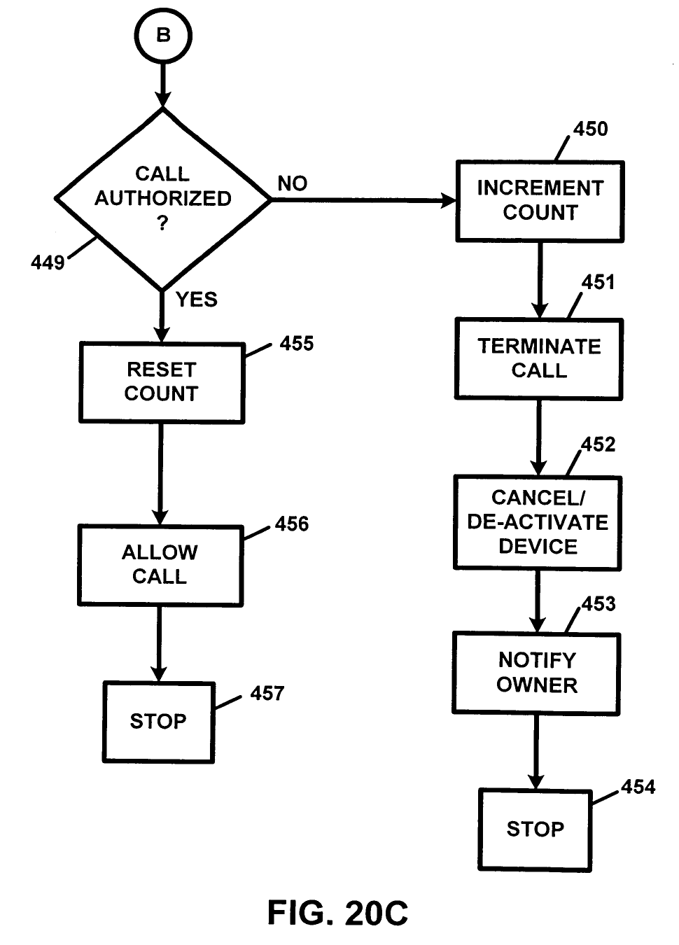

FIGS. 20A, 20B and 20C illustrate another preferred embodiment operation of the apparatus 400 of FIG. 17, in flow diagram form. In the preferred embodiment of FIGS. 20A, 20B and 20C, the apparatus 400 can be utilized in conjunction with a central transaction processing computer or service. With reference to FIGS. 20A, 20B and 20C, the operation of the apparatus 400 commences at step 430 when the wireless communication device 402 is utilized to make a wireless communication or telephone call or communication and/or transaction.

The wireless communication device 402 will activate the apparatus 400, at step 431, with the initiation of the wireless communication device call, and/or in any other typical manner, such as when a wireless communication device is utilized to gain access to the telephone network so that the calling connection can be established via the wireless communications network and/or the cell site. Upon the making of the wireless communication device communication or call, at step 431, the wireless communication device 402 will transmit data and/or information, which identifies the calling communication device or telephone, to the central processing computer which services the particular wireless communication device or wireless communication device network, so that appropriate billing and/or accounting of telephone usage can be noted and/or processed.

In the preferred embodiment, the central processing computer for the particular wireless communication device and/or wireless communication device network is the central processing computer 403. At step 434, the central processing computer will receive and store the data and/or information which is transmitted by the wireless communication device 402. At step 433, the central processing computer 403 will process the data and/or information which is received from the wireless communication device 402.

The central processing computer 403 can utilize any of the widely known data processing and/or software routines, which are known to those skilled in that art, in order to process communication or transaction requests and/or authorizations involving the use of the respective wireless communication device(s) and/or wireless communication device, and/or wireless communication device number. At step 434, the central processing computer 403 will perform a test in order to determine if the wireless communication device is lost, stolen, cancelled or de-activated. If the wireless communication device is determined to be lost, stolen, cancelled or de-activated, the central processing computer 403 will, at step 435, block the communication or telephone call or terminate the call if it has already been connected. The central processing computer 403 will then, at step 436, cancel and/or de-activate the wireless communication device number or account. The central processing computer 403 will then, at step 437, notify the wireless communication device owner that his or her wireless communication device has been cancelled and/or de-activated. The operation of the apparatus will then cease at step 438.

If, at step 434, the central processing computer 403 determines that the wireless communication device is not lost, stolen, cancelled or de-activated, the central processing computer 403 will, at step 439, transmit a signal and/or data to the communication device 402 which is located at the wireless communication device owner. At step 440, the communication device 404 will receive and display the data and/or information which is transmitted from the central processing computer 403. The displayed information, in the preferred embodiment, will include the number called, the time of the call, the destination of the call and the duration of the call, in real-time. The information will remain displayed during the duration of the call so that the wireless communication device owner will be notified continuously throughout the duration of the call.

At step 441, the central processing computer 403 will await the wireless communication device owner's reply or response. If the wireless communication device owner replies or responds, the reply or response data will also be transmitted to, and received by, the central processing computer 403 at step 441. At step 442, the central processing computer 403 will then determine if the wireless communication device owner's response was made within a pre-defined time period, which is chosen, in the preferred embodiment, to be one (1) minute. If at step 442, it is determined that the wireless communication device owner did not reply or respond within the pre-defined time limit, the central processing computer will, at step 443, increment the unauthorized transaction count (UNAUTHCT) by one (1).

The central processing computer 403 will then, depending upon pre-defined instructions of the wireless communication device owner, at step 444, either allow the communication or telephone call to continue, such as for a pre-defined duration of one (1) minute, so as to allow for cases wherein an emergency condition exists, or terminate the communication or telephone call immediately. The decision to either allow the communication or telephone call to continue or to terminate the communication or telephone call can be made by the wireless communication device owner and/or by the wireless communication device service provider. Upon the completion of step 444, the central processing computer 403 will then, at step 445, cancel and/or de-activate the wireless communication device and/or account. Thereafter, the central processing computer 403 will, at step 446, notify the wireless communication device owner that the wireless communication device number or account has been cancelled and/or de-activated. Upon completion of step 446, the apparatus will cease operation at step 447.

If, at step 444, the wireless communication device owner did respond in time, the central processing computer 403 will process the reply or response data and/or information, at step 448. The central processing computer 403 will then determine, at step 449, if the wireless communication device call is authorized by the wireless communication device owner. If, at step 449, the wireless communication device call is unauthorized, the central processing computer will, at step 450, increment the unauthorized transaction count (UNAUTHCT) by one (1). The central processing computer 403 will then, at step 451, terminate the communication or telephone call immediately. Upon the completion of step 451, the central processing computer 403 will then, at step 454, cancel and/or de-activate the wireless communication device. Thereafter, the central processing computer 403 will, at step 453, notify the wireless communication device owner that the wireless communication device has been cancelled and/or de-activated. Upon completion of step 453, the apparatus will cease operation at step 454.

If, at step 449, the central processing computer 403 identifies the account holder reply or response as being one to authorize the wireless communication device call, the central processing computer 403 will, at step 455, reset the unauthorized transaction count (UNAUTHCT) to zero (0). An unauthorized transaction count (UNAUTHCT) of 0 will signify that any string of unauthorized transactions has now been broken by the wireless communication device owner. The central processing computer 403 will then, at step 456, allow the wireless communication device call to continue uninterrupted. Upon the completion of the wireless communication device call, at step 456, the apparatus 400 will cease operation at step 457.

In another preferred embodiment, the central processing computer 403 can perform any and/or all of the functionality described as being performed by the wireless communication device 402 as described herein in conjunction with FIGS. 19A and 19B. In this manner, in another preferred embodiment of FIG. 17, the central processing computer 403 can transmit a notification signal, data, and/or information, to the communication device 404, to notify the account holder of a communication or transaction on the wireless communication account. Thereafter, the account holder can transmit a response, to the notification signal, to the central processing computer 403. The central processing computer 403 can thereafter process the account holder's response. If the central processing computer 403 determines that the communication or transaction is authorized or approved, the central processing computer 403 can connect, complete, or consummate, the respective communication or transaction. If the communication or transaction is not authorized or not approved, the central processing computer 403 can disconnect, cancel, or terminate, the respective wireless communication or transaction.

The apparatus 400 can be utilized and/or can be programmed so that the account holder can or must approve the communication prior to the communication being made, effected, and/or transacted. The apparatus 400 can also be utilized and/or programmed so that the account holder can or must approve the communication subsequent to the communication being made, effected, the communication link established, and/or transacted. In the case when the account holder disapproves of the communication after the communication or call has been made, effected, communication established, and/or transacted, the wireless communication device 402 will terminate and/or cancel the communication.

In any of the embodiments described herein, any of the communications which are transmitted, received, and/or which take place during apparatus operation, by and between any of the wireless communication devices 402, the central processing computers 403, and the communication devices 404, can take place in real-time and/or otherwise.

In any of the embodiments described herein, any of the communications which are transmitted, received, and/or which take place during apparatus operation, by and between any of the wireless communication devices 402, the central processing computers 403, and the communication devices 404, can take place in real-time and/or otherwise.

In instances when the wireless communication device owner is a party to the wireless communication device call and/or transaction, he or she, having the communication device 404 on his or her person, can authorize the call and/or transaction at his or her present location. If the wireless communication device owner has lent out the wireless communication device, he or she can authorize the wireless communication device call and/or transaction from his or her remote location.

The wireless communication device owner can also program and/or set the communication device 404 to automatically authorize or disapprove or disallow wireless communication device calls and/or transactions with said selective authorizations being made as to time of day, calling areas, numbers called, and/or call and/or transaction duration. In this regard, the communication device 404 can be programmable so as to receive and analyze the wireless communication device call information and/or data and reply or respond to same automatically and/or with preset or programmed replies and/or responses. The communication device 404 can also be programmable so as to limit the number of wireless communication device calls made from the wireless communication device and/or with the wireless communication device number.

The communication device 404, in the preferred embodiment, is provided with a memory device for storing any number of wireless communication device calls and/or transactions so that the wireless communication device owner can review his or her account activity and/or wireless communication device calls and/or transactions made and/or which have occurred involving his or her wireless communication device. In this manner, the wireless communication device owner can “scroll” through and/or in other ways review account activity. The communication device 404 can also be equipped to service more than one wireless communication devices.

The central processing computer 403 can also be programmed to provide notification to the account owner upon the occurrence of any number of events and/or occurrences which take place regarding and/or relating to the respective account. The central computer 403 can provide notification to the account owner upon the receipt of an account owner's payment, a credit to the account, a reaching of a certain level of account charges, the crediting of the payment to the respective account, account calling activity, the reaching of a certain limitation on account usage, the restricting of a certain usage, the attempt to perform a restricted and/or prohibited activity on the account, the reaching of a pre-specified credit, charge, debit, and/or other respective limit on the respective account, telephone or communications transacted, and/or any other occurrence and/or event which may be of interest to the account holder.

The central processing computer 403 can also notify the account owner regarding a payment due date, an overdue status of a payment, an account restriction and/or limitation on usage, etc.

In this manner, the account owner can be notified of any of the above-described and/or any other event or occurrences. For example, the account owner can be notified when a payment is received, when a certain level of usage, and/or when any other event or transaction of interest to the account owner occurs on and/or regarding the account.

Similarly, the account owner can be notified when he or she has reached and/or is close to reaching a pre-specified account usage level and/or upon the occurrence of administrative events or occurrences, i.e. payment due date, payment overdue, account restrictions, and/or the charging of maintenance or service fee charges.

In another preferred embodiment, the wireless communication device 402 can be programmed to provide any of the functions described herein as being performed by the central processing computer 403, including, but not limited to, providing any of the notification functions for providing notification to the account owner of any of the above-described events and/or occurrences.

The various processing routines described herein as being performed by the apparatus 400 of the present invention in FIGS. 19A and 19B and FIGS. 20A, 20B and 20C can also be performed in conjunction with each other and/or can be combined so that the apparatus 400 can perform multiple routines in conjunction with each other. In this regard, the wireless communication device 402 can, in another preferred embodiment, transmit the information and/or data pertinent to a transaction to the communication device 404 associated with an account owner, and process the transaction in the manner described herein with the account owner, while also transmitting the information and/or data pertinent to the transaction to the central processing computer 403 and processing the transaction with the central processing computer 403.

The wireless communication device 402 can transmit the respective transmissions to the respective devices 404 and 403 in a sequential fashion and/or in any desired and/or specified order and/or the wireless communication device can transmit the respective transmissions to the respective devices 404 and 403 simultaneously. In any event, the wireless communication device(s) 402, the central processing computer(s) 403, and the communication device(s) 404, in the preferred embodiments described herein, can be suitably equipped with any necessary, additional, and/or desired, hardware and/or software for facilitation their respective operations and/or functionality as described herein.

In this manner, the wireless communication device 402 can communicate with the account holder via the communication device 404 and independently of any transaction processing by a central transaction processing computer or central transaction processing service.

In another preferred embodiment of the apparatus of FIG. 17, the apparatus 400 can be programmed and/or can be programmable by the respective account holder, account owner, wireless communication device owner, and/or any other authorized individual, (hereinafter referred to as “account holder” or “account owner”). The account holder or account owner can access the central processing computer 403 via the communication device 404, a telephone, and/or any other communication device. The account holder or account owner can thereafter program the central processing computer 403 by transmitting a signal, data, and/or information, containing and/or corresponding to instructions for restricting and/or limiting activity and/or communications and/or transactions which can occur and/or take place on, or in conjunction with, the respective account.

The signal, data and/or information, containing the restriction(s) and/or limitation(s) data and/or information is received by the receiver 403G. Thereafter, the CPU 403A will process the restriction(s) and/or limitation(s) data and/or information and store any appropriate data and/or information in the database 403H.

The above-described programming of restrictions and/or limitations into the central processing computer 403 can take place in real-time and/or otherwise.

The restrictions and/or limitations which can be programmed into the central processing computer 403 can include the types of communications and/or transactions which are allowed and/or authorized, limitations and/or restrictions on account or wireless communication device usage, types of communications and/or transactions which are allowed and/or authorized, limits on the amounts of communications and/or transactions which can occur on an account, number of communications, calls, and/or transactions, which can occur on an account and/or from a wireless communication device, authorized parties to use the account, authorized geographical area or location of usage, authorized times for account access and/or account and/or wireless communication device usage (i.e. specific days, dates, time of day, time of month, year, etc.), and/or any other limitation and/or restriction regarding amount of communications and/or transactions, parties involved, geographical area, and/or times of allowed usage.

The limitations and/or restrictions can also include limitations and/or restrictions on account usage and/or wireless communication device account usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of wireless communication devices.

The limitations and/or restrictions can also include limitations on and/or regarding communication charges, individuals who may make communications or the transactions on the account and/or with the wireless communication device, proof of identity of which the types of proof may be specified, specific communication providers and/or carriers authorized to service the account and/or wireless communication device,

With regards to any of the wireless communication accounts and/or wireless communication devices described herein, the account holder or account holder can also change, specify, or programmably change, passwords, personal identification numbers and/or any other access code(s) and provide for various personal identification numbers and/or access codes for different communications, transactions, times of usage, etc.

For example, the account holder, account owner, and/or wireless communication device owner can limit account usage (i.e. no calls or communications outside the United States, no calls to certain designated telephone numbers, can program the central processing computer 403, and/or the server computer, if utilized, so as to limit account communications and/or transactions by amounts (i.e. no calls exceeding a certain charge limit, no account usage once a pre-specified account charge limit, for example 600 minutes or $100.00 has been reached), to limit communications and/or transactions by times of usage (i.e. no wireless communication device usage between 10:00 P.M. and 8:00 A.M.), to change service plan (i.e. unlimited regional or long distance calling), and/or to establish and/or change credit limits on an account, periodically and/or at any desired time.

The account holder of account owner can program the central processing computer 403, and/or the server computer, if utilized, via the communication device 404, a telephone, and/or any other suitable communication device. The account holder or account owner can also perform the above-described programming via a touch-tone telephone. In the same manner, the account holder or account owner, can also program the apparatus 400 so as to limit the types of communications and/or transactions involving his or her account.

Once programmed by the account holder or account owner, the central processing computer 403, upon receiving a communication and/or transaction authorization request or a communication and/or transaction processing request, will process the communication and/or transaction in conjunction with the restriction(s) and/or limitation(s) provided, programmed, and/or dictated, by the account holder or account owner.

By utilizing the above-described programming routine(s), an account holder, account owner, cardholder, and/or other authorized individual, can program and/or update any data and/or information which can or may be stored in the database 403H. The above-described programming routine(s) can be performed in real-time and/or otherwise.

In another preferred embodiment, the account holder or account owner can program the respective wireless communication device 402 and/or communication device 404, in the same manner in which the central processing computer 403 can be programmed, so as to program restrictions and/or limitations into the respective devices. The wireless communication device 402 can, in this manner, be directly programmable, by the account holder, or account owner, wireless communication device owner, and/or other authorized individual, in real-time and/or otherwise, in the same manner described above regarding the central processing computer 403, so as to automatically process a communication and/or transaction in accordance with the restrictions or limitations provided by account holder, account owner, wireless communication device owner, and/or other authorized individual. The communication device 404 can also be directly programmable by the account holder or account owner, in real-time and/or otherwise, in the same manner described above regarding the central processing computer 403, so as to automatically process a communication and/or transaction authorization request and/or a communication and/or transaction.

In a similar manner, the account holder, account owner, wireless communication device owner, and/or other authorized individual, can program the apparatus 400 as described above in conjunction with the use of any of the herein-described wireless communication accounts and/or wireless communication devices.

In another preferred embodiment of the apparatus of FIG. 17, the apparatus 400 can be programmed and/or can be programmable by the respective account holder, account owner, wireless communication device owner, and/or any other authorized individual, (hereinafter referred to as “account holder” or “account owner”). The account holder or account owner can access the central processing computer 403 via the communication device 404, a telephone, and/or any other communication device.

The account holder or account owner can thereafter program the central processing computer 403 by transmitting a signal, data, and/or information, containing and/or corresponding to instructions for restricting and/or limiting activity and/or communication and/or transactions which can occur and/or take place on, or in conjunction with, the respective account and/or wireless communication device.

The signal, data and/or information, containing the restriction(s) and/or limitation(s) data and/or information is received by the receiver 403G. Thereafter, the CPU 403A will process the restriction(s) and/or limitation(s) data and/or information and store any appropriate data and/or information in the database 403H.

The above-described programming of restrictions and/or limitations into the central processing computer 403 can take place in real-time and/or otherwise.

The restrictions and/or limitations which can be programmed into the central processing computer 403 can include the types of communications and/or transactions which are allowed and/or authorized, limitations and/or restrictions on account or wireless communication device usage, types of communications and/or transactions which are allowed and/or authorized, limits on the amounts of communications and/or transactions which can occur on an account and/or with a wireless communication device, number of communications, calls, and/or transactions, which can occur on an account and/or from a wireless communication device, authorized parties to use the account and/or wireless communication device, authorized geographical area or location of usage, authorized times for account and/or wireless communication device access and/or account and/or wireless communication device usage (i.e. specific days, dates, time of day, time of month, year, etc.), and/or any other limitation and/or restriction regarding amount of communications and transactions, parties involved, geographical area, and/or times of allowed usage.

The limitations and/or restrictions can also include limitations and/or restrictions on account and/or wireless communication device usage and/or wireless communication device account and/or wireless communication device usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of wireless communication devices.

The limitations and/or restrictions can also include limitations on and/or regarding communication charges, individuals who may make communications or the transactions on the account and/or with the wireless communication device, proof of identity of which the types of proof may be specified, specific communication providers and/or carriers authorized to service the account and/or wireless communication device,

With regards to any of the wireless communication accounts and/or wireless communication devices described herein, the account holder or account holder can also change, specify, or programmably change, passwords, personal identification numbers and/or any other access code(s) and provide for various personal identification numbers and/or access codes for different communications, transactions, times of usage, etc.

For example, the account holder, account owner, and/or wireless communication device owner can limit account and/or wireless communication device usage (i.e. no calls or communications outside the United States, no calls to certain designated telephone numbers, can program the central processing computer 403, and/or the server computer, if utilized, so as to limit account and/or wireless communication device communications and/or transactions by amounts (i.e. no calls exceeding a certain charge limit, no account and/or wireless communication device usage once a pre-specified account and/or wireless communication device charge limit, for example 600 minutes or $100.00 has been reached), to limit communications and/or transactions by times of usage (i.e. no wireless communication device usage between 10:00 P.M. and 8:00 A.M.), to change service plan (i.e. unlimited regional or long distance calling), and/or to establish and/or change credit limits on an account, periodically and/or at any desired time.

The account holder of account owner can program the central processing computer 403, and/or the server computer, if utilized, via the communication device 404, a telephone, and/or any other suitable communication device. The account holder or account owner can also perform the above-described programming via a touch-tone telephone. In the same manner, the account holder or account owner, can also program the apparatus 400 so as to limit the types of communications and/or transactions involving his or her account and/or wireless communication device.

Once programmed by the account holder or account owner, the central processing computer 403, upon receiving a communication and/or transaction authorization request or a communication and/or transaction processing request, will process the communication and/or transaction in conjunction with the restriction(s) and/or limitation(s) provided, programmed, and/or dictated, by the account holder or account owner.

By utilizing the above-described programming routine(s), an account holder, account owner, cardholder, and/or other authorized individual, can program and/or update any data and/or information which can or may be stored in the database 403H. The above-described programming routine(s) can be performed in real-time and/or otherwise.

In another preferred embodiment, the account holder or account owner can program the respective wireless communication device 402 and/or communication device 404, in the same manner in which the central processing computer 403 can be programmed, so as to program restrictions and/or limitations into the respective devices.

The wireless communication device 402 can, in this manner, be directly programmable, by the account holder, or account owner, wireless communication device owner, and/or other authorized individual, in real-time and/or otherwise, in the same manner described above regarding the central processing computer 403, so as to automatically process a communication and/or transaction in accordance with the restrictions or limitations provided by account holder, account owner, wireless communication device owner, and/or other authorized individual. The communication device 404 can also be directly programmable by the account holder or account owner, in real-time and/or otherwise, in the same manner described above regarding the central processing computer 403, so as to automatically process a communication and/or transaction authorization request and/or a communication and/or transaction.

In a similar manner, the account holder, account owner, wireless communication device owner, and/or other authorized individual, can program the apparatus 400 as described above in conjunction with the use of any of the herein-described wireless communication accounts and/or wireless communication devices.

The apparatus and method of the present invention provides for the real-time notification of wireless communication device usage which enables a wireless communication device owner and/or account holder to monitor, in real-time, activity involving his or her wireless communication device and/or wireless communication device number and/or account.

The apparatus and method of the present invention also provides a means and a mechanism by which to inform a wireless communication device owner that the wireless communication device is lost or stolen, and/or to provide notification to the wireless communication device owner that his or her wireless communication device number is being utilized in communications, calls, and/or transactions, such as when a wireless communication device has been illegally “cloned”. The wireless communication device owner and/or account holder can then report the wireless communication device lost or stolen and/or cancel and/or de-activate the wireless communication device number and/or account.

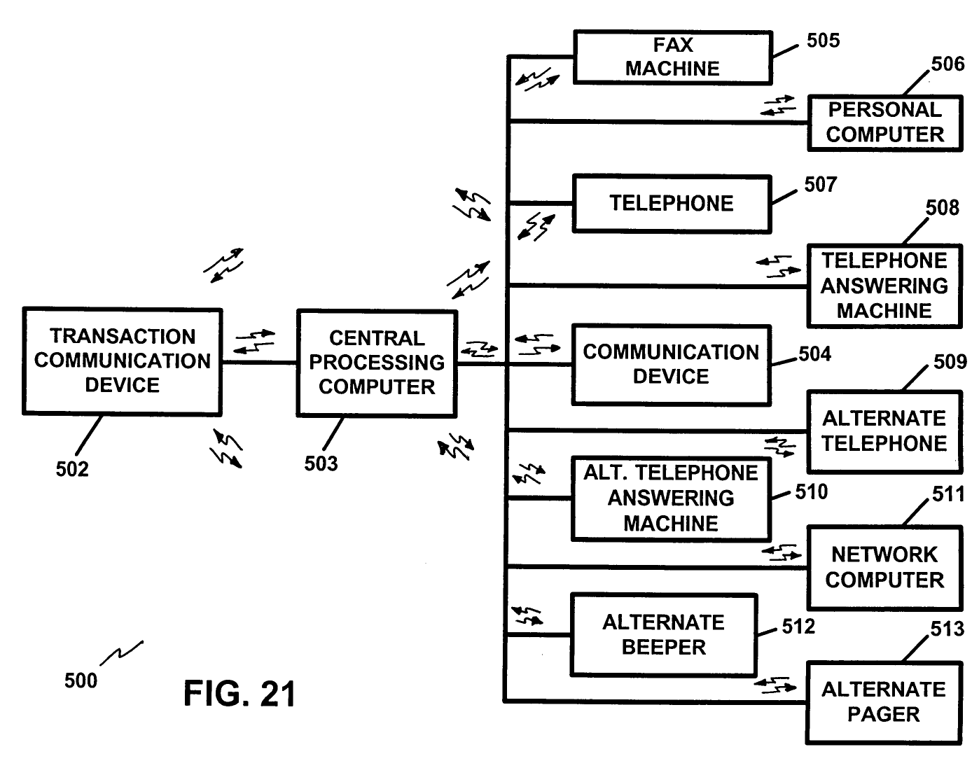

In another preferred embodiment of the apparatus of FIG. 21, the apparatus 500 can be programmed and/or can be programmable by the respective account holder, account owner, non-wireless communication device owner, and/or any other authorized individual, (hereinafter referred to as “account holder” or “account owner”). The account holder or account owner can access the central processing computer 503 via the communication device 504, a telephone, and/or any other communication device. The account holder or account owner can thereafter program the central processing computer 503 by transmitting a signal, data, and/or information, containing and/or corresponding to instructions for restricting and/or limiting activity and/or communications and/or transactions which can occur and/or take place on, or in conjunction with, the respective account.

The signal, data and/or information, containing the restriction(s) and/or limitation(s) data and/or information is received by the receiver 503G. Thereafter, the CPU 503A will process the restriction(s) and/or limitation(s) data and/or information and store any appropriate data and/or information in the database 503H.

The above-described programming of restrictions and/or limitations into the central processing computer 503 can take place in real-time and/or otherwise.

The restrictions and/or limitations which can be programmed into the central processing computer 503 can include the types of communications and/or transactions which are allowed and/or authorized, limitations and/or restrictions on account or non-wireless communication device usage, types of communications and/or transactions which are allowed and/or authorized, limits on the amounts of communications and/or transactions which can occur on an account, number of communications, calls, and/or communications and/or transactions, which can occur on an account and/or from a non-wireless communication device, authorized parties to use the account or device, authorized geographical area or location of usage, authorized times for account access and/or account and/or non-wireless communication account and/or device usage (i.e. specific days, dates, time of day, time of month, year, etc.), and/or any other limitation and/or restriction regarding amount of communications and/or transactions, parties involved, geographical area, and/or times of allowed usage.

The limitations and/or restrictions can also include limitations and/or restrictions on account usage and/or non-wireless communication device account usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of non-wireless communication devices.

The limitations and/or restrictions can also include limitations on and/or regarding communication charges, individuals who may make communications or the transactions on the account and/or with the non-wireless communication device, proof of identity of which the types of proof may be specified, specific communication providers and/or carriers authorized to service the account and/or non-wireless communication device,

With regards to any of the non-wireless communication accounts and/or non-wireless communication devices described herein, the account holder or account holder can also change, specify, or programmably change, passwords, personal identification numbers and/or any other access code(s) and provide for various personal identification numbers and/or access codes for different communications, transactions, times of usage, etc.

For example, the account holder, account owner, and/or non-wireless communication device owner can limit account usage (i.e. no calls or communications outside the United States, no calls to certain designated telephone numbers, can program the central processing computer 103, and/or the server computer, if utilized, so as to limit account communications and/or transactions by amounts (i.e. no calls exceeding a certain charge limit, no account usage once a pre-specified account charge limit, for example 600 minutes or $100.00 has been reached), to limit communications and/or transactions by times of usage (i.e. no non-wireless communication device usage between 10:00 P.M. and 8:00 A.M.), to change service plan (i.e. unlimited regional or long distance calling), and/or to establish and/or change credit limits on an account, periodically and/or at any desired time.

The account holder of account owner can program the central processing computer 503, and/or the server computer, if utilized, via the communication device 504, a telephone, and/or any other suitable communication device. The account holder or account owner can also perform the above-described programming via a touch-tone telephone. In the same manner, the account holder or account owner, can also program the apparatus 500 so as to limit the types of communications and/or transactions involving his or her account.

Once programmed by the account holder or account owner, the central processing computer 503, upon receiving a communication and/or transaction authorization request or a communication and/or transaction processing request, will process the communication and/or transaction in conjunction with the restriction(s) and/or limitation(s) provided, programmed, and/or dictated, by the account holder or account owner.

By utilizing the above-described programming routine(s), an account holder, account owner, cardholder, and/or other authorized individual, can program and/or update any data and/or information which can or may be stored in the database 503H. The above-described programming routine(s) can be performed in real-time and/or otherwise.

In another preferred embodiment, the account holder or account owner can program the respective transaction communication device 502 and/or communication device 504, in the same manner in which the central processing computer 503 can be programmed, so as to program restrictions and/or limitations into the respective devices.

The transaction communication device 502 can, in this manner, be directly programmable, by the account holder, or account owner, non-wireless communication device owner, and/or other authorized individual, in real-time and/or otherwise, in the same manner described above regarding the central processing computer 503, so as to automatically process a communication or transaction in accordance with the restrictions or limitations provided by account holder, account owner, non-wireless communication device owner, and/or other authorized individual.

The communication device 504 can also be directly programmable by the account holder or account owner, in real-time and/or otherwise, in the same manner described above regarding the central processing computer 503, so as to automatically process a communication and/or transaction authorization request and/or a communication and/or transaction.

In a similar manner, the account holder, account owner, non-wireless communication device owner, and/or other authorized individual, can program the apparatus 500 as described above in conjunction with the use of any of the herein-described non-wireless communication accounts and/or non-wireless communication devices.

The present invention also provides a means and a mechanism by which to monitor the number of wireless communication device wireless communications, communications or telephone calls, and/or transactions, which are unauthorized by the wireless communication device owner and/or account holder and to determine whether or not to de-activate the wireless communication device and/or the wireless communication device number and/or account.

The central processing computer 503 and/or the wireless communication device 502 can also generate and transmit notification signals, e-mails, and/or other electronic and/or conventional messages and/or transmissions to notify the account holder regarding any account occurrence, event, and/or activity described herein.

The account owner can report any unauthorized activity and/or respond to any account activity at time. In the above manner, the apparatus and method of the present invention provides an apparatus and a method to prevent and/or to drastically limit fraudulent and/or unauthorized use of, and/or the “cloning” of, wireless communication devices and/or the unauthorized use of wireless communication device numbers and/or accounts.

The embodiment of FIG. 17 can also be utilized with wireless communication devices utilized on, over, and/or in conjunction with the Internet, the World Wide Web, and/or any other communication network.

FIG. 21 illustrates a block diagram of another preferred embodiment of the apparatus of the present invention which is utilized in conjunction with a communication device and/or telephone and/or corresponding non-wireless communication device and/or telephone account number and/or information related thereto which utilize any suitable communication technology, including, but not limited to, telephone communication systems, line-connected telephones and/or communication devices, cable television transmission systems, digital television transmission systems, satellite television transmission systems, and broadband communication systems, telephones, digital telephones, cable televisions, digital televisions, broadband communication devices, broadband telephones, internet telephones, (hereinafter, for simplicity, collectively referred to as “communication device”).

The term “communication device” or the plural of same can include, but are not limited to, telephones, facsimile (fax) machines, personal digital assistants, hand-held devices, Palm top devices such as Palm Pilot® devices, computers, personal computers, laptop computers, mini-computers, mainframe computers, watches, electronic wallets and/or electronic purses, and/or any other device which can be utilized on or over a non-wireless, communication network and/or system.

The apparatus of FIG. 21 is denoted generally by the reference numeral 500. In FIG. 21, the apparatus 500 includes of a transaction communication device 502 which can be any non-wireless communication device described herein.

In the embodiment of FIG. 21, the transaction communication device 502 serves as the transaction device which is described in the above described embodiments. The transaction communication device 502 can transmit an authorization request and/or a transaction notification signal, which can include data and/or information pertaining to the communication transaction and/or event, to a central processing computer and/or to an account holder communication device and/or another communication device associated with the communication account holder, and/or an individual authorized to act for, and/or on behalf of the account holder. The transaction communication device 502 can also receive authorization data and/or information from the central processing computer and/or from the communication device associated with the communication account holder. The transaction communication device 502 can also include, or have associated therewith, a keypad for the manual entry of transaction information and/or data, such as the telephone number, as well as various command codes utilized in making or placing a communication, transmission, and/or a telephone call.

The apparatus 500 also includes a central processing computer 503 which services any predefined group of transaction communication devices and/or communication accounts. For example, the central processing computer 503 can handle non-wireless communication and/or telephone accounts and/or devices for a given utility, telecommunications service provider and/or company and/or for any communication network, area and/or region. The central processing computer 503, for example, can process and maintain records of non-wireless communication device communications, transactions, telephone calls, including billing information, account activity, usage records, times of usage, usage time, total usage time, usage costs, total usage costs, telephone numbers called, incoming calls telephone numbers, etc., for any number of non-wireless communication devices which are serviced by a particular communications company or central processing office or computer.

The central processing computer 503 can be a mainframe computer, a mini-computer, a micro-computer, a server computer, such as those utilized in conjunction with on-line services and/or in a network environment, and/or any other suitable computer or computer system.

The central processing computer 503 can also process accounts for any of the non-wireless communication devices and/or non-wireless communication accounts described herein. In the preferred embodiment, the transaction communication device 502 is linked and/or connected to the central processing computer 503 via a telecommunications network, system, link and/or medium (hereinafter referred to as “communications network” or “communication system”) such as, for example, a telephone network or line, a non-wireless network or link, the Internet, the World Wide Web, and/or any other suitable network.

The communications network or system which is utilized can be any communications network or system and can include telecommunication systems, satellite communications systems, radio communication systems, digital communications systems, digital satellite communications systems, personal communications services communication systems, cable television systems, digital television systems, satellite television systems, broadband communication systems, as well as any other appropriate communications system. The transaction communication device 502 transmits signals and/or data to the central processing computer 503 as well as receives signals and/or data from the central processing computer 503.

The apparatus 500 also includes a communication account holder communication device 504 which can receive signals and/or data from as well as transmit signals and/or data from, the transaction communication device 502.

In another preferred embodiment of FIG. 21, the communication device 504 receives signals and data directly from the transaction communication device 502 with said signals being transmitted via a suitable communication system. In this preferred embodiment, the communication device 504 can also transmit signals and data to the transaction communication device 502, directly and/or indirectly, with said signals being transmitted via a suitable communication system. In another preferred embodiment of FIG. 21, the communication device 504 can receive signals and data from the central processing computer 503, directly and/or indirectly, with said signals being transmitted via a suitable communication system. In this preferred embodiment, the communication device 504 can also transmit signals and data to the central processing computer 503, directly and/or indirectly, with said signals being transmitted via a suitable communication system.

The communication device 504 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch. The communication account holder communication device 504 can also receive signals and/or data from as well as transmit signals and/or data from the central processing computer 503. In the embodiment of FIG. 21, the communications network or system utilized for transmitting signals and/or data to and/or from any of the communication devices 502 and 504 and the central processing computer(s) 503 is a communication network which can include a non-wireless network or link.

In the preferred embodiment, the communication device 504 is also equipped with a transmitter for transmitting signals and/or data to the central processing computer 503. In this regard, the central processing computer 503 transmits signals and/or data to the communication device 504 as well as receives signals and/or data from the communication device 504. The communication device 504 can also transmit signals and/or data directly to the transaction communication device 502 and receive signals and/or data directly from the transaction communication device 502.

As noted above, the communication device 504 can be a wireless device. In any of the embodiments described herein, any of the account holder's communication devices can be carried by the account holder and/or an individual authorized to act for and/or on behalf of the account holder.

In the embodiment of FIG. 21, the apparatus 500 also includes a facsimile (fax) machine 505, a personal computer or personal digital assistant 506, a telephone 502, a telephone answering machine 508, an alternate telephone 509, an alternate telephone answering machine 510, a network computer 511, an alternate beeper 512, and an alternate pager 513.

The transaction communication device 502 and the central processing computer 503 can be linked with the above fax machine 505, personal computer or personal digital assistant 506, telephone 507 and associated answering machine 508, alternate telephone 509 and associated answering machine 510, network computer 511, alternate beeper 512 and/or alternate pager 513, via any suitable communication system. In the preferred embodiment, a telecommunications link or telephone line or link, which may or may not be a wireless link depending on the device and/or the circumstances, is utilized in order to link the central processing computer 503 with each of the fax machine 505, the personal computer or personal digital assistant 506, the telephone 507 and associated answering machine 508, the alternate telephone 509 and associated answering machine 510, the network computer 511, the alternate beeper 512, and/or the alternate pager 513.

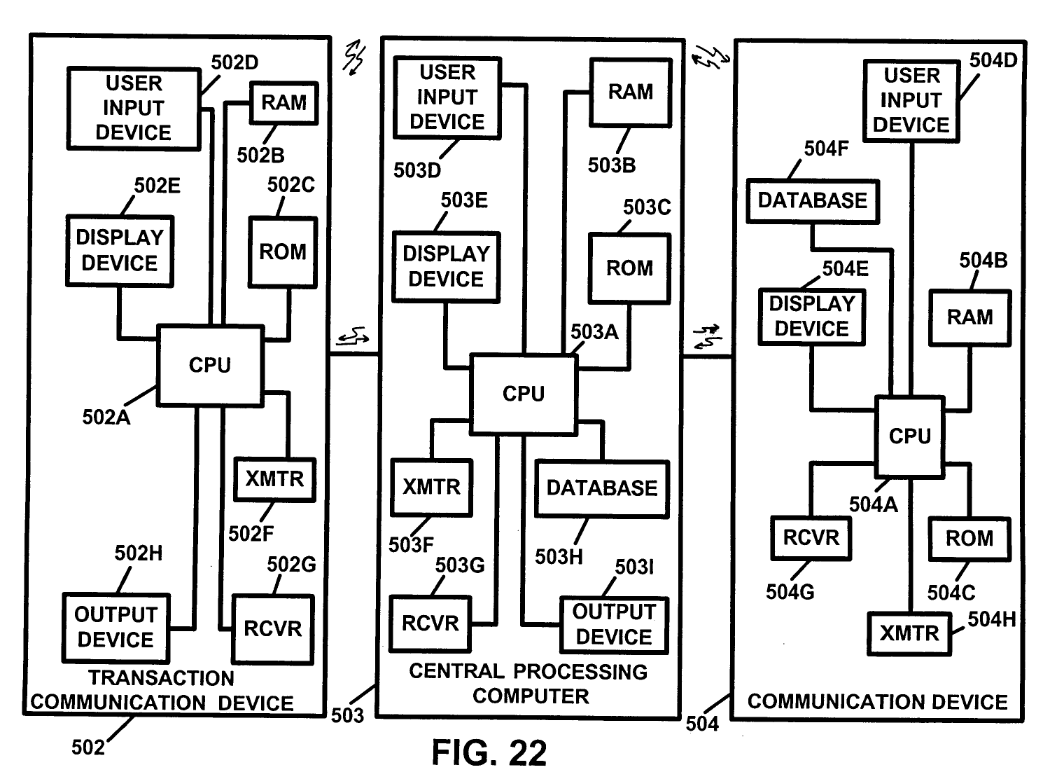

FIG. 22 illustrates the various components of the apparatus 500 of FIG. 21. In FIG. 22, the transaction communication device 502, in the preferred embodiment, includes a central processing unit or CPU 502A, associated random access memory 502B (RAM) and read only memory 502C (ROM) devices, which are also connected to the CPU 502A, a user input device 502D, which is a typically a keypad or other suitable input device for inputting data into the transaction communication device 502 and which is also connected to the CPU 502A, and a display device 502E for displaying information and/or data to a user or operator of the transaction communication device 502.

The transaction communication device 502 also includes a transmitter 502F for transmitting signals during normal communication operation and for transmitting signals and/or data to the central processing computer 503, and/or to the account holder communication device 504 and/or to any other device associated with the account owner or apparatus 500, if desired. The transmitter can be a wireless transmitter for transmitting wireless signals. The transmitter 502F is also connected to the CPU 502A. The transaction communication device 502 also includes a receiver 502G for receiving signals during normal telephone operation and/or for receiving signals and/or data from the central processing computer 503 and from the communication device 504 and/or from any other associated device which can be utilized, if desired. The receiver can also be a wireless receiver for receiving wireless signals. The receiver 502G is also connected to the CPU 502A.

The transaction communication device 502 can also include a printer 502H or other appropriate output device for outputting data to the user. The printer 502H, if utilized, is also connected to the CPU 502A. In the preferred embodiment, the printer 502H prints receipts corresponding to the transaction and/or information transmitted during the communication or telephone call or transaction.

The transaction communication device 502 can also include a database 502I. The database 502I can include data and/or information regarding the transaction communication device, the account holder, the communication account, restrictions and/or limitations on account usage and/or communication device usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of non-wireless communication devices. The transaction communication device 502 can also be programmable so that any of the restrictions and/or limitations described herein can be programmed into the transaction communication device 502.

The transaction communication device 502 can also includes a scanner or reader device 502J which is connected to the CPU 502A and which can be utilized to scan or read data and/or information from a respective account card and/or magnetic strip or “smart” chip located thereon or therein.

In FIG. 22, the central processing computer 503 includes a central processing unit or CPU 503A, associated random access memory 503B (RAM) and read only memory 503C (ROM) devices, which are connected to the CPU 503A, a user input device 503D, which is a keypad or any other suitable input device for inputting data into the central processing computer 503 and which is also connected to the CPU 503A and a display device 503E for displaying information and/or data to a user or operator.

The user input device 503D can include any data input device including, but not limited to, a keyboard, a mouse, a scanner, a reader or card reader, an audio input device, a voice recognition device, a fingerprint reading device, a retinal scanning device, and/or any other device for inputting data and/or information into the central processing computer 503.

The central processing computer 503 also includes a transmitter(s) 503F for transmitting signals and/or data to the transaction communication device 502 and to the communication device 504, and/or to any other device which can be utilized, and/or to any one or more of the fax machine 505, personal computer or personal computer or personal digital assistant 506, telephone 507 and associated answering machine 508, alternate telephone 509 and associated answering machine 510, network computer 511, alternate beeper 512, and/or alternate pager 513. The transmitter(s) 503F is also connected to the CPU 503A. The central processing computer 503 also includes a receiver(s) 503G for receiving signals and/or data from the transaction communication device 502 and from the communication device 504, and/or from any other suitable device which can be utilized in conjunction with the apparatus 500. The receiver(s) 503G is also connected to the CPU 503A.

The central processing computer 503 also includes a database(s) 503H which contains account information and data pertaining to the wireless communication account, device, and/or account holder. The database 503H contains information about the non-wireless communication device, account, and account holder, information and/or data necessary to the manage and/or process an account and/or account transaction as described herein, as well as restrictions and/or limitations on account usage and/or non-wireless communication device account usage, for any of the accounts processed and/or managed via the central processing computer 503, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of non-wireless communication devices. The central processing computer 503 can also be programmable so that any of the restrictions and/or limitations described herein can be programmed into the central processing computer 503. The database 503H is also connected to the CPU 503A.

The database 503H can include any number of databases which may or may not be linked to one another. The database 503H can also be linked to a database or databases which are located external from the central processing computer 503.

The database 503H can also include data and/or information regarding specific limitations and/or restrictions which can be placed on a particular account, which can be pre-selected and/or programmed by the account holder and which can include limitations and/or restrictions on the usage of the non-wireless communication device.

The limitations and/or restrictions can include the types of transactions or communications which are allowed and/or authorized, limits on the amounts of transactions or communications which can occur with the non-wireless communication devices, number of transactions or communications which can occur with the non-wireless communication devices, authorized parties to use the non-wireless communication devices, authorized geographical area or location of usage, wherein authorized communication device use can be limited, and/or authorized times for account access and/or account usage (i.e. specific days, dates, time of day, time of month, year, etc.), and/or any other limitation and/or restriction regarding amount of transaction or communication, parties involved, geographical area, and/or times of allowed usage.

The central processing computer 503 also includes a printer 503I or other appropriate output device for outputting information and/or data to a user or operator.

In FIG. 22, the account holder communication device 504, in the preferred embodiment, includes a central processing unit or CPU 504A, associated random access memory 504B (RAM) and read only memory 504C (ROM) devices, which also connected to the CPU 504A, a user input device 504D, which is a keypad or a plurality of keys and/or switches for inputting data into the communication device 504 and which is also connected to the CPU 504A, and a display device 504E, for displaying information and/or data to the non-wireless communication device account holder, and a database 504F, which are also connected to the CPU 504A.

The user input device 504D can include any data input device including, but not limited to, a keyboard, a mouse, a scanner, a reader or card reader, an audio input device, a voice recognition device, a fingerprint reading device, a retinal scanning device, and/or any other device for inputting data and/or information into the account holder communication device 504.

The database 504F can include data and/or information regarding the non-wireless communication device, the account holder, the non-wireless communication account, restrictions and/or limitations on account usage and/or non-wireless communication device account usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of non-wireless communication devices. The communication device 504 can also be programmable so that any of the restrictions and/or limitations described herein can be programmed into the transaction communication device 504. The communication device 504 can be programmed to process any transaction described herein.

The communication device 504 also includes a receiver 504G for receiving signals and/or data from the central processing computer 503 and for receiving signals and/or data from the transaction communication device 502. The receiver 504G is also connected to the CPU 504A. The communication device 504 also includes a transmitter 504H for transmitting signals and/or data to the central processing computer 503 and for transmitting signals and/or data to the transaction communication device 502. The transmitter 504H is also connected to the CPU 504A.

The transaction communication device 502, also referred to as the “non-wireless communication device”, can also include a scanner and/or reader device 502I, such as a card reader, a magnetic strip card reader, and/or any other reading or scanning device for obtaining information from an account card associated with a transaction communication device 502 account, also referred to as a non-wireless communication account. The scanner or reader device 502I can, in the preferred embodiment, be capable of reading and processing data and/or information, which is stored on the magnetic strips and/or on the processors or chips which are located on the respective account card, and for providing one or multiple communications for one or multiple parties as well as reading and processing any restriction and/or limitation information regarding and/or related to account usage. For example, the magnetic card reader or card reader 502I can read and/or process data and/or information for identifying and communicating with a central transaction processing computer 503 as well as can read and/or process data and/or information for communicating with the individual account holder and/or an individual or agent authorized to act for and/or on behalf of the individual account holder, at any one or more of the communication devices 504 associated with the individual account holder or the individual or agent associated with the individual account holder.

Data and/or information for providing any other the communications described herein can be obtained from the data and/or information contained in the magnetic strip on the card, the respective processor or chip located on the card, and/or can be obtained form an external database (not shown) which can be linked to the transaction communication device 502 and/or which can be accessed thereby for obtaining any additional data and/or information.

In the preferred embodiment, the communication device 504 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch. A two-way pager and/or pager systems can also be utilized for implementing the respective components, and/or systems in the communication device 504/central processing computer 503 combination and/or link.

The apparatus 500 of the present invention, in the preferred embodiment, can be utilized in order provide a non-wireless communication device owner and/or account holder with authorization, notification and/or security measures in transactions involving any of the non-wireless communication devices described herein, and/or any transaction involving and/or related to same as described herein.

The apparatus and method of the present invention can be utilized to obtain non-wireless communication device owner and/or account holder authorization in a transaction involving non-wireless communication devices.

The apparatus 500 can also be utilized in conjunction with an account card or cards, such as telephone calling cards, which correspond to, and/or which are associated with non-wireless communication devices and/or the accounts corresponding thereto.

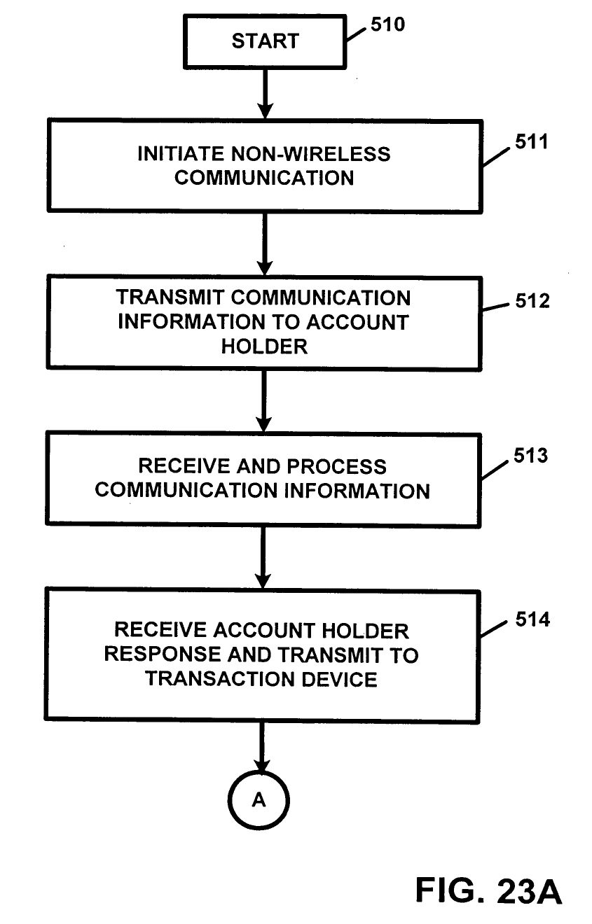

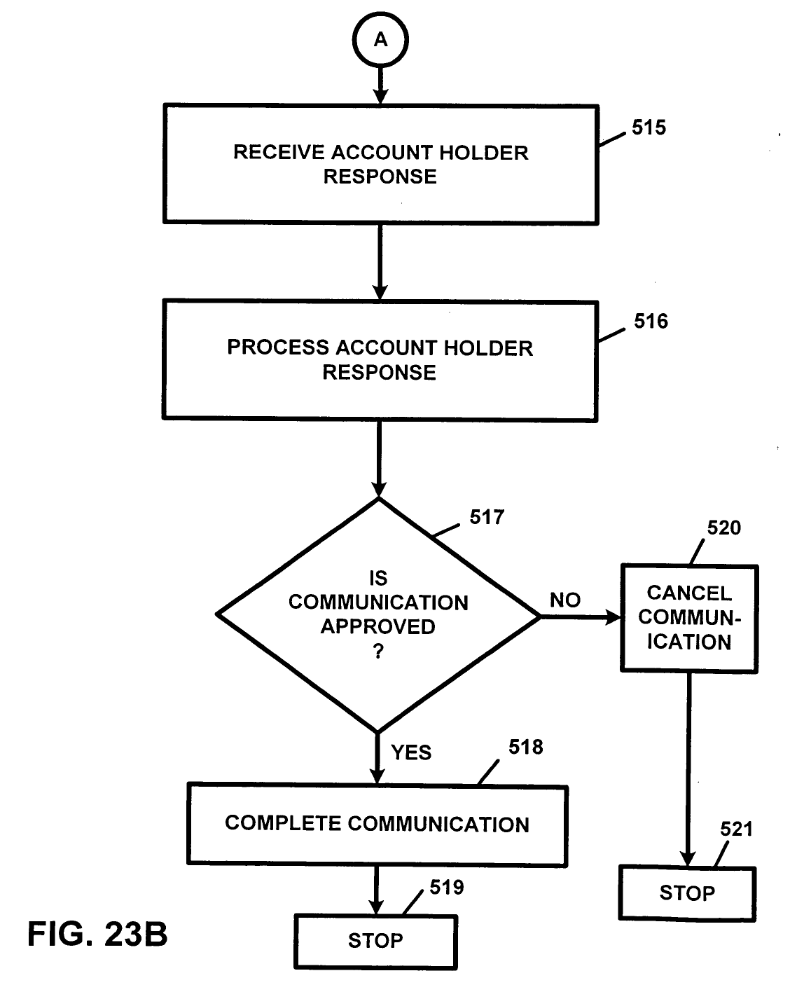

FIGS. 23A and 23B illustrate a preferred embodiment operation of the apparatus 500, in flow diagram form. With reference to FIGS. 23A and 23B, the operation of the apparatus 500 commences at step 510. At step 511, the owner, user, or operator, of the transaction communication device 502 initiates the transaction, communication, transmission, telephone call, and/or transaction, via the transaction communication device 502. The transaction communication device 502 is also referred to herein as a “non-wireless communication device”. The communication or transaction can be initiated by dialing a desired phone number, by swiping an appropriate account card, and/or via any other suitable practice. Thereafter, the non-wireless communication or transaction can either take place, while the remainder of the routine proceeds as described hereinbelow, or the non-wireless communication or transaction can be halted until authorized by the account holder as described herein.

In any of the embodiments described herein, the transaction communication device 502 can involve any one or more of a voice transmission, a data transmission, a telephone call, facsimile transmission, Internet or World Wide Web transmission, and/or any other transmission involving communication devices.

Data entry prior to, and/or during communication or transaction initiation can typically be performed by entering information via the data input device 502D, such as keyboard or mouse, or by swiping the magnetic strip of the account card through the scanner/reader 502J or by reading information from the processor or chip on the account card via the scanner/reader 502J. The data obtained from the magnetic strip and/or the card processor or chip, and/or from any associated database, can be utilized to contact the account holder communication device 504 and/or the account holder directly and/or to process the communication or transaction.

In another preferred embodiment, the transaction communication device 502 can process the communication or transaction in conjunction with any restrictions and/or limitations on account usage. The restrictions and/or limitations on account usage can be obtained via the data input device 502D, a respective account card, and/or which can be stored in the database 502J.

If the transaction communication device 502 determines that the communication or transaction violates and/or otherwise does not conform to a restriction and/or limitation on account usage, the non-wireless communication device 502 can cancel and/or reject the communication or transaction without proceeding further. For example, the transaction communication device 502, upon reading a restriction involving a time of use (i.e. no account usage allowed between 12:00 A.M. and 6:00 A.M.), a location of usage (i.e. no usage outside a particular city, state, or country), or a transaction amount limitation (i.e. no account usage for transactions exceeding $100), can process the communication or transaction and determine if the communication or transaction would violate a particular restriction or limitation.

If the communication or transaction would violate a restriction or limitation, the transaction communication device 502 can cancel the communication or transaction or prevent the communication or transaction, whichever the case may be, and no further processing would be required. If the communication or transaction would not violate a restriction and/or limitation, the communication or transaction processing could continue in any appropriate manner described herein and/or otherwise.

The information and/or data pertinent to the communication or transaction, and/or the account, is then transmitted, at step 512, to the communication device 504 via the communication network. In any of the embodiments described herein, any information and/or data which is transmitted from the transaction communication device 502 to the communication device 504 can be transmitted directly to the communication device 504 via the communication network.

The information and/or data which is transmitted from the transaction communication device 502 to the communication device 504 can also be transmitted indirectly to the communication device 504, via the communication network, and independently of any communication or transaction processing by a central transaction processing computer and/or central transaction processing system. The transmission of the information and/or pertinent data, which takes place at step 512, is a transmission from the transaction communication device 502 to the communication device 504 via the communication network and takes place independently of any processing of the communication or transaction by a central processing computer or central processing service, such as by the central processing computer 503 and/or otherwise. In this manner, the present invention provides notification to the account holder of the communication or transaction independently of any communication or transaction processing by a central processing computer and/or a central processing service. In this manner, the communication or transaction can also take place independently of any processing by the apparatus 500.

At step 512, the transaction communication device 502, by utilizing account holder contact information obtained from the account card, the database 502H, and/or otherwise, can also transmit respective signals and/or data to any one or more of the account holder's designated fax machine 505, personal computer or personal digital assistant 506, telephone 507, telephone answering machine 508, alternate telephone 509, alternate telephone answering machine 510, network computer 511, and/or alternate beeper 512 or alternate pager 513.

The information and/or data which is transmitted to the communication device 504 can include information and/or data identifying the communication or transaction, telephone number, and/or destination identification, time of transmission, location of communication or transaction origination, telephone number called, communication or transaction destination, parties involved, projected cost of communication or transaction, time of communication or transaction, name of the non-wireless services carrier, etc. The information and/or data can also include the phone number of the entity and/or a central processing office and/or computer servicing the account so that the account holder can telephone same in order to authorize or cancel the communication or transaction.

The communication device 504 will, at step 513, receive and process the information and/or data pertinent to the communication or transaction and provide the information to the account holder. At step 503, the information and/or data which is transmitted from the transaction communication device 502 and received at the communication device 504 can be displayed to the account holder on the display device 504E of the communication device 504.

The information displayed on the display device 504E can include the data identifying the communication or transaction, telephone number and/or destination identification, time of transmission, location of communication or transaction origination, telephone number called, communication or transaction destination, parties involved, projected cost of communication or transaction, time of communication or transaction, name of the non-wireless services carrier, and/or any other information described herein as being pertinent to and/or related to the non-wireless communication device, account, and/or the non-wireless communication or transaction, etc. The information and/or data can also include the phone number of the entity and/or a central processing office and/or computer servicing the account so that the account holder can telephone same in order to authorize or cancel the communication or transaction.

The communication device 504 can utilize any of the widely known data processing and/or software routines, which are known to those skilled in that art, in order to process communication or transaction requests and/or authorizations involving the use of the respective account(s).

Thereafter, the account holder can, at step 514, enter a response either approving or disapproving the communication or transaction. At step 514, the account holder's response is also transmitted, via the transmitter 504H of the communication device 504, to the transaction communication device 502. In any of the embodiments described herein, any information and/or data which is transmitted from the communication device 504 to the transaction communication device 502 can be transmitted directly to the transaction communication device 502 and/or indirectly to the transaction communication device 502 via the communication network.

The information and/or data which is transmitted from the communication device 504 to the transaction communication device 502 can also be transmitted indirectly to the communication device 504, via the communication network, and independently of any communication or transaction processing by a central communication or transaction processing computer and/or central communication or transaction processing system. In another embodiment, the information and/or data which is transmitted from the communication device 504 to the communication or transaction communication device 502 can also be transmitted indirectly to the communication device 504, via the central processing computer 503 or other processing computer or device.

At step 515, the receiver 502H of the communication or transaction communication device 502 will receive the account holder's response. At step 516, the communication or transaction communication device 502 will process the account holder's response. At step 517, the communication or transaction communication device 502 will determine whether the communication or transaction is approved or authorized. If, at step 517, it is determined that the communication or transaction is approved or authorized the wireless communication device 502 will authorize, allow, and/or connect or complete, the respective communication or transaction at step 518. Thereafter, operation of the apparatus 500 will cease at step 519.

If, however, at step 517, it is determined that the communication or transaction is disapproved or unauthorized, the transaction communication device 502 will cancel the communication or transaction, at step 520. Thereafter, the operation of the apparatus 500 will cease at step 521.

The apparatus 500 can be utilized and/or can be programmed so that the account holder can or must approve the communication or transaction prior to the communication or transaction being made, effected, and/or transacted. The apparatus 500 can also be utilized and/or programmed so that the account holder can or must approve the communication or transaction subsequent to the communication or transaction being made, effected, the communication link established, and/or transacted. In the case when the account holder disapproves of the communication or transaction after the communication or transaction or call has been made, effected, communication or transaction established, and/or transacted, the communication or transaction communication device 502 will terminate and/or cancel the communication or transaction.

In the embodiment described above, as well as in any of the embodiments described herein, the transaction communication device 502 can be programmed to wait a pre-specified amount of time for the account holder's response. The transaction communication device 502, can also be programmed to cancel the communication or transaction or complete the communication or transaction if no response is received.

Any of the particular instructions for the particular account can be included in the data and/or information which is stored in the respective databases of the transaction communication device 502, central processing computer 503, and/or the communication device 504, and/or which can be stored on the magnetic strip and/or otherwise stored on the respective account card. In this manner, the transaction communication device 502 can utilize communication or transaction instructions which are stored in the respective databases and/or on the respective account card and utilize this data and/or information in performing processing routines regarding the communication or transaction. In this manner, the present invention can be utilized in order to provide custom tailoring of communication or transaction processing regarding a particular non-wireless communication or transaction device account which information can be pre-specified and stored in the respective databases of the respective transaction communication devices, central processing computer(s) and/or communication devices and/or on the respective account cards.

In instances when the communication device 504 does not have a reply or two-way pager feature, the account holder can simply telephone the transaction communication device 502, or center or office servicing, and/or associated with, same, in order to personally appraise the device 502, or center or office, of his or her response to the communication or transaction.

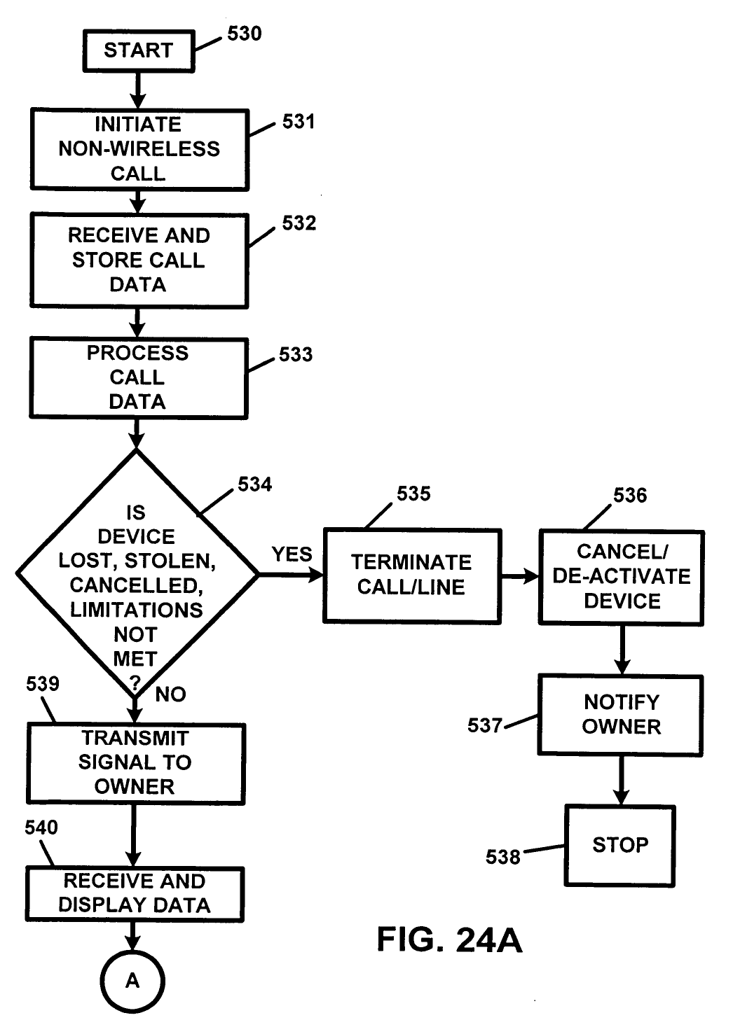

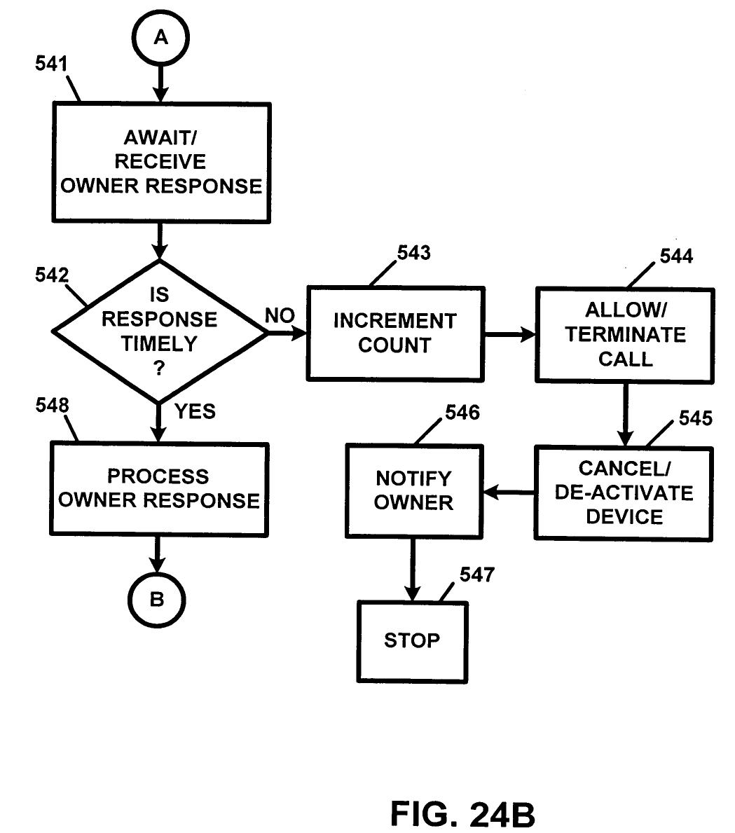

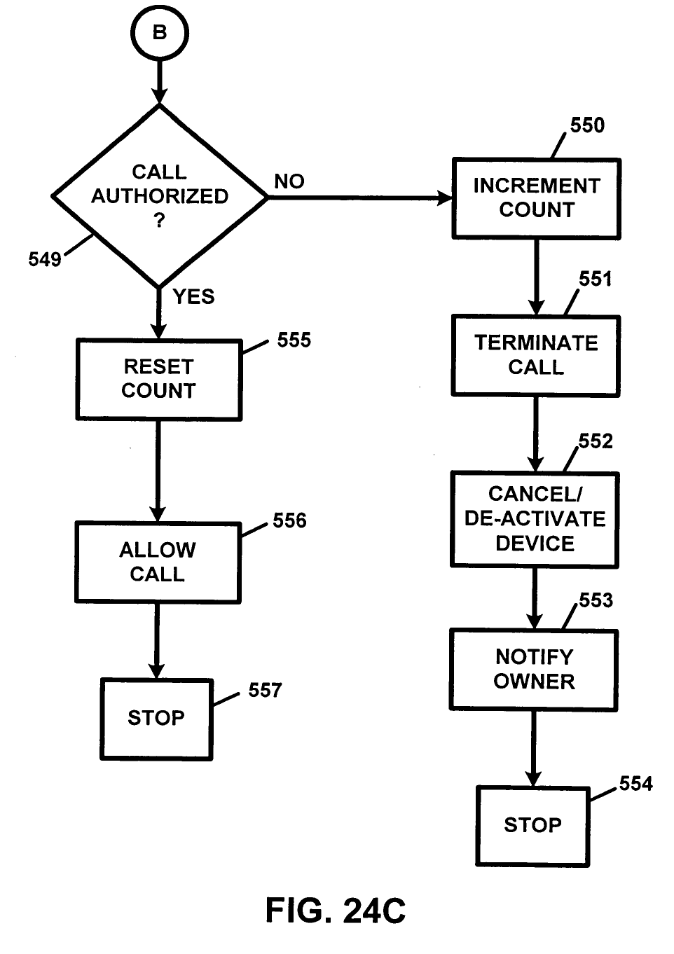

FIGS. 24A, 24B and 24C illustrate the operation of the apparatus 500 of FIG. 21, in flow diagram form. In the preferred embodiment of FIGS. 24A, 24B and 24C, the apparatus 500 can be utilized in conjunction with a central transaction processing computer or service. With reference to FIGS. 24A, 24B and 24C, the operation of the apparatus 500 commences at step 530 when the transaction communication device 502 is utilized to make a non-wireless communication, telephone call and/or transaction.

The transaction communication device 502 will activate the apparatus 500, at step 531, with the initiation of the non-wireless communication device communication or call, and/or in any other typical manner, such as when a non-wireless communication device is utilized to gain access to the communication or telephone network so that the calling connection can be established via the non-wireless communications network. Upon the making of the non-wireless communication device call, at step 531, the transaction communication device 502 will transmit data and/or information, which identifies the calling communication device or telephone, to the central processing computer 503 which services the particular transaction communication device 503, non-wireless communication device, or non-wireless communication device network, so that appropriate billing and/or accounting of communication device or telephone usage can be noted and/or processed.

In the preferred embodiment, the central processing computer 503 for the particular transaction communication device 502, non-wireless communication device, and/or non-wireless communication network, is the central processing computer 503. At step 534, the central processing computer 503 will receive and store the data and/or information which is transmitted by the transaction communication device 502. At step 533, the central processing computer 503 will process the data and/or information which is received from the transaction communication device 502.

The central processing computer 503 can utilize any of the widely known data processing and/or software routines, which are known to those skilled in that art, in order to process transaction requests and/or authorizations involving the use of the respective transaction communication device(s) and/or non-wireless communication device(s), and/or non-wireless communication device number or account. At step 534, the central processing computer 503 will perform a test in order to determine if the transaction communication device 504 is lost, stolen, cancelled or de-activated. If the transaction communication device 502 is determined to be lost, stolen, cancelled or de-activated, the central processing computer 503 will, at step 535, block the communication or telephone call or terminate the communication or call if it has already been connected. The central processing computer 503 will then, at step 536, cancel and/or de-activate the transaction communication device number or account. The central processing computer 503 will then, at step 537, notify the transaction communication device owner that his or her transaction communication device has been cancelled and/or de-activated. The operation of the apparatus will then cease at step 538.

If, at step 534, the central processing computer 503 determines that the transaction communication device is not lost, stolen, cancelled or de-activated, the central processing computer 503 will, at step 539, transmit a signal and/or data to the communication device 504. At step 540, the communication device 504 will receive and display the data and/or information which is transmitted from the central processing computer 503. The displayed information, in the preferred embodiment, will include the number called, the time of the call, the destination of the call and the duration of the call, in real-time. The information will remain displayed during the duration of the call so that the transaction communication device owner will be notified continuously throughout the duration of the call.

At step 541, the central processing computer 503 will await the transaction communication device owner's reply or response. If the transaction communication device owner replies or responds, the reply or response data will also be transmitted to, and received by, the central processing computer 503 at step 541. At step 542, the central processing computer 503 will then determine if the transaction communication device owner's response was made within a pre-defined time period, which is chosen, in the preferred embodiment, to be one (1) minute. If at step 542, it is determined that the transaction communication device owner did not reply or respond within the pre-defined time limit, the central processing computer will, at step 543, increment the unauthorized transaction count (UNAUTHCT) by one (1).

The central processing computer 503 will then, depending upon pre-defined instructions of the transaction communication device owner, at step 544, either allow the communication or telephone call to continue, such as for a pre-defined duration of one (1) minute, so as to allow for cases wherein an emergency condition exists, or terminate the communication or telephone call immediately. The decision to either allow the communication or telephone call to continue or to terminate the communication or telephone call can be made by the transaction communication device owner and/or by the non-wireless communication device service provider. Upon the completion of step 544, the central processing computer 503 will then, at step 545, cancel and/or de-activate the transaction communication device or account. Thereafter, the central processing computer 503 will, at step 546, notify the transaction communication device owner that the transaction communication device number or account has been cancelled and/or de-activated. Upon completion of step 546, the apparatus will cease operation at step 547.

If, at step 544, the transaction communication device owner did respond in time, the central processing computer 503 will process the reply or response data and/or information, at step 548. The central processing computer 503 will then determine, at step 549, if the transaction communication device call is authorized by the transaction communication device owner. If, at step 549, the transaction communication device communication or call is unauthorized, the central processing computer will, at step 550, increment the unauthorized transaction count (UNAUTHCT) by one (1). The central processing computer 503 will then, at step 551, terminate the communication or telephone call immediately. Upon the completion of step 551, the central processing computer 503 will then, at step 554, cancel and/or de-activate the transaction communication device 502. Thereafter, the central processing computer 503 will, at step 553, notify the transaction communication device owner that the transaction communication device 502 or account has been cancelled and/or de-activated. Upon completion of step 553, the apparatus 500 will cease operation at step 554.

If, at step 549, the central processing computer 503 identifies the account holder reply or response as being one to authorize the non-wireless communication device or call, the central processing computer 503 will, at step 555, reset the unauthorized transaction count (UNAUTHCT) to zero (0). An unauthorized transaction count (UNAUTHCT) of 0 will signify that any string of unauthorized transactions has now been broken by the transaction communication device owner. The central processing computer 503 will then, at step 556, allow the transaction communication device communication or call to continue uninterrupted. Upon the completion of the transaction communication device communication or call, at step 556, the apparatus 500 will cease operation at step 557.

In another preferred embodiment, the central processing computer 503 can perform any and/or all of the functionality described as being performed by the transaction communication device 502 as described herein in conjunction with FIGS. 23A and 23B. In this manner, in another preferred embodiment of FIG. 21, the central processing computer 503 can transmit a notification signal, data, and/or information, to the communication device 504, to notify the account holder of a communication or transaction on the non-wireless communication account. Thereafter, the account holder can transmit a response, to the notification signal, to the central processing computer 503. The central processing computer 503 can thereafter process the account holder's response. If the central processing computer 503 determines that the communication or transaction is authorized or approved, the central processing computer 503 can connect, complete, or consummate, the communication or transaction. If the communication or transaction is not authorized or not approved, the central processing computer 503 can disconnect, cancel, or terminate, the respective non-wireless communication or transaction.

The apparatus 500 can be utilized and/or can be programmed so that the account holder can or must approve the communication prior to the communication being made, effected, and/or transacted. The apparatus 500 can also be utilized and/or programmed so that the account holder can or must approve the communication subsequent to the communication being made, effected, the communication link established, and/or transacted. In the case when the account holder disapproves of the communication after the communication or call has been made, effected, communication established, and/or transacted, the transaction communication device 502 will terminate and/or cancel the communication.

In any of the embodiments described herein, any of the communications which are transmitted, received, and/or which take place during apparatus operation, by and between any of the transaction communication devices 502, the central processing computers 503, and the communication devices 504, can take place in real-time and/or otherwise.

In instances when the transaction communication device owner is a party to the non-wireless communication or call, he or she, having the communication device 504 on his or her person, can authorize the communication, call, and/or transaction, at his or her present location. If the transaction communication device owner has lent out the transaction communication device, he or she can authorize the non-wireless communication, call, and/or transaction, from his or her remote location.

The transaction communication device owner can also program and/or set the communication device 504 to automatically authorize or disapprove or disallow non-wireless communication, calls, and/or transactions, with said selective authorizations being made as to time of day, calling areas, numbers called, and/or call and/or transaction duration. In this regard, the communication device 504 can be programmable so as to receive and analyze the transaction communication device call information and/or data and reply or respond to same automatically and/or with preset or programmed replies and/or responses. The communication device 504 can also be programmable so as to limit the number of non-wireless communications, calls, and/or transactions, made from the transaction communication device and/or with the transaction communication device number.

The communication device 504, in the preferred embodiment, is provided with a memory device for storing any number of non-wireless communication device calls and/or transactions so that the transaction communication device owner can review his or her account activity and/or non-wireless communications, calls, and/or transactions, made and/or which have occurred involving his or her transaction communication device. In this manner, the transaction communication device owner can “scroll” through and/or in other ways review account activity. The communication device 504 can also be equipped to service more than one transaction communication devices.

The central processing computer 503 can also be programmed to provide notification to the account owner upon the occurrence of any number of events and/or occurrences which take place regarding and/or relating to the respective account. The central computer 503 can provide notification to the account owner upon the receipt of an account owner's payment, a credit to the account, a reaching of a certain level of account charges, the crediting of the payment to the respective account, account calling activity, the reaching of a certain limitation on account usage, the restricting of a certain usage, the attempt to perform a restricted and/or prohibited activity on the account, the reaching of a pre-specified credit, charge, debit, and/or other respective limit on the respective account, telephone or communications transacted, and/or any other occurrence and/or event which may be of interest to the account holder.

The central processing computer 503 can also notify the account owner regarding a payment due date, an overdue status of a payment, an account restriction and/or limitation on usage, etc.

In this manner, the account owner can be notified of any of the above-described and/or any other event or occurrences. For example, the account owner can be notified when a payment is received, when a certain level of usage, and/or when any other event or transaction of interest to the account owner occurs on and/or regarding the account.

Similarly, the account owner can be notified when he or she has reached and/or is close to reaching a pre-specified account usage level and/or upon the occurrence of administrative events or occurrences, i.e. payment due date, payment overdue, account restrictions, and/or the charging of maintenance or service fee charges.

In another preferred embodiment, the transaction communication device 502 can be programmed to provide any of the functions described herein as being performed by the central processing computer 503, including, but not limited to, providing any of the notification functions for providing notification to the account owner of any of the above-described events and/or occurrences.

The various processing routines described herein as being performed by the apparatus 500 of the present invention in FIGS. 23A and 23B and FIGS. 24A, 24B and 24C can also be performed in conjunction with each other and/or can be combined so that the apparatus 500 can perform multiple routines in conjunction with each other. In this regard, the transaction communication device 502 can, in another preferred embodiment, transmit the information and/or data pertinent to a transaction to the communication device 504 associated with an account owner, and process the transaction in the manner described herein with the account owner, while also transmitting the information and/or data pertinent to the transaction to the central processing computer 503 and processing the transaction with the central processing computer 503.

The transaction communication device 502 can transmit the respective transmissions to the respective devices 504 and 503 in a sequential fashion and/or in any desired and/or specified order and/or the transaction communication device can transmit the respective transmissions to the respective devices 504 and 503 simultaneously. In any event, the transaction communication device(s) 502, the central processing computer(s) 503, and the communication device(s) 504, in the preferred embodiments described herein, can be suitably equipped with any necessary, additional, and/or desired, hardware and/or software for facilitation their respective operations and/or functionality as described herein.

In this manner, the transaction communication device 502 can communicate with the account holder via the communication device 504 and independently of any transaction processing by a central transaction processing computer or central transaction processing service.

The apparatus and method of the present invention provides for the real-time notification of non-wireless communication device usage which enables a non-wireless communication device owner and/or account holder to monitor, in real-time, activity involving his or her non-wireless communication device and/or non-wireless communication device number and/or account.

The apparatus and method of the present invention also provides a means and a mechanism by which to inform a non-wireless communication device owner that the non-wireless communication device is lost or stolen, and/or to provide notification to the non-wireless communication device owner that his or her non-wireless communication device number is being utilized in communications, calls, and/or transactions, such as when a non-wireless communication device has been illegally “cloned”. The non-wireless communication device owner and/or account holder can then report the non-wireless communication device lost or stolen and/or cancel and/or de-activate the non-wireless communication device number and/or account.

The present invention also provides a means and a mechanism by which to monitor the number of non-wireless communications, telephone calls, and/or transactions, which are unauthorized by the non-wireless communication device owner and/or account holder and to determine whether or not to de-activate the non-wireless communication device and/or the non-wireless communication device number and/or account.

The central processing computer 503 and/or the transaction communication device 502 can also generate and transmit notification signals, e-mails, and/or other electronic and/or conventional messages and/or transmissions to notify the account holder regarding any account occurrence, event, and/or activity described herein.

The account owner can report any unauthorized activity and/or respond to any account activity at time. In the above manner, the apparatus and method of the present invention provides an apparatus and a method to prevent and/or to drastically limit fraudulent and/or unauthorized use of, and/or the “cloning” of, non-wireless communication devices and/or the unauthorized use of non-wireless communication device numbers and/or accounts.

In another preferred embodiment of the apparatus of FIG. 21, the apparatus 500 can be programmed and/or can be programmable by the respective account holder, account owner, non-wireless communication device owner, and/or any other authorized individual, (hereinafter referred to as “account holder” or “account owner”). The account holder or account owner can access the central processing computer 503 via the communication device 504, a telephone, and/or any other communication device. The account holder or account owner can thereafter program the central processing computer 503 by transmitting a signal, data, and/or information, containing and/or corresponding to instructions for restricting and/or limiting activity and/or communications and/or transactions which can occur and/or take place on, or in conjunction with, the respective account.

The signal, data and/or information, containing the restriction(s) and/or limitation(s) data and/or information is received by the receiver 503G. Thereafter, the CPU 503A will process the restriction(s) and/or limitation(s) data and/or information and store any appropriate data and/or information in the database 503H.

The above-described programming of restrictions and/or limitations into the central processing computer 503 can take place in real-time and/or otherwise.

The restrictions and/or limitations which can be programmed into the central processing computer 503 can include the types of communications and/or transactions which are allowed and/or authorized, limitations and/or restrictions on account or non-wireless communication device usage, types of communications and/or transactions which are allowed and/or authorized, limits on the amounts of communications and/or transactions which can occur on an account, number of communications, calls, and/or communications and/or transactions, which can occur on an account and/or from a non-wireless communication device, authorized parties to use the account or device, authorized geographical area or location of usage, authorized times for account access and/or account and/or non-wireless communication account and/or device usage (i.e. specific days, dates, time of day, time of month, year, etc.), and/or any other limitation and/or restriction regarding amount of communications and/or transactions, parties involved, geographical area, and/or times of allowed usage.

The limitations and/or restrictions can also include limitations and/or restrictions on account usage and/or non-wireless communication device account usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of non-wireless communication devices.

The limitations and/or restrictions can also include limitations on and/or regarding communication charges, individuals who may make communications or the transactions on the account and/or with the non-wireless communication device, proof of identity of which the types of proof may be specified, specific communication providers and/or carriers authorized to service the account and/or non-wireless communication device,

With regards to any of the non-wireless communication accounts and/or non-wireless communication devices described herein, the account holder or account holder can also change, specify, or programmably change, passwords, personal identification numbers and/or any other access code(s) and provide for various personal identification numbers and/or access codes for different communications, transactions, times of usage, etc.

For example, the account holder, account owner, and/or non-wireless communication device owner can limit account usage (i.e. no calls or communications outside the United States, no calls to certain designated telephone numbers, can program the central processing computer 503, and/or the server computer, if utilized, so as to limit account communications and/or transactions by amounts (i.e. no calls exceeding a certain charge limit, no account usage once a pre-specified account charge limit, for example 600 minutes or $100.00 has been reached), to limit communications and/or transactions by times of usage (i.e. no non-wireless communication device usage between 10:00 P.M. and 8:00 A.M.), to change service plan (i.e. unlimited regional or long distance calling), and/or to establish and/or change credit limits on an account, periodically and/or at any desired time.

The account holder of account owner can program the central processing computer 503, and/or the server computer, if utilized, via the communication device 504, a telephone, and/or any other suitable communication device. The account holder or account owner can also perform the above-described programming via a touch-tone telephone. In the same manner, the account holder or account owner, can also program the apparatus 500 so as to limit the types of communications and/or transactions involving his or her account.

Once programmed by the account holder or account owner, the central processing computer 503, upon receiving a communication and/or transaction authorization request or a communication and/or transaction processing request, will process the communication and/or transaction in conjunction with the restriction(s) and/or limitation(s) provided, programmed, and/or dictated, by the account holder or account owner.

By utilizing the above-described programming routine(s), an account holder, account owner, cardholder, and/or other authorized individual, can program and/or update any data and/or information which can or may be stored in the database 503H. The above-described programming routine(s) can be performed in real-time and/or otherwise.

In another preferred embodiment, the account holder or account owner can program the respective transaction communication device 502 and/or communication device 504, in the same manner in which the central processing computer 503 can be programmed, so as to program restrictions and/or limitations into the respective devices. The transaction communication device 502 can, in this manner, be directly programmable, by the account holder, or account owner, non-wireless communication device owner, and/or other authorized individual, in real-time and/or otherwise, in the same manner described above regarding the central processing computer 503, so as to automatically process a communication or transaction in accordance with the restrictions or limitations provided by account holder, account owner, non-wireless communication device owner, and/or other authorized individual.

The communication device 504 can also be directly programmable by the account holder or account owner, in real-time and/or otherwise, in the same manner described above regarding the central processing computer 503, so as to automatically process a communication and/or transaction authorization request and/or a communication and/or transaction.

In a similar manner, the account holder, account owner, non-wireless communication device owner, and/or other authorized individual, can program the apparatus 500 as described above in conjunction with the use of any of the herein-described non-wireless communication accounts and/or non-wireless communication devices.

While the embodiment of the present invention is described above in conjunction with the use of non-wireless communication devices, the present invention of FIG. 21, in other preferred embodiments, can be utilized in conjunction with any non-wireless communication device including personal computers, personal digital assistants, facsimile machines, and/or other non-wireless communication devices which work in conjunction with a non-wireless communication network. The embodiment of FIG. 21 can also be utilized with non-wireless communication devices utilized on, over, and/or in conjunction with the Internet, the World Wide Web, and/or any other communication network.

The apparatus and method of the present invention can also be utilized in connection with an on-line service and/or on, or over, the Internet and/or the World Wide Web, so as to provide for a means by which the respective cardholder, account owner, and/or wireless communication device owner, can utilize the apparatus and method in conjunction with a home and/or a personal computer, a personal communications device, and/or a commercial or industrial computer system (i.e., an internet server computer), and/or any other appropriate device, in any appropriate network, system or medium.

The present invention, in another preferred embodiment, can also be utilized so as to provide authorization, notification and/or security for, and in conjunction with, wireless communication device and/or communication systems wherein a wireless communication device owner and/or account owner can be notified of a transmission and/or an attempted transmission and/or wireless communication transaction made with his or her cellular or mobile telephone and/or with the telephone number and or transmission codes and/or associated signatures and/or data which corresponds to his or her wireless communication device.

The present invention, in another preferred embodiment, can also be utilized so as to provide authorization, notification and/or security for, and in conjunction with, wireless communication devices and/or wireless communication systems wherein a wireless communication device owner and/or account owner can be notified of a transmission and/or an attempted transmission and/or transaction made with his or her wireless communication device and/or with the account and/or telephone number and/or transmission codes and/or associated signatures and/or data which corresponds thereto.

In another preferred embodiment, the present invention can be utilized to monitor and/or to provide security for Internet accounts and/or for communications utilized in conjunction with the Internet, the World Wide Web, and/or any other communication network.

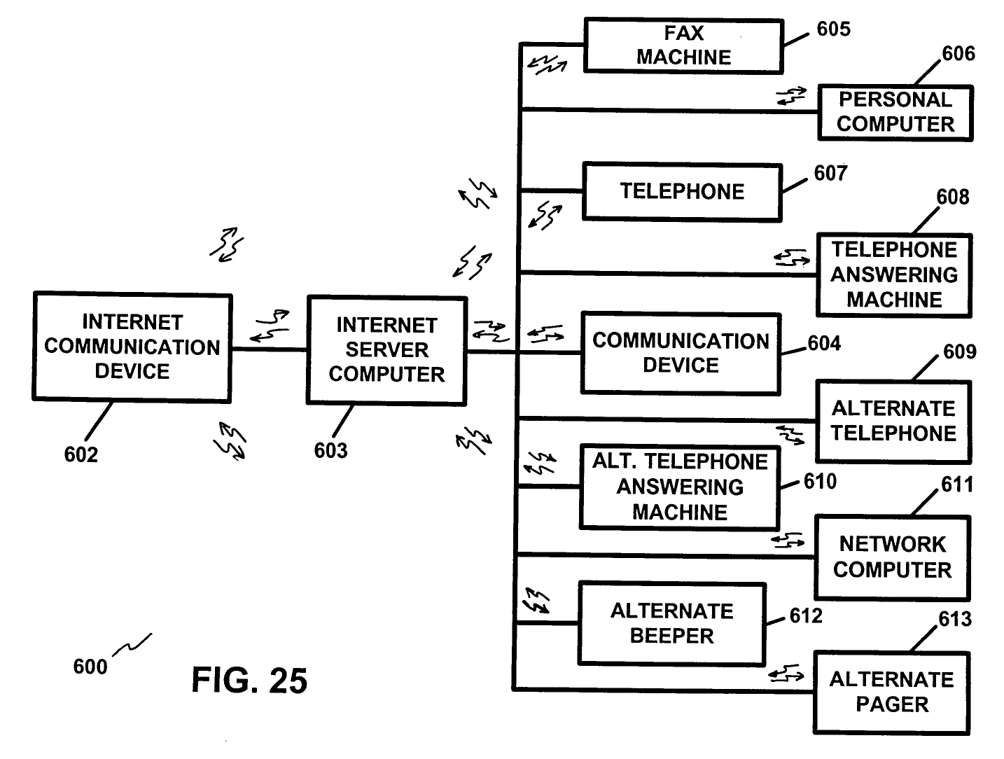

FIG. 25 illustrates a block diagram of another preferred embodiment of the apparatus of the present invention which is utilized in conjunction with an Internet account, Internet subscription account, and/or Internet Service Provider Account (hereinafter referred to as “Internet account”).

The apparatus of FIG. 25 is denoted generally by the reference numeral 600. In the embodiment of FIG. 25, the apparatus 600 can be utilized to provide authorization, notification, and/or security for Internet accounts, for preventing access to certain web sites, for preventing access to certain objectionable material or subject matter, for preventing access during certain time periods, for supervising and/or controlling use of an Internet account, and/or for exercising control, for authorizing account usage, for providing notification of account usage and/or activity, and/or for providing any other service or function which is described herein and/or which may be pertinent to Internet account usage.

In FIG. 25, the apparatus 600 includes of a Internet communication device 602 which, in a preferred embodiment, can be computer, computer, computer system, and/or communication device for accessing, utilizing, and/or “surfing” the Internet and/or the World Wide Web, and/or any other communication network.

The apparatus of FIG. 25 is denoted generally by the reference numeral 600. In FIG. 25, the apparatus 600 includes of a Internet communication device 602 which can be any computer or communication device described herein for utilization in conjunction with the Internet and/or the World Wide Web, and/or any other communication network.

In the embodiment of FIG. 25, the Internet communication device 602 serves as the transaction device which is described in the above described embodiments. The Internet transaction communication device 602 can transmit an authorization request and/or a transaction notification signal, which can include data and/or information pertaining to the Internet communication and/or transaction and/or event, to a central processing computer, an Internet server computer, and/or to an account holder communication device, and/or another communication device associated with the Internet account holder, and/or an individual authorized to act for, and/or on behalf of the account holder. The Internet communication device 602 can also receive authorization data and/or information from the Internet server computer and/or from the communication device associated with the Internet account holder. The Internet communication device 602 can include, or have associated therewith, a keypad for the manual entry of information and/or data, command codes, Internet domain codes, and/or any other data and/or information in conjunction with usage of an Internet account and/or Internet activities.

The apparatus 600 also includes a central processing computer, Internet server computer, server computer, DNS server computer, and/or any other network computer or computer system 603 (hereinafter referred to as “Internet server computer 603”) which services any predefined group of Internet communication devices and/or Internet accounts. For example, the Internet server computer 603 can handle Internet communications and/or transactions for a given Internet service provider(s), for any number of Internet accounts, and/or for any communication network, area and/or region. The Domain Name Server (DNS) can be utilized in processing requests or transmissions which involve accessing and/or linking to a web site associated with the domain name. Other Internet server computers or network computers can be utilized to process requests for information, transactions, commercial transactions, and/or any other processing services which can be provided by Internet or network server computers.

The Internet server computer 603, for example, can process and maintain records of Internet communication device access to web sites or other host or other computers, attempted access to web sites or other host or other computers, web sites or other computers visited, the content of web sites visited (i.e. whether certain objectionable words and/or other content was detected from the visit to the site), access by other computers or web sites, the content of the visiting web sites or computers (i.e. whether certain objectionable words and/or other content was detected from the visiting site), communications, transactions, commercial transactions, retail transaction, business-to-business transactions, purchases made, communications made, telephone calls made, including billing information, account activity, usage records, times of usage, usage time, total usage time, usage costs, total usage costs, telephone numbers called, incoming calls telephone numbers, etc., web sites and/or computers hosting same, restrictions and/or limitations on access to certain web sites or computers hosting same, for any number of Internet communication devices which are serviced by a particular Internet server computer 603, Internet service provider, company, or central processing office or computer.

The Internet server computer 603 can be a mainframe computer, a mini-computer, a micro-computer, a server computer, such as those utilized in conjunction with the Internet, the World Wide Web, on-line services, and/or in any network environment, and/or any other suitable computer or computer system.

The Internet server computer 603 can also process accounts for any of the Internet communication devices and/or Internet accounts described herein. In the preferred embodiment, the Internet communication device 602 is linked and/or connected to the Internet server computer 603 via a telecommunications network, system, link and/or medium (hereinafter referred to as “communications network” or “communication system”) such as, for example, a telephone network or line, a non-wireless network or link, the Internet, the World Wide Web, and/or any other suitable network. The communications network or system which is utilized can be any communications network or system and can include telecommunication systems, satellite communications systems, radio communication systems, digital communications systems, digital satellite communications systems, personal communications services communication systems, cable television systems, digital television systems, satellite television systems, broadband communication systems, as well as any other appropriate communications system. The Internet communication device 602 transmits signals and/or data to the Internet server computer 603 as well as receives signals and/or data from the Internet server computer 603.

The apparatus 600 also includes a Internet account holder communication device 604 which can receive signals and/or data from as well as transmit signals and/or data from, the Internet communication device 602.

In any and/or all of the embodiments described herein, the Internet communication devices 602 and/or the account holder communication devices 604 can also process and maintain records of Internet communication device access to web sites or other host or other computers, attempted access to web sites or other host or other computers, web sites or other computers visited, the content of web sites visited (i.e. whether certain objectionable words and/or other content was detected from the visit to the site), access by other computers or web sites, the content of the visiting web sites or computers (i.e. whether certain objectionable words and/or other content was detected from the visiting site), communications, transactions, commercial transactions, retail transaction, business-to-business transactions, purchases made, communications made, telephone calls made, including billing information, account activity, usage records, times of usage, usage time, total usage time, usage costs, total usage costs, telephone numbers called, incoming calls telephone numbers, etc., web sites and/or computers hosting same, restrictions and/or limitations on access to certain web sites or computers hosting same, for any number of Internet communication devices which are serviced by a particular Internet server computer 603, Internet service provider, company, or central processing office or computer.

In another preferred embodiment of FIG. 25, the communication device 604 receives signals and/or data directly from the Internet communication device 602 with said signals being transmitted via a suitable communication system. In this preferred embodiment, the communication device 604 can also transmit signals and data to the Internet communication device 602, directly and/or indirectly, with said signals being transmitted via a suitable communication system.

In another preferred embodiment of FIG. 25, the communication device 604 can receive signals and/or data from the Internet server computer 603, directly and/or indirectly, with said signals being transmitted via a suitable communication system. In this preferred embodiment, the communication device 604 can also transmit signals and data to the Internet server computer 603, directly and/or indirectly, with said signals being transmitted via a suitable communication system.

The communication device 604 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch.

The Internet account holder communication device 604 can also receive signals and/or data from as well as transmit signals and/or data from the Internet server computer 603. In the embodiment of FIG. 25, the communications network or system utilized for transmitting signals and/or data to and/or from any of the communication devices 602 and 604 and the Internet server computer 603 is a communication network which can include a non-wireless network or link.

In a preferred embodiment, the communication device 604 is also equipped with a transmitter for transmitting signals and/or data to the Internet server computer 603. In this regard, the Internet server computer 603 transmits signals and/or data to the communication device 604 as well as receives signals and/or data from the communication device 604. The communication device 604 can also transmit signals and/or data directly to the Internet communication device 602 and receive signals and/or data directly from the Internet communication device 602.

As noted above, the communication device 604 can be a wireless communication device. The Internet communication device 602 can also be a wireless communication device. In any of the embodiments described herein, any of the account holder's communication devices 604 can be carried by the account holder and/or an individual authorized to act for and/or on behalf of the account holder.

In the embodiment of FIG. 25, the apparatus 600 can also includes a facsimile (fax) machine 605, a personal computer or personal digital assistant 606, a telephone 602, a telephone answering machine 608, an alternate telephone 609, an alternate telephone answering machine 610, a network computer 611, an alternate beeper 612, and an alternate pager 613.

The Internet communication device 602 and the Internet server computer 603 can be linked with the above fax machine 605, personal computer or personal digital assistant 606, telephone 607 and associated answering machine 608, alternate telephone 609 and associated answering machine 610, network computer 611, alternate beeper 612 and/or alternate pager 613, via any suitable communication system. In the preferred embodiment, a telecommunications link or line, which may or may not be a wireless link depending on the device and/or the circumstances, is utilized in order to link the Internet server computer 603 with each of the fax machine 605, the personal computer or personal digital assistant 606, the telephone 607 and associated answering machine 608, the alternate telephone 609 and associated answering machine 610, the network computer 611, the alternate beeper 612, and/or the alternate pager 613.

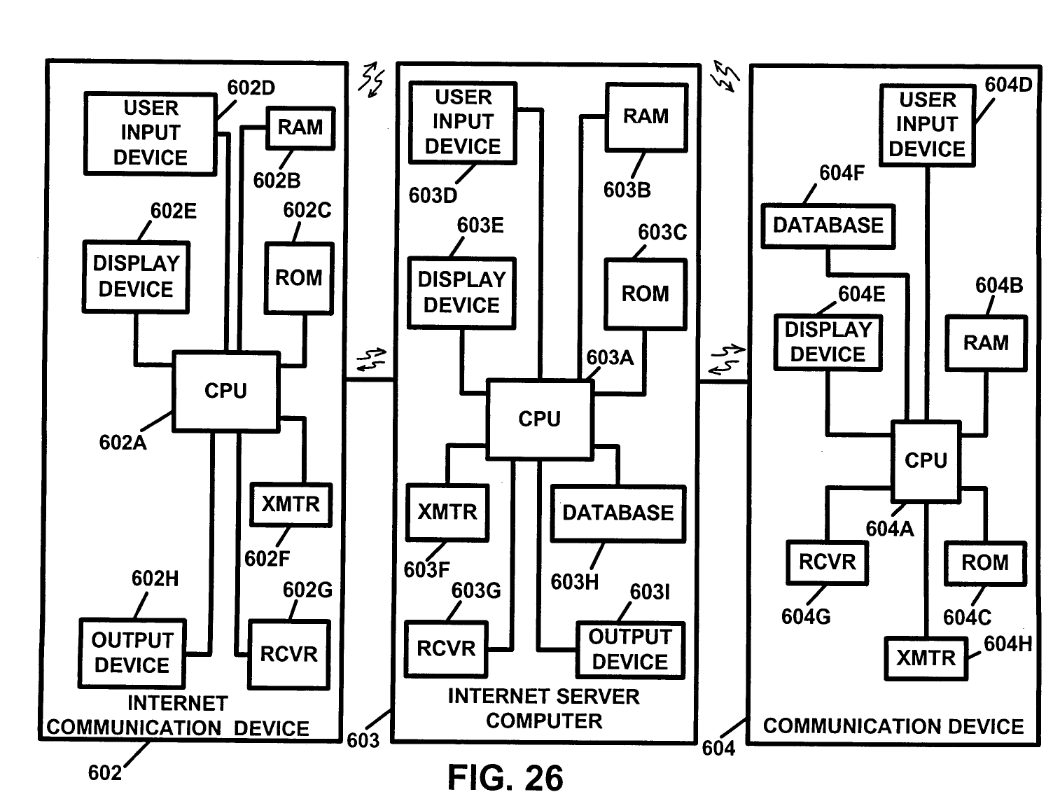

FIG. 26 illustrates the various components of the apparatus 600 of FIG. 26. In FIG. 26, the Internet communication device 602, in the preferred embodiment, includes a central processing unit or CPU 602A, associated random access memory 602B (RAM) and read only memory 602C (ROM) devices, which are also connected to the CPU 602A, a user input device 602D, which is a typically a keypad or other suitable input device for inputting data into the Internet communication device 602 and which is also connected to the CPU 602A, and a display device 602E for displaying information and/or data to a user or operator of the Internet communication device 602.

The Internet communication device 602 also includes a transmitter 602F for transmitting signals during normal communication operation and for transmitting signals and/or data to the Internet server computer 603, and/or to the account holder communication device 604 and/or to any other device associated with the account owner or apparatus 600, if desired. The transmitter can also be a wireless transmitter for transmitting wireless signals. The transmitter 602F is also connected to the CPU 602A.

The Internet communication device 602 also includes a receiver 602G for receiving signals during normal telephone operation and/or for receiving signals and/or data from the Internet server computer 603 and from the communication device 604 and/or from any other associated device which can be utilized, if desired. The receiver can also be a wireless receiver for receiving wireless signals. The receiver 602G is also connected to the CPU 602A.

The Internet communication device 602 can also include a printer 602H or other appropriate output device for outputting data to the user. The printer 602H, if utilized, is also connected to the CPU 602A. In the preferred embodiment, the printer 602H prints receipts corresponding to the transaction and/or information transmitted during the communication or telephone call or transaction.

The Internet communication device 602 also includes a database 602I. The database 602I can include data and/or information regarding the Internet communication device, the account holder, the Internet account, restrictions and/or limitations on account usage and/or Internet communication device usage, including but not limited to, times of usage, types of usage, authorized web sites and/or computers which can be accessed by, and/or which can access the Internet communication device 602, prohibited web sites and/or computers which cannot be accessed by and/or which cannot access the Internet communication device 602, authorized numbers called and/or communicated with, authorized numbers from which calls or communication can be received, usage time limits, usage costs limits, restrictions and/or limitations on transactions which can occur via an Internet account and/or which can be prohibited via an Internet account (i.e. no credit card purchases allowed, no transactions with a certain type of web site, etc.), and/or any other restrictions, limitations, and/or authorizations, and/or disapprovals, restrictions and/or limitations of usage of Internet communication devices.

The Internet communication device 602 can also be programmable so that any of the restrictions and/or limitations described herein can be programmed into the Internet communication device 602.

The Internet communication device 602 can also include a scanner or reader device 602J which is connected to the CPU 602A and which can be utilized to scan or read data and/or information from a respective account card and/or magnetic strip or “smart” chip located thereon or therein.

In FIG. 26, the Internet server computer 603, in the preferred embodiment, includes a central processing unit or CPU 603A, associated random access memory 603B (RAM) and read only memory 603C (ROM) devices, which are connected to the CPU 603A, a user input device 603D, which is a keypad or any other suitable input device for inputting data into the Internet server computer 603 and which is also connected to the CPU 603A and a display device 603E for displaying information and/or data to a user or operator.

The user input device 603D can includes any data input device including, but not limited to, a keyboard, a mouse, a scanner, a reader or card reader, an audio input device, a voice recognition device, a fingerprint reading device, a retinal scanning device, and/or any other device for inputting data and/or information into the Internet server computer 603.

The Internet server computer 603 also includes a transmitter(s) 603F for transmitting signals and/or data to the Internet communication device 602 and to the communication device 604, and/or to any other device which can be utilized, and/or to any one or more of the fax machine 605, personal computer or personal computer or personal digital assistant 606, telephone 607 and associated answering machine 608, alternate telephone 609 and associated answering machine 610, network computer 611, alternate beeper 612, and/or alternate pager 613. The transmitter(s) 603F is also connected to the CPU 603A.

The Internet server computer 603 also includes a receiver(s) 603G for receiving signals and/or data from the Internet communication device 602 and from the communication device 604, and/or from any other suitable device which can be utilized in conjunction with the apparatus 600. The receiver(s) 603G is also connected to the CPU 603A.

The Internet server computer 603 also includes a database(s) 603H which contains account information and data pertaining to the Internet account, device, and/or account holder. The database 603H contains information about the Internet communication device, account, and account holder, information and/or data necessary to the manage and/or process an account and/or account transaction as described herein, as well as restrictions and/or limitations on account usage and/or Internet communication device account usage, for any of the accounts processed and/or managed via the Internet server computer 603, including but not limited to, times of usage, types of usage, authorized web sites and/or computers which can be accessed by, and/or which can access the Internet communication device 602, prohibited web sites and/or computers which cannot be accessed by and/or which cannot access the Internet communication device 602, prohibited words and/or subject matter which is, or could be, found on the web site or host computer, authorized numbers called and/or communicated with, authorized numbers from which calls or communication can be received, usage time limits, usage costs limits, restrictions and/or limitations on transactions which can occur via an Internet account and/or which can be prohibited via an Internet account (i.e. no credit card purchases allowed, no transactions with a certain type of web site, etc.), and/or any other restrictions, limitations, and/or authorizations, and/or disapprovals, restrictions and/or limitations of usage of Internet communication devices and/or Internet accounts.

The Internet server computer 603 can also be programmable so that any of the restrictions and/or limitations described herein can be programmed into the Internet server computer 603. The database 603H is also connected to the CPU 603A.

The database 603H can include any number of databases which may or may not be linked to one another. The database 603H can also be linked to a database or databases which are located external from the Internet server computer 603.

The database 603H can also include data and/or information regarding specific limitations and/or restrictions which can be placed on a particular account, which can be pre-selected and/or programmed by the account holder and which can include limitations and/or restrictions on the usage of the Internet communication device 602.

The limitations and/or restrictions can include the types of transactions or communications which are allowed and/or authorized, limits on the amounts of transactions or communications which can occur with the Internet communication devices, number of transactions or communications which can occur with the Internet communication devices, authorized parties to use the Internet communication devices, authorized geographical area or location of usage, wherein authorized communication device use can be limited, and/or authorized times for account access and/or account usage (i.e. specific days, dates, time of day, time of month, year, etc.), and/or any other limitation and/or restriction regarding amount of transaction or communication, parties involved, geographical area, and/or times of allowed usage.

The Internet server computer 603 also includes a printer 603I or other appropriate output device for outputting information and/or data to a user or operator.

In FIG. 26, the account holder communication device 604, in the preferred embodiment, includes a central processing unit or CPU 604A, associated random access memory 604B (RAM) and read only memory 604C (ROM) devices, which also connected to the CPU 604A, a user input device 604D, which is a keypad or a plurality of keys and/or switches for inputting data into the communication device 604 and which is also connected to the CPU 604A, and a display device 604E, for displaying information and/or data to the Internet communication device account holder, and a database 604F, which are also connected to the CPU 604A.

The user input device 604D can include any data input device including, but not limited to, a keyboard, a mouse, a scanner, a reader or card reader, an audio input device, a voice recognition device, a fingerprint reading device, a retinal scanning device, and/or any other device for inputting data and/or information into the account holder communication device 604.

The database 604F can include data and/or information regarding the Internet communication device, the account holder, the Internet account, the account holder, the Internet account, restrictions and/or limitations on account usage and/or Internet communication device usage, including but not limited to, times of usage, types of usage, authorized web sites and/or computers which can be accessed by, and/or which can access the Internet communication device 602, prohibited web sites and/or computers which cannot be accessed by and/or which cannot access the Internet communication device 602, authorized numbers called and/or communicated with, authorized numbers from which calls or communication can be received, usage time limits, usage costs limits, restrictions and/or limitations on transactions which can occur via an Internet account and/or which can be prohibited via an Internet account (i.e. no credit card purchases allowed, no transactions with a certain type of web site, etc.), and/or any other restrictions, limitations, and/or authorizations, and/or disapprovals, restrictions and/or limitations of usage of Internet communication devices.

The communication device 604 can also be programmable so that any of the restrictions and/or limitations described herein can be programmed into the transaction communication device 604. The communication device 604 can be programmed to process any transaction described herein.

The communication device 604 also includes a receiver 604G for receiving signals and/or data from the Internet server computer 603 and for receiving signals and/or data from the Internet communication device 602. The receiver 604G is also connected to the CPU 604A. The communication device 604 also includes a transmitter 604H for transmitting signals and/or data to the Internet server computer 603 and for transmitting signals and/or data to the Internet communication device 602. The transmitter 604H is also connected to the CPU 604A.

The communication device 604 can also include a scanner and/or reader device 604I, such as a card reader, a magnetic strip card reader, and/or any other reading or scanning device for obtaining information from an account card associated with a Internet account, also referred to as a Internet account. The scanner or reader device 604I can, in the preferred embodiment, be capable of reading and processing data and/or information, which is stored on the magnetic strips and/or on the processors or chips which are located on the respective account card, and for providing one or multiple communications for one or multiple parties as well as reading and processing any restriction and/or limitation information regarding and/or related to account usage. For example, the magnetic card reader or card reader 604I can read and/or process data and/or information for identifying and communicating with a Internet server computer 603 as well as can read and/or process data and/or information for communicating with the individual account holder and/or an individual or agent authorized to act for and/or on behalf of the individual account holder, at any one or more of the communication devices 604 associated with the individual account holder or the individual or agent associated with the individual account holder.

Data and/or information for providing any other the communications described herein can be obtained from the data and/or information contained in the magnetic strip on the card, the respective processor or chip located on the card, and/or can be obtained from an external database (not shown) which can be linked to the communication device 602 and/or which can be accessed thereby for obtaining any additional data and/or information.

In the preferred embodiment, the communication device 604 can be and/or can include any one or more of a personal computer, a personal digital assistant, a telephone, a facsimile (fax) machine, a personal communications device, a telephone answering machine, an alternate telephone, an alternate telephone answering machine, an interactive television, a television, a network computer, a pager, a beeper, an alternate beeper or pager, and/or a watch. A two-way pager and/or pager systems can also be utilized for implementing the respective components, and/or systems in the communication device 604/Internet server computer 603 combination and/or link.

The apparatus 600 of the present invention, in the preferred embodiment, can be utilized in order provide a Internet account holder with authorization, notification and/or security measures in usage and/or transactions involving an Internet account as well as any of the Internet communication devices described herein, and/or any communications and/or transactions involving and/or related to same.

The apparatus and method of the present invention can be utilized to obtain Internet account holder authorization in communications and/or transactions involving an Internet account and/or Internet communication devices. The apparatus and method of FIG. 25 can be utilized to block access to certain web sites and/or server computers, to monitor a user's usage of an internet account, the user's access of web sites, a user's transactions on an Internet account. In another preferred embodiment, the present invention, for example, can be utilized by a parent, or any other individual, to prevent a child's, and/or any other individual's, access to certain web sites containing objectionable material (i.e. pornographic web sites, adult entertainment sites, certain goods, services, and/or information), to prevent a child's, or any other individual's purchasing goods and/or services over the Internet, and/or to provide any Internet account authorization, monitoring and/or security functions.

The apparatus 600 can also be utilized in conjunction with an account card or cards, such as Internet subscription cards, credit cards, charge cards, debit cards, “smart” cards bank cards, electronic money account cards, ATM cards, telephone calling cards, and/or any other account card or cards, and/or any other financial accounts, which can be utilized in conjunction with an Internet account and/or an Internet communication and/or transaction, so as to provide authorization, monitoring, and/or security for these accounts and/or account cards.

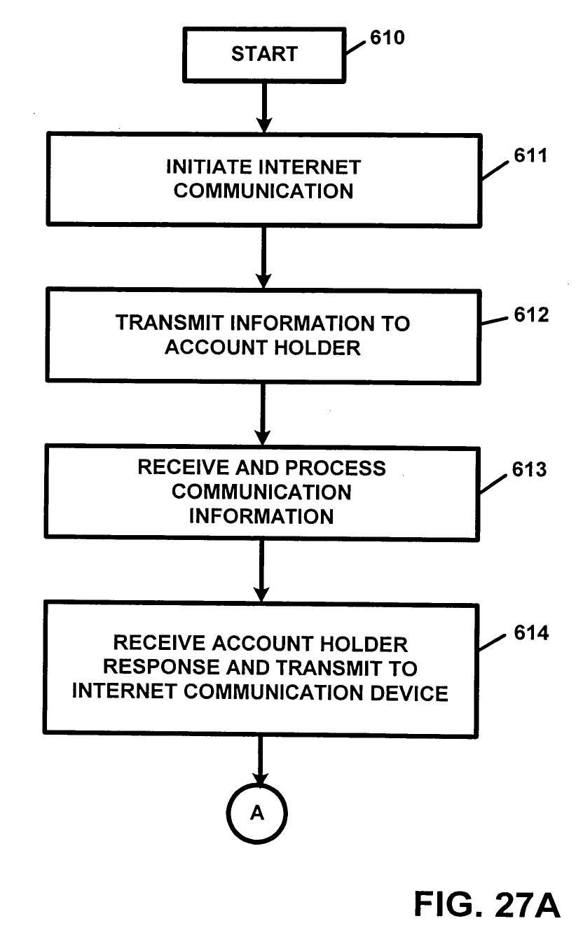

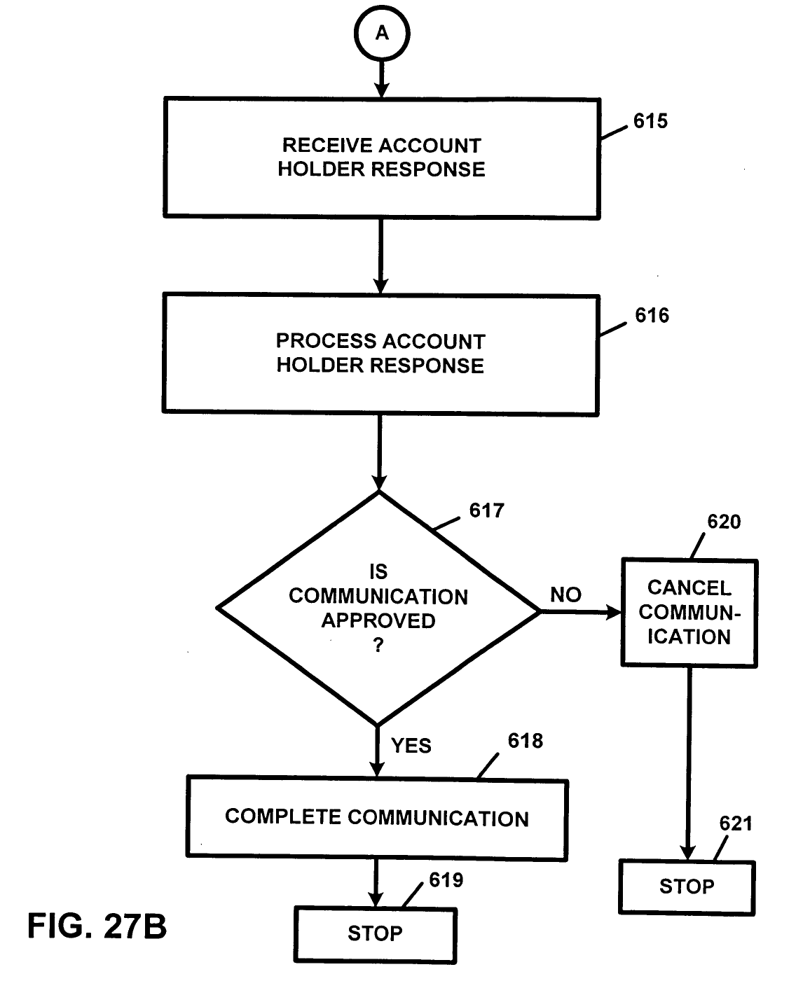

FIGS. 27A and 27B illustrate a preferred embodiment operation of the apparatus 600, in flow diagram form. With reference to FIGS. 27A and 27B, the operation of the apparatus 600 commences at step 610. At step 611, the owner, user, or operator, of the Internet communication device 602 initiates the Internet communication, transmission, transfer, Internet transmission, telephone call, and/or transaction (hereinafter referred to as “Internet communication”), such as by entering a domain name for a web site or computer, accessing a web site or computer, attempting to access a web site or computer, attempting to transfer to a web site or computer, transferring to a web site or computer, accessing an Internet account, engaging in and/or making a transaction on the Internet and/or the World Wide Web or other communication network, attempting to engage in and/or to make a transaction on the Internet, the World Wide Web, and/or any other communication network, and/or performing any other activity and/or function on, and/or in conjunction with, the Internet and/or the World Wide Web, and/or via the Internet communication device 602. For example, the communication can be initiated by entering a domain name or a web site identification into the Internet communication device 602.

Thereafter, the Internet communication can either take place, while the remainder of the routine proceeds as described hereinbelow, or the Internet communication can be halted until authorized by the account holder as described herein.

In any of the embodiments described herein, the Internet communication, transmission, and/or transaction, can involve any one or more of an internet transmission, an Internet protocol transmission, a voice transmission, a data transmission, an audio transmission, a video transmission, a streaming video transmission, a telephone call, a facsimile transmission, an Internet and/or World Wide Web transmission, and/or any other transmission involving communication devices in conjunction with the Internet and/or the World Wide Web.

Data entry prior to, and/or during, communication initiation can typically be performed by entering information via the data input device 602D, such as keyboard or mouse, or by swiping the magnetic strip of the account card through the scanner/reader 602J or by reading information from the processor or chip on the account card via the scanner/reader 602J. The data obtained from the magnetic strip and/or the card processor or chip, and/or from any associated database, can be utilized to contact the account holder communication device 604 and/or the account holder, directly and/or indirectly, and/or to process the communication, transmission, and/or transaction.

In another preferred embodiment, as well as any of the other embodiments described herein, the Internet communication device 602 can process the communication and/or transaction in conjunction with any restrictions and/or limitations on account usage. The restrictions and/or limitations on account usage can be obtained via the data input device 602D, a respective account card, and/or which can be stored in the database 602J.

If the Internet communication device 602 determines that the communication, transmission, and/or transaction, violates and/or otherwise does not conform to a restriction and/or limitation on account usage, the Internet communication device 602 can cancel and/or reject the communication, transmission, and/or transaction, without proceeding further. For example, the Internet communication device 602, upon reading a restriction involving a time of use (i.e. no account usage allowed between 12:00 A.M. and 6:00 A.M.), a location of usage (i.e. no usage outside a particular city, state, or country), or a transaction amount limitation (i.e. no account usage for transactions exceeding $100), can process the communication, transmission, and/or transaction, and determine if the communication, transmission, and/or transaction, would violate a particular restriction or limitation.

If the communication, transmission, and/or transaction, would violate a restriction or limitation, the Internet communication device 602 can cancel the communication, transmission, and/or communication, or prevent same, whichever the case may be, and no further processing would be required. If the communication, transmission, and/or the transaction, would not violate a restriction and/or limitation, the communication processing could continue in any appropriate manner described herein and/or otherwise.

The information and/or data pertinent to the communication, transmission, and/or transaction, and/or the account, is then transmitted, at step 612, to the communication device 604 via the communication network. In any of the embodiments described herein, any information and/or data which is transmitted from the Internet communication device 602 to the communication device 604 can be transmitted directly to the communication device 604 via the communication network.

The information and/or data which is transmitted from the Internet communication device 602 to the communication device 604 can also be transmitted indirectly to the communication device 604, via the communication network, and independently of any communication processing by a central transaction processing computer and/or central transaction processing system.

The transmission of the information and/or pertinent data, which takes place at step 612, is a transmission from the Internet communication device 602 to the communication device 604 via the communication network and takes place independently of any processing of the transaction by a central processing computer or central processing service, such as by the Internet server computer 603 and/or otherwise. In this manner, the present invention provides notification to the account holder of the Internet communication, transmission, and/or transaction, independently of any processing by a central processing computer and/or a central processing service. In this manner, the communication to the communication device 604 can also take place independently of any processing by the apparatus 600.

At step 612, the Internet communication device 602, by utilizing account holder contact information obtained from the account card, the database 602H, and/or otherwise, can also transmit respective signals and/or data to any one or more of the account holder's designated fax machine 605, personal computer or personal digital assistant 606, telephone 607, telephone answering machine 608, alternate telephone 609, alternate telephone answering machine 610, network computer 611, and/or alternate beeper 612 or alternate pager 613.

The information and/or data which is transmitted to the communication device 604 can include information and/or data identifying the communication, the domain name accessed, the web site or server computer accessed, the transaction being attempted, the transaction performed, the web site or server accessing the Internet communication device 602, the destination of the communication or transmission, the source of the communication or transmission, time of communication, transmission and/or transaction, location of communication, transmission and/or transaction, communication origination, telephone number called, communication destination, parties involved, projected cost of communication, time of communication, Internet service provider or carrier involved in the communication, transmission, and/or transaction, etc.

The information and/or data can also include the phone number of the entity and/or a central processing office and/or computer servicing the account so that the account holder can telephone same in order to authorize or cancel the communication, transmission, and/or transaction.

The communication device 604 will, at step 613, receive and process the information and/or data pertinent to the transaction and provide the information to the account holder. At step 613, the information and/or data which is transmitted from the Internet communication device 602 and received at the communication device 604 can be displayed to the account holder on the display device 604E of the communication device 604.

The information displayed on the display device 604E can include the data identifying the communication, transmission, and/or transaction, the domain name accessed, the web site or server computer accessed, the transaction being attempted, the transaction performed, the web site or server accessing the Internet communication device 602, the destination of the communication or transmission, the source of the communication or transmission, time of communication, transmission and/or transaction, location of communication, transmission and/or transaction, communication origination, telephone number called, communication destination, parties involved, projected cost of communication, time of communication, Internet service provider or carrier involved in the communication, transmission, and/or transaction, etc.

The information can also include any other information described herein as being pertinent to and/or related to the Internet communication device, account, and/or the Internet communication, etc. The information and/or data can also include the phone number of the entity and/or a central processing office and/or computer servicing the account so that the account holder can telephone same in order to authorize or cancel the communication.

The communication device 604 can utilize any of the widely known data processing and/or software routines, which are known to those skilled in that art, in order to process transaction requests and/or authorizations involving the use of the respective account(s).

Thereafter, the account holder can, at step 614, enter a response either approving or disapproving the communication, transmission, and/or transaction. At step 614, the account holder's response is also transmitted, via the transmitter 604H of the communication device 604, to the Internet communication device 602. In any of the embodiments described herein, any information and/or data which is transmitted from the communication device 604 to the Internet communication device 602 can be transmitted directly to the Internet communication device 602 and/or indirectly to the Internet communication device 602 via the communication network.

The information and/or data which is transmitted from the communication device 604 to the Internet communication device 602 can also be transmitted indirectly to the Internet communication device 602, via the communication network, and independently of any transaction processing by a central transaction processing computer and/or central transaction processing system. In another embodiment, the information and/or data which is transmitted from the communication device 604 to the Internet communication device 602 can also be transmitted indirectly to the Internet communication device 602, via the Internet server computer 603 or other processing computer or device.

At step 615, the receiver 602H of the Internet communication device 602 will receive the account holder's response. At step 616, the Internet communication device 602 will process the account holder's response. At step 617, the Internet communication device 602 will determine whether the communication, transmission, and/or transaction, is approved or authorized. If, at step 617, it is determined that the communication is approved or authorized the Internet communication device 602 will authorize, allow, and/or connect or complete, the respective communication, transmission, and/or transaction, at step 618.

Thereafter, operation of the apparatus 600 will cease at step 619. If, however, at step 617, it is determined that the communication, transmission, and/or transaction, is disapproved or unauthorized, the Internet communication device 602 will cancel the communication, at step 620. Thereafter, the operation of the apparatus 600 will cease at step 621.

In any of the embodiments described herein, the Internet communication device 602 can utilize software to monitor the actions of the user or operator, ascertain the action(s) taken by the user or operator, determine the communication, transmission, and/or transaction, which may or which could reasonably result from the user's action(s) (i.e. an entry of adult or pornographic web site, the credit card purchase of a good and/or service), determine whether the attempted communication, transmission, and/or transaction is authorized or prohibited, and allow or prevent, respectively, the respective communication, transmission, and/or transaction, from taking place.

The apparatus 600 can also be utilized and/or can be programmed so that the account holder can or must approve the communication, transmission, and/or transaction, prior to the communication being made, effected, and/or transacted. The apparatus 600 can also be utilized and/or programmed so that the account holder can or must approve the communication subsequent to the communication, transmission, and/or transaction, being made, effected, the communication link being established, and/or a transaction taking place. In a case where the account holder disapproves of the communication, transmission, and/or transaction after same has been initiated and/or is in progress, Internet communication device 602 can terminate and/or cancel the respective communication, transmission, and/or transaction.

In the embodiment described above, as well as in any of the embodiments described herein, the Internet communication device 602 can be programmed to wait a pre-specified amount of time for the account holder's response. The Internet communication device 602, can also be programmed to cancel the communication or complete the communication if no response is received. Any of the particular instructions for the particular account can be included in the data and/or information which is stored in the respective databases of the Internet communication device 602, Internet server computer 603, and/or the communication device 604, and/or which can be stored on the magnetic strip, chip, and/or otherwise stored on the respective account card. In this manner, the Internet communication device 602 can utilize instructions which are stored in the respective databases and/or on the respective account card and utilize this data and/or information in performing processing routines regarding the Internet communication, transmission, and/or transaction. In this manner, the present invention can be utilized in order to provide custom tailoring of Internet account usage and/or communication processing regarding a particular Internet communication device and/or Internet account which information can be pre-specified and stored in the respective databases of the respective Internet communication devices, Internet server computer(s) and/or account holder's communication devices and/or on the respective account cards.

In instances when the communication device 604 does not have a reply or two-way pager feature, the account holder can simply telephone the Internet communication device 602, or center or office servicing, and/or associated with, same, in order to personally appraise the device 602, or center or office, of his or her response to the communication.

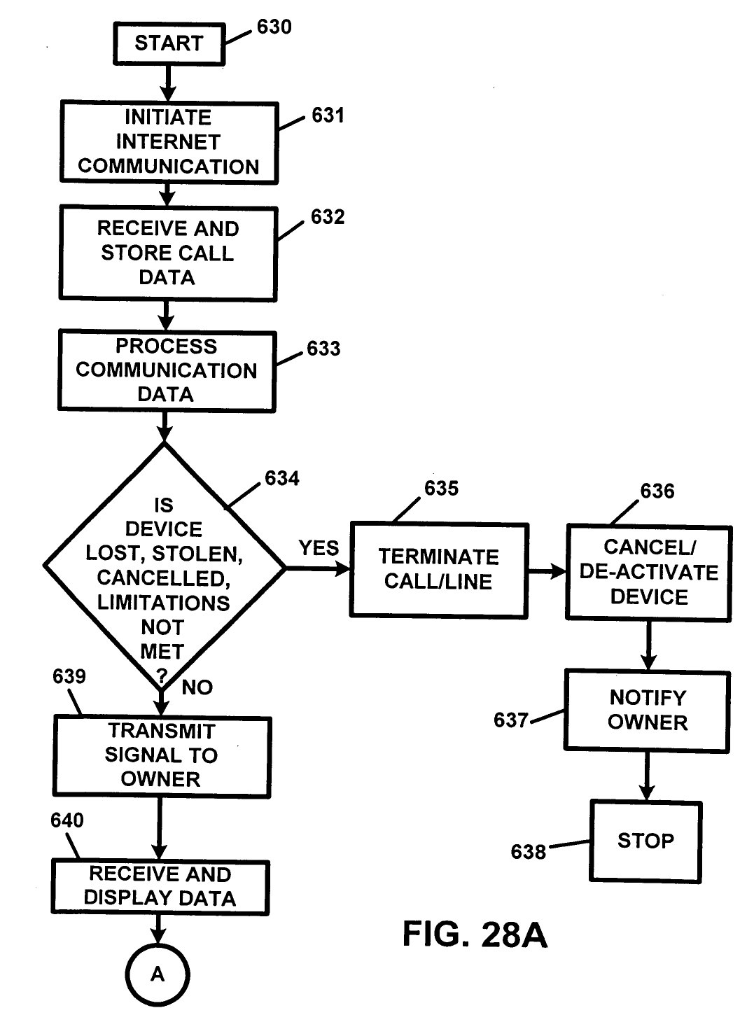

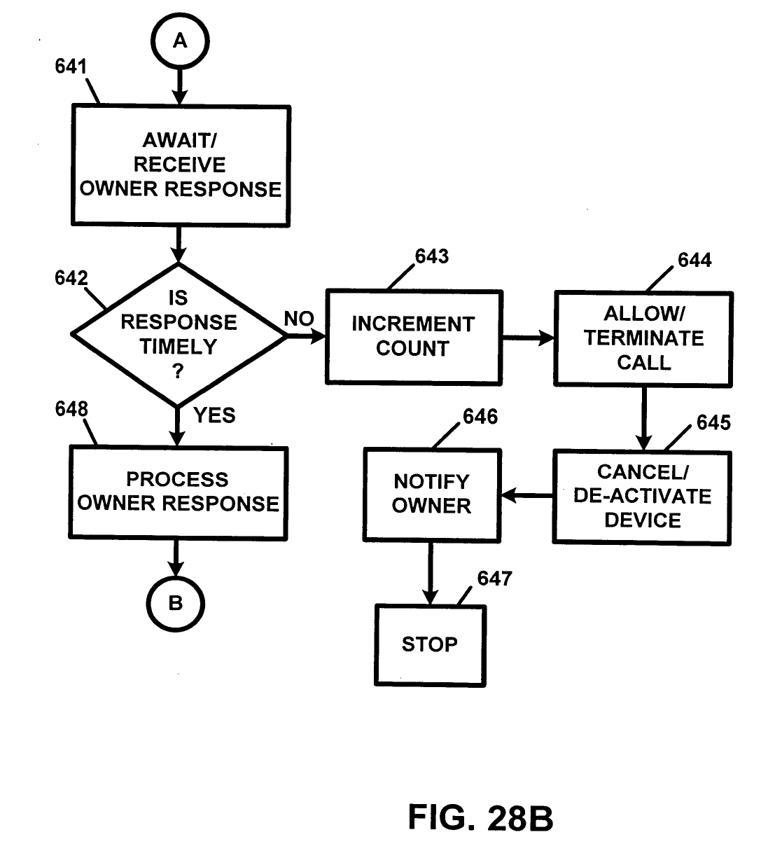

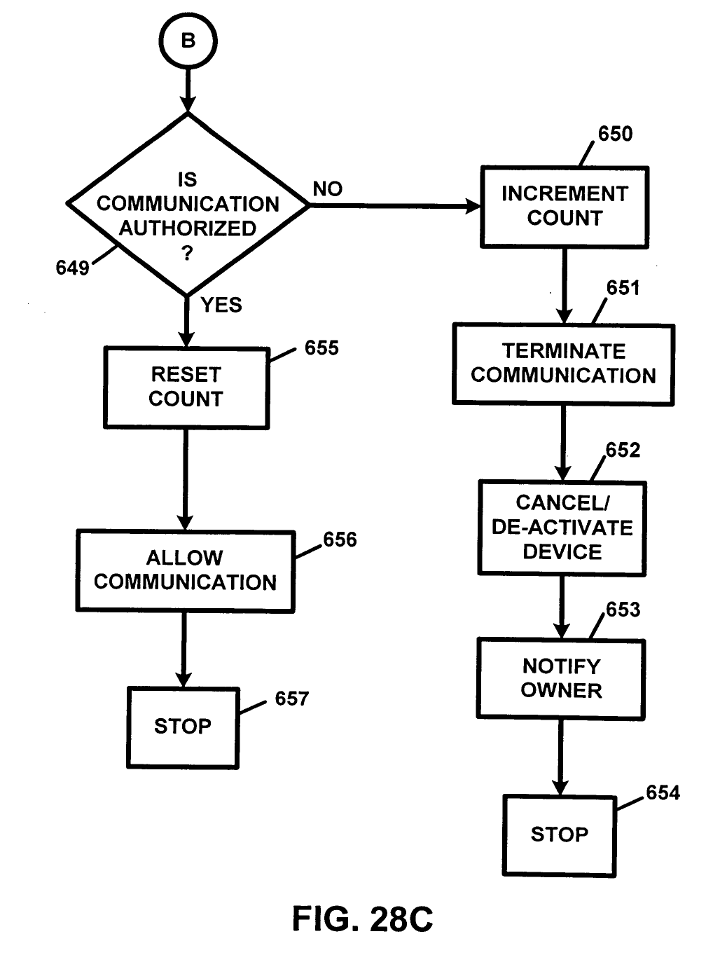

FIGS. 28A, 28B and 28C illustrate the operation of the apparatus 600 of FIG. 25, in flow diagram form. In the preferred embodiment of FIGS. 28A, 28 and 28, the apparatus 600 can be utilized in conjunction with an Internet server computer or other central transaction processing computer or service. With reference to FIGS. 28A, 28B and 28C, the operation of the apparatus 600 commences at step 630. At step 631, the owner, user, or operator, of the Internet communication device 602 initiates the Internet communication, transmission, transfer, Internet transmission, telephone call, and/or transaction (hereinafter referred to as “Internet communication”), such as by entering a domain name for a web site or computer, accessing a web site or computer, attempting to access a web site or computer, attempting to transfer to a web site or computer, transferring to a web site or computer, accessing an Internet account, engaging in and/or making a transaction on the Internet and/or the World Wide Web or other communication network, attempting to engage in and/or to make a transaction on the Internet, the World Wide Web, and/or any other communication network, and/or performing any other activity and/or function on, and/or in conjunction with, the Internet and/or the World Wide Web, and/or via the Internet communication device 602. For example, the communication can be initiated by entering a domain name or a web site identification into the Internet communication device 602.

Thereafter, the Internet communication can either take place, while the remainder of the routine proceeds as described hereinbelow, or the Internet communication can be halted until authorized by the Internet server computer 603, the account holder communication device 604, and/or the account holder, as described herein.

In any of the embodiments described herein, the Internet communication, transmission, and/or transaction, can involve any one or more of an internet transmission, an Internet protocol transmission, a voice transmission, a data transmission, an audio transmission, a video transmission, a streaming video transmission, a telephone call, a facsimile transmission, an Internet and/or World Wide Web transmission, and/or any other transmission involving communication devices in conjunction with the Internet and/or the World Wide Web.

Data entry prior to, and/or during, communication initiation can typically be performed by entering information via the data input device 602D, such as keyboard or mouse, or by swiping the magnetic strip of the account card through the scanner/reader 602J or by reading information from the processor or chip on the account card via the scanner/reader 602J. The data obtained from the magnetic strip and/or the card processor or chip, and/or from any associated database, can be utilized to contact the account holder communication device 604 and/or the account holder, directly and/or indirectly, and/or to process the communication, transmission, and/or transaction.

The Internet communication device can, at step 632, transmit data and/or information, which identifies the Internet communication device 602, the Internet account, and/or the user or operator, to the Internet server computer 603 which services the particular Internet communication device 602, the Internet account, and/or the Internet communication device network, so that appropriate billing and/or accounting of the communication, transmission, and/or transaction, and/or so that Internet communication device 602 usage and/or Internet account usage can be noted, recorder, and/or processed.

At step 633, the Internet server computer 603 will receive and store the data and/or information which is transmitted by the Internet communication device 602. At step 634, the Internet server computer 603 will process the data and/or information which is received from the Internet communication device 602.

The Internet server computer 603 can utilize any of the widely known data processing and/or software routines, which are known to those skilled in that art, in order to process the communication, transmission, and/or transaction, information, and/or any requests and/or authorizations involving the use of the respective Internet communication device(s) and/or Internet accounts.

At step 635, the Internet server computer 603 will perform a test in order to determine if the Internet communication device 604 is lost, stolen, cancelled or de-activated and/or whether the Internet account is still active or de-activated. If the Internet communication device 602 is determined to be lost, stolen, cancelled or de-activated, and/or that the Internet account is de-activated, the Internet server computer 603 will, at step 636, block the communication, transmission, and/or transaction, and/or terminate same if it has already been connected and/or is in progress. The Internet server computer 603 can also, at step 636, cancel, de-activate, and/or suspend usage of, the Internet communication device and/or the Internet account until further instructions are received from the account holder. The Internet server computer 603 will then, at step 637, notify the Internet communication device owner that a communication, transmission, and/or transaction was attempted and the nature of same, and can also notify the Internet communication device owner that his or her Internet communication device and/or Internet account has been cancelled, de-activated, and/or that usage has been suspended, and receive further instructions from the account holder. The operation of the apparatus will then cease at step 638.

If, at step 635, the Internet server computer 603 determines that the Internet communication device 602 is not lost, stolen, cancelled or de-activated, the Internet server computer 603 will, at step 639, transmit a signal and/or data to the communication device 604. At step 640, the communication device 604 will receive and display the data and/or information which is transmitted from the Internet server computer 603.

The displayed information, in the preferred embodiment, can include the data identifying the communication, transmission, and/or transaction, the domain name accessed, the web site or server computer accessed, the transaction being attempted, the transaction performed, the web site or server accessing the Internet communication device 602, the destination of the communication or transmission, the source of the communication or transmission, time of communication, transmission and/or transaction, location of communication, transmission and/or transaction, communication origination, telephone number called, communication destination, parties involved, projected cost of communication, time of communication, Internet service provider or carrier involved in the communication, transmission, and/or transaction, etc, in real-time. The information can also include any other information described herein as being pertinent to and/or related to the Internet communication device, account, and/or the Internet communication, etc.

The information and/or data can also include the phone number of the entity and/or a central processing office and/or computer servicing the account so that the account holder can telephone same in order to authorize or cancel the communication.

The information can remain displayed during the duration of the call so that the transaction communication device owner and/or account holder can be notified continuously throughout the duration of the call.

At step 641, the Internet server computer 603 will await the Internet communication device owner's reply or response. If the Internet communication device owner replies or responds, the reply or response data will also be transmitted to, and received by, the Internet server computer 603 at step 641. At step 642, the Internet server computer 603 will then determine if the Internet communication device owner's response was made within a pre-defined time period, which is chosen, in the preferred embodiment, to be one (1) minute. If at step 642, it is determined that the transaction communication device owner did not reply or respond within the pre-defined time limit, the Internet server computer 603 will, at step 643, increment the unauthorized transaction count (UNAUTHCT) by one (1).

The Internet server computer 603 will then, depending upon pre-defined instructions of the Internet communication device owner, at step 644, either allow the communication, transmission, and/or transaction, to proceed and/or to continue, such as for a pre-defined duration of one (1) minute, so as to allow for cases wherein an emergency condition exists, or terminate same immediately. The decision to either allow the communication, transmission, and/or transaction, to proceed or to continue, or to terminate same can be made by the Internet communication device owner and/or Internet account holder. The decision can also be made by the Internet server computer 603 based upon previously received instructions.

Upon the completion of step 644, the Internet server computer 603 will then, at step 645, cancel and/or de-activate the communication, transmission, and/or transaction, and/or cancel, de-activate, and/or suspend usage of, the Internet communication device and/or Internet account, depending upon account holder instructions, and await further instructions from the account holder. Thereafter, if relevant, the Internet server computer 603 will, at step 646, notify the Internet communication device owner and/or Internet account holder that the Internet communication device and/or Internet account has been cancelled, de-activated, and/or that usage of same has been suspended, and await the account holder's further instructions. Upon completion of step 646, the apparatus will cease operation at step 647.

If, at step 644, the Internet communication device owner did respond in time, the Internet server computer 603 will process the reply or response data and/or information, at step 648. The Internet server computer 603 will then determine, at step 649, if the communication, transmission, and/or transaction, is authorized by the Internet communication device owner and/or Internet account holder. If, at step 649, the communication, transmission, and/or transaction, is unauthorized, the Internet server computer 603 will, at step 650, increment the unauthorized transaction count (UNAUTHCT) by one (1). The Internet server computer 603 will then, at step 651, terminate the communication, transmission, and/or transaction, immediately. Upon the completion of step 651, the Internet server computer 603 can then, at step 652, cancel, de-activate, and/or suspend usage of, the Internet communication device 602 and/or the Internet account until further instructions are received from the account holder. Thereafter, the Internet server computer 603 will, at step 653, notify the transaction communication device owner and/or the Internet account holder that the Internet communication device 602 and/or Internet account has been cancelled, de-activated, and/or that usage of same has been suspended, and can receive further instructions from the account holder. Upon completion of step 653, the apparatus 600 will cease operation at step 654.

If, at step 649, the Internet server computer 603 identifies the account holder's reply or response as being one to authorize the Internet communication, transmission, and/or transaction, the Internet server computer 603 will, at step 655, reset the unauthorized transaction count (UNAUTHCT) to zero (0). An unauthorized transaction count (UNAUTHCT) of 0 will signify that any string of unauthorized transactions has now been broken by the Internet communication device owner and/or Internet account holder. The Internet server computer 603 will then, at step 656, allow the Internet communication, transmission, and/or transaction, to proceed and/or continue.

Upon the completion of the communication, transmission, and/or transaction, at step 656, the apparatus 600 will cease operation at step 657.

In another preferred embodiment, the Internet server computer 603 can perform any and/or all of the functionality described as being performed by the Internet communication device 602 as described herein in conjunction with FIGS. 27 and 27B. In this manner, in another preferred embodiment of FIG. 25, the Internet server computer 603 can transmit a notification signal, data, and/or information, to the communication device 604, to notify the account holder of a communication, transmission, transfer, and/or transaction, on the Internet account. Thereafter, the account holder can transmit a response, to the notification signal, to the Internet server computer 603. The Internet server computer 603 can thereafter process the account holder's response. If the Internet server computer 603 determines that the communication, transmission, transfer, and/or transaction is authorized or approved, the Internet server computer 603 can consummate, connect, and/or complete, the respective Internet communication, transmission, transfer, and/or transaction. If the communication, transmission, transfer, and/or transaction, is not authorized or not approved, the Internet server computer 603 can disconnect, cancel or terminate, the respective Internet communication, transmission, transfer, and/or transaction.

In another preferred embodiment of the apparatus of FIG. 25, the apparatus 600 can be programmed and/or can be programmable by the respective account holder, account owner, Internet communication device owner, and/or any other authorized individual, (hereinafter referred to as “account holder” or “account owner”). The account holder or account owner can access the Internet server computer 603 and/or a central processing computer via the communication device 604, a telephone, and/or any other communication device. The account holder or account owner can thereafter program the Internet server computer 603 by transmitting a signal, data, and/or information, containing and/or corresponding to instructions for restricting and/or limiting activity and/or communications and/or transactions which can occur and/or take place on, or in conjunction with, the respective Internet account.

The signal, data and/or information, containing the restriction(s) and/or limitation(s) data and/or information is received by the receiver 603G. Thereafter, the CPU 603A will process the restriction(s) and/or limitation(s) data and/or information and store any appropriate data and/or information in the database 603H.

The above-described programming of restrictions and/or limitations into the Internet server computer 603 can take place in real-time and/or otherwise.

The limitations and/or restrictions which can be programmed into the Internet server computer 603 or central processing computer can include limitations and/or restrictions regarding times of account and/or Internet communication device usage, types of usage, authorized web sites and/or computers which can be accessed by and/or which can access the Internet communication device 602, prohibited web sites and/or computers which cannot be accessed by and/or which cannot access, the Internet communication device 602, prohibited words and/or content which is, or which could be, found on a web site or host computer which is accessed by the Internet communication device 602 and/or which can access the Internet communication device 602, authorized numbers called and/or communicated with, authorized numbers from which calls or communication can be received, usage time limits, usage costs limits, restrictions and/or limitations on communications and/or transactions which can occur via an Internet account and/or which can be prohibited via an Internet account (i.e. no credit card purchases allowed, no communications and/or transactions with a certain type of web site, etc.), and/or any other restrictions, limitations, and/or authorizations, and/or disapprovals, restrictions and/or limitations of usage of Internet communication devices and/or Internet accounts.

The restrictions and/or limitations can also include the types of communications and/or transactions which are allowed and/or authorized, limitations and/or restrictions on account or Internet communication device usage, types of communications and/or transactions which are allowed and/or authorized, limits on the amounts of communications and/or transactions which can occur on an account, number of communications, calls, and/or communications and/or transactions, which can occur on an account and/or from an Internet communication device, authorized parties to use the account or device, authorized geographical area or location of usage, authorized times for account access and/or account and/or Internet communication device usage (i.e. specific days, dates, time of day, time of month, year, etc.), and/or any other limitation and/or restriction regarding amount of communications and/or transactions, parties involved, geographical area, and/or times of allowed usage.

The limitations and/or restrictions can also include limitations and/or restrictions on account usage and/or Internet communication device account usage, including but not limited to, times of usage, types of usage, authorized numbers called and/or communicated with, authorized numbers from which calls or communication can be received, usage time limits, usage costs limits, and/or any other restrictions, limitations, and/or authorizations, and/or disapprovals, regarding any type of usage of non-wireless as well as wireless Internet communication devices.

The limitations and/or restrictions can also include limitations on and/or regarding communication charges, individuals who may make communications or the transactions on the account and/or with the Internet communication device, proof of identity of which the types of proof may be specified, specific communication providers and/or carriers authorized to service the account and/or Internet communication device.

With regards to any of the Internet accounts and/or Internet communication devices described herein, the account holder or account owner can also change, specify, or programmably change, passwords, personal identification numbers and/or any other access code(s) and provide for various personal identification numbers and/or access codes for different communications, transactions, times of usage, etc.

For example, the account holder, account owner, and/or Internet communication device owner can limit account usage (i.e. no access to web sites outside of the United States, no accessing web sites providing objectionable material, and/or can program the Internet server computer 603 so as to limit account communications and/or transactions by amounts (i.e. no purchases exceeding a certain charge limit, no account usage once a pre-specified account charge limit, for example 140 hours/month or $100.00 in usage fees have been reached), to limit communications and/or transactions by times of usage (i.e. no Internet access or Internet communication device usage between 11:00 P.M. and 5:00 A.M.), to change Internet service plan (i.e. unlimited usage versus limited usage), and/or to establish and/or change usage limits, periodically and/or at any desired time.

The account holder of account owner can program the Internet server computer 603, and/or the central processing computer, if utilized, via the communication device 604, a telephone, and/or any other suitable communication device. The account holder or account owner can also perform the above-described programming via a touch-tone telephone. In the same manner, the account holder or account owner, can also program the apparatus 600 so as to limit the types of communications and/or transactions involving his or her Internet account.

Once programmed by the account holder or account owner, the Internet server computer 603 and/or the central processing computer, upon receiving a communication and/or transaction authorization request or a communication and/or transaction processing request, will process the communication and/or transaction in conjunction with the restriction(s) and/or limitation(s) provided, programmed, and/or dictated, by the account holder or account owner.

By utilizing the above-described programming routine(s), an account holder, account owner, Internet communication device owner, and/or other authorized individual, can program and/or update any data and/or information which can or may be stored in the database 603H. The above-described programming routine(s) can be performed in real-time and/or otherwise.

In another preferred embodiment, the account holder can restrict, limit, and/or completely prohibit, access to web sites and/or host computers which provide specific content, specific goods and/or specific services. For example, applications can include, but certainly not be limited to, an account holder can restrict access to web sites or host computers which provide on-line auction sites and/or on-line bidding sites, an account holder can limit times and transactions on on-line gaming or on-line gambling sites, an account holder can restrict a child's access to web sites which may contain pornographic and/or explicit sexual language by providing examples of words and/or content which are typically found at such prohibited web sites and/or at associated host computers.

The present invention can also provide notification to an account holder of any use or activity involving the Internet account which would violate the account holder's restrictions and/or limitations and/or which are attempts to violate the account holder's restrictions and/or limitations. The above notification can be performed in real-time and/or otherwise.

In another preferred embodiment, the account holder or account owner can program the respective Internet communication device 602 and/or communication device 604, in the same manner in which the Internet server computer and/or central processing computer 603 can be programmed, so as to program restrictions and/or limitations into the respective devices. The Internet communication device 602 can, in this manner, be directly programmable, by the account holder, or account owner, Internet communication device owner, and/or other authorized individual, in real-time and/or otherwise, in the same manner described above regarding the Internet server computer 603 and/or central processing computer, so as to automatically process a communication or transaction in accordance with the restrictions or limitations provided by account holder, account owner, Internet communication device owner, and/or other authorized individual.

The communication device 604 can also be directly programmable by the account holder or account owner, in real-time and/or otherwise, in the same manner described above regarding the Internet server computer 603 and/or central processing computer, so as to automatically process a communication and/or transaction authorization request and/or a communication and/or transaction.

In a similar manner, the account holder, account owner, Internet communication device owner, and/or other authorized individual, can program the apparatus 600 as described above in conjunction with the use of any of the herein-described Internet accounts and/or Internet communication devices.

The apparatus 600 can be utilized to supervise, monitor, and/or control, usage of an Internet account and/or Internet communication device. For example, a parent be alerted when a child accesses objectionable web sites and/or host computers, such as those providing pornographic and/or other offensive or objectionable material. The parent can also pre-restrict access to certain web sites or host computers which he or she may know or believe to contain pornographic and/or other offensive or objectionable material.

The apparatus 600 can be utilized and/or can be programmed so that the account holder can or must approve the communication, transmission, and/or transaction, prior to same being made, effected, and/or transacted. The apparatus 600 can also be utilized and/or programmed so that the account holder can or must approve the communication, transmission, and/or transaction, subsequent to the communication being made, effected, the communication link being established, and/or transacted. In the case when the account holder disapproves of the communication, transmission, and/or transaction, after same has been made, effected, and/or in progress, the Internet communication device 602 can terminate and/or cancel the communication.

In any of the embodiments described herein, any of the communications which are transmitted, received, and/or which take place during apparatus operation, by and between any of the Internet communication devices 602, the Internet server computers 603, and the communication devices 604, can take place in real-time and/or otherwise.

In instances when the Internet communication device owner is a party to the Internet communication, transmission, and/or transaction, he or she, having the communication device 604 on his or her person, can authorize the communication, transmission, and/or transaction, at his or her present location. In any of the embodiments described herein, if the Internet communication device owner has lent out the Internet communication device and/or has allowed Internet account usage, he or she can authorize the Internet communication, transmission, and/or transaction, from his or her remote location.

The Internet communication device owner can also program and/or set the communication device 604 to automatically authorize or disapprove or disallow Internet communications, transmissions, and/or transactions, with said selective authorizations being made as to any restrictions and/or limitations on Internet communication device 602 usage and/or Internet account usage. In this regard, the communication device 604 can be programmable so as to receive and analyze the communication, transmission, and/or transaction information and/or data and reply or respond to same automatically and/or with preset or programmed replies and/or responses.

The communication device 604 can also be programmable so as to limit the number of Internet communications, transmissions, and/or transactions, which can be made from the Internet communication device 602 and/or Internet account.

The communication device 604, in the preferred embodiment, is provided with a memory device for storing any number of Internet communication device communications, transmissions, and/or transactions, so that the Internet communication device owner and/or Internet account holder can review his or her account activity and/or Internet communications, transmissions, and/or transactions, made and/or which have occurred involving his or her Internet communication device and/or Internet account. In this manner, the Internet communication device owner can “scroll” through and/or in other ways review account activity. The communication device 604 can also be equipped to service more than one Internet communication devices and/or Internet accounts.

The Internet server computer 603 can also be programmed to provide notification to the account owner upon the occurrence of any number of events and/or occurrences which take place regarding and/or relating to the respective Internet communication device and/or Internet account. The Internet server computer 603 can provide notification to the account owner upon the receipt of an account owner's payment, a credit to the account, a reaching of a certain level of account charges, the crediting of the payment to the respective account, account communication, transmission, and/or transaction activity, the reaching of a certain limitation on account usage, the restricting of a certain usage, the attempt to perform a restricted and/or prohibited activity on the account, the reaching of a pre-specified credit, charge, debit, and/or other respective limit on the respective account, telephone or other communications transacted, and/or any other occurrence and/or event which can be of interest to the Internet communication device owner and/or Internet account holder.

The Internet server computer 603 can also notify the account owner regarding a payment due date, an overdue status of a payment, an account restriction and/or limitation on usage, etc.

In this manner, the account owner can be notified of any of the above-described and/or any other events or occurrences. For example, the account owner can be notified when a payment is received, when a certain level of usage is reached, and/or when any other event or transaction of interest to the account owner occurs on and/or regarding the Internet account.

Similarly, the account owner can be notified when he or she has reached and/or is close to reaching a pre-specified account usage level and/or upon the occurrence of administrative events or occurrences, i.e. payment due date, payment overdue, account restrictions, and/or the charging of maintenance or service fee charges.

In another preferred embodiment, the Internet communication device 602 can be programmed to provide any of the functions described herein as being performed by the Internet server computer 603, including, but not limited to, providing any of the notification functions for providing notification to the account owner of any of the above-described events and/or occurrences.

The various processing routines described herein as being performed by the apparatus 600 of the present invention in FIGS. 27A and 27B and FIGS. 28A, 28B and 28C can also be performed in conjunction with each other and/or can be combined so that the apparatus 600 can perform multiple routines in conjunction with each other. In this regard, the Internet communication device 602 can, in another preferred embodiment, transmit the information and/or data pertinent to a transaction to the communication device 604 associated with an account owner, and process the transaction in the manner described herein with the account owner, while also transmitting the information and/or data pertinent to the transaction to the Internet server computer 603 and processing the transaction with the Internet server computer 603.

The Internet communication device 602 can transmit the respective transmissions to the respective devices 604 and 603 in a sequential fashion and/or in any desired and/or specified order and/or the transaction communication device can transmit the respective transmissions to the respective devices 604 and 603 simultaneously. In any event, the transaction communication device(s) 602, the central processing computer(s) 603, and the communication device(s) 604, in the preferred embodiments described herein, can be suitably equipped with any necessary, additional, and/or desired, hardware and/or software for facilitation their respective operations and/or functionality as described herein.

In this manner, the Internet communication device 602 can communicate with the account holder via the communication device 604 and independently of any transaction processing by a central transaction processing computer or central transaction processing service.

The apparatus and method of the present invention provides for the real-time notification of Internet communication device usage and/or Internet account usage, which enables an Internet communication device owner and/or account holder to monitor, in real-time, activity involving his or her Internet communication device and/or Internet account. The apparatus and method of the present invention also provides a means and a mechanism by which to inform an Internet communication device owner that the Internet communication device is lost or stolen, and/or to provide notification to the Internet account holder that his or her Internet communication device and/or Internet account is being utilized in communications, transmissions, and/or transactions, such as when a Internet communication device has been illegally “cloned” and/or when communications, transmissions, and/or transactions, can involve unauthorized and/or objectionable usage of his or her Internet communication device and/or Internet account. The Internet communication device owner and/or account holder can then take appropriate action with regarding the usage of the Internet communication device and/or the usage of the Internet account.

The present invention also provides a means and a mechanism by which to monitor the number of Internet communications, transmissions, and/or transactions, which are unauthorized by the Internet communication device owner and/or account holder and to determine whether or not to cancel, de-activate, and/or suspend usage of, the Internet communication device and/or the Internet account until further instructions are received from the Internet communication device owner and/or Internet account holder.

The Internet server computer 603 and/or the Internet communication device 602 can also generate and transmit notification signals, e-mails, and/or other electronic and/or conventional messages and/or transmissions to notify the account holder regarding any account occurrence, event, and/or activity described herein.

The account owner can report any unauthorized activity and/or respond to any account activity at any time. In the above manner, the apparatus and method of the present invention provides an apparatus and a method to prevent and/or to drastically limit unauthorized and/or fraudulent use of Internet communication devices and/or the Internet accounts.

While the embodiment of the present invention is described above in conjunction with the use of Internet communication devices, the present invention of FIG. 25, in other preferred embodiments, can be utilized in conjunction with any Internet communication device including personal computers, personal digital assistants, facsimile machines, and/or other Internet communication devices which work in conjunction with the Internet, the World Wide Web, and/or any other suitable

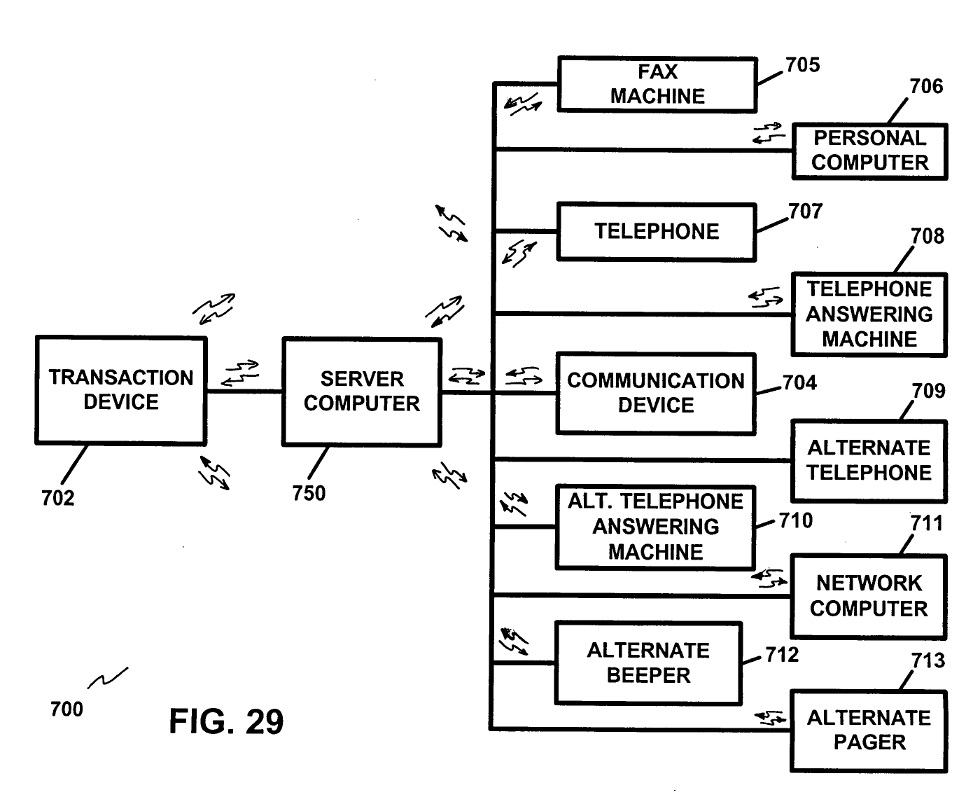

FIG. 29 illustrates yet another preferred embodiment of the present invention wherein the apparatus and method of any of the embodiments described herein can be utilized on, or over, an on-line service, the Internet, and/or the World Wide Web, and/or any other suitable communication network or medium. In FIG. 29, the apparatus, which is denoted generally by the reference numeral 700, includes a transaction device 702, which can be any of the point-of-sale devices, banking devices, brokerage devices, wireless communication devices, transaction communication devices, and/or Internet communication devices described herein, depending upon the application. The apparatus also includes a server computer 750, which is a central processing computer for processing data and/or information in an on-line, and/or Internet, and/or World Wide Web, communication environment, network, or medium.

The server computer 750 can be a mainframe computer, a mini-computer, a micro-computer, a server computer, such as those utilized in conjunction with on-line services and/or in a network environment, and/or any other suitable computer or computer system. The server computer 750, in the preferred embodiment, should have associated therewith a suitable receiver(s) or transmitter(s) which can be a fax/modem and/or any other device(s) which are well known to those skilled in the art for providing communications and/or a link with a server computer in such a network environment.

The apparatus of FIG. 29 also includes a communications device 604 which can be or include a home and/or a personal computer, a laptop or a notebook computer and any one or more of the herein-described communications devices so that the individual can access the apparatus 700, and in particular, the server computer 750, at any time and from any location. The embodiment of FIG. 29 can serve to replace the central processing computer of the previously described embodiments with a server computer for utilization on, or over, an on-line service, the Internet, the World Wide Web, and/or any other suitable communications network or medium. The apparatus of FIG. 29 can operate and/or can be utilized in the same, in a similar and/or in an analogous, manner as described herein in conjunction with any of the previously described embodiments.

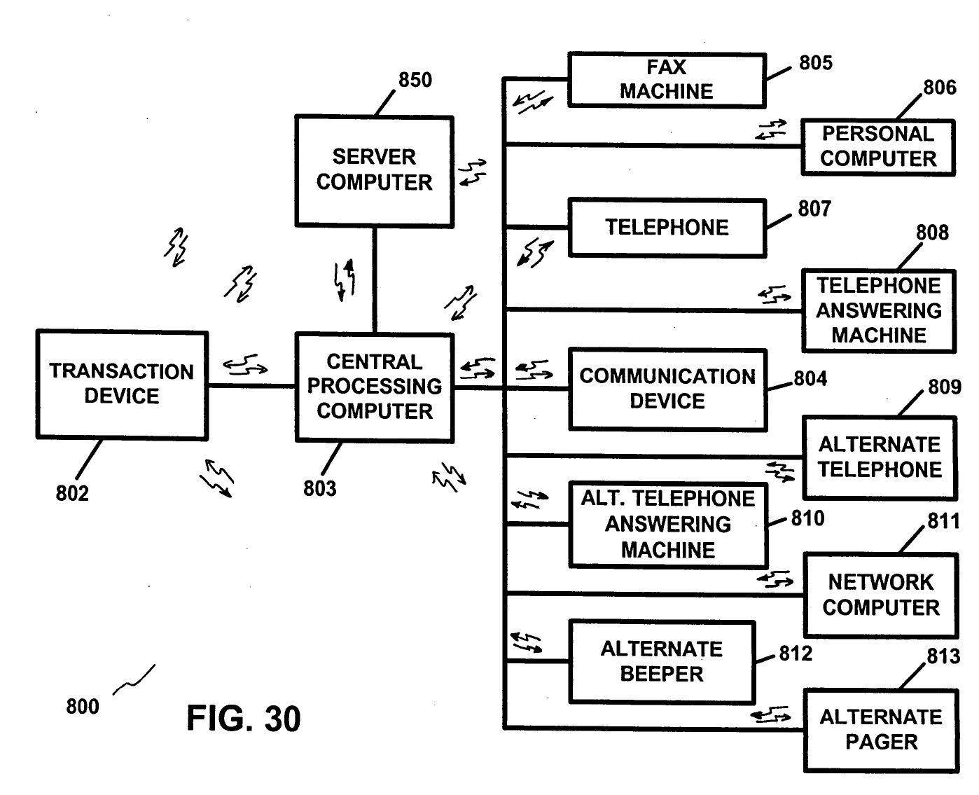

FIG. 30 illustrates yet another alternate embodiment of the present invention, wherein the present invention is also utilized in conjunction with an on-line service and/or on, or over, the Internet and/or the World Wide Web, and/or any other suitable communication network or medium. In FIG. 30, the apparatus, which is denoted generally by the reference numeral 800, includes a transaction device 802, which can be any of the point-of-sale devices, banking devices, brokerage devices, wireless communication devices, transaction communication devices, and/or Internet communication devices described herein, depending upon the application.

The apparatus of FIG. 30 also includes a central processing computer 803 which provides processing and/or control over the apparatus 800 in the manner described above in conjunction with any of the previously described embodiments. The apparatus 800 also includes a server computer 850. The central processing computer 803 and/or the server computer 850 can be a mainframe computer, a mini-computer, a micro-computer, a server computer, such as those utilized in conjunction with on-line services and/or in a network environment, and/or any other suitable computer or computer system.

The apparatus 800 of FIG. 80 also includes a communications device(s) 804 such as those described herein and in conjunction with the apparatus 800 of FIG. 30. The apparatus also includes a server computer 850 which can either perform parallel operations and/or processing of the data and/or information which is performed and/or processed by the central processing computer 803 and/or can simply receive the data and/or information processed by the central processing computer 803. In any event, the server computer 850 provides the means by which the data and/or information, which is provided by the apparatus, can be accessed and or utilized via an on-line service and/or on, or over, the Internet, and/or the World Wide Web, and/or any other communications network or medium.

The server computer 850 can have associated therewith a suitable receiver(s) and transmitter(s) which can be a fax/modem and/or any other device(s) which are well known to those skilled in the art for providing communications and/or for providing a link to or with a server computer in such a network environment. The apparatus of FIG. 30 also includes a communications device 804 which can be or which can include a home and/or a personal computer, a laptop, a notebook computer, and/or any one or more of the herein described communications devices, so that the individual can access the apparatus, and in particular, the server computer 850, at any time and from any location.

The apparatus of FIG. 30 can be utilized and/or operates in the same, a similar, and/or an analogous, manner as any of the embodiments described herein.

Applicant hereby incorporates by reference herein all of the methods and/or techniques for providing information and/or data over an on-line service and/or on, or over, the Internet, and/or the World Wide Web, and/or any other suitable communication network, system, or medium, along with client/server, Internet, and/or Web Site, technology as well as methods and/or techniques utilized in conjunction therewith, which are known by those skilled in the art as of the filing date of the present application. Further, Applicant also hereby incorporates by reference herein those techniques for providing electronic-mail and electronic information transfer, including push technology techniques, which are known by those skilled in the art as of the filing date of the present application.

In any and/or all of the embodiments described herein, every device, computer, and/or communication device, which can be involved in a transmission and/or reception of any of the signals, data, and/or information, can include one or more transmitters and/or one or more receivers, depending upon the application and/or the system utilized, for performing and/or for facilitating any and/or all of the described functionality. In cases where modems are employed for or as a component of a transmitter, in conjunction with a communication line, a telephone line, or other entity, multiple modems can also be utilized with each modem being associated with a single or dedicated line. Similarly, in cases where modems are employed, for or as a component of a receiver, in conjunction with a communication line, a telephone line, or other entity, multiple modems can also be utilized with each modem being associated with a single or dedicated line.

In any and/or all of the embodiments described herein, each and every one the components of the apparatus, which include, but which are not limited to, the described point-of-sale devices, banking devices, brokerage devices, electronic cash devices, wireless communication devices, transaction communication devices, Internet communication devices, central processing computers, Internet server computers, and any of the various communication devices described herein, can transmit and/or receive any of the signals, data and/or information, and/or can be capable or transmitting and/or receiving signals, data and/or information, to and from any and all of the other respective apparatus components which can be utilized in conjunction therewith, in and for any given embodiment. Further, any of the respective communications which occur between any of the above-described devices, central processing computers, server computers and communication devices can take place in real-time and/or otherwise.

The communication network, system, or medium, should provide for the transmission and/or for the reception of a multitude of remote electrical, electronic, electromagnetic, and/or other suitable signals, over long distances and/or in a mobile and/or a wireless communications environment. Telephone signals and telephone communication devices can be utilized in the present invention as well as personal computers and associated peripheral devices which can be utilized in conjunction with telecommunications and/or other suitable communication networks, systems, and/or mediums.

The apparatus and method of the present invention can operate over any appropriate communications system, network and/or medium, and/or over any other suitable communications systems, including radio signal, optical, satellite, digital, digital satellite, and/or other communications systems. The communications system utilized can operate anywhere in the electromagnetic and/or radio frequency spectrum. As noted above, the present invention can also be utilized in conjunction with a satellite communications system and/or Low Earth Orbiting Satellite (LEOs) systems, in which case, the receivers and transmitters, which are utilized, should be satellite communication receivers and transmitters, respectively. For example, a receiver(s) can also be a satellite dish receiver(s). Similarly, the present invention can be utilized in conjunction with cable television communication systems, digital television communication systems, satellite television communication systems, broadband communication systems, personal communication services (PCS) systems, global standard for mobile (GSM) systems as well as any other communication system.

In this regard, the cardholder, account holder, account owner, wireless communication account holder, non-wireless communication account holder, and/or Internet account holder, can utilize the apparatus and method of the present invention to its fullest capabilities over an on-line service and/or on, or over, the Internet, and/or the World Wide Web, and/or any other suitable communication network, system, or medium. In this manner, the embodiments described herein, and any other preferred and/or alternate embodiments, can allow the respective cardholders, account holders, account owners, wireless communication account holders, non-wireless communication account holders, and/or Internet account holders, to utilize the apparatus and method of the present invention, in order to monitor any transaction and/or communication, as well as to monitor the operation of the apparatus, over the on-line service and/or on, or over, the Internet, and/or the World Wide Web, and/or any other communication network, system, or medium, from any suitable computer or communication device, and/or from any location.

In any and/or all of the embodiments described herein, the respective apparatuses 1, 100, 200, 300, 400, 500, 600, 700, and 800, can also provide notification to an account holder of any use or activity involving the respective account which would violate the account holder's restrictions and/or limitations and/or which are attempts to violate the account holder's restrictions and/or limitations. The above notification can be performed in real-time and/or otherwise.

The apparatus can also by employing any appropriate server computer and/or an associated Web Site and/or Web Site technology in conjunction with any appropriate communication medium and communication equipment.

In any and/or all of the above-described embodiments, the present invention can be utilized in conjunction with any suitable communication device(s) and/or communication system(s). In this manner, the present invention can be utilized in conjunction with a telephone, a line-connected and/or a permanent telephone, a touch-tone telephone, a cordless telephone and/or a cellular or mobile telephone, a home computer, a personal computer, a network computer, a personal digital assistant, a pager, a beeper, and/or any other communication device, having associated telecommunication devices or other suitable peripheral device(s), such as a modem and/or a fax/modem, and/or other suitable personal communication devices which can operate over an appropriate communications system, and/or other suitable communications systems and/or mediums, including radio signal, optical, satellite, digital, cable television, digital television, satellite television, broadband and/or other communications systems and/or mediums.

Any suitable communication system and/or medium can be utilized. Personal communication service (PCS) systems and devices, including stationary, portable and/or hand-held devices, can also be utilized. Digital signal communications devices and systems can also be utilized. Televisions, interactive and/or digital televisions, high definition televisions, personal communication devices, personal communication services (PCS) devices, personal digital assistants, wireless telephones, wireless communication devices, cellular telephones, digital telephones, display telephones, video telephones, display wireless telephones, wireless communication devices, cellular telephones and electronically equipped watches and/or other devices and/or effects and/or accessories, can also be utilized for performing user interactive control, monitoring, authorization, notification and/or security functions in conjunction with the present invention.

Any of the above-described communication devices can include any type of transmitter/receiver combination or transceiver, electronic or otherwise, which provides for the transmission and reception of a multitude of remote electrical, electronic, electromagnetic, and/or other suitable signals, over long distances in a conventional, line-connected, wireless, and/or non-wireless communications environment, and/or in any combination thereof. As noted above, a personal computer system which can be adapted to such operation, or a personal communication device(s) or personal communication services (PCS) device(s) can also be utilized for, or in, any of the transmitter/receiver system combinations described herein. Two-way pagers and reply pagers can also be utilized for any, or in any, of the transmitter/receiver system combinations described herein.

The communication device(s) utilized in the present invention, as well as the associated transaction devices and/or wireless or cellular communications devices and/or associated central processing computers can be personal communication services (PCS) devices and/or other suitable communications devices. A television, appropriately equipped to receive and/or to transmit signals can also be utilized. It is also envisioned that digital televisions, interactive televisions, high definition televisions, personal communications devices, personal communications services (PCS) devices, personal digital assistants, digital telephones, display telephones, electronically equipped watches, wireless telephones, wireless communication devices, cellular telephones and/or display wireless telephones, wireless communication devices, cellular telephones can also be utilized in conjunction with the present invention.

Any communication device can also include and/or utilize a remote transmitter/receiver system, such as by a remote transmitter, i.e., a television-type remote control unit, which control unit would require a user interface feature and which has the capability to remotely transmit a multitude of signals over long distances to an associated receiver. It is also envisioned that digital televisions, interactive televisions, personal communications devices, personal communications services (PCS) devices, personal digital assistants, display telephones, video telephones, electronically equipped watches and/or other effects or accessories, wireless telephones, wireless communication devices, cellular telephones, display wireless telephones, wireless communication devices, cellular telephones, can also be utilized in conjunction with the present invention.

The apparatus of the present invention can be designed or can be programmed to telephone any card holder, account holder, account owner, as well as any user, operator, occupant, or other authorized central office individual or other authorized individual, at a primary phone number, at an alternate or forwarding phone number and/or at a business phone number, send a beeper or pager message to the individual or central office and/or send a facsimile message, an electronic mail message, a voice mail message and/or an answering service message to, or for, the individual or central office. In this manner, the apparatus can report a transaction, a communication, fraudulent activity, and/or any other event or occurrence of interest, to any respective party or individual so as to provide and ensure that the interested party or individual can be notified of same as soon as possible. The multiple notification transmissions can be sequentially and/or simultaneously performed.

The apparatus and method of the present invention can also be programmable for programmed and/or automatic activation, self-activation, programmed and/or automatic operation and/or self-operation. The apparatus and method of the present invention can provide for an immediate, as well as for a deferred, control, monitoring and/or security function, and/or response thereto, so as to provide for the immediate and/or the deferred control, activation, de-activation, programming, monitoring and/or security, etc., of any one or more the herein described credit card accounts, charge card accounts, debit card accounts, smart card accounts, currency card accounts, telephone calling card accounts, cable television accounts, digital television accounts, satellite television accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, facility access accounts, facility security accounts, banking accounts, brokerage account, electronic money accounts, wireless communication accounts, non-wireless communications accounts, and/or Internet accounts, and/or any cards, devices, and/or communication devices related and/or corresponding thereto, and/or any other suitable application in and for which the present invention can or may be utilized.

In any and/or all of the herein-described embodiments, any of the respective point-of-sale devices, banking devices, brokerage devices, electronic cash devices, wireless communication devices, transaction communications devices, Internet communication devices, central processing computers, Internet server computers, and account holder communication devices, and/or other devices or computers described herein, can receiving and/or transmit telephone signals, radio signals, satellite communication signals, telecommunications signals, optical communication signals, and/or other signals, and/or any signals, including digital signals, analog signals, and/or other signals which are utilized in conjunction with any appropriate communication devices and/or communication networks or systems.

The present invention can also be equipped with, and be utilized in conjunction with, hardware and software necessary for providing self-monitoring functions, automatic control and/or responses to account events and/or occurrences, providing automatic notice of an event or occurrence and/or a situation to a cardholder, account holder, account owner, user, operator and/or other authorized individual. In this regard, any and all of the embodiments described herein can include a monitoring device, a triggering device and/or any other suitable device for detecting an event, an occurrence, a transaction, and/or a communication, which can warrant providing notice to the respective a cardholder, account holder, account owner, user, operator and/or other authorized individual. In this regard, the apparatus can provide for an appropriate signal, data and/or information transmission to a respective communication device and/or central processing computer, and/or server computer, if utilized.

Any signals, data, and/or information, described herein can be transmitted in the form of an electronic transmission and/or a communication transmission, depending upon the communication medium utilized, a communication, a telephone call, a voice message, a beeper and/or a pager message, an electronic mail message, a facsimile transmission, and/or any other mode or manner of communication which can be utilized in conjunction with any of the embodiments described herein.

The present invention, in any of the embodiments described herein, can be designed to be user-friendly. In this regard, the present invention can be menu-driven, and/or its operation can be menu-selected, from audio menus, visual menus, or from both audio and visual menus.

While the present invention has been illustrated and described as being utilized in conjunction with providing notice and for obtaining authorizations with regard to transactions involving any accounts, cards, and/or devices, described herein, it is also envisioned that the present invention can be utilized in any similar type of communication and/or transactional activity, such as on-line purchasing and/or transaction activities on, or over, the Internet, the World Wide Web, and/or any other communication network or system, and/or in any other type of transaction wherein frequent notice to a cardholder, account holder, account owner, can or may be desired to provide monitoring, notification, and/or security, and/or to guard against fraud, theft, and/or other illegal activity.

The apparatus of the present invention can be accessed at any time, and from any location, by the respective cardholder, account holder, account owner, user, operator, and/or other authorized individual, so as to access the apparatus, and in particular, any of the respective point-of-sale devices, banking devices, brokerage devices, electronic cash devices, wireless communication devices, transaction communications devices, Internet communication devices, central processing computers, Internet server computers, and account holder communication devices, so as to obtain information regarding activity, to obtain transaction records regarding any transaction, group or string of transactions, to obtain information regarding communications and/or transactions by types, goods and/or services involved and/or transactions by amounts and/or transaction amounts.

The respective cardholder, account owner, account holder, user, operator, and/or other authorized individual, can also obtain, via the central processing computer, and/or the server computer, if utilized, periodic transaction and/or communication records showing any and/or all transactions and/or communications for a given time period, time interval, day, week, etc, and can provide hourly, daily, weekly, bi-weekly, monthly, yearly, reports and/or reports for any given and/or desired time period and/or interval. The apparatus and, in particular, the central processing computer, and/or the server computer, if utilized, can be designed and/or can be programmed so as to automatically and/or periodically provide and/or transmit any of the above-described respective account transaction and/or communication information to the respective cardholder, account owner, account holder, user, operator, and/or other authorized individual, by transmitting same to the respective communication device.

The apparatus and, in particular, the central processing computer, and/or the server computer, if utilized, can also be designed and or can be programmed to transmit any of the above-described account information and/or transaction and/or communication information to any one or more of the respective communication device, facsimile (fax) machine, personal computer, personal digital assistant, telephone, telephone answering machine, alternate telephone, alternate telephone answering machine, network computer, television, interactive television, and/or alternate beeper or pager, etc., associated with the respective cardholder, account owner, account holder, user, operator, and/or other authorized individual. Such multiple notification transmissions, if utilized, can be performed sequentially and/or simultaneously.

In any of the herein-described embodiments, the respective central processing computer(s) or Internet server computers, can include, and/or be comprised of, a plurality of computers and/or computer systems. Further, any of the respective central processing computers and/or Internet server computers can process account information, and/or can service and/or monitor the respective account(s) activity. The respective central processing computers or Internet server computers can each be a separate and/or a distinct computer or computer system which can be associated with and/or can be linked other computers or computer systems.

In any of the herein-described embodiments, the respective communication device can operate independently of, and/or in conjunction with, a central service and/or a communications service. For example, a beeper or pager can be utilized in conjunction with a corresponding beeper or pager communications service, which communications service can serve to relay signals, data and/or information to, and from, the beeper or pager, whichever the case may be. The respective communication devices which can be utilized can also be capable of transmitting signals, data and/or information, directly to, and receiving signals, data and/or information, directly from, any of the devices or computers described herein, without the need for a central service and/or a communications service and/or a relay system.

The apparatus and method of the present invention can provide for transmitting signals, data and/or information, to the respective cardholder, account owner, account holder, user, operator, and/or other authorized individual, via transmissions made to, and received at a television, radio, car radio, computer and/or other communication device which receives signals transmitted via any suitable communication system. In this manner, for example, a respective cardholder, account owner, account holder, user, operator, and/or other authorized individual can be notified or account events, occurrences, transactions, and/or communications, by having signals, data and/or information, transmitted to a television, radio, car radio, computer, etc., in such a manner so as to interrupt the normal operation of same, and so as to convey the information and/or message to the respective carholder, account owner, account holder, user, operator, and/or other authorized individual, in real-time and/or otherwise, upon the occurrence of the event, occurrence, transaction, and/or communication, triggering or giving rise to same.

In any and/or all of the herein described embodiments, the apparatus can be programmed and/or can be programmable by the respective cardholder, account owner, account holder, and/or other authorized individuals. In conjunction with the use of credit cards, charge cards, debit cards, currency cards, electronic money cards, electronic cash cards, and/or digital cash cards, and/or any other cards and/or accounts described herein, the respective cardholder, account holder, account owner, and/or any other authorized individuals, can program the central processing computer, and/or the server computer, if utilized, for example, so as to change the credit limits on his or her account, periodically and/or at any desired time. For example, a cardholder having a credit card with a $10,000 dollar credit limit, but who very seldom utilizes his or her card for much more than $500 dollars during a monthly billing period, can program the apparatus and, in particular, the central processing computer, or server computer, if utilized, so as to temporarily reduce his or her credit limit.

If the cardholder should then desire to make a major purchase with his or her credit card of, for example, a purchase in the amount of $8500, the cardholder can, prior to the transaction, reprogram the central processing computer and/or server computer, if utilized, so as to temporarily increase his or her temporary credit limit. The apparatus can then be programmed so that, after the major purchase has been made, the apparatus can revert operation back to the reduced credit limit.

The cardholder, account holder, account owner, and/or any other authorized individuals, can program the central processing computer, and/or the server computer, if utilized, via the communication device, which can be any one or more of the devices described herein. The cardholder can also perform the above-described programming via a touch-tone telephone. In the same manner, the cardholder can program the apparatus so as to limit the types of transactions involving, and/or the goods and/or services which can be purchased with, his or her card, and/or the stores, goods and/or service providers which can be authorized to accept the card, limits on the dollar amounts of transactions pertaining to each authorized vendor, seller and/or service provider, daily spending limits, the vendors, sellers, and/or service providers with which the card can be utilized, the geographical area or location within which the card can be utilized, and/or authorized times for card usage (i.e. specific days, dates, times of day, times of month, year, etc.), and/or any other limitations and/or restrictions regarding amount of transaction, parties involved, geographical area, and or times of allowed usage. In a similar manner, the cardholder may similarly program the apparatus as described above in conjunction with the use of any of the herein-described cards.

In a similar manner, a cardholder of an electronic cash card, currency card, and/or “smart” card can program the apparatus so as to limit the types of transactions involving, and/or the goods and/or services which can be purchased with, his or her card, and/or the stores or service providers which can be authorized to accept the card, limits on the dollar amounts of transactions pertaining to each authorized vendor, seller and/or service provider, daily spending limits, the vendors, sellers, and/or service providers with which the card can be utilized, the geographical area or location within which the card can be utilized, and/or authorized times for card usage (i.e. specific days, dates, times of day, times of month, year, etc.), and/or any other limitations and/or restrictions regarding amount of transaction, parties involved, geographical area, and or times of allowed usage.

In the case of financial accounts, brokerage accounts, savings accounts, checking accounts, and/or automated teller machine accounts, and/or electronic cash accounts, the respective account owner, account holder, cardholder, and/or other authorized individuals, can program the apparatus and, in particular, the central processing computer, and/or the server computer, if utilized, so as to limit the amount of any one transaction or transactions, individuals who may make the transactions, proof of identity of which the types of proof may be specified, specific banks, financial and/or brokerage institutions authorized to accept and/or perform transactions for the account, the nature of the transactions, geographical areas and/or location within which banks, financial and brokerage institutions which can be authorized to accept and/or perform transactions with the account, specific purchases and/or trades which can be made in conjunction with the account, specific securities which can be purchased and/or traded in conjunction with the account, specific times of day, specific days, dates and/or time of the month in, or on, which transactions can be authorized, limits of charge-backs, returned item amount withdrawals, maintenance and/or other fee charge withdrawals, etc., and/or authorized times for account usage (i.e. specific days, dates, times of day, times of month, year, etc.), and/or any other limitations and/or restrictions regarding amount of transaction, parties involved, securities involved, geographical area, and or times of allowed usage.

With regards to any of the cards and/or accounts described herein, such as, the respective cardholders, account holders, account owners, and/or other authorized individuals, can specify and/or programmably change passwords, personal identification numbers and/or any other access code(s) and provide for various personal identification numbers and/or access codes for different locations, different automated teller machines, different days, different times and/or different transaction amounts.

In the cases of wireless communication devices, non-wireless communication devices, and/or Internet accounts, the account holder, account owner, and/or other authorized individuals, can program the apparatus and, in particular, the central processing computer, and/or the server computer, if utilized, so as to limit the phone numbers which may be called, and/or the numbers from which incoming calls may be accepted and/or received, the geographical areas and/or locations which may be called and/or accessed or from which calls may be received, the times of day, specific days, dates, times of month or year, during which the wireless or cellular device or telephone and/or communication device can be utilized, specific transactions which may be allowed, specific phone numbers which may be called, specific time durations for a transaction and/or phone call and/or any authorized times for wireless or cellular device or telephone and/or wireless or cellular communication device usage (i.e. specific days, dates, times of day, times of month, year, etc.), and/or any other limitations and/or restrictions, regarding amount and type of transaction, parties involved, geographical area, and or times of allowed usage.

The present invention can also be utilized so as to provide authorization, notification, and/or security, for any number, combinations, and/or types of accounts, including, but not limited to, the credit card accounts, charge card accounts, debit card accounts, smart card accounts, currency card accounts, telephone calling card accounts, cable television accounts, digital television accounts, satellite television accounts, insurance accounts, subscription accounts for any goods, products, and/or services, health care insurance accounts, pharmacy accounts, social security accounts, accounts monitoring use of official seals, accounts monitoring use of private, individual, and/or organizational seals or access codes, security access accounts, computer access code accounts, facility access accounts, facility security accounts, banking accounts, brokerage account, electronic money accounts, wireless communication accounts, non-wireless communications accounts, and/or Internet accounts, e-mail accounts, membership accounts, club membership accounts, entertainment membership accounts, entertainment tickets accounts, sports tickets accounts, theatre tickets accounts, concert or opera tickets accounts, consumer or purchaser memberships accounts, sports club membership accounts, health club membership accounts, merchant credit accounts for customers, merchant accounts, association membership accounts, professional association membership accounts, trade association membership accounts, and/or any accounts, cards, devices, and/or communication devices related and/or corresponding thereto, which are described herein.

The apparatus can include a communication device or communications devices which can receive and/or transmit signals, data, and/or information, for any number, combination, and/or types, of the herein-described accounts and/or devices, and/or for each of the respective accounts and/or devices utilized. In this manner, an individual may utilize a single communication device so as to monitor all of his or her accounts and/or devices and/or types of accounts.

The apparatus and method of the present invention provides for the real-time authorization, notification, and/or security, for any and/or all of the transactions, financial transactions, non-financial transactions, communication transactions, and/or Internet transactions, which can occur in and/or in relation to, any and/or all of the accounts described herein. The present invention enables a respective cardholder, account holder, account owner, user, operator, and/or other authorized individual, to monitor, in real-time, any of the herein-described transactions and/or activity involving his or her respective account, account card, and/or account devices and/or account-related devices.

The apparatus and method of the present invention also provides a means and a mechanism by which to inform a cardholder, account holder, and/or account owner, that a respective account, account card(s), and/or account device, is lost, stolen, or is being utilized in a fraudulent and/or in an unauthorized manner. The present invention also provides information to the respective a cardholder, account holder, and/or account owner, regarding how, when, and/or where, the respective account, account card, and/or account device, is being utilized in transactions and/or is otherwise and/or in other ways accessed and/or infiltrated. The cardholder, account holder, and/or account owner, can thereafter report the account activity, a lost or stolen account card, and/or cancel and/or de-activate the account.

In any and/or all of the embodiments described herein, an advertisement or any number of advertisements can be included in, and/or can be sent in conjunction with, or along with, any signal(s), data, information, message(s), and/or transmission(s), which is/are described herein as being transmitted to any communication device or communication devices described herein as being associated with, or used by, a respective account holder, cardholder, account owner, or any other authorized individual.

While the various communications device(s) described herein can be utilized for specific uses (i.e. credit card and/or other card transactions, account transactions, banking transactions, financial transactions, brokerage transactions, electronic cash transactions, and/or wireless communication device transactions, non-wireless communication device transactions, and/or Internet transactions), the communication device(s) can also be programmed and/or can be adapted for use in conjunction with multiple accounts and/or with any combination of accounts. In this manner, a single communication device can be utilized to service multiple accounts.

The apparatus and method of the present invention can be utilized in conjunction with other apparatuses and methods in the prior art, and further, the present invention can be incorporated with these known apparatuses and methods so as to improve upon them and so as to further define additional applications for the present invention as well as the teachings in the prior art.

Applicant hereby incorporates by reference herein the following United States Patents: U.S. Pat. No. 5,173,594 which teaches a system for printing personalized charge-card service receipts at remote locations; U.S. Pat. No. 5,479,510 which teaches an automated data card payment verification method; U.S. Pat. No. 5,473,667 which teaches a paging system with third party authorization; U.S. Pat. No. 3,723,655 which teaches a credit authorization terminal; U.S. Pat. No. 5,485,510 which teaches a secure credit/debit card authorization; U.S. Pat. No. 5,406,619 which teaches a universal authentication device for use over telephone lines; U.S. Pat. No. 5,444,616 which teaches financial transaction systems and methods utilizing a multi-reader transaction terminal; U.S. Pat. No. 5,513,250 which teaches telephone based credit card protection; U.S. Pat. No. 4,485,300 which teaches a loss control system; U.S. Pat. No. 4,758,714 which teaches a point-of-sale mechanism; U.S. Pat. No. 4,947,027 which teaches a system for identifying authorized use of credit cards; U.S. Pat. No. 5,357,563 which teaches a data card terminal for receiving authorizations from remote locations; U.S. Pat. No. 5,444,763 which teaches a translation and connection device for radio frequency point of sale transaction system; U.S. Pat. No. 5,243,645 which teaches an automatic system for forwarding of calls; U.S. Pat. No. 3,938,090 which teaches a terminal apparatus; U.S. Pat. No. 5,642,419 which teaches a method for acquiring and revalidating an electronic credential; U.S. Pat. No. 5,621,797 which teaches an electronic ticket presentation and transfer method; U.S. Pat. No. 5,557,518 which teaches trusted agents for open electronic commerce; U.S. Pat. No. 5,455,407 which teaches an electronic-monetary system; U.S. Pat. No. 5,453,601 which teaches an electronic-monetary system; U.S. Pat. No. 5,511,121 which teaches efficient electronic money; U.S. Pat. No. 5,224,162 which teaches an electronic cash system; U.S. Pat. No. 4,977,595 which teaches a method and apparatus for implementing electronic cash; U.S. Pat. No. 5,623,547 which teaches a value transfer system; U.S. Pat. No. 5,438,184 which teaches a method and apparatus for electronic cash transactions; U.S. Pat. No. 5,534,683 which teaches a system for conducting transactions with a multifunctional card having an electronic purse; U.S. Pat. No. 5,521,362 which teaches an electronic purse card having multiple storage memories to prevent fraudulent usage and method therefor; U.S. Pat. No. 5,221,838 which teaches an electronic wallet; U.S. Pat. No. 5,030,806 which teaches a transaction system of the electronic purse type; U.S. Pat. No. 4,992,646 which teaches a transaction system of the electronic purse type; and U.S. Pat. No. 4,877,950 which teaches an electronic purse device; U.S. Pat. No. 5,903,830 which teaches a transaction security apparatus and method; U.S. Pat. No. 5,878,337 which teaches a transaction security apparatus and method; U.S. Pat. No. 5,708,422 which teaches a transaction authorization and alert system; U.S. Pat. No. 5,699,528 which teaches a system and method for bill delivery and payment over a communications network; U.S. Pat. No. 5,661,285 which teaches a self-service, banking system; U.S. Pat. No. 5,655,007 which teaches a telephone based credit card protection; U.S. Pat. No. 5,631,947 which teaches a mobile telephone device for storing a plurality of changeable charge rates and time limit data; U.S. Pat. No. 5,615,110 which teaches a security system for non-cash transactions; U.S. Pat. No. 5,530,438 which teaches a method of providing an alert of a financial transaction; U.S. Pat. No. 5,526,407 which teaches a method and apparatus for managing information; U.S. Pat. No. 5,177,342 which teaches a transaction approval system; U.S. Pat. No. 5,335,278 which teaches a fraud prevention system and process for cellular mobile telephone networks; and U.S. Pat. No. 5,345,595 which teaches an apparatus and method for detecting fraudulent telecommunication activity.

In another preferred embodiment, as well as in any of the embodiments described herein, intelligent agents, software agents, mobile agents, and/or related technologies, can be utilized in conjunction with the present invention. The respective intelligent agent(s), software agent(s), mobile agent(s), (hereinafter referred to collectively as “intelligent agent” or “intelligent agents”) can be programmed and/or designed to act on behalf of the respective cardholders, account owners, account holders, device owners, and/or other owners, users and/or operators of the various point-of-sale devices, banking devices, brokerage devices, electronic cash devices, wireless communication devices, transaction communication devices, Internet communication devices, central processing computers, Internet server computers and account holder communication, devices described herein, so as to act on behalf of the respective party or parties as well as to perform any of processing functions and/or other functions described herein.

The intelligent agent can act on behalf of the respective party or parties in various related interactions and/or other activities which are described as being performed herein and/or which may be incidental and/or related thereto. Therefore, the present invention also provides an agent-based apparatus and method for providing account security.

Applicant hereby incorporates by reference herein the subject matter of the Agent Sourcebook, A Complete Guide to Desktop, Internet and Intranet Agents, by Alper Caglayan and Colin Harrison, Wiley Computer Publishing, 1997. Applicant also incorporates by reference herein the subject matter of Cool Intelligent Agents For The Net, by Leslie L. Lesnick with Ralph E. Moore, IDG Books Worldwide, Inc. 1997.

The apparatus of the present invention, in any and/or all of the embodiments described herein, can also be programmed to be self-activating and/or activated automatically.

The apparatus of the present invention can also be programmed in order to automatically generate and/or transmit any of the e-mails, electronic message transmissions, electronic notification transmissions, telephone calls, pager transmission and/or messages, and/or any of the other communications, which are described herein, between any of the parties which utilize the present invention.

The present invention, in any and/or all of the herein-described embodiments, can utilize electronic commerce technologies and security methods, techniques and technologies, as described and as set forth in Electronic Commerce Technical, Business and Legal Issues, Nabil R. Adam, et al. Prentice Hall, 1999 and Web Security & Commerce, Simson Garfinkel with Gene Spafford, O'Reilly 1997, the subject matter of which are hereby incorporated by reference herein.

The communications networks and/or systems on, or over, which the present invention may be utilized, can include any one or combination of telecommunication networks or systems, satellite communication networks or systems, radio communication networks or systems, digital communication networks or systems, digital satellite communication networks or systems, personal communications services networks or systems, cable television networks or systems, digital television networks or systems, satellite television networks or systems, broadband communication networks or systems, low earth orbiting satellite (LEOs) networks or systems, wireless communication networks or systems, wireless Internet networks or systems, wireless World Wide Web networks or systems, as well as in, or on any internets and/or intranets, the Internet, the World Wide Web, and any other suitable communication network or system.

While the present invention has been described and illustrated in various preferred and alternate embodiments, such descriptions are merely illustrative of the present invention and are not to be construed to be limitations thereof. In this regard, the present invention encompasses any and all modifications, variations and/or alternate embodiments with the scope of the present invention being limited only by the claims which follow.

What is claimed is:

1. An account security apparatus, comprising:
a memory device for storing a limitation or restriction on a use of an account, wherein the account is at least one of a cable television account, an electrical utility account, a gas utility account, a fuel oil utility account, an insurance account, a subscription account for a good, product, or service, a health care insurance account, a pharmacy account, a social security account, and a credit report account, wherein the limitation or restriction is transmitted to a receiver from a communication device associated with an individual account holder, and wherein the limitation or restriction is automatically received by the receiver, and further wherein the limitation or restriction is automatically stored in the memory device; and
a processing device for processing an authorization request for a transaction on the account or a use of the account, wherein the processing device utilizes the limitation or restriction automatically stored in the memory device in processing the authorization request, wherein the processing device generates a signal containing information for authorizing or disallowing the transaction on the account or the use of the account.

2. The apparatus of claim 1, further comprising:
a transmitter for transmitting a second signal to a communication device associated with the individual account holder, wherein the communication device receives the second signal, and further wherein the second signal contains information regarding the transaction.

3. The apparatus of claim 1, wherein the authorization request is transmitted to the apparatus from an authorization device.

4. The apparatus of claim 2, further comprising:
a receiver for receiving a third signal, wherein the third signal is transmitted to the receiver from the communication device which receives the second signal, and further wherein the third signal contains information for authorizing or disallowing the transaction on the account or the use of the account.

5. The apparatus of claim 1, wherein the authorization request is transmitted to the apparatus from at least one of a point-of-sale authorization device, a point-of-sale authorization terminal, and a transaction authorization device.

6. The apparatus of claim 1, wherein the limitation or restriction is transmitted to a receiver via, on, or over, at least one of the Internet and the World Wide Web.

7. The apparatus of claim 2, wherein the transmitter transmits the second signal to a plurality of communication devices which receive the second signal, wherein the plurality of communication devices which receive the second signal are associated with the individual account holder, and further wherein the transmitter transmits the second signal to the plurality of communication devices which receive the second signal at least one of simultaneously and sequentially.

8. The apparatus of claim 1, further comprising:
a transmitter for transmitting an electronic mail message to a computer in a network, wherein the computer in a network is associated with the individual account holder, wherein the electronic mail message contains information regarding the transaction, and further wherein the computer in a network transmits the electronic mail message to a communication device associated with the individual account holder.

9. The apparatus of claim 4, wherein the processing device processes the third signal and determines whether the transaction on the account or the use of the account is authorized or disallowed.

10. The apparatus of claim 4, wherein the processing device processes the third signal and determines whether the transaction on the account or the use of the account is authorized or disallowed, and further wherein the processing device transmits a fourth signal to the transaction authorization device, wherein the fourth signal contains information for at least one of authorizing the transaction on the account or the use of the account, disallowing the transaction on the account or the use of the account, and canceling the transaction on the account or the use of the account.

11. An account security apparatus, comprising:
a processing device for processing information regarding a transaction on an account or a use of an account, wherein the account is at least one of a cable television account, an electrical utility account, a gas utility account, a fuel oil utility account, an insurance account, a subscription account for a good, product, or service, a health care insurance account, a pharmacy account, a social security account, and a credit report account, wherein the information is automatically received by a receiver, wherein the processing device is capable of allowing or disallowing the transaction on the account or the use of the account, and further wherein the processing device generates a signal containing information regarding the transaction on the account or the use of the account; and
a transmitter for transmitting the signal to a communication device associated with an individual account holder, wherein the signal is transmitted to the communication device via, on, or over, at least one of the Internet and the World Wide Web, and further wherein the communication device provides information to the individual account holder regarding the transaction on the account or the use of the account.

12. An account security apparatus, comprising:
at least one of an input device and a data entry device for at least one of inputting and entering information regarding a transaction on an account or a use of an account into a first communication device, wherein the account is at least one of a cable television account, an electrical utility account, a gas utility account, a fuel oil utility account, an insurance account, a subscription account for a good, product, or service, a health care insurance account, a pharmacy account, a social security account, and a credit report account;
a processing device for processing the information and for generating a signal corresponding to the transaction on the account or the use of the account; and
a transmitter for transmitting the signal to a second communication device, wherein the second communication device is associated with an individual account holder, and wherein the second communication device provides information to the individual account holder regarding the transaction on the account or the use of the account, and further wherein the second communication device is at least one of a beeper, a pager, a telephone, a two-way pager, a reply pager, a home computer, a personal computer, a personal communication device, a personal communication services device, a television, an interactive television, a digital television, a personal digital assistant, a display telephone, a video telephone, a watch, a cellular telephone, a wireless telephone, a mobile telephone, a display cellular telephone, and a facsimile machine.

13. The apparatus of claim 11, wherein the signal is transmitted to the communication device after the transaction on the account or the use of the account begins and before the transaction on the account or the use of the account ends.

14. The apparatus of claim 11, wherein the communication device is a cellular telephone, a personal digital assistant, a personal computer, or a television.

15. The apparatus of claim 11, further comprising:
a receiver for receiving a second signal, wherein the second signal is transmitted to the receiver from the communication device, and further wherein the second signal contains information for authorizing or disallowing the transaction on the account or the use of the account.

16. The apparatus of claim 15, wherein the processing device processes the second signal and determines whether the transaction on the account or the use of the account is authorized or disallowed.

17. The apparatus of claim 12, wherein the signal is transmitted to the second communication device via, on, or over, at least one of the Internet and the World Wide Web.

18. The apparatus of claim 12, wherein the signal is transmitted to the communication device after the transaction on the account or the use of the account begins and before the transaction on the account or the use of the account ends.

19. The apparatus of claim 12, wherein the second communication device is a wireless device.

20. The apparatus of claim 12, further comprising:
a receiver for receiving a second signal, wherein the second signal is transmitted to the receiver from the second communication device, and further wherein the second signal contains information for authorizing or disallowing the transaction on the account or the use of the account.
